(19) United States
(12) Patent Application Publication
(10) Pub. No.: US 2010/0183077 A1
(43) Pub. Date: Jul. 22, 2010

(54) RESPONSE TO ATSC MOBILE/HANDHELD RFP A-VSB MCAST AND, A-VSB PHYSICAL AND LINK LAYERS WITH SINGLE FREQUENCY NETWORK

(75) Inventors: June-Hee Lee, Seongnam-si (KR); Joon-Soo Kim, Seoul (KR); Jung-Pil Yu, Suwon-si (KR); Chan-Sub Park, Incheon (KR); Jong-On Park, Yongin-si (KR); Jung-Jin Kim, Seoul (KR); In-Sik Chang, Seoul (KR); Yong-Sik Kwon, Seoul (KR); Jun-Seok Kang, Bucheon-si (KR); Eui-Jun Park, Seoul (KR); Jin-Hee Jeong, Anyang-si (KR); Kum-Ran Ji, Seoul (KR); Jong-Hun Kim, Suwon-si (KR); Se-Jun Kim, Suwon-si (KR); Hae-Joo Jeong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/666,918

(22) PCT Filed: Jun. 30, 2008
(86) PCT No.: PCT/IB08/01725

§ 371 Date: Dec. 28, 2009

Related U.S. Application Data
(60) Provisional application No. 60/946,851, filed on Jun. 28, 2007.
(60) Provisional application No. 60/947,501, filed on Jul. 2, 2007.
(60) Provisional application No. 60/948,081, filed on Jul. 5, 2007.
(60) Provisional application No. 60/948,119, filed on Jul. 5, 2007.
(60) Provisional application No. 60/952,662, filed on Jul. 30, 2007.
(60) Provisional application No. 60/979,528, filed on Oct. 12, 2007.
(60) Provisional application No. 61/041,356, filed on Apr. 1, 2008.

(51) Int. Cl. H04N 11/04

(52) U.S. Cl. 375/240.24; 375/E07.026

(57) ABSTRACT

A digital broadcasting transmitter including a Reed-Solomon (RS) encoder to encode signaling information, and a randomizer to randomize a stream including the signaling information encoded by the RS encoder. The signaling information is used by a receiver to demodulate and/or equalize the stream.

### CROSS-REFERENCE TO RELATED APPLICATION

This application claims the benefit of PCT International Patent Application No. PCT/IB2008/001725, filed Jun. 30, 2008, and U.S. Provisional Application No. 60/946,851, filed Jun. 28, 2007, U.S. Provisional Application No. 60/947,501, filed Jul. 2, 2007, U.S. Provisional Application No. 60/948,081, filed Jul. 5, 2007, U.S. Provisional Application No. 60/948,119, filed Jul. 5, 2007, U.S. Provisional Application No. 60/952,662, filed Jul. 30, 2007, U.S. Provisional Application No. 60/979,528, filed Oct. 12, 2007 and U.S. Provisional Application No. 61/041,356, filed Apr. 1, 2008, in the United States Patent and Trademark Office, the disclosures of which are incorporated herein by reference.

### BACKGROUND OF THE INVENTION

1. Field of the Invention

Aspects of the present invention relate to digital multimedia broadcasts and, more particularly, to an advanced vestigial sideband (A-VSB) physical layer for digital multimedia broadcasts.

2. Description of the Related Art

Conventionally, digital television is broadcast using the 8-level vestigial sideband (8-VSB) standard chosen by the Advanced Television Systems Committee (ATSC). However, the 8-VSB standard is unable to reliably transmit digital broadcasts to mobile receivers.

### SUMMARY OF THE INVENTION

Aspects of the present invention provide signaling information used by a receiver to demodulate and/or equalize a stream, the signaling information being encoded and randomized.

According to an aspect of the present invention, there is provided a digital broadcasting transmitter, including: a Reed-Solomon (RS) encoder to encode signaling information; and a randomizer to randomize a stream including the signaling information encoded by the RS encoder.

According to another aspect of the present invention, there is provided a method of processing a stream by a digital broadcasting transmitter, the method including: encoding signaling information; and randomizing a stream including the encoded signaling information.

According to another aspect of the present invention, there is provided a digital broadcasting receiver, including: a receiver to receive a turbo stream processed to be robust against errors and signaling information; a demodulator to demodulate the turbo stream; and an equalizer to equalize the turbo stream, wherein the demodulator and/or the equalizer demodulates and/or equalizes the turbo stream using the signaling information, and wherein the signaling information is transmitted from a digital broadcasting transmitter which comprises an RS encoder to encode the signaling information and a randomizer to randomize the encoded signaling information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the overall architecture of A-VSB MCAST;

FIG. 2 illustrates the functional architecture of A-VSB MCAST;

FIG. 3 illustrates the A-VSB system architecture;

FIG. 4 illustrates deterministic and non-deterministic framing;

FIG. 5 illustrates an A-VSB multiplexer and exciter;

FIG. 6 illustrates a VFIP packet location in a frame;

FIG. 7 illustrates a byte-splitter and (12) TCM encoders;

FIG. 8 illustrates a TCM Encoder with deterministic trellis reset;

FIG. 9 illustrates normal MPEG TS packet syntax;

FIG. 10 illustrates normal TS packet syntax with adaptation field;

FIG. 11 illustrates a VSB parcel, package, sliver, and track;

FIG. 12 illustrates packet segmentation with adaptation field;

FIG. 13 illustrates packet segmentation without adaptation field;

FIG. 14 illustrates packet segmentation without adaptation field at the 0th packet in a track;

FIG. 15 illustrates packet segmentation by sectors where the 0th packet is assumed to have no AF;

FIG. 16 illustrates packet segmentation by sectors where the 0th packet is assumed to have the AF;

FIG. 17 illustrates a data mapping representation;

FIG. 18 illustrates an example of data mapping

FIG. 19 illustrates another example of data mapping;

FIG. 20 illustrates data mapping with SRS;

FIG. 21 illustrates data mapping with distributed SRS with the adaptation field;

FIG. 22 illustrates data mapping with distributed SRS without the adaptation field;

FIG. 23 illustrates an A-VSB multiplexer for SRS;

FIG. 24 illustrates an A-VSB exciter for SRS;

FIG. 25 illustrates an SRS stuffer;

FIG. 26 illustrates a parity compensator;

FIG. 27 illustrates a burst SRS-placeholder-carrying TS packet;

FIG. 28 illustrates an A-VSB transmission adaptor output for burst SRS;

FIG. 29 illustrates an MPEG data stream carrying SRS bytes;

FIG. 30 illustrates a VSB frame;

FIG. 31 illustrates a VSB sliver of DF template for SRS;

FIG. 32 illustrates a TCM encoder block with parity correction;

FIG. 33 illustrates a sliver snapshot in burst SRS;

FIG. 34 illustrates a distributed SRS-placeholder-carrying TS packet;

FIG. 35 illustrates a distributed SRS mapping in track (Size=6, 7, 10, 14 Sectors);

FIG. 36 illustrates a package carrying distributed SRS-bytes;

FIG. 37 illustrates an A-VSB frame with advanced SRS;

FIG. 38 illustrates SRS-bytes, DTR, and parity compensation in distributed SRS of 6 sectors;

FIG. 39 illustrates SRS-bytes, DTR, and parity compensation in distributed SRS of 7 sectors;

FIG. 40 illustrates SRS-bytes, DTR, and parity compensation in distributed SRS of 10 sectors;

FIG. 41 illustrates SRS-bytes, DTR, and parity compensation in distributed SRS of 14 sectors;

FIG. 42 is an overview of FIG. 41;

FIG. 43 illustrates a functional encoding structure for a turbo stream;

FIG. 44 illustrates an A-VSB transmitter for a turbo stream;

FIG. 45 illustrates an A-VSB multiplexer;

FIG. 46 illustrates an output of a transmission adaptor in 1 package;

FIG. 47 illustrates a turbo stream sliver template;

FIG. 48 illustrates an MCAST stream from an MCAST service multiplexer;

FIG. 49 illustrates a randomizer defined in A/53 Part 2;

FIG. 50 illustrates a (208, 188) systematic RS encoder;

FIG. 51 illustrates a time interleaver;

FIG. 52 illustrates a basic idea for a time interleaver in burst transmission;

FIG. 53 illustrates optional processing for the time interleaver;

FIG. 54 illustrates a pre-processing for the time interleaver in burst transmission;

FIG. 55 illustrates post-processing for time interleaver in burst transmission;

FIG. 56 illustrates outer encoding on a byte basis;

FIG. 57 illustrates an outer encoder;

FIG. 58 illustrates ½-rate encoding in the outer encoder;

FIG. 59 illustrates ⅓-rate encoding in the outer encoder;

FIG. 60 illustrates ¼-rate encoding in the outer encoder;

FIG. 61 illustrates ⅙-rate encoding in the outer encoder for a SIC;

FIG. 62 illustrates an interleaving rule where the length of an input block is 4 bits;

FIG. 63 illustrates a multi-stream data de-interleaver;

FIG. 64 illustrates a turbo stream transmission combined with SRS;

FIG. 65 illustrates a sliver template for burst SRS of 20 bytes and a turbo stream;

FIG. 66 illustrates a sliver template for distributed SRS of 14 sectors and a turbo stream;

FIG. 67 illustrates a field sync at an even field;

FIG. 68 illustrates a field sync at an odd field;

FIG. 69 illustrates a signaling bit structure for A-VSB;

FIG. 70 illustrates error correction coding for DFS;

FIG. 71 illustrates a Reed-Solomon (6,4) t=1 parity generator polynomial;

FIG. 72 illustrates a 1/7 rate tail biting convolutional encoder {37, 27, 25, 27, 33, 35, 37} octal number;

FIG. 73 illustrates a randomizer;

FIG. 74 illustrates an insertion of signaling information into DFS;

FIG. 75 illustrates a single frequency network (SFN);

FIG. 76 illustrates a VFIP over a distribution network;

FIG. 77 illustrates a VFIP SFN;

FIG. 78 illustrates DTR byte positions in an ATSC interleaver;

FIG. 79 illustrates a common temporal reference;

FIG. 80 illustrates an SFN timing diagram;

FIG. 81 illustrates VFIP error detection and correction;

FIG. 82 illustrates translators supported in SFN;

FIG. 83 illustrates a graph representing the generator matrix G;

FIG. 84 illustrates a flow chart for finding deg(vi);

FIG. 85 illustrates a flow chart for message node and codeword node connection;

FIG. 86 illustrates a flow chart for obtaining a message node index;

FIG. 87 illustrates the overall architecture of A-VSB MCAST;

FIG. 88 illustrates the functional architecture of A-VSB MCAST;

FIG. 89 illustrates the A-VSB system architecture;

FIG. 90 illustrates deterministic and non-deterministic framing;

FIG. 91 illustrates an A-VSB multiplexer and exciter;

FIG. 92 illustrates a VFIP packet location in a frame;

FIG. 93 illustrates an A/53 byte interleaver and (12) TCM encoders;

FIG. 94 illustrates a TCM Encoder with deterministic trellis reset;

FIG. 95 illustrates normal MPEG TS packet syntax;

FIG. 96 illustrates normal TS packet syntax with adaptation field;

FIG. 97 illustrates a VSB parcel, package, sliver, and track;

FIG. 98 illustrates packet segmentation with adaptation field;

FIG. 99 illustrates packet segmentation without adaptation field;

FIG. 100 illustrates packet segmentation without adaptation field at the 0th packet in a track;

FIG. 101 illustrates packet segmentation by sectors where the 0th packet is assumed to have no AF;

FIG. 102 illustrates packet segmentation by sectors where the 0th packet is assumed to have the AF;

FIG. 103 illustrates a data mapping representation;

FIG. 104 illustrates an example of data mapping;

FIG. 105 illustrates another example of data mapping;

FIG. 106 illustrates data mapping with burst SRS;

FIG. 107 illustrates data mapping with distributed SRS with the adaptation field;

FIG. 108 illustrates data mapping with distributed SRS without the adaptation field;

FIG. 109 illustrates an A-VSB multiplexer for SRS;

FIG. 110 illustrates an A-VSB exciter for SRS;

FIG. 111 illustrates an SRS stuffer;

FIG. 112 a burst SRS-placeholder-carrying TS packet;

FIG. 113 illustrates an A-VSB transmission adaptor output for burst SRS;

FIG. 114 illustrates an MPEG data stream carrying SRS bytes;

FIG. 115 illustrates a VSB frame;

FIG. 116 illustrates a VSB sliver of DF template for SRS;

FIG. 117 illustrates a TCM encoder block with parity correction;

FIG. 118 illustrates a sliver snapshot in burst SRS;

FIG. 119 illustrates a distributed SRS-placeholder-carrying TS packet;

FIG. 120 illustrates a distributed SRS mapping in track (Size=6, 7, 10, 14 Sectors);

FIG. 121 illustrates a package carrying distributed SRS-bytes;

FIG. 122 illustrates an A-VSB frame with advanced SRS;

FIG. 123 illustrates SRS-bytes, DTR, and parity compensation in distributed SRS of 6 Sectors;

FIG. 124 illustrates SRS-bytes, DTR, and parity compensation in distributed SRS of 7 sectors;

FIG. 125 illustrates SRS-bytes, DTR, and parity compensation in distributed SRS of 10 sectors;

FIG. 126 illustrates SRS-bytes, DTR, and parity compensation in distributed SRS of 14 sectors;

FIG. 127 is a sliver snapshot of FIG. 126;

FIG. 128 illustrates a functional encoding structure for a turbo stream;

FIG. 129 illustrates an A-VSB transmitter for a turbo stream;

FIG. 130 illustrates an A-VSB multiplexer;

FIG. 131 illustrates an output of a transmission adaptor in 1 package;

FIG. 132 illustrates a turbo stream sliver template;

FIG. 133 illustrates an MCAST stream from an MCAST service multiplexer;

FIG. 134 illustrates a randomizer defined in A/53 Part 2;

FIG. 135 illustrates a (208, 188) systematic RS encoder;

FIG. 136 illustrates a time interleaver;

FIG. 137 illustrates a basic idea for a time interleaver in burst transmission;

FIG. 138 illustrates optional processing for the time interleaver;

FIG. 139 illustrates packet rearrangement and cummy insertion for the time interleaver;

FIG. 140 illustrates post-processing for time interleaver in burst transmission;

FIG. 141 illustrates outer encoding on a byte basis;

FIG. 142 illustrates an outer encoder;

FIG. 143 illustrates ½-rate encoding in the outer encoder;

FIG. 144 illustrates ⅓-rate encoding in the outer encoder;

FIG. 145 illustrates ¼-rate encoding in the outer encoder;

FIG. 146 illustrates ⅙-rate encoding in the outer encoder for a SIC;

FIG. 147 illustrates an interleaving rule where the length of an input block is 4 bits

FIG. 148 illustrates a multi-stream data de-interleaver;

FIG. 149 illustrates a turbo stream transmission combined with SRS;

FIG. 150 illustrates a sliver template for burst SRS of 20 bytes and a turbo stream;

FIG. 151 illustrates a sliver template for distributed SRS of 14 sectors and a turbo stream;

FIG. 152 illustrates a field sync at an even field;

FIG. 153 illustrates a field sync at an odd field;

FIG. 154 illustrates a signaling bit structure for A-VSB;

FIG. 155 illustrates error correction coding for DFS;

FIG. 156 illustrates a Reed-Solomon (6,4) t=1 parity generator polynomial;

FIG. 157 illustrates a 1/7 rate tail biting convolutional encoder {37, 27, 25, 27, 33, 35, 37} octal number;

FIG. 158 illustrates a randomizer;

FIG. 159 illustrates an insertion of signaling information into DFS;

FIG. 160 illustrates a single frequency network (SFN);

FIG. 161 illustrates a VFIP over a distribution network;

FIG. 162 illustrates a VFIP SFN;

FIG. 163 illustrates DTR byte positions in an ATSC interleaver;

FIG. 164 illustrates a common temporal reference;

FIG. 165 illustrates an SFN timing diagram;

FIG. 166 illustrates VFIP error detection and correction;

FIG. 167 illustrates translators supported in SFN;

FIG. 168 illustrates a VSB sliver of DF template for SRS;

FIGS. 169 to 173 illustrate SRS-bytes, DTR, and parity compensation in distributed SRS of 6 sectors;

FIGS. 174 to 178 illustrate SRS-bytes, DTR, and parity compensation in distributed SRS of 7 sectors;

FIGS. 179 to 183 illustrate SRS-bytes, DTR, and parity compensation in distributed SRS of 10 sectors;

FIGS. 184 to 188 illustrate SRS-bytes, DTR, and parity compensation in distributed SRS of 14 sectors;

FIG. 189 illustrates a sliver template for burst SRS of 20 bytes and a turbo stream;

FIG. 190 illustrates a VSB sliver of DF template for SRS;

FIGS. 191 to 195 illustrate SRS-bytes, DTR, and parity compensation in distributed SRS of 6 sectors;

FIGS. 196 to 200 illustrate SRS-bytes, DTR, and parity compensation in distributed SRS of 7 sectors;

FIGS. 201 to 205 illustrate SRS-bytes, DTR, and parity compensation in distributed SRS of 10 sectors;

FIGS. 206 to 210 illustrate SRS-bytes, DTR, and parity compensation in distributed SRS of 14 sectors; and

FIG. 211 illustrates a sliver template for burst SRS of 20 bytes and a turbo stream.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The following references are cited in the present disclosure, and are incorporated herein by reference:

ISO/IEC 13818-1:2000 Information technology—Generic Coding of moving pictures and associated audio information: Systems

### ATSC A153:2006: “ATSC Standard: Digital Television Standard (A/53), Parts 1 and 2”, Advanced Television Systems Committee, Washington, D.C.

### ATSC A/110A: “Synchronization Standard for Distributed Transmission, Revision A”, Section 6.1, “Operations and Maintenance Packet Structure”, Advanced Television Systems Committee, Washington, D.C.

ETSI TS 101 191 V1.4.1 (2004-06), “Technical Specification Digital Video Broadcasting DVB); DVB mega-frame for Single Frequency Network (SFN) synchronization”, Annex A, “CRC Decoder Model”, ETS
ATSC TSG3-019r9_TSG-3 report to TSG_privatedata.doc

### ATSC A/90. “ATSC DATA BROADCAST STANDARD”

In the present disclosure, the terms used herein have the following definitions:

Application layer—AudioNideo (NV) streaming, IP, and NRT services.

ATSC Epoch—Start of Advanced Television Systems Committee (ATSC) System Time (Jan. 6, 1980 00:00:00 UTC).

ATSC System Time—Number of Super Frames since ATSC Epoch.

A-VSB Multiplexer—a special purpose ATSC multiplexer that is used at the studio facility and feeds directly to an 8-level vestigial sideband (8-VSB) transmitter, or transmitters, each having an advanced vestigial sideband (A-VSB) exciter.

Cluster—a group of any number of sectors where Turbo bytes are placed.

Cross Layer Design—an 8-VSB enhancement technique that places requirements and/or constraints on one system layer by another to gain an overall efficiency and/or performance not intrinsically inherent from the 8-VSB system architecture while still maintaining backward compatibility.

Data Frame—includes two Data Fields, each containing 313 Data Segments. The first Data Segment of each Data Field is a unique synchronizing signal (Data Field Sync).

Exciter—receives the baseband signal (Transport Stream), performs the main operations of channel coding and modulation and produces RF Waveform at assigned frequency. The exciter is capable of receiving external reference signals such as 10 MHz frequency. One pulse per second (1PPS) and GPS seconds count from a GPS receiver.

Link layer—FEC encoding, partitioning and mapping between Turbo stream and clusters.

Linkage Information Table (LIT)—linkage information between service components which is placed in the first signal packet in MCAST parcel.

Location Map Table (LMT)—location information that is placed in the first signal packet in the MCAST parcel.

MAC—a unit partitioning and mapping between Turbo stream and clusters in the link layer

MCAST—Mobile Broadcasting for A-VSB.

MCAST parcel—a group of MCAST packets protected by a Turbo code within a VSB parcel.

MCAST stream—a sequence of MCAST packets.

MCAST Transport layer—Transport layer defined in ATSC-MCAST.

MPEG data—sync byte-absent MPEG transport stream (TS).

MPEG data packet—sync byte-absent MPEG TS packet.

MPEG TS—MPEG transport stream, which is a sequence of MPEG packets.

MPEG TS packet—a MPEG transport stream packet.

N_{SRS}—number of supplementary reference sequence (SRS) bytes in the adaptation field (AF) in a TS or MPEG data packet.

N_{TStream}—number of bytes in the AF in a TS or MPEG data packet for Turbo stream, Cluster size.

N_{TP}—number of MCAST packets encapsulated in a package.

Package—group of 312 TS or MPEG data packets, a VSB package.

Parcel—group of 624 TS of MPEG data packets, a VSB parcel.

Primary Service—First priority service the user watches when powered on. This is an optional service for the broadcaster.

Sector—8 bytes of reserved space in the AF of a TS or MPEG data packet.

Segment—in a normal ATSC A/53 exciter, MPEG data are interleaved by an ATSC A/53 Byte Interleaver. A data unit of consecutive 207 bytes is called a segment payload or just segment.

SIC—Signaling information channel for every Turbo stream and which is itself a Turbo stream

Slice—group of 52 segments.

Sliver—group of 52 TS or MPEG data packets.

SRS-bytes—Pre-calculated bytes to generate SRS-symbols.

SRS-symbols—SRS created with SRS-bytes through zero-state TCMs.

Sub data channel—Physical space for AN streaming, IP and NRT data within a MCAST parcel A group of sub data channels constitutes a Turbo channel.

Super Frame—one of a continuous grouping of twenty (20) consecutive VSB Frames which first started at ATSC Epoch

TCM Encoder—a set of the Pre-Coder, Trellis Encoder, and 8-level-mapper.

Track—group of 4 TS or MPEG data packets.

Transport layer—Transport layer defined in ATSC-MCAST.

Turbo data—Turbo coded data (bytes) composing Turbo TS packet.

Turbo channel—Physical space for MCAST stream, divided into several sub-data channel.

Turbo Stream—Turbo coded Transport Stream.

Turbo TS packet —Turbo coded Transport Stream packet.

VFIP—Special OMP generated by an A-VSB Multiplexer (locked AST) which the appearance of in the ATSC Transport Stream signals the beginning of a Super Frame to the Exciter which results in placement of the Data Sync Field (DFS) with No PN 63 Inversion in the VSB Frame.

VSB Frame—626 segments consisting of 2 data field sync segments and 624 (data+FEC) segments.

In the present disclosure, the following abbreviations are used herein:

### 1PPS One Pulse Per Second

### 1PPSF One Pulse Per Super Frame

### A-VSB Advanced VSB System

### AF Adaptation Field

### AST ATSC System Time

### DC Decoder Configuration

### DCI Decoder Configuration Information

### DFS Data Field Sync

EC channel Elementary Component channel

### ES Elementary Stream

### F/L First/Last

### FEC Forward Error Correction

### GPS Global Positioning System

### IPEP IP Encapsulation Packet

### LMT Location Map Table

### LIT Linkage Information Table

### MAC Medium Access Control

### MCAST Mobile Broadcasting

### OEP Object Encapsulation Packet

### OMP Operations and Maintenance Packet

### PCR Program Clock Reference

### PSI Program Specific Information

### REP Real-time Encapsulation Packet

### SD-VFG Service Division in Variable Frame Group

### SEP Signaling Encapsulation Packet

### SF Super Frame

### SFN Single Frequency Network

### SIC Signaling Information Channel

### TCM Trellis Coded Modulation

TS A/53 defined Transport Stream

### PSI/PSIP Program Specific Information/Program Specific Information Protocol

### UTF Unit Turbo Fragment

The A-VSB Mobile Broadcasting (A-VSB MCAST) design consists of transport and signaling optimized for mobile and handheld services. The following disclosure provides the overall A-VSB MCAST architecture, and specifies the physical and link layers. Backwards compatibility is ensured by the careful design of the physical and link layers.

A-VSB MCAST Architecture

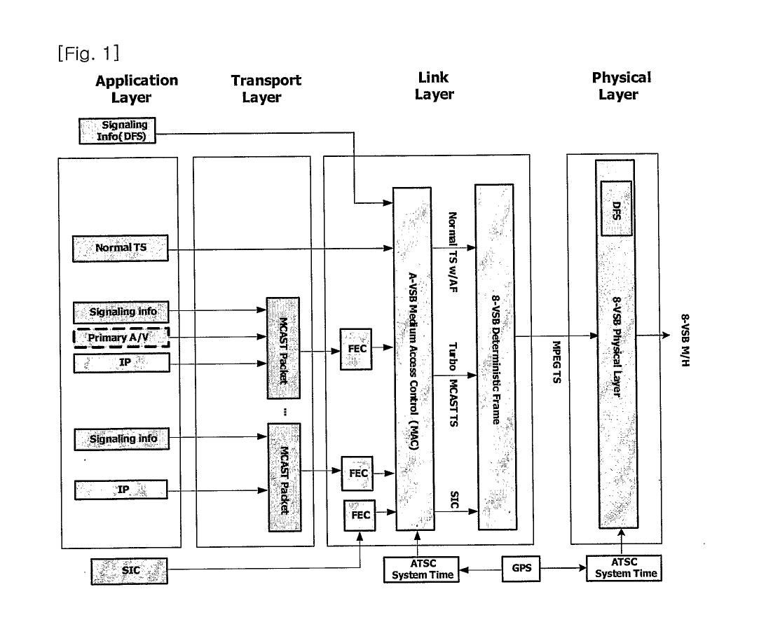

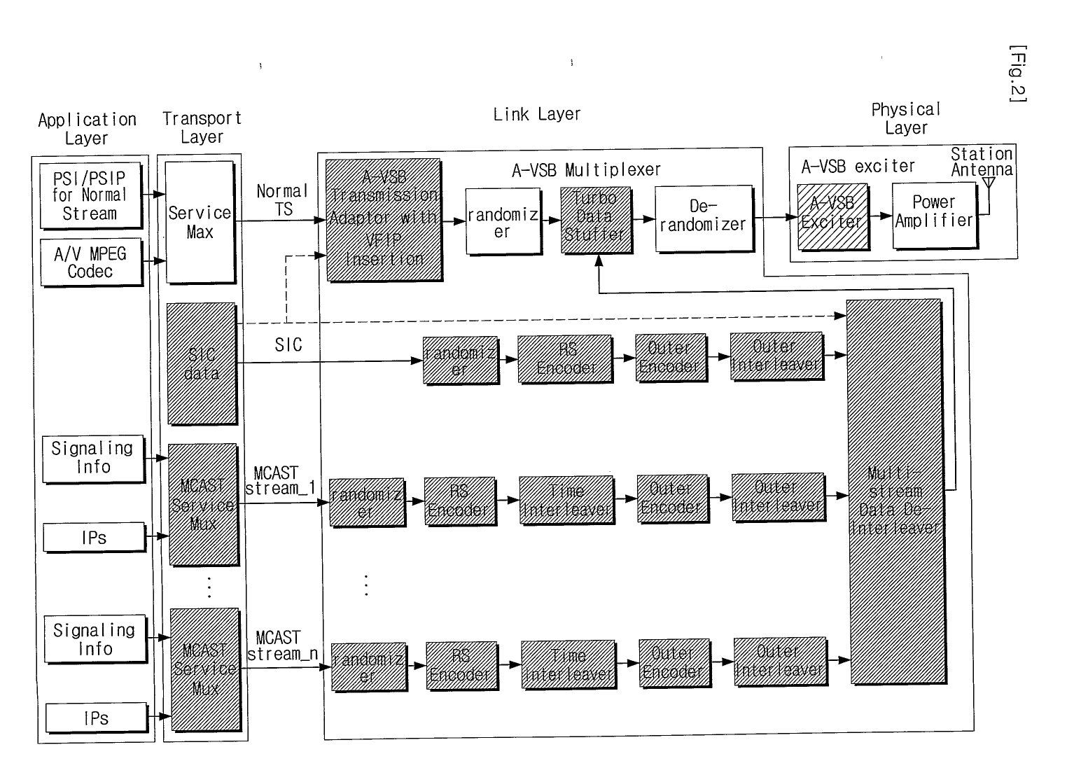

FIG. 1 illustrates the overall architecture of A-VSB MCAST, and FIG. 2 illustrates the overall architecture of A-VSB MCAST in more detail. Referring to FIGS. 1 and 2, A-VSB MCAST includes 4 layers: an application layer, a transport layer, a link layer, and a physical layer. IP Services are multiplexed into an MCAST stream per turbo channel. For fast initial service acquisition, A-VSB MCAST provides a primary service, which will be described in more detail below.

The link layer receives the turbo channels and applies a specific FEC (code rate, etc) to each turbo channel. The signaling information in the SIC will have the most robust FEC (⅙ rate turbo code) to ensure that the signaling information can be received at a signal-to-noise (SNR) level below the application data that the signaling information is signaling. The turbo channels with FEC applied thereto are then sent to the A-VSB MAC unit along with the normal TS packets. The exciter signaling information is transported in OMP or SRS placeholder bytes from the studio to the transmitter. The A-VSB Medium Access Control (MAC) unit is responsible for the sharing of the physical layer medium (8-VSB) between normal and robust data.

The A-VSB MAC unit uses adaptation fields (AF) in normal TS packets when needed. The A-VSB MAC Layer places constraints or rules on how the physical layer is to be operated in a deterministic manner and how the physical layer is partitioned between normal and robust data. The robust data is mapped into a deterministic frame structure, signaled, and sent to the 8-VSB physical layer to achieve an overall gain in system efficiency and/or performance (enhancement) not intrinsically inherent from the 8-VSB system while still maintaining backward compatibility. The exciter at the physical layer also operates deterministically under the control of the MAC unit and inserts signaling in DFS.

Physical and Link Layers (A-VSB)

System Overview

The objective of A-VSB MCAST is to improve reception issues of 8-VSB services in mobile or handheld modes of operation. This system is backwards-compatible in that existing receiver designs are not adversely affected by the A-VSB signal. This disclosure defines the following core techniques: Deterministic Frame (DF) and Deterministic Trellis Reset (DTR).

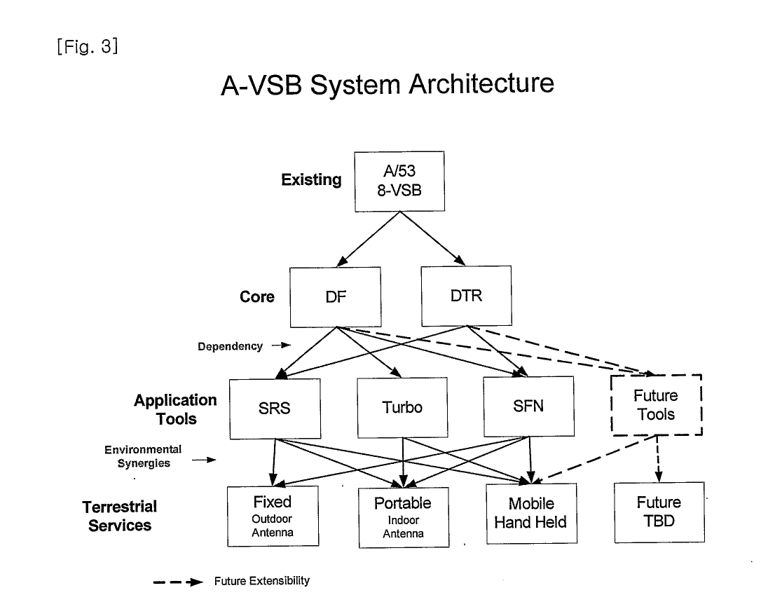

Furthermore, this document defines the following application tools: Supplementary Reference Sequence (SRS); Turbo Stream; and Single Frequency Network (SFN). These core techniques and application tools can be combined as shown in FIG. 3. FIG. 3 shows the core techniques (DF, DTR) as the basis for all of the application tools defined herein and potentially in the future. The solid lines show this dependency. Certain tools are used to mitigate propagation channel environments expected for certain broadcast services. Again, the solid lines show this relationship. Tools can be combined together synergistically for certain terrestrial environments. The solid lines demonstrate this synergy. The dashed lines are for potential future tools not defined by this disclosure.

The Deterministic Frame (DF) and Deterministic Trellis Reset DTR) are backwardly compatible system constraints that prepare the 8-VSB system to be operated in a deterministic or synchronous manner and enable a cross layer 8-VSB enhancement design. In the A-VSB system, the A-VSB multiplexer has knowledge of and signals the start of the 8-VSB frame to the A-VSB exciter. This a priori knowledge is an inherent feature of the A-VSB multiplexer which allows intelligent multiplexing (cross layer) to gain efficiency and/or increase performance of the 8-VSB system.

The absence of frequent equalizer training signals has encouraged receiver designs with an over dependence on “blind equalization” techniques to mitigate dynamic multipath. The SRS is a cross layer technique that offers a system solution with frequent equalizer training signals to overcome this using the latest algorithmic advances in receiver design principles. The SRS application tool is backwards compatible with existing receiver designs (specifically, the information is ignored in existing receiver designs), but improves reception in SRS-designed receivers.

The turbo stream provides an additional level of error protection capability. This brings robust reception in terms of a lower SNR receiver threshold and improvements in multi-path environments. Like SRS, the turbo stream application tool is based on cross layer techniques and is backwards compatible with existing receiver designs (specifically, the information is ignored in existing receiver designs).

The application tool SFN leverages both core elements DF and DTR to enable an efficient cross layer SFN capability. An effective SFN design can enable a higher, more uniform signal strength along with spatial diversity to deliver a higher quality of service (QOS) in mobile and handheld environments.

The tools such as SRS, turbo stream, and SFN can be used independently. That is, there is no dependency among these application tools and any combination of them is possible. These tools also can be used together synergistically to improve the quality of service in many terrestrial environments.

Deterministic Frame (DF)

Introduction

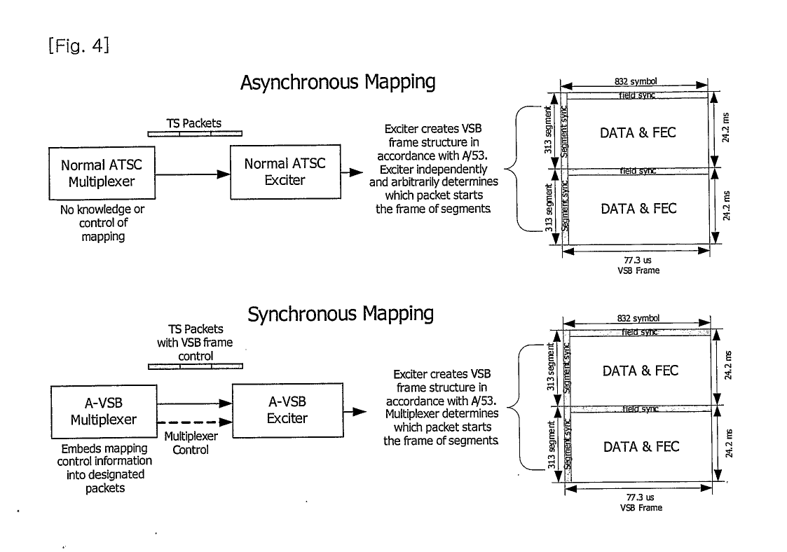

The first core technique of A-VSB is to make the mapping of ATSC transport stream packets a synchronous process (currently, this is an asynchronous process). The current ATSC multiplexer produces a fixed rate transport stream with no knowledge of the 8-VSB physical layer frame structure or mapping of packets. This is depicted in the top of FIG. 4.

When powered on, the 8-VSB ATSC exciter independently and arbitrarily determines which packet begins a frame of segments. Currently, no knowledge of this decision and hence the temporal position of any transport stream packet in the VSB frame is available to the current ATSC multiplexing system. Meanwhile, in the A-VSB system according to embodiments of the present invention, the A-VSB multiplexer makes a selection for the first packet to begin an ATSC physical layer frame. This framing decision is then signaled to the A-VSB exciter, which is a slave to the A-VSB multiplexer for this framing decision.

In summary, the knowledge of the starting packet coupled with the fixed ATSC VSB frame structure gives the A-VSB multiplexer insight into the position of every packet in the 8-VSB physical layer frame. This situation is shown in the bottom of FIG. 4. The knowledge of the DF structure allows pre-processing in an A-VSB multiplexer and synchronous post-processing in an A-VSB exciter (i.e., the a priori knowledge of where each and every byte in the TS will reside at a later point in time in the stages of ATSC exciter allows cross layer techniques to enhance the performance of the 8-VSB physical layer).

A-VSB Multiplexer to Exciter Control

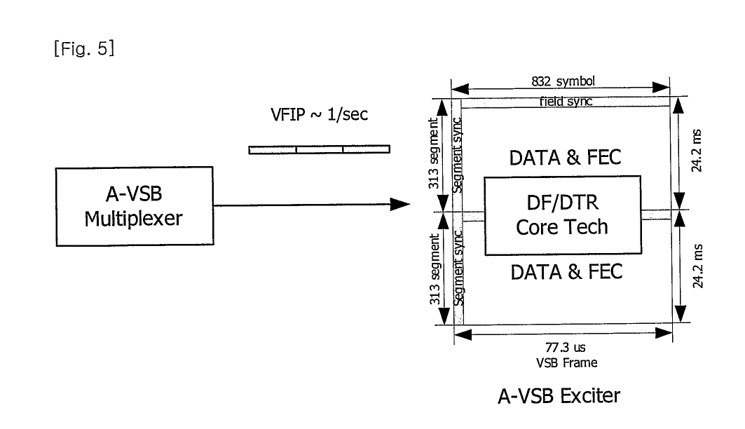

The A-VSB multiplexer inserts a VFIP (the A-VSB multiplexer VFIP cadence is aligned with the ATSC Epoch) every 12,480 packets (this quantity of packets is equal to 20 VSB frames and is termed a super frame). The VFIP signals the A-VSB exciter to insert a DFS with no PN 63 inversion into the VSB Frame. This periodic appearance of VFIP establishes and maintains the A-VSB DF structure which is a core element of the A-VSB system architecture, as described above. This is shown in FIG. 5.

Additionally, the A-VSB multiplexer transport stream clock and the symbol clock in the A-VSB exciter must be locked to a common universally available frequency reference from a GPS receiver. Locking both the symbol and transport clocks to an external reference brings stability that assures the synchronous operation. It is noted that in the normal A/53 ATSC exciter, the symbol clock is locked to the incoming SMPTE 310M and has a tolerance of +/−30 Hz. Locking both to a common external reference will prevent rate adaptation or stuffing by the exciter in response to drift of the incoming SMPTE 310M+/−54 Hz tolerance. This helps maintain the DF once initialized. ASI is the transport stream interface, though it is understood that SMPTE 310M can still be used. Another benefit of locking both the symbol and transport clocks to a common external reference is the prevention of symbol clock jitter which can be problematic for a receiver.

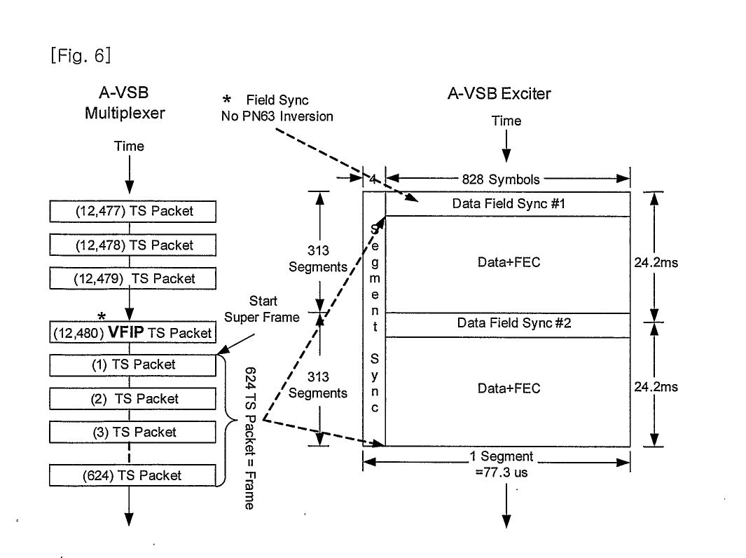

The A-VSB multiplexer is the master and signals which transport stream packet shall be used as the first VSB data segment in a VSB frame. Since the system is operating with synchronous clocks, it can be stated with 100 percent certainty which 624 transport stream packets make up a VSB frame in the A-VSB exciter. A counter (locked to 1PPSF as described below in the section on ATSC System Time) of (624×20=) 12,480 TS packets is maintained in the A-VSB multiplexer. The DF is achieved through the insertion of a VFIP as defined below. The VFIP shall be the last packet in group of 624 packets when the VFIP is inserted, as shown in FIG. 6.

VFIP Special Operations and Maintenance Packet

In addition to the common clock, a special transport stream packet is needed. This packet shall be an Operations and Maintenance Packet (OMP) as defined in ATSC A/110A, Section 6.1. The value of the OM_type shall be 0x30 (Note: a VFIP OM_type in the range of 0x31-0x3F shall be used for SFN operation). Moreover, this packet is on a reserved PID, 0x1FFA.

The A-VSB multiplexer inserts the VFIP into the transport stream once every 20 frames (12,480 TS packets), which will signal the exciter to start a VSB frame that also demarcates the beginning of a next super frame. The VFIP is inserted as the last, 624^{th} packet in the frame, which causes the A-VSB modulator to insert a Data Field Sync with no PN63 inversion of the middle PN63 after the last bit of the VFIP.

Table 1 shows the syntax of the VFIP OMP. The complete packet syntax that includes the definition of the private field shall be as defined below in the SFN description.

TABLE 1
VFIP Packet Syntax

| Syntax | # of Bits | mnemonic |
|---|---|---|
| VFIP_omp_packet( ) { | | |
| transport_packet_header | 32 | bslbf |
| OM_type | 8 | bslbf |
| Reserved | 8 | uimsbf |
| Private | 182 * 8 | uimsbf |

In Table 1, transport_packet_header is as defined and constrained by ATSC A/110A, Section 6.1, OM_type is as defined in ATSC A/110A, Section 6.1 and set to 0x30, and private is to be defined by application tools.

Deterministic Trellis Reset (DTR)

Introduction

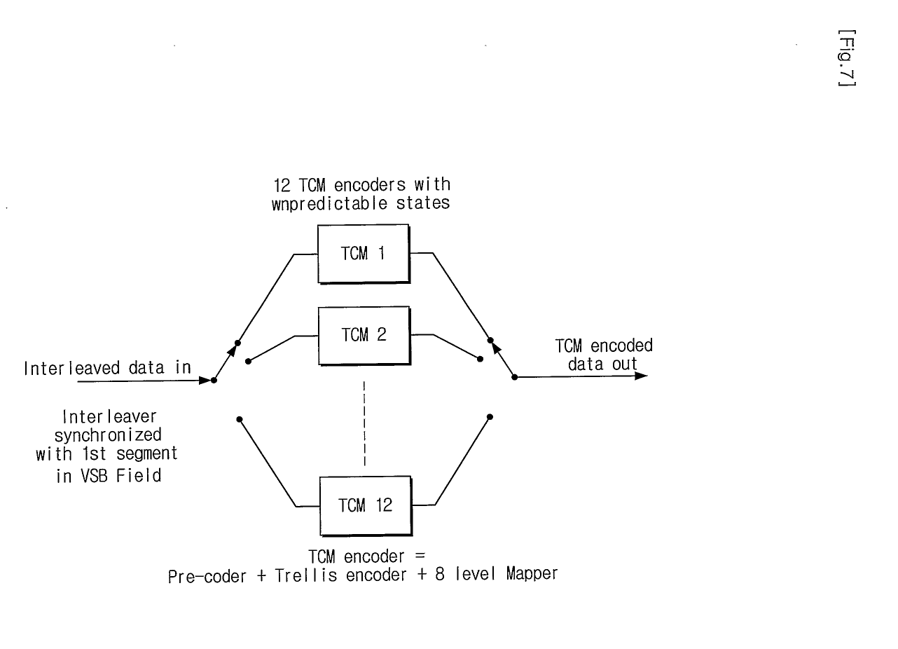

The second core element is the Deterministic Trellis Resetting (DTR), which resets the trellis coded modulation (TCM) encoder states (i.e., the pre-coder and trellis encoder states) in the A-VSB exciter. The reset is triggered at selected temporal locations in the VSB Frame. FIG. 7 shows that the states of the (12) TCM encoders in 8VSB are random. No external knowledge of the states can be known due to the random nature in the A/53 design. The DTR offers a new mechanism to force all TCM encoders to zero state (i.e., a known deterministic state). The emission multiplexer (cross layer design) allows insertion of placeholder packets in calculated positions in the TS, which later will be post processed in the A-VSB exciter. It is noted that this disclosure refers to the intra-segment interleaver as a byte splitter as that is felt to be a more precise term for the function.

Operation of State Reset

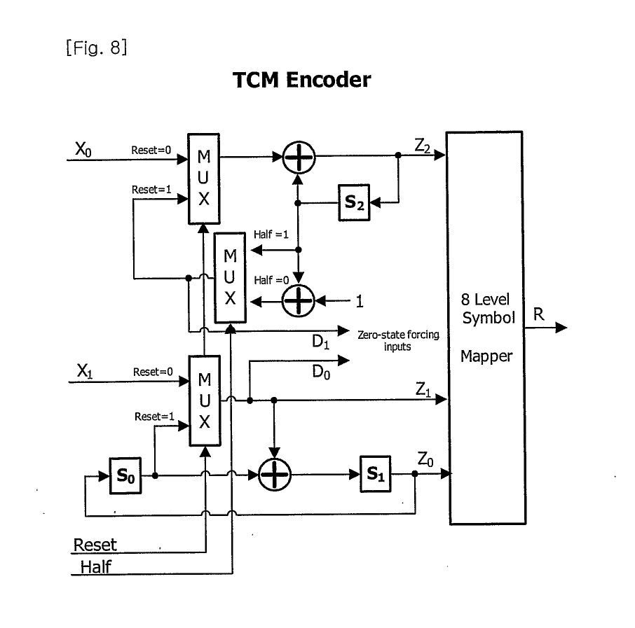

FIG. 8 shows 1 of 12 TCM encoders used in trellis coded 8-VSB (8T-VSB). There are two new multiplexer circuits added to existing logic gates in the shown circuit. When the reset is inactive (Reset=0) the circuit performs as a normal 8-VSB TCM encoder.

The truth table of an XOR gates provides that when both inputs are at like logic levels (either 1 or 0), the output of the XOR is always 0 (Zero). Note that there are three D-Latches (S0, S1, S2), which form the memory. The latches can be in one of two possible states (0 or 1). Therefore, as shown in Table 2 below, the second column indicates eight (8) possible starting states of each TCM encoder. Table 2 shows the logical outcome when the reset signal is held active (Reset=1) for two consecutive symbol clock periods. Independent of the starting state of the TCM, the TCM is forced to a known zero state (S0=S1=S2=0). This is shown in the next to last column labeled Next State. Hence a DTR can be forced over two symbol clock periods. When the reset is not active, the circuit performs normally.

TABLE 2
Trellis Reset Truth Table (In (Reset Half) at t = 2, X don't care 0 or 1)

| (Reset | (S0 S1 | | (S0 S1 | (D0 | | (S0 S1 S2) | (Reset |
|---|---|---|---|---|---|---|---|
| Half) | S2) | (D0 D1) | S2) | D1) at | (Reset | Next State | Half) |
| at t = 0 | at t = 0 | at t = 0 | at t = 1 | t = 1 | Half) at t = 1 | t = 2 | at t = 2 |
| 1, 0 | 0, 0, 0 | 0, 1 | 0, 0, 1 | 0, 1 | 1, 1 | 0, 0, 0 | 0, X |
| 1, 0 | 0, 0, 1 | 0, 0 | 0, 0, 1 | 0, 1 | 1, 1 | 0, 0, 0 | 0, X |
| 1, 0 | 0, 1, 0 | 0, 1 | 1, 0, 1 | 1, 1 | 1, 1 | 0, 0, 0 | 0, X |
| 1, 0 | 0, 1, 1 | 0, 0 | 1, 0, 1 | 1, 1 | 1, 1 | 0, 0, 0 | 0, X |
| 1, 0 | 1, 0, 0 | 1, 1 | 0, 0, 1 | 0, 1 | 1, 1 | 0, 0, 0 | 0, X |
| 1, 0 | 1, 0, 1 | 1, 0 | 0, 0, 1 | 0, 1 | 1, 1 | 0, 0, 0 | 0, X |
| 1, 0 | 1, 1, 0 | 1, 1 | 1, 0, 1 | 1, 1 | 1, 1 | 0, 0, 0 | 0, X |
| 1, 0 | 1, 1, 1 | 1, 0 | 1, 0, 1 | 1, 1 | 1, 1 | 0, 0, 0 | 0, X |

Additionally, zero-state forcing inputs (D0, D1 in Table 2) are available. These are TCM encoder inputs which force the encoder state to be zero. During the 2 symbol clock periods, they are produced from the current TCM encoder state. At the instant to reset, the inputs of TCM encoder are discarded and the zero-state forcing inputs are fed to a TCM encoder over two symbol clock periods. Then the TCM encoder state becomes zero. Since these zero-state forcing inputs (D0, D1) are used to correct parity errors induced by DTR, they should be made available to any application tools. The actual point at which reset is performed is dependent on the application tool. See the SRS and SFN tools for examples.

Medium Access Control (MAC)

The A-VSB MAC unit is the protocol entity responsible for establishing the A-VSB core DF structure under the control of ATSC system time. This enables cross layer techniques to create tools such as A-SRS or enables the efficiency of the A-VSB turbo encoder scheme. The MAC unit sets the rules for sharing of the physical layer medium (8-VSB) between normal and robust data in the time domain. The MAC unit first defines an addressing scheme for locating robust data into the deterministic frame. The A-VSB track is first defined, which is then segmented into a grid of sectors. The sector is the smallest addressable robust unit of data. A group of sectors are assigned together to form a larger data container, which is called a cluster. The addressing scheme allows robust data to be mapped into the deterministic frame structure and this assignment (address) is signaled via the Signaling Information Channel (SIC). The SIC is ⅙ outer turbo coded for added robustness in low S/N and placed in a known position (address) in every VSB frame. The MAC unit also opens adaptation fields in the normal TS packets when needed.

A-VSB MCAST Data as MPEG Private Data

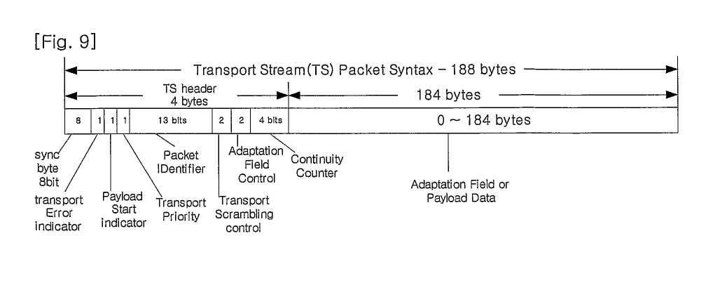

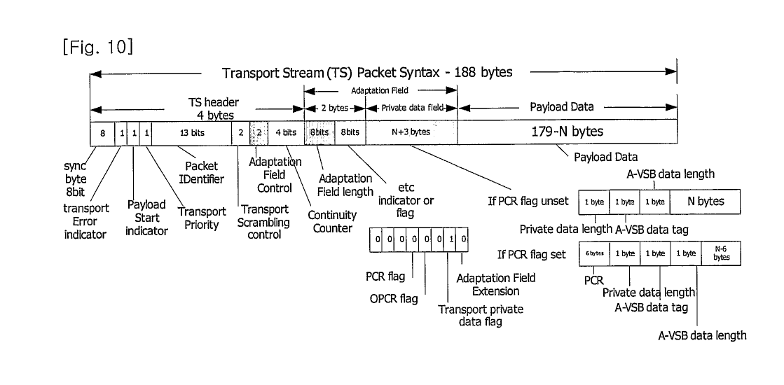

The normal MPEG-2 TS packet syntax is shown in FIG. 9. The adaptation field control in the TS header signals that an adaptation field is present. The normal transport packet syntax with an adaptation field is shown in FIG. 10. The “etc indicator” is a 1 byte field for various flags including PCR. See ISO/IEC 13818-1 for more details.

A-VSB MCAST data, such as the turbo stream and the SRS, shall be delivered through an MPEG private data field in the adaptation field. In order to identify the data type in the private data field, A-VSB MCAST data shall follow the tag-length-data syntax. If there are several data types from different applications, A-VSB MCAST data shall precede the other data types.

Data Mapping in Track

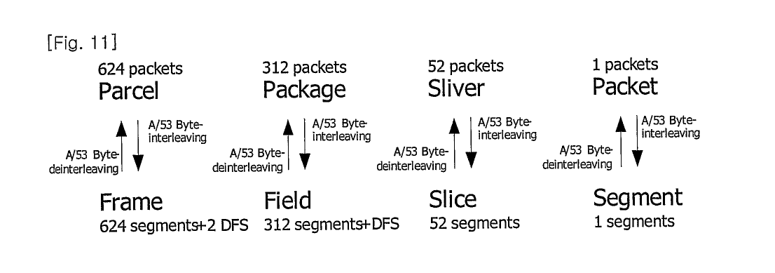

A VSB parcel, package, sliver, and track are defined as a group of 624, 312, 52, and 4 MPEG-2 data packets respectively. A VSB frame is composed of 2 data fields, each data field having a Data Field Sync and 312 data segments. A slice is defined as a group of 52 data segments. Accordingly, a VSB frame has 12 slices. This 52 data segment granularity fits well with the special characteristics of the 52 segment VSB-interleaver. These terms are summarized in FIG. 11.

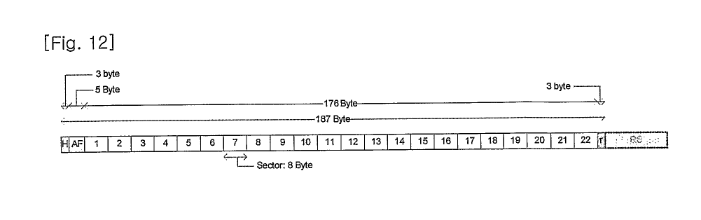

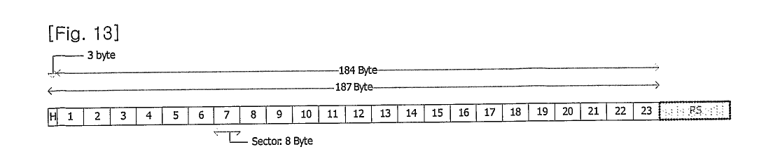

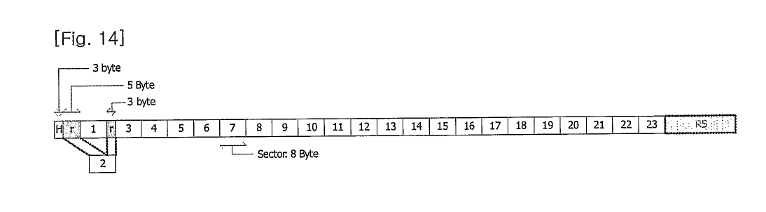

A VSB track is defined as 4 MPEG data packets. The reserved 8 byte space in the AF for the turbo stream is called a sector. A group of sectors is called a cluster. When data such as turbo TS packets and SRS-bytes are delivered in MPEG data packets, the private data field in the AF will be used. However, when a MPEG data packet is entirely dedicated for turbo data and/or SRS-bytes, a null packet, A/90 data packet, or a packet with a newly defined PID will be used to save 2 bytes of the AF header and 3 bytes of the private field overhead. In this case, the saved 5 bytes affect packet segmentation into a grid of sectors. For example, FIG. 12 shows the case of packet segmentation by sectors with the AF header (2 bytes) and the private data field overhead (3 bytes). Since (187−8=) 176 bytes is not divided by 8 bytes, there remains 3 bytes at the end of 22nd sectors. However, a packet without the adaptation field is segmented without any remaining bytes as is shown in FIGS. 13 and 14. A packet without the adaptation field shall be segmented in FIG. 14 when the 0^{th} packet in a track is concerned. Here, the second sector in a packet is divided into two fragments: one being 5 bytes and the other being 3 bytes. The division of the second sector provides the fixed location to the first sector which is used by SIC.

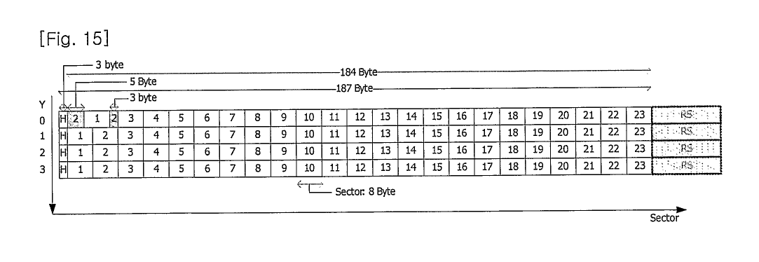

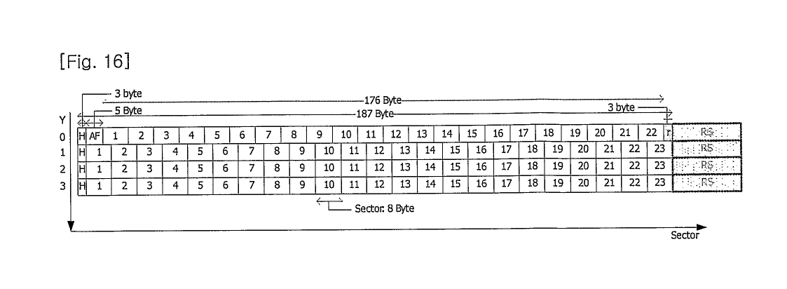

FIGS. 15 and 16 show the segmentation and partitioning of 4 packets by sectors. Since the data mapping into a cluster of sectors repeats every track in this disclosure, it suffices to define the data mapping within a track. Each data occupies a cluster of some sectors. The cluster size determines the normal TS overhead.

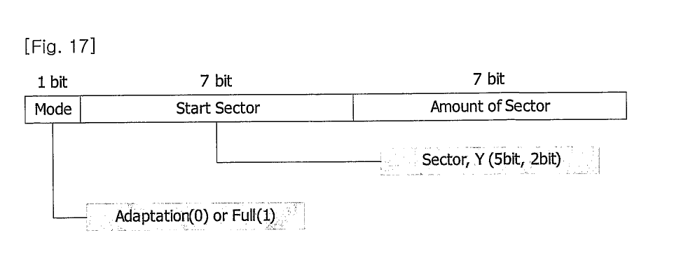

The data mapping is represented by 15 bits as shown in FIG. 17. Referring to FIG. 17, the mode refers to the existence of AF, the next 7 bits indicate the location of the first sector in a cluster, and the remaining 7 bits signify the cluster size as a number of sectors. The first sector in a cluster is located by a sector number in the Y-th packet in a track. When the mode is set to 1, the packet containing the first sector shall have no AF and the sector number can be up to 23.

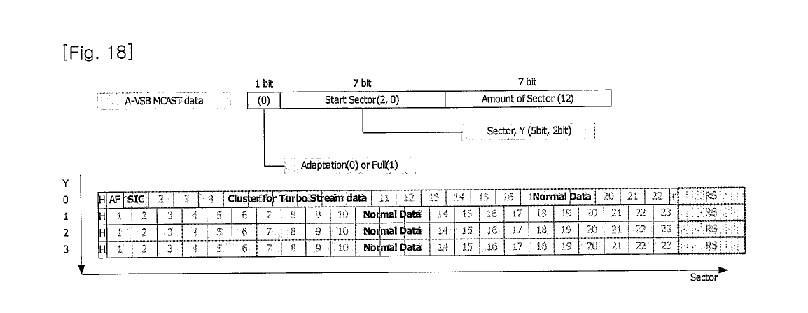

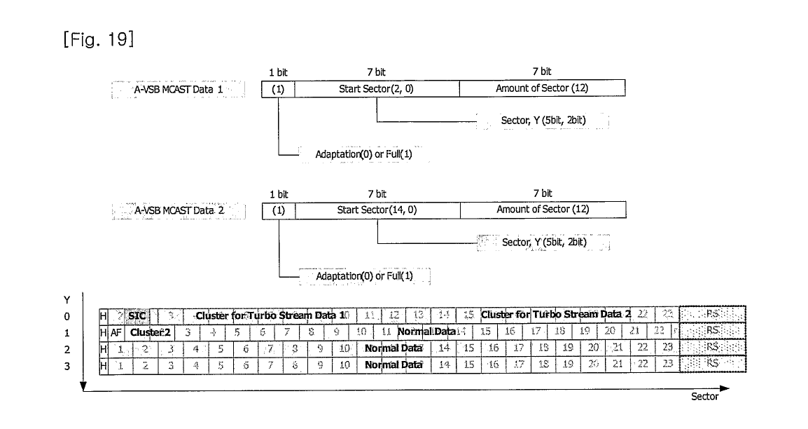

Data mapping examples are shown in FIGS. 18 and 19. As shown in FIG. 19, when a packet is not enough to accommodate a specified number of sectors, the next packet provides the room for the rest of the sectors. The 15 bits of mapping information for each turbo stream data is sent through the SIC. The SIC will always be placed at the 1st sector in the 0th packet.

Data Mapping with Burst SRS

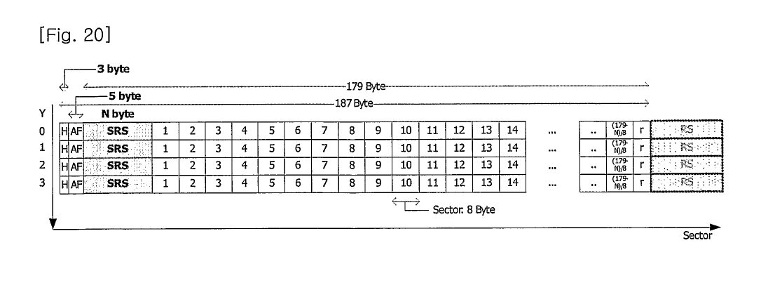

FIG. 20 shows how to segment a track by sectors when a burst SRS is turned on. The last sector number reduces due to the SRS placeholders and depends on the SRS placeholder size. The data mapping representation is the same as in the case of no SRS.

Data Mapping with Distributed SRS

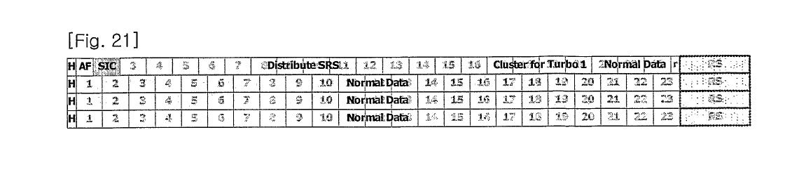

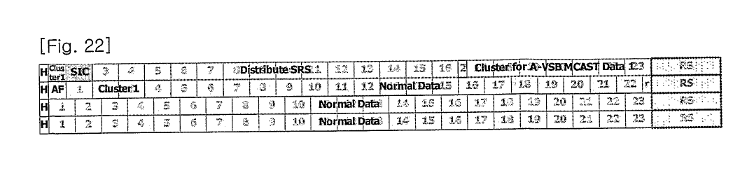

The distributed SRS-bytes shall always follow the SIC data. Thus, the distributed SRS of 14 sectors is depicted as shown in FIG. 21. However, when the first MPEG data packet is entirely used by A-VSB MCAST data such as SIC, SRS, and turbo stream data, the adaption field shall not be used. In this case, the second section is divided into two fragments: one being 5 bytes and the other being 3 bytes. The 5 byte fragment is bytes occupied by the adaptation field before. The other 3 byte fragment shall be placed at the end of the distributed SRS-bytes. The case of the distributed SRS of 14 sectors with a turbo stream of 12 sectors is depicted in FIG. 22. The division of the second sector in this way provides the fixed location of the cluster which is used by the distributed SRS.

Supplementary Reference Sequence (SRS)

Introduction

According to aspects of the present invention, the conventional ATSC 8-VSB system is improved to provide reliable reception for fixed, indoor, portable, mobile, and handheld environments in the dynamic multi-path interference by making known symbol sequences frequently available. The basic principle of the SRS is to periodically insert a special known sequence in a deterministic VSB frame in such a way that a receiver equalizer can utilize this known contiguous sequence to adapt itself to track a dynamically changing channel and, thus, mitigate dynamic multi-path and other adverse channel conditions.

System Overview

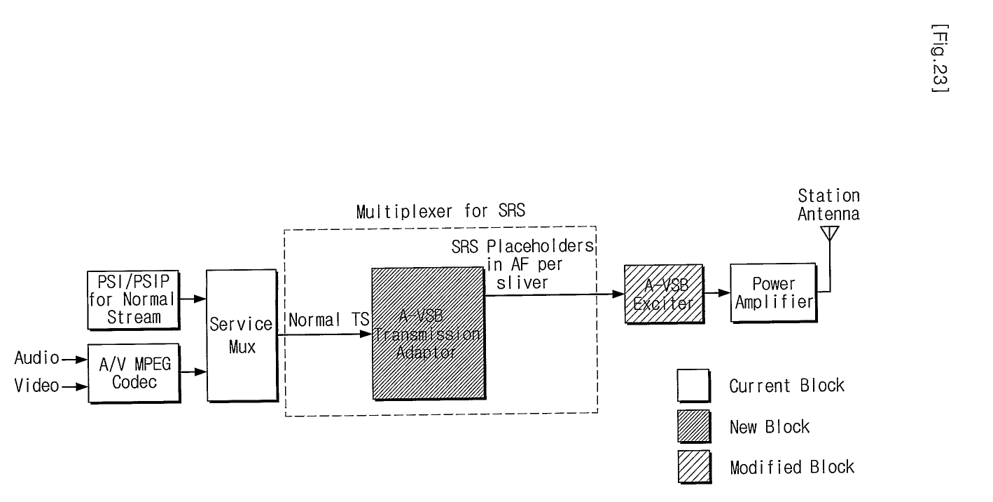

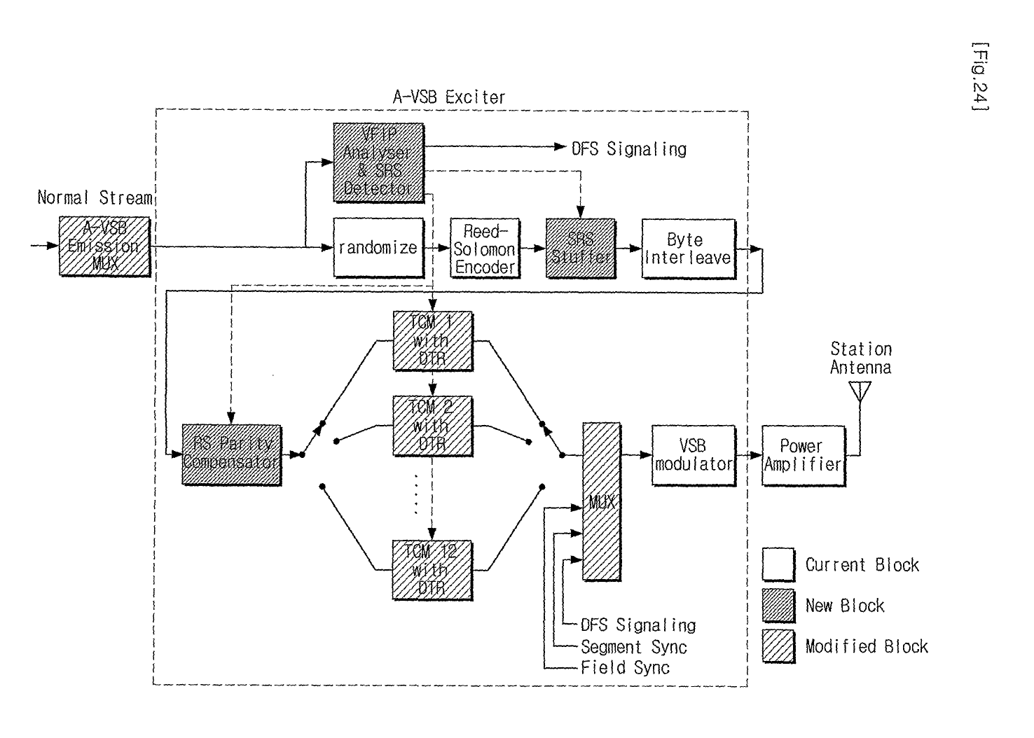

An SRS-enabled ATSC DTV Transmitter is shown in FIGS. 23 and 24. In detail, the blocks modified for SRS processing, the newly introduced block, and the current ATSC DTV blocks are shown in FIGS. 23 and 24. The ATSC A-VSB multiplexer takes into consideration a pre-defined deterministic frame template for SRS. The generated packets are prepared for the SRS post-processing in an A-VSB exciter.

A-VSB Multiplexer for SRS

An ATSC A-VSB multiplexer for SRS is shown in FIG. 23. As illustrated, there is a new conceptual process block, transmission adaptor (TA). The transmission adaptor processes a normal stream to properly set the adaptation fields which serve as SRS-byte placeholders. How to set the adaptation fields for SRS-byte placeholders is defined by the sliver templates.

A-VSB Exciter

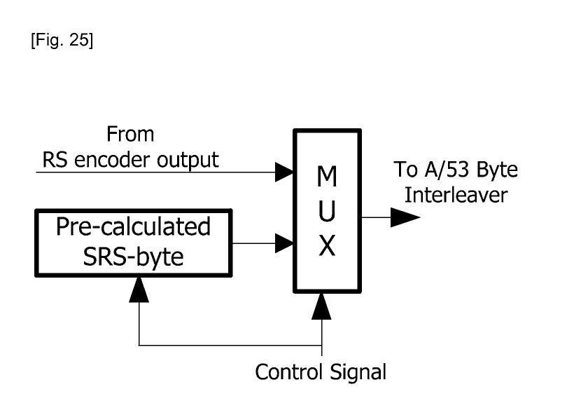

Referring to FIG. 24, the (Normal A/53) randomizer drops all sync bytes of incoming TS packets. The packets are then randomized, and the randomized packets are processed for forward error corrections with the (207, 187) Reed-Solomon code. Then, the SRS stuffer fills the SRS placeholders in the adaptation fields of packets with a pre-defined byte-sequence (i.e., the SRS-bytes). In FIG. 25, the pre-defined fixed SRS-bytes are stuffed into the adaptation field of incoming packets by the control signal at SRS stuffing time. The control signal switches the output of the SRS stuffer to the pre-calculated SRS-bytes properly configured for insertion before the interleaver.

It is noted that, since the placeholders bytes serve no useful purpose between the emission multiplexer and the exciter and will be discarded and replaced by pre-calculated SRS bytes in the exciter, the placeholders can be used to create a high speed data channel to deliver A-VSB signaling and other data to the transmitter site.

In the byte interleaver, output bytes of the SRS stuffer are interleaved. The segment (or the payload for a segment) is a unit of 207 bytes after byte interleaving. These segments are fed to the parity compensator.

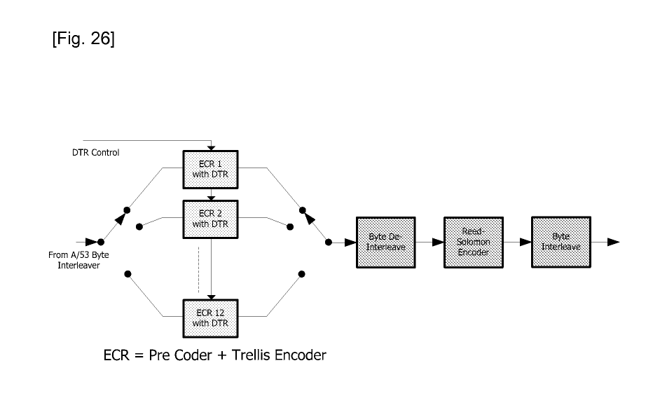

FIG. 26 shows a basic block diagram of the parity compensator. The segments from the A/53 byte interleaver are encoded in (12) TCM encoders where the 8-level mapper is missing. At the beginning of each interleaver-rearranged SRS-byte sequence, the DTR occurs to prepare the generation of known 8-level symbols. However, the symbol generation does not happen here because there is no 8-level mapper. After the outputs are byte-deinterleaved, the parity changes due to DTR are compensated for in the Reed-Solomon encoder. Then the parity-compensated packets are byte-interleaved before leaving the parity compensator.

The output of the parity compensator is again encoded in (12) TCM encoders. Since the parity bytes are already compensated, the DTR does not need to occur. At the prescribed time instants, the TCM encoder states go to zeros. When TCM encoders go to a known deterministic zero state, a pre-determined known byte-sequence (SRS-bytes) inserted by the SRS stuffer follows and is then immediately TCM encoded. The resulting 8-level symbols at the TCM encoder output will appear as known 8-level symbol patterns in known locations in the VSB frame. This 8-level symbol-sequence is called SRS-symbols and is available to the receiver as an additional equalizer training sequence. These generated symbols have the specific properties of a noise-like spectrum with a zero dc-value, which are an SRS-byte design criteria.

In the remaining blocks in FIG. 24, the MUX completes VSB frame generation by multiplexing the DFS signaling, frame sync, and segment sync signal. The remaining blocks are the same as the standard ATSC VSB Exciter.

Burst SRS

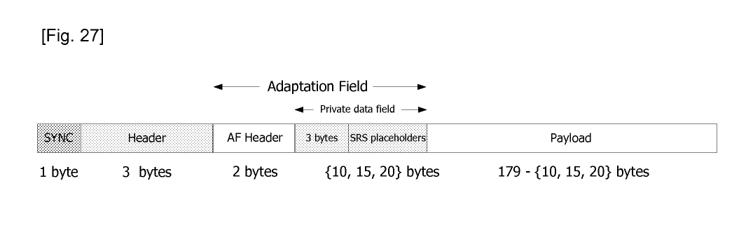

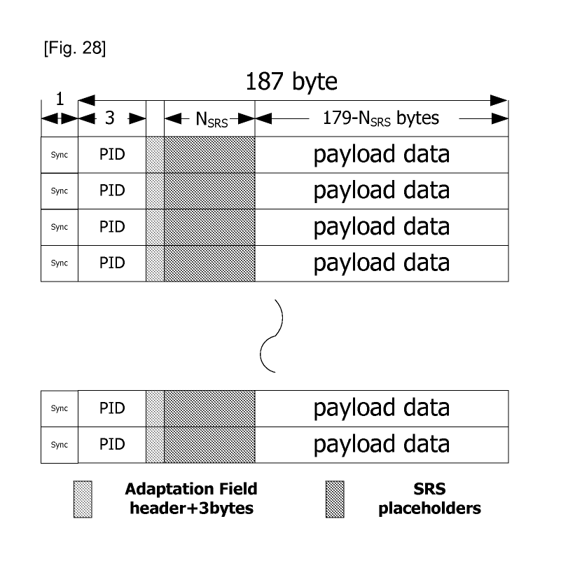

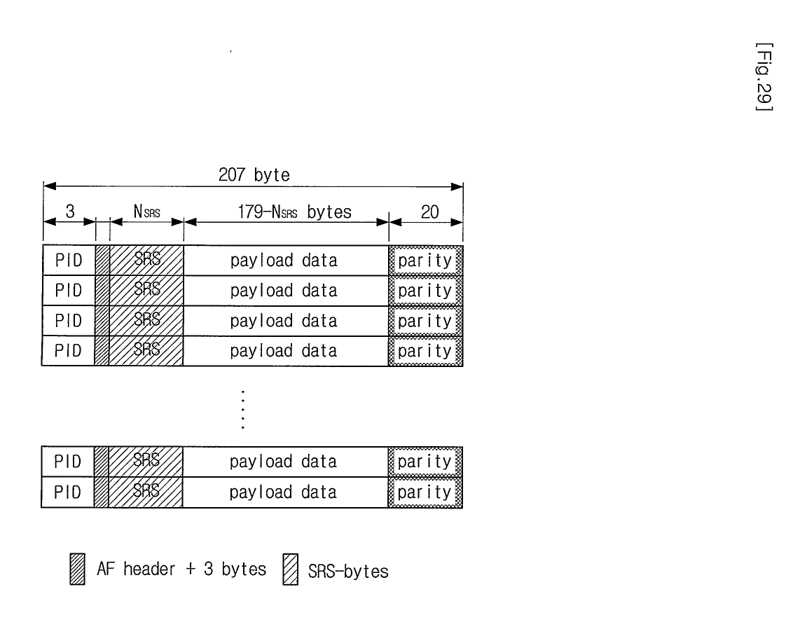

A burst SRS-placeholder-carrying packet is depicted in FIG. 27, and a transport stream with the SRS-placeholder-carrying packets is depicted in FIG. 28, which is the output of the A-VSB multiplexer. Furthermore, FIG. 29 depicts the packets carrying burst SRS-bytes in the adaptation field after the SRS stuffer. The SRS stuffer is careful not to overwrite a PCR or other standard adaptation field values when they are present in the adaptation field.

It is noted that the normal 8-VSB standard has two DFS per frame, each with training sequences (PN-511 and PN-63s). In addition to those training sequences, the burst SRS provides 184 symbols of SRS tracking sequences per segment in groups of 10, 15, or 20 segments. The number of such segments (with known 184 contiguous SRS symbols) available per frame will be 120, 180, and 240 for SRS-10, SRS-15, and SRS-20, respectively. These can help a new SRS receiver's equalizer track dynamic changing channel conditions when objects in the environment and/or the receiver itself are in motion.

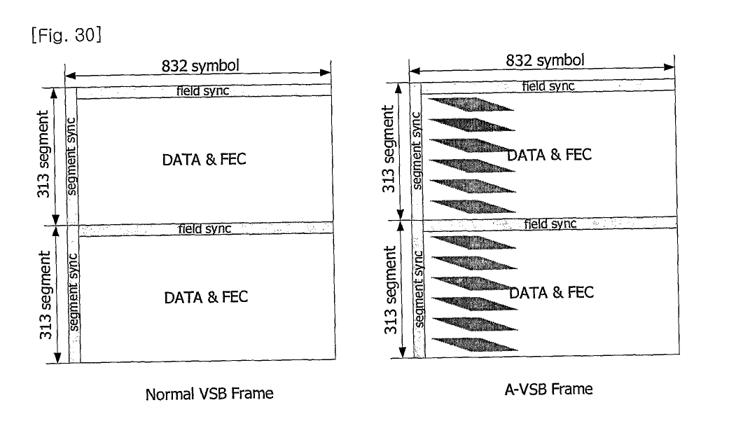

FIG. 30 shows the normal VSB frame on the left and an A-VSB frame on the right with the burst SRS turned on. Each A-VSB frame has 12 groups of SRS 8-level symbols. Each group is in 10, 15, or 20 sequential data-segments depending on N_{SRS} in FIG. 28. On MPEG-2 TS decoding, the SRS symbols appearing in the adaptation field will be ignored by a legacy receiver. Hence the backward compatibility is maintained.

FIG. 30 shows 12 (check) groups which have different compositions depending on the number of SRS bytes (N_{SRS}). The SRS-bytes that are stuffed and the resulting group of SRS symbols are pre-determined and fixed.

Sliver Template for Burst SRS

There are several pieces of information to be delivered through the adaptation field, along with the SRS bytes to be compatible with A/53. These can be the PCR, splice counter, PSIP, private data (other than A-VSB data), and so on. From the ATSC perspective, the program clock reference (PCR) and splice counter must also be carried when needed along with the SRS. This imposes a constraint during the TS packet generation since the PCR is located at the first 6 SRS-bytes.

Some packets such as PMT, PAT, and PSIP impose another constraint because they are assumed to have no adaptation fields. This conflict is solved using the DF. The DF enables these packets to be located in a known position of a sliver. Thus, an exciter designed for the burst SRS can know the temporal position of the PCR and splice counter, non-AF packets and accordingly fill the SRS-bytes, avoiding this other adaptation field information. See ATSC/TSG-3 Adhoc report (TSG3-024r5_UpdatedSummaryA-VSBImplications.doc) for more details on the adaptation field constraints.

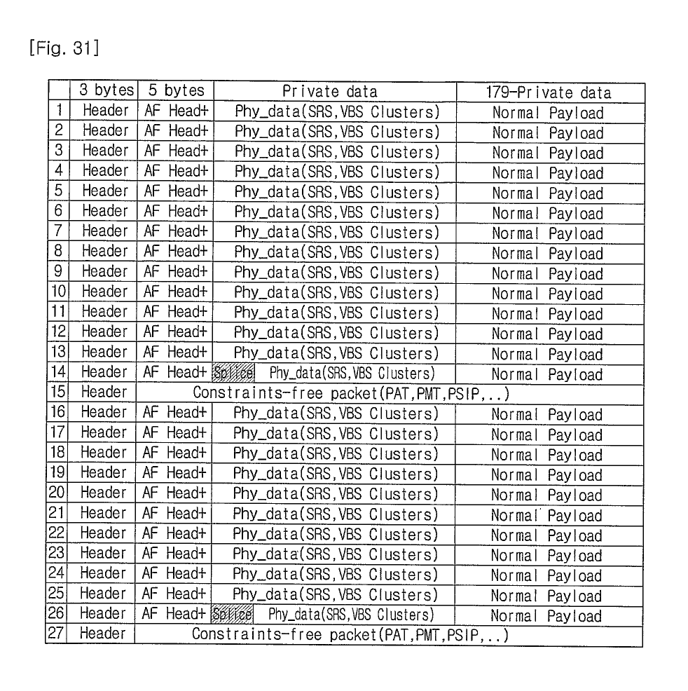

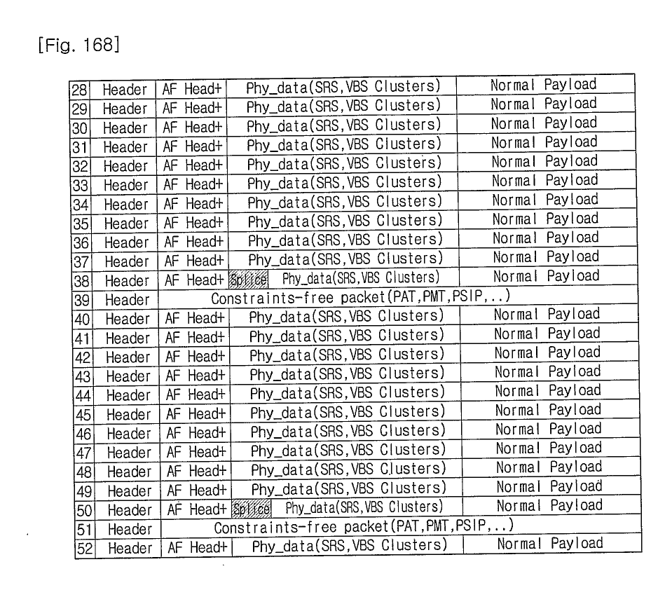

One sliver of SRS DF is shown in FIGS. 31 and 168. The burst SRS DF template stipulates that the 14th, 26th, 38th, and 50th (15th, 27th, 39th, and 51st) MPEG data packets in every VSB sliver can be a splice counter-carrying (constraint-free) packet. This set-up makes the PCR (and splice counter) available at about 1 ms, which is well within the required frequency limit for PCR.

Obviously, a normal payload data rate with the burst SRS will be reduced depending on N_{SRS} bytes in FIG. 28. The N_{SRS} can be 0 through 20, SRS-0 bytes being normal ATSC 8-VSB. The proposed values of N_{SRS} bytes are 10, 15, or 20 bytes listed in Table 3 below. The table gives the three SRS byte length candidates. SRS-byte length choices are signaled through the VFIP to the exciter from the A-VSB multiplexer and also through DFS reserved bytes from the exciter to the receiver. Table 3 also shows the normal stream payload loss associated with each choice. Rough payload loss can be calculated as follows: Since 1 sliver takes 4.03 ms, the payload loss due to SRS-10 bytes is (10+5) bytes*48 packets/4.03 ms*8=1.43 Mbps (Only 48 packets per slice are carrying N_{SRS} bytes). Similarly, a payload loss of SRS 15 and 20 bytes is 1.91 and 2.38 Mbps. The known SRS-symbols are used to update the equalizer in the receiver. The degree of improvement achieved for a given N_{SRS} byte will depend on a particular equalizer design.

TABLE 3
Recommended N_{SRS} bytes for Burst SRS

| SRS Mode | Choice 1 | | Choice 2 | | Choice 3 | |
|---|---|---|---|---|---|---|
| SRS-bytes Length (N_{SRS)} | 10 | bytes | 15 | bytes | 20 | bytes |
| Payload Loss | 1.43 | Mbps | 1.91 | Mbps | 2.38 | Mbps |

Parity Compensator in Burst SRS

The parity compensator in FIG. 24 is a conceptual description. The specific implementation can be varied as long as the desired objective is achieved. In this section, an efficient implementation of the parity compensator is explained.

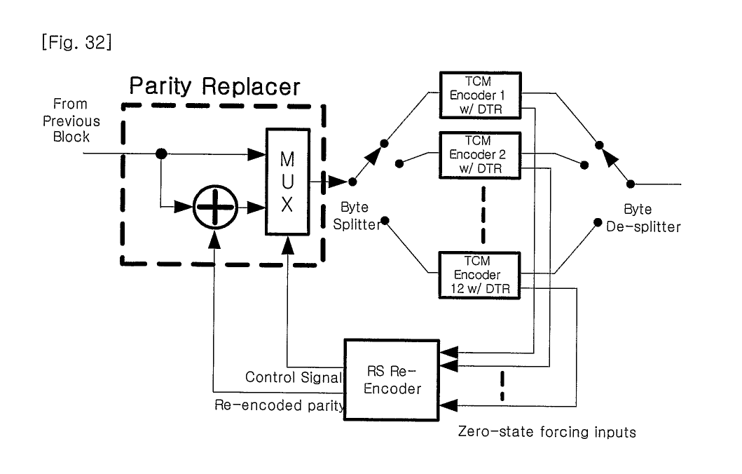

FIG. 32 shows the block diagram of the TCM encoder block with parity correction. The RS re-encoder receives zero-state forcing inputs from TCM encoders with DTR in FIG. 8. The message word for RS-re-encoding is synthesized by taking all zero-bit words except the bits replaced by zero-state forcing inputs. After synthesizing a message word in this way, the RS re-encoder calculates the parity bytes. As RS codes are linear codes, any codeword given by the XOR operation of two valid codewords is also a valid codeword. When the parity bytes to be replaced arrive, genuine parity bytes are obtained by the XOR operation of the incoming parity bytes and the parity bytes computed from the synthesized message word.

For example, assume that an original codeword by (7, 4) RS code is [M₁ M₂ M₃ M₄ P₁ P₂ P₃] (Mᵢ refers to a message byte and Pᵢ refers to a parity byte). The deterministic trellis reset replaces the second message byte (M₂) with M₅ so that the genuine parity bytes are computed by the message word [M₁ M₅ M₃ M₄].

However, the RS re-encoder receives only the zero-state forcing input (M₅) and synthesizes the message word with [0 M₅ 0 0]. Suppose that the parity bytes computed from the synthesized message word [0 M₅ 0 0] by the RS re-encoder is [P₄ P₅ P₆]. Then, since the two RS codewords of [M₁ M₂ M₃ M₄ P₁ P₂ P₃] and [0 M₅ 0 0 P₄ P₅ P₆] are valid codewords, the parity bytes of the message word [M₁ M₂+M₅ M₃ M₄] will be the bitwise XORed value of [P₁ P₂ P₃] and [P₄ P₅ P_{6]}. M₂ is initially set to 0, so that the genuine parity bytes of the message word [M₁ M₅ M₃ M₄] are obtained by [P₁+P₄ P₂+P₅ P₃+P₆].

The 12-way byte splitter and 12-way byte de-splitter shown in FIG. 8 are described in ATSC document A/53 Part 2. The 12 trellis encoders have DTR functionality providing the zero-state forcing inputs.

Adaptation Field Contents (SRS Bytes) for Burst SRS

Table 4 below defines the pre-calculated SRS-byte values configured for insertion before the interleaver. TCM encoders are reset at the first SRS-byte and the adaptation fields shall contain the bytes of this table according to the algorithm here. The shaded values in Table 4, ranging from 0 to 15 (4 MSB bits are zeros, M₂) are the first byte to be fed to TCM encoders (the beginning SRS-bytes). Since there are (12) TCM encoders, there are (12) bytes shades in each column except the column 1-3. At DTR, the 4 MSB bits of these bytes are discarded and replaced with the zero-state forcing inputs. Then the state of TCM encoders becomes zero and TCM encoders are ready to receive SRS-bytes to generate 8-level symbols (SRS-symbols) which serve as a training symbol sequence in a receiver. This training sequence (TCM encoder output) is 8-level symbols, +1-{1, 3, 5, 7}. The SRS-byte values are designed to give the SRS-symbols which have a white noise-like flat spectrum and almost zero DC value (the mathematical average of the SRS-symbols is almost zero).

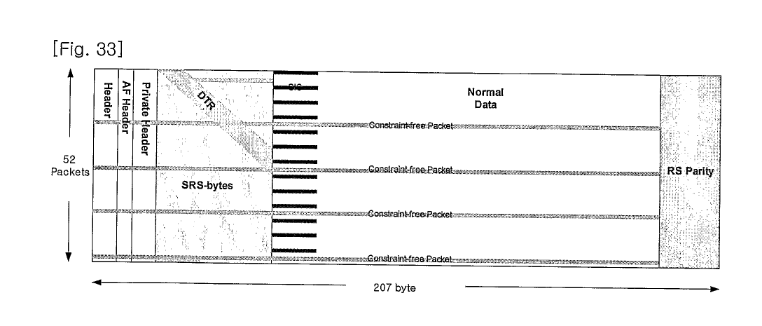

Depending on the selected N_{SRS} bytes, only a specific portion of the SRS-byte values in Table 4 is used. For example, in the case of SRS-10 bytes, SRS byte values from the 1st to the 10th column in Table 4 are used. In the case of SRS-20 bytes, the byte values from the 1st to the 20th column are used. Since the same SRS-bytes are repeated at every 52 packets (a sliver), the table in Table 4 has values for only 52 packets. FIG. 33 clearly shows a sliver snapshot in the Burst SRS.

TABLE 4
Pre-calculated SRS bytes to be stuffed into adaptation fields

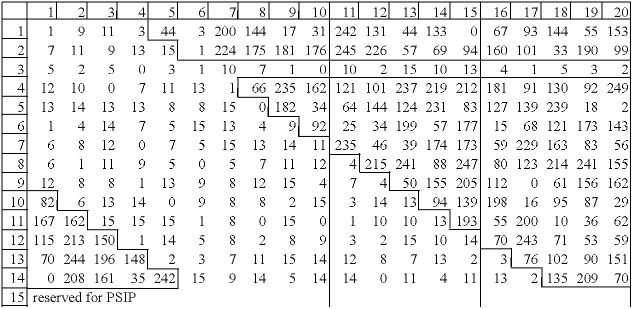

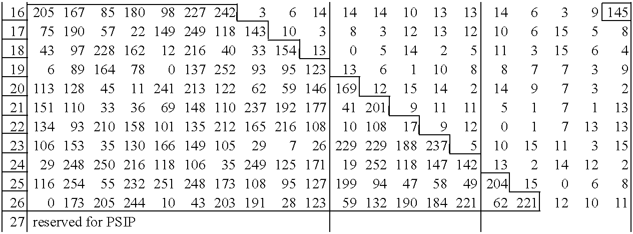

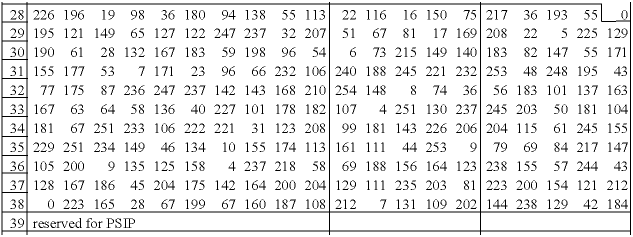

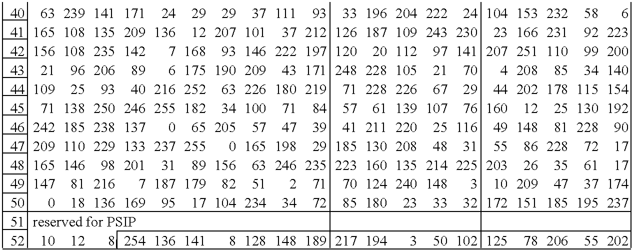

[symbol]

TCM inputs when DTRs happen
reserved slot for AF constraint-free packet
Splice Counter

Distributed SRS

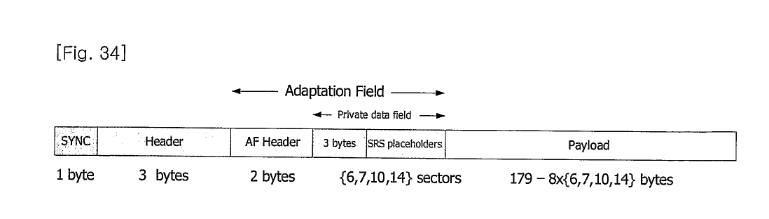

The basic idea of the distributed SRS is to uniformly spread the equalizer reference sequence through the VSB frame. A distributed SRS-placeholder-carrying packet is depicted in FIG. 34.

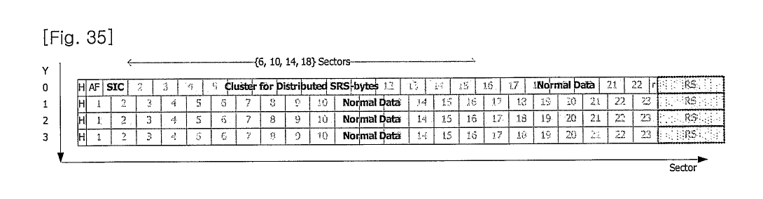

The distributed SRS-bytes are inserted into one packet per track and occupy a cluster of 6, 7, 10, or 14 sectors. When a cluster has {6, 7, 10, 14} sectors, FIG. 35 shows how the distributed SRS-bytes are specifically placed in a track. This is different from the case of the burst SRS. Note that these clusters are accommodated with the help of the adaptation field.

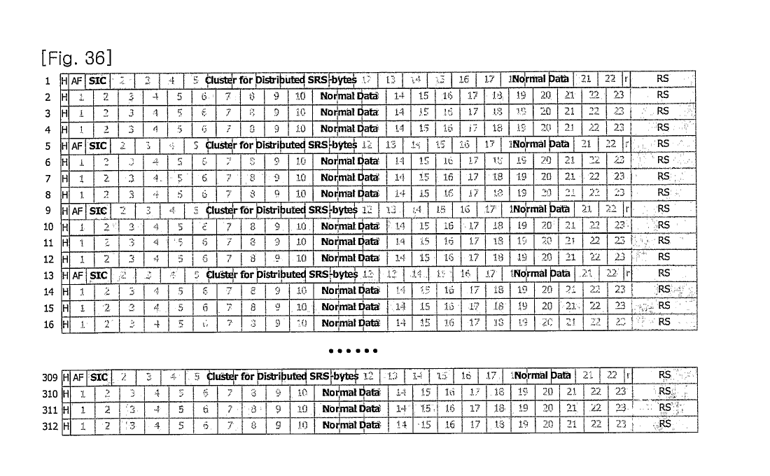

FIG. 36 depicts a package carrying distributed SRS-bytes in the adaptation field after the SRS stuffer. Since only one packet in a track carries the SRS-bytes, non-AF packets and other standard adaptation field values such as PCR come in the other packet slots than the first packet one.

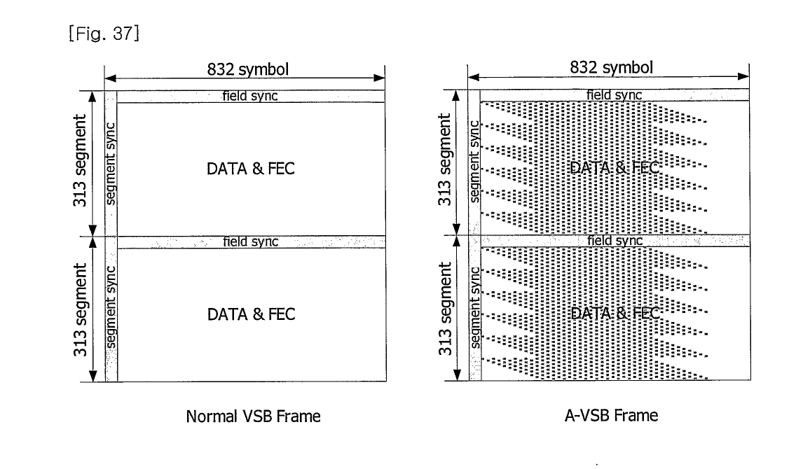

FIG. 37 shows the normal VSB frame on the left and an A-VSB frame on the right with distributed SRS. Each A-VSB frame has 12 groups of SRS 8-level symbols. Each group is in 52 consecutive data-segments, i.e. a slice. The 12 (check) groups stand for the distributed SRS-symbols for the use of the training sequence. Note that the distributed SRS provides a different number of tracking sequences in all segments. In other words, the number of such segments available per frame will be 312. These tracking sequences are less dense than a conventional SRS but more uniformly spread. They help a new distributed SRS receiver's equalizer track dynamic changing channel conditions when objects in the environment or the receiver itself are in motion.

Sliver Template for Distributed SRS

Non-AF packets such as PMT, PAT, and PSIP must be delivered. However, the distributed SRS is carried in adaptation fields. Accordingly, non-AF packets shall appear in the packet slots where there are no distributed SRS-bytes. Some standard adaptation field values such as PCR, splice count, and so on can be saved in this way.

Similar to the case of burst SRS, there are four different distributed SRS choices. These are summarized in Table 5 below with the normal payload overhead associated with each choice. Compared with values in Table 5 of burst SRS, payload losses in Choice 1 and Choice 3 in Table 5 are comparable with those in Choice 1 and the Choice 3 in burst SRS. (In the burst SRS, SRS-{10, 15, 20} has a payload loss of {1.43, 1.91, 2.39}Mbps.)

The sliver templates for distributed SRS are obtained by repeating 13 times the track templates shown in FIGS. 35 and 36. The explanation in the above description of distributed SRS can be applied to understand the sliver templates for the distributed SRS.

TABLE 5
Recommended Cluster Size for Distributed SRS

| SRS Mode | Choice 1 | | Choice 2 | | Choice 3 | | Choice 4 | |
|---|---|---|---|---|---|---|---|---|
| Sector Count | 6 | Sectors | 7 | Sectors | 10 | Sectors | 14 | Sectors |
| Payload Loss | 1.37 | Mbps | 1.58 | Mbps | 2.20 | Mbps | 3.03 | Mbps |

Parity Compensation in Distributed SRS

Referring to FIG. 37, the affected parity byte positions in the distributed SRS are sometimes taken out of the last consecutive 20 bytes because all of the corresponding parity-bytes do not appear after the bytes at DTR due to the (A/53 Normal) byte-interleaving. Even DTRs occur in the last consecutive 20 bytes. Consequently, some bytes in the distributed SRS cluster are reserved for parity compensation. This is different from the RS-encoder in the burst SRS parity compensator.

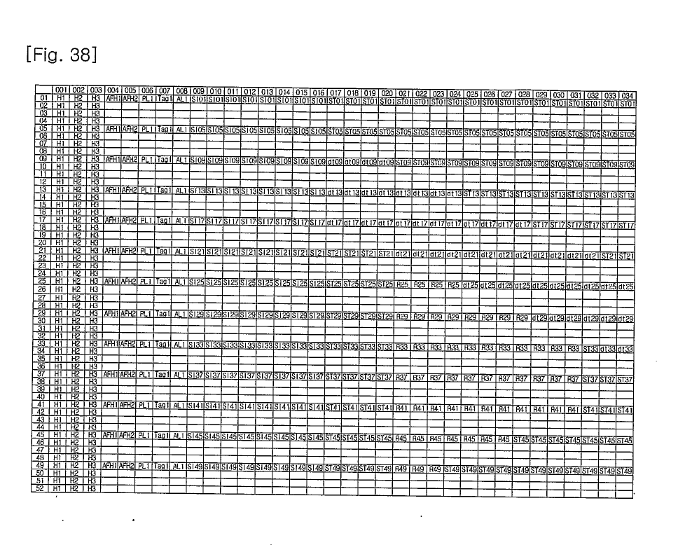

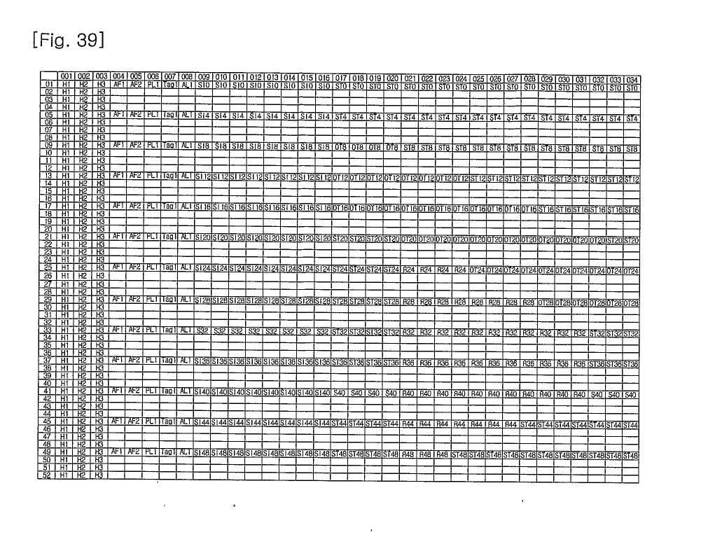

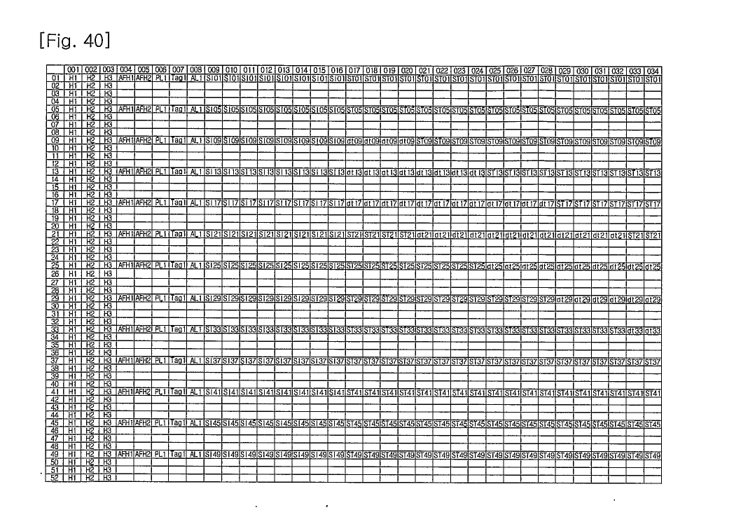

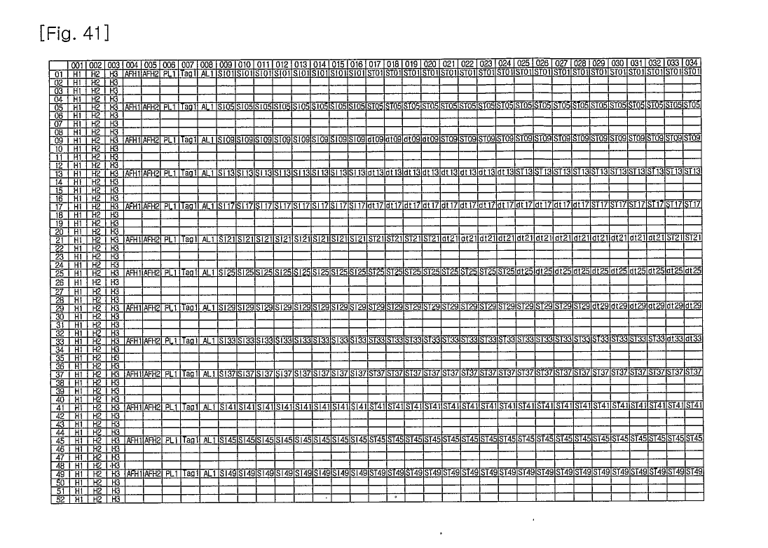

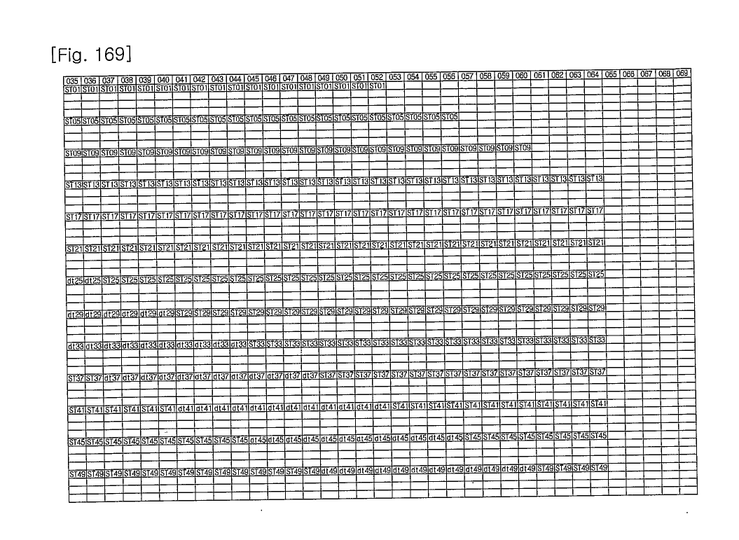

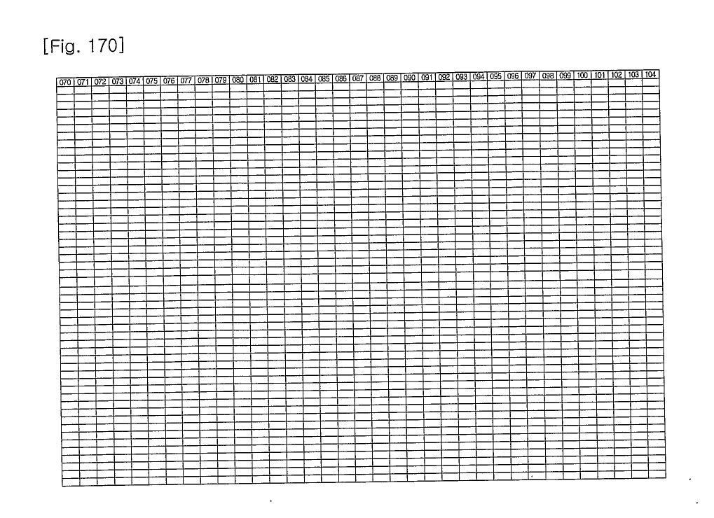

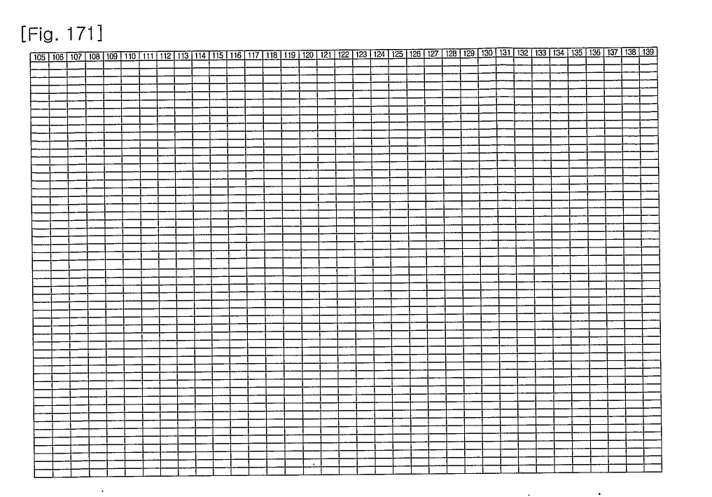

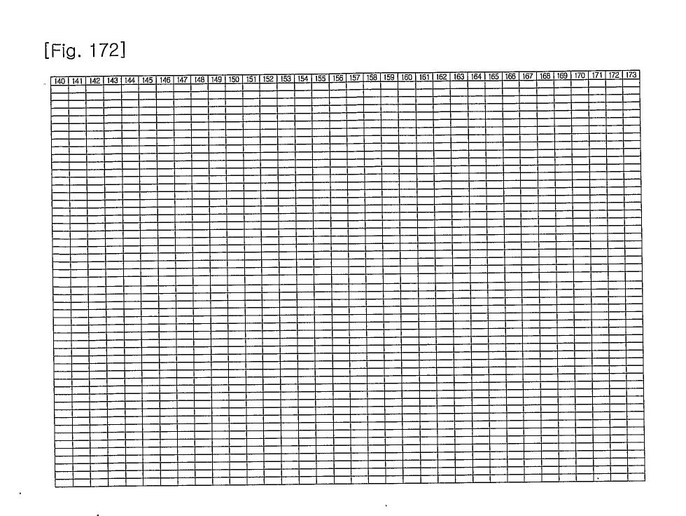

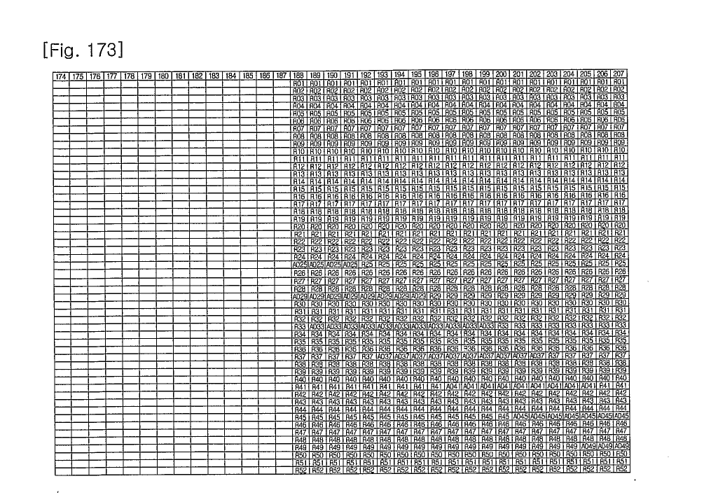

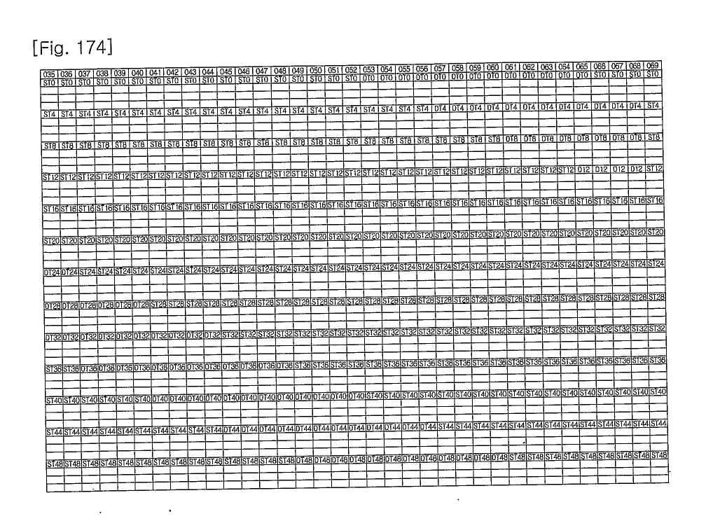

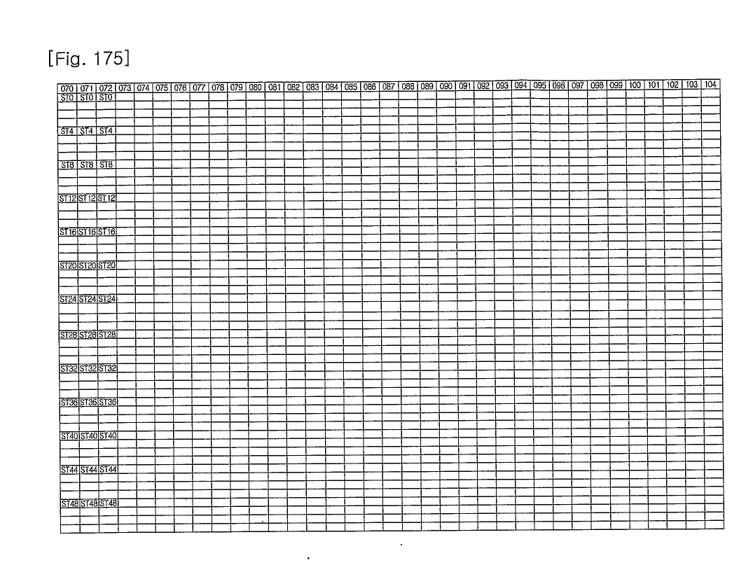

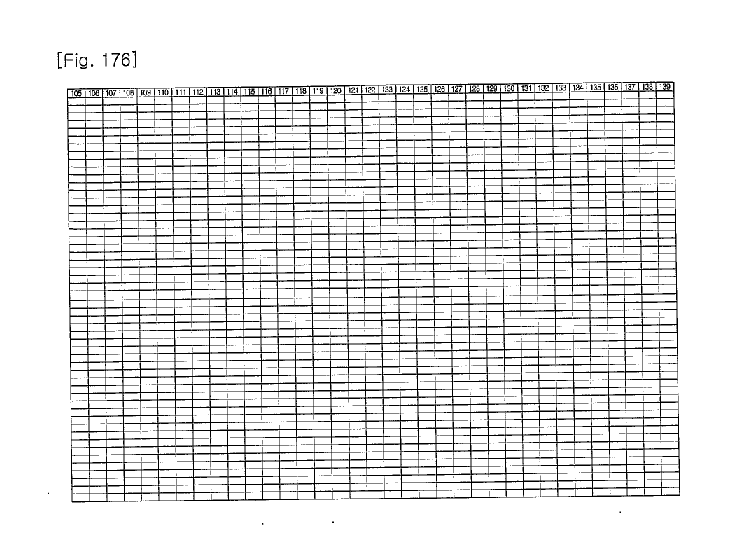

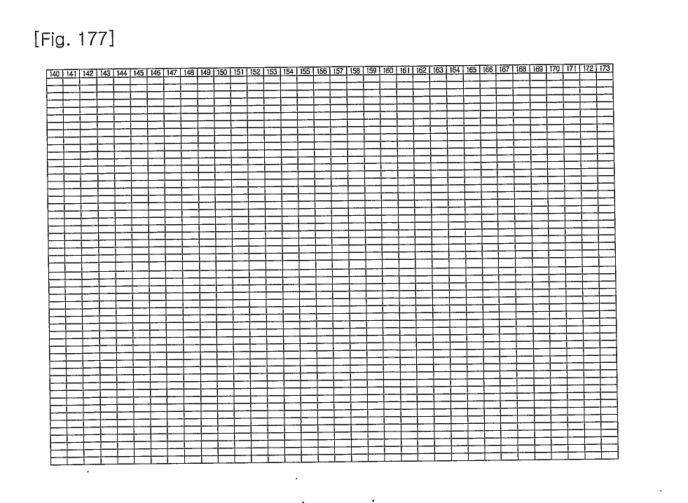

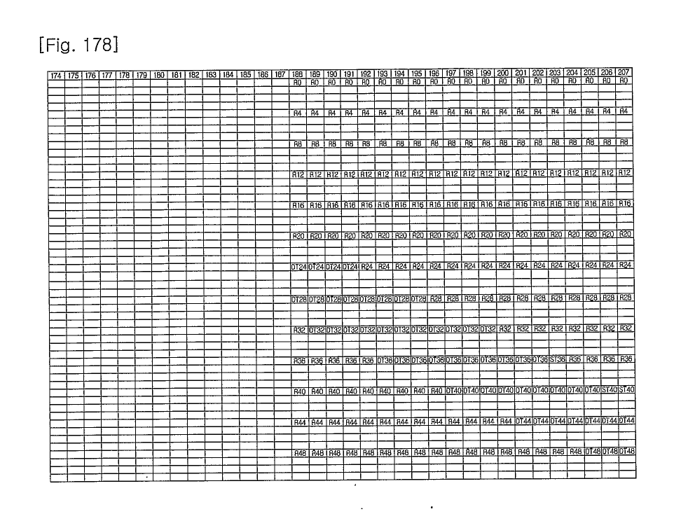

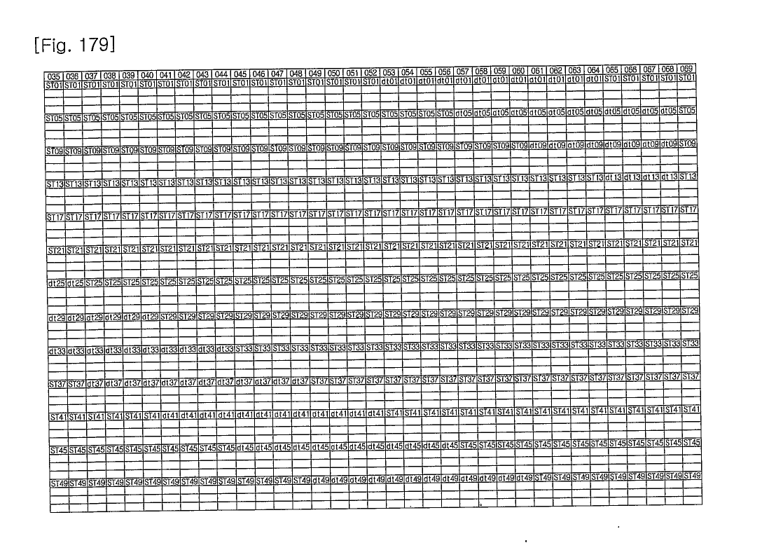

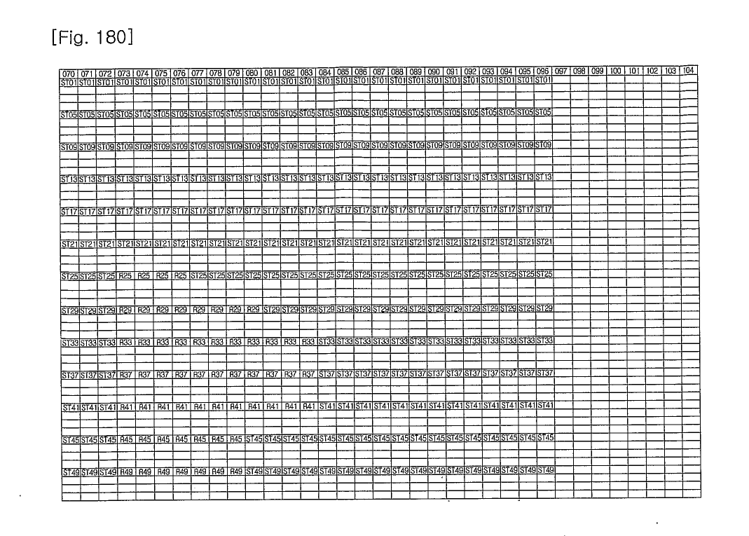

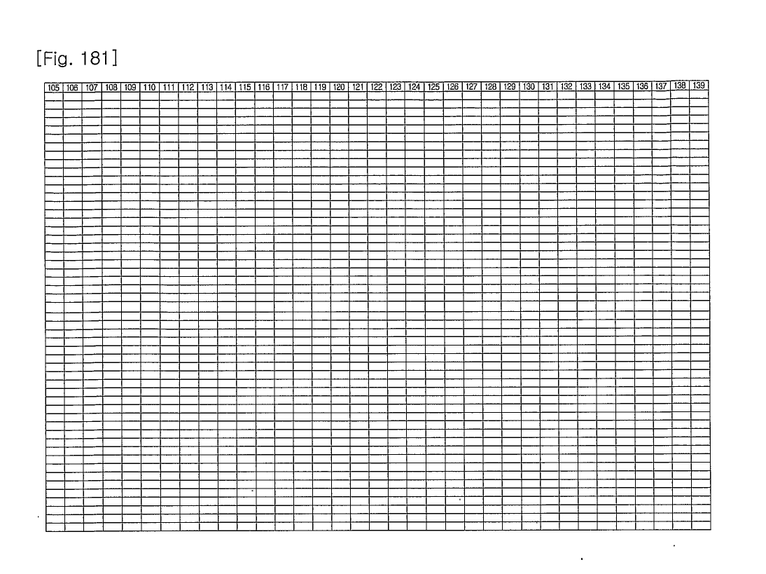

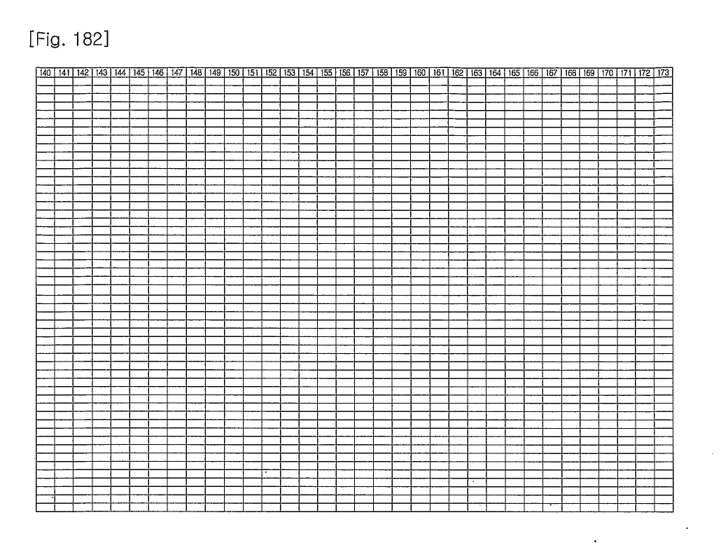

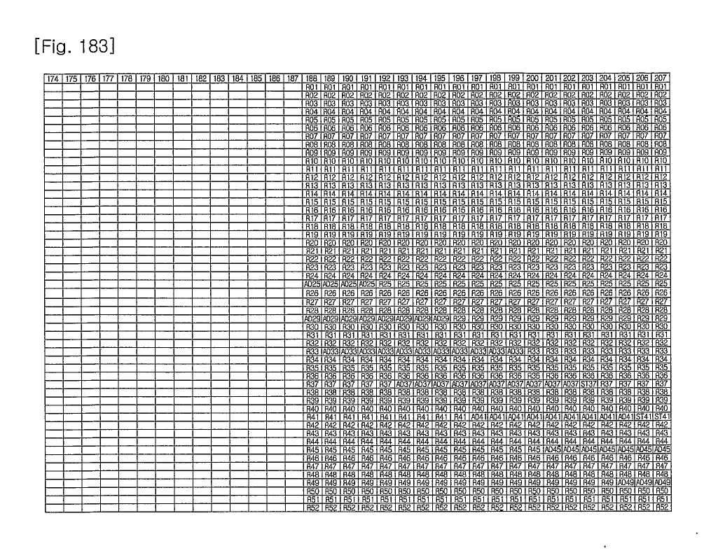

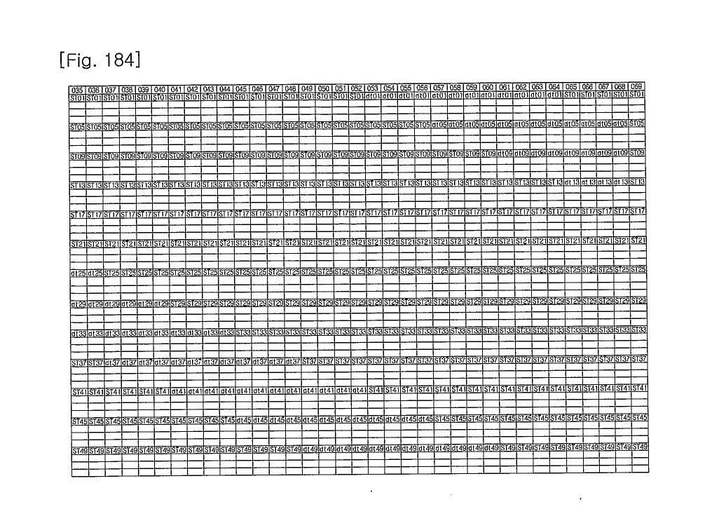

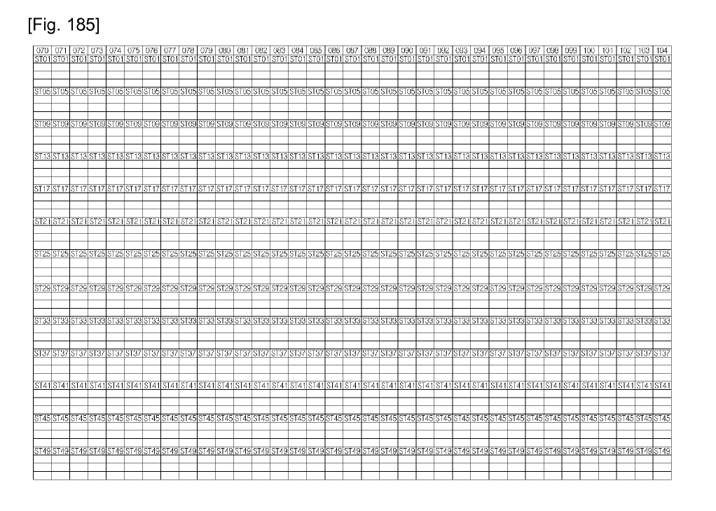

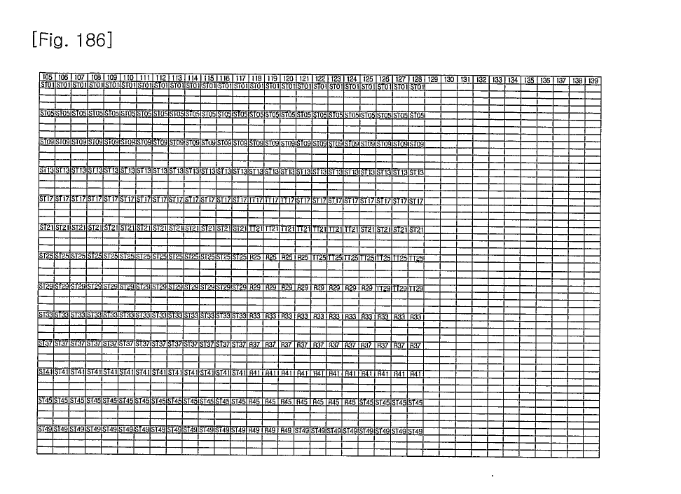

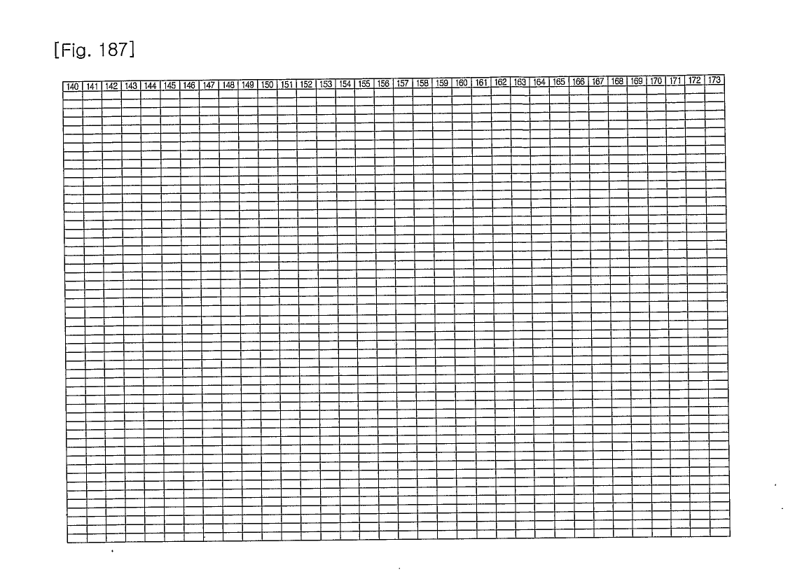

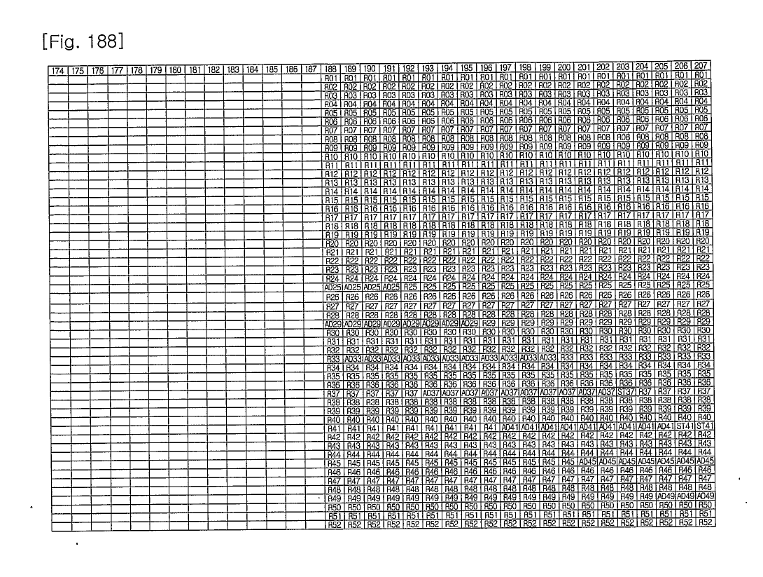

FIGS. 38-41 depict the DTR positions and their affected parity byte positions in the sliver templates of all cluster sizes, {6, 10, 14, 18, 22} sectors. Due to the big horizontal size, they are cut in 6 parts and shown in 6 consecutive figures. In other words, FIGS. 38 and 169 to 173 are represented by one drawing (hereinafter referred to as FIG. 38), FIGS. 39 and 174 to 178 are represented by one drawing (hereinafter, referred to as FIG. 39), FIGS. 40 and 179 to 183 are represented by one drawing (hereinafter referred to as FIG. 40), and FIGS. 41 and 184 to 188 are represented by one drawing (hereinafter referred to as FIG. 41). Table 6 shows the legend of these figures. The number after a symbol in figures means the packet slot number in a sliver. Note that there are the reserved bytes (marked in R) for RS parity compensation in the distributed SRS cluster due to DTR (marked in AD) and SRS-byte (marked in ST) in the last 20 bytes.

TABLE 6
Legend for FIGS. 38-41

| Symbol | Meaning |
|---|---|
| H1 | 1st byte in MPEG TS Packet Header |
| H2 | 2nd byte in MPEG TS Packet Header |
| H3 | 3rd byte in MPEG TS Packet Header |
| AFH1 | 1st byte in Adaptation Field Header |
| AFH2 | 2nd byte in Adaptation Field Header |
| PL1 | Private Data Field Length |
| Tag1 | Private Data (A-VSB MCAST data) Tag |
| AL1 | Private Data Length |
| dt | Byte at Deterministic Trellis Reset (DTR) |
| ST | Cluster for Distributed SRS bytes |
| SI | Cluster for Signaling Information Channel (SIC) |
| R | Reed Solomon Parity Bytes |
| AD | Byte at DTR in the last 20 consecutive bytes of |
| | packet |

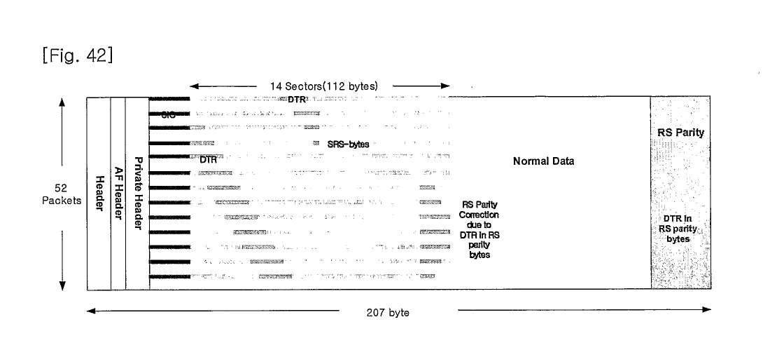

FIGS. 38-41 show the long tables for all choices in the distributed SRS. Simplified versions are shown in FIG. 42. All packets have 20 RS parity bytes. The RS parity bytes in some packets are located in the SRS-bytes cluster because some bytes in the last consecutive 20 bytes are reserved for the distributed SRS-bytes. So, in that case, the SRS-stuffier in FIG. 24 replaces the bytes in the last 20 bytes and the RS encoder in FIG. 26 calculates the bytes to be placed in the RS parity byte positions specified by ‘R’ in FIGS. 38-41. These RS parity byte positions are not always in the last 20 bytes as are shown in FIG. 38 but they are always 20 bytes per packet.

Adaptation Field Contents for Distributed SRS

Table 7 below defines the pre-calculated SRS-byte values configured for insertion for the distributed SRS. The bytes at DTR are the first byte to be fed to TCM encoders before the generation of SRS-symbols. The SRS-bytes are designed to give the SRS-symbols which have a white noise-like flat spectrum and almost zero DC value. Depending on the choice for various sliver templates, only a specific portion of the SRS-byte values in Table 7 is used. For example, in the case of the choice 1 (6 sectors), the SRS-bytes positions are identified from FIG. 38. These are marked in “ST#” (# means a numerical value). Then, the SRS stuffer shall overwrite the values in these positions with the values in Table 7 at the same position.

TABLE 7
Pre-calculated SRS Bytes for the Distributed SRS

| | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|---|
| 1 | 0 | 0 | 0 | 2 | 7 | 5 | 12 | 3 | 0 | 0 | 0 | 0 | 0 | 0 | 0 | 0 | 176 | 243 | 117 | 151 | 119 | 5 | 137 | 134 |
| 2 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 5 | 0 | 0 | 0 | 177 | 11 | 11 | 10 | 2 | 0 | 0 | 0 | 0 | 0 | 0 | 0 | 0 | 50 | 152 | 132 | 79 | 142 | 40 | 23 | 235 |
| 6 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 9 | 0 | 0 | 0 | 56 | 36 | 49 | 186 | 198 | 0 | 0 | 0 | 0 | 0 | 0 | 0 | 0 | 4 | 13 | 0 | 7 | 101 | 138 | 129 | 180 |
| 10 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 13 | 0 | 0 | 0 | 245 | 106 | 251 | 147 | 46 | 0 | 0 | 0 | 0 | 0 | 0 | 0 | 0 | 13 | 15 | 5 | 5 | 2 | 12 | 8 | 3 |
| 14 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 17 | 0 | 0 | 0 | 87 | 1 | 115 | 76 | 118 | 0 | 0 | 0 | 0 | 0 | 0 | 0 | 0 | 1 | 11 | 13 | 14 | 1 | 2 | 12 | 6 |
| 18 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 21 | 0 | 0 | 0 | 104 | 61 | 217 | 18 | 92 | 0 | 0 | 0 | 0 | 0 | 0 | 0 | 0 | 38 | 6 | 254 | 43 | 7 | 8 | 12 | 14 |
| 22 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 25 | 0 | 0 | 0 | 145 | 137 | 79 | 118 | 41 | 0 | 0 | 0 | 0 | 0 | 0 | 0 | 0 | 52 | 161 | 106 | 133 | 46 | 45 | 158 | 252 |
| 26 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 29 | 0 | 0 | 0 | 3 | 227 | 43 | 108 | 208 | 0 | 0 | 0 | 0 | 0 | 0 | 0 | 0 | 157 | 247 | 123 | 237 | 42 | 142 | 192 | 51 |
| 30 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 33 | 0 | 0 | 0 | 126 | 32 | 183 | 214 | 143 | 0 | 0 | 0 | 0 | 0 | 0 | 0 | 0 | 64 | 215 | 20 | 105 | 216 | 83 | 121 | 195 |
| 34 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 37 | 0 | 0 | 0 | 183 | 119 | 10 | 29 | 131 | 0 | 0 | 0 | 0 | 0 | 0 | 0 | 0 | 37 | 255 | 47 | 66 | 41 | 119 | 145 | 42 |
| 38 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 41 | 0 | 0 | 0 | 56 | 65 | 129 | 143 | 202 | 0 | 0 | 0 | 0 | 0 | 0 | 0 | 0 | 54 | 9 | 45 | 61 | 205 | 76 | 144 | 149 |
| 42 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 45 | 0 | 0 | 0 | 15 | 47 | 5 | 92 | 48 | 0 | 0 | 0 | 0 | 0 | 0 | 0 | 0 | 208 | 254 | 171 | 56 | 252 | 198 | 96 | 50 |
| 46 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 49 | 0 | 0 | 0 | 15 | 7 | 58 | 2 | 11 | 0 | 0 | 0 | 0 | 0 | 0 | 0 | 0 | 41 | 15 | 229 | 40 | 149 | 10 | 249 | 101 |
| 50 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |

| | 25 | 26 | 27 | 28 | 29 | 30 | 31 | 32 | 33 | 34 | 70 | 71 | 72 | 73 | 74 | 75 | 76 | 77 | 78 | 79 |
|---|---|---|---|---|---|---|---|---|---|---|---|---|---|---|---|---|---|---|---|---|
| 1 | 36 | 145 | 152 | 244 | 194 | 196 | 123 | 208 | 184 | 115 | 143 | 10 | 59 | 184 | 67 | 38 | 107 | 179 | 37 | 58 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 80 | 12 | 100 | 137 | 146 | 65 | 175 | 215 | 10 | 6 | 9 | 89 | 215 | 75 | 236 | 118 | 57 | 125 | 218 | 52 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 85 | 160 | 236 | 54 | 165 | 203 | 246 | 124 | 230 | 74 | 119 | 5 | 30 | 192 | 245 | 38 | 17 | 198 | 186 | 92 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 60 | 100 | 222 | 190 | 26 | 184 | 183 | 23 | 128 | 203 | 163 | 187 | 93 | 96 | 50 | 44 | 25 | 38 | 215 | 113 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 15 | 2 | 10 | 6 | 213 | 229 | 164 | 25 | 47 | 243 | 27 | 140 | 235 | 91 | 148 | 67 | 128 | 98 | 245 | 119 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 12 | 9 | 6 | 2 | 3 | 2 | 14 | 4 | 199 | 31 | 201 | 252 | 176 | 77 | 110 | 172 | 186 | 204 | 186 | 105 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 7 | 5 | 13 | 13 | 10 | 15 | 9 | 14 | 10 | 14 | 120 | 149 | 203 | 137 | 137 | 139 | 15 | 120 | 162 | 153 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 217 | 94 | 23 | 30 | 12 | 9 | 2 | 8 | 2 | 15 | 78 | 23 | 17 | 139 | 136 | 135 | 85 | 103 | 226 | 108 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 121 | 102 | 52 | 197 | 95 | 101 | 87 | 15 | 5 | 15 | 80 | 48 | 129 | 23 | 245 | 110 | 220 | 208 | 254 | 55 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 148 | 227 | 207 | 38 | 39 | 34 | 165 | 91 | 163 | 5 | 254 | 233 | 119 | 84 | 45 | 149 | 33 | 228 | 185 | 197 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 71 | 182 | 30 | 109 | 77 | 81 | 15 | 65 | 50 | 251 | 194 | 196 | 201 | 45 | 7 | 31 | 184 | 45 | 30 | 25 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 250 | 237 | 155 | 250 | 26 | 6 | 66 | 118 | 219 | 165 | 41 | 141 | 63 | 31 | 27 | 101 | 100 | 4 | 65 | 42 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 178 | 88 | 120 | 38 | 22 | 12 | 235 | 200 | 144 | 2 | 149 | 74 | 248 | 230 | 211 | 64 | 58 | 190 | 151 | 101 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 80 | 81 | 82 | 83 | 84 | 85 | 86 | 87 | 88 | 89 | 90 | 91 | 92 | 93 | 94 | 95 | 96 | 97 | 98 | 99 |
| 1 | 92 | 142 | 216 | 17 | 147 | 204 | 251 | 74 | 41 | 236 | 155 | 208 | 41 | 141 | 160 | 88 | 202 | 146 | 197 | 59 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 35 | 121 | 216 | 250 | 214 | 216 | 188 | 203 | 18 | 207 | 133 | 144 | 24 | 104 | 130 | 208 | 253 | 36 | 197 | 3 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 226 | 105 | 189 | 249 | 209 | 104 | 107 | 247 | 203 | 235 | 233 | 61 | 60 | 220 | 168 | 153 | 144 | 115 | 71 | 29 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 147 | 148 | 193 | 100 | 163 | 198 | 183 | 146 | 143 | 242 | 250 | 67 | 63 | 19 | 35 | 1 | 125 | 38 | 160 | 174 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 220 | 219 | 252 | 184 | 56 | 13 | 244 | 85 | 189 | 78 | 158 | 15 | 177 | 5 | 155 | 72 | 197 | 41 | 138 | 152 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 190 | 8 | 165 | 53 | 119 | 102 | 162 | 34 | 204 | 130 | 78 | 127 | 248 | 113 | 247 | 2 | 41 | 223 | 178 | 226 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 215 | 30 | 170 | 103 | 188 | 182 | 122 | 168 | 157 | 36 | 44 | 80 | 199 | 205 | 54 | 255 | 232 | 153 | 166 | 150 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 49 | 59 | 225 | 252 | 232 | 153 | 131 | 150 | 126 | 83 | 30 | 36 | 242 | 133 | 251 | 128 | 61 | 150 | 135 | 33 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 155 | 212 | 15 | 133 | 34 | 100 | 183 | 182 | 2 | 191 | 169 | 232 | 119 | 35 | 149 | 124 | 26 | 236 | 81 | 96 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 148 | 218 | 27 | 222 | 25 | 128 | 35 | 18 | 136 | 34 | 225 | 197 | 201 | 158 | 194 | 233 | 198 | 169 | 230 | 228 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 174 | 168 | 240 | 112 | 85 | 79 | 130 | 177 | 6 | 175 | 38 | 222 | 166 | 228 | 73 | 11 | 50 | 113 | 99 | 105 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 118 | 128 | 103 | 206 | 178 | 45 | 188 | 6 | 31 | 71 | 229 | 235 | 38 | 30 | 62 | 30 | 117 | 199 | 203 | 169 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 124 | 102 | 253 | 133 | 20 | 117 | 237 | 224 | 21 | 76 | 210 | 148 | 207 | 213 | 200 | 156 | 72 | 59 | 117 | 8 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 100 | 101 | 102 | 103 | 104 | 140 | 141 | 142 | 143 | 144 | 145 | 146 | 147 | 148 | 149 | 150 | 151 | 152 | 153 | 154 |
| 1 | 59 | 50 | 151 | 4 | 96 | 52 | 122 | 94 | 146 | 41 | 237 | 226 | 134 | 124 | 30 | 170 | 57 | 250 | 39 | 223 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 179 | 18 | 159 | 173 | 242 | 230 | 150 | 49 | 161 | 217 | 148 | 241 | 89 | 90 | 184 | 120 | 144 | 161 | 1 | 43 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 54 | 21 | 80 | 7 | 131 | 178 | 14 | 107 | 59 | 208 | 223 | 38 | 106 | 168 | 183 | 222 | 226 | 227 | 191 | 247 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 88 | 103 | 122 | 149 | 44 | 183 | 153 | 191 | 74 | 212 | 121 | 34 | 188 | 130 | 79 | 126 | 232 | 53 | 225 | 0 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 253 | 227 | 205 | 57 | 191 | 103 | 130 | 195 | 9 | 244 | 241 | 117 | 96 | 150 | 243 | 246 | 222 | 87 | 78 | 19 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 101 | 135 | 125 | 112 | 100 | 182 | 70 | 6 | 74 | 145 | 118 | 78 | 102 | 111 | 216 | 29 | 52 | 66 | 24 | 213 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 62 | 67 | 225 | 26 | 253 | 34 | 180 | 230 | 115 | 113 | 210 | 199 | 233 | 175 | 87 | 130 | 124 | 211 | 146 | 107 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 120 | 191 | 186 | 8 | 233 | 114 | 128 | 171 | 214 | 168 | 41 | 89 | 119 | 5 | 31 | 201 | 183 | 118 | 130 | 220 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 28 | 130 | 150 | 133 | 246 | 227 | 55 | 138 | 1 | 41 | 204 | 197 | 54 | 144 | 194 | 107 | 27 | 52 | 130 | 49 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 232 | 103 | 169 | 84 | 204 | 71 | 17 | 39 | 24 | 19 | 115 | 41 | 130 | 24 | 223 | 235 | 115 | 151 | 58 | 94 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 69 | 7 | 105 | 196 | 170 | 107 | 211 | 129 | 177 | 127 | 101 | 93 | 65 | 44 | 113 | 142 | 164 | 108 | 79 | 186 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 163 | 63 | 189 | 179 | 5 | 80 | 4 | 84 | 45 | 187 | 115 | 112 | 28 | 39 | 81 | 132 | 53 | 249 | 202 | 238 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 186 | 142 | 232 | 129 | 5 | 110 | 70 | 144 | 151 | 45 | 26 | 117 | 120 | 148 | 98 | 82 | 255 | 82 | 251 | 2 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 155 | 156 | 157 | 158 | 159 | 160 | 161 | 162 | 163 | 164 | 165 | 166 | 167 | 168 | 169 | 170 | 171 | 172 | 173 | 174 |
| 1 | 90 | 48 | 123 | 2 | 70 | 0 | 225 | 55 | 159 | 229 | 94 | 209 | 107 | 224 | 96 | 45 | 24 | 39 | 41 | 0 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 185 | 137 | 101 | 139 | 78 | 109 | 163 | 216 | 29 | 7 | 42 | 194 | 227 | 173 | 63 | 3 | 105 | 153 | 27 | 78 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 81 | 126 | 96 | 92 | 161 | 83 | 117 | 74 | 52 | 53 | 71 | 167 | 101 | 83 | 130 | 148 | 159 | 157 | 106 | 181 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 216 | 191 | 136 | 224 | 51 | 50 | 118 | 61 | 22 | 218 | 244 | 14 | 99 | 156 | 43 | 33 | 226 | 172 | 122 | 251 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 159 | 67 | 58 | 180 | 113 | 213 | 208 | 121 | 75 | 123 | 239 | 149 | 21 | 38 | 199 | 90 | 189 | 95 | 3 | 69 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 184 | 160 | 98 | 48 | 167 | 72 | 252 | 172 | 95 | 237 | 12 | 6 | 158 | 36 | 173 | 58 | 148 | 90 | 85 | 48 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 236 | 193 | 207 | 96 | 94 | 82 | 248 | 159 | 188 | 83 | 255 | 33 | 253 | 196 | 140 | 198 | 192 | 239 | 157 | 183 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 179 | 109 | 87 | 66 | 200 | 176 | 136 | 238 | 64 | 131 | 154 | 109 | 88 | 220 | 240 | 62 | 133 | 183 | 189 | 86 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 205 | 252 | 241 | 159 | 11 | 180 | 57 | 81 | 102 | 85 | 59 | 248 | 205 | 152 | 197 | 219 | 22 | 15 | 218 | 247 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 216 | 83 | 179 | 116 | 212 | 143 | 59 | 128 | 207 | 158 | 59 | 19 | 42 | 17 | 95 | 45 | 29 | 241 | 225 | 178 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 147 | 161 | 6 | 100 | 99 | 127 | 204 | 206 | 27 | 249 | 152 | 12 | 64 | 252 | 247 | 24 | 4 | 247 | 248 | 182 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 50 | 97 | 236 | 241 | 153 | 77 | 85 | 129 | 8 | 160 | 128 | 167 | 18 | 167 | 42 | 191 | 210 | 129 | 117 | 98 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 50 | 51 | 237 | 245 | 201 | 233 | 251 | 183 | 144 | 121 | 252 | 121 | 239 | 22 | 48 | 225 | 181 | 15 | 209 | 80 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 175 | 176 | 177 | 178 | 179 | 180 | 181 | 182 | 183 | 184 | 185 | 186 | 187 | 188 | 189 | 190 | 191 | 192 | 193 | 194 |
| 1 | 8 | 247 | 226 | 248 | 132 | 230 | 149 | 78 | 205 | 2 | 170 | 66 | 243 | 0 | 0 | 0 | 0 | 0 | 0 | 0 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 198 | 126 | 223 | 95 | 132 | 153 | 58 | 208 | 43 | 197 | 85 | 101 | 138 | 0 | 0 | 0 | 0 | 0 | 0 | 0 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 115 | 142 | 246 | 183 | 247 | 85 | 20 | 66 | 212 | 30 | 106 | 86 | 185 | 0 | 0 | 0 | 0 | 0 | 0 | 0 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 19 | 129 | 132 | 128 | 90 | 146 | 59 | 15 | 70 | 47 | 42 | 230 | 107 | 0 | 0 | 0 | 0 | 0 | 0 | 0 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 227 | 229 | 241 | 165 | 194 | 201 | 102 | 32 | 196 | 79 | 33 | 42 | 23 | 0 | 0 | 0 | 0 | 0 | 0 | 0 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 161 | 175 | 192 | 99 | 124 | 144 | 101 | 49 | 59 | 191 | 212 | 98 | 186 | 0 | 0 | 0 | 0 | 0 | 0 | 0 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 47 | 69 | 0 | 0 | 0 | 0 | 1 | 59 | 157 | 188 | 105 | 194 | 160 | 9 | 13 | 3 | 10 | 0 | 0 | 0 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 205 | 181 | 0 | 0 | 0 | 0 | 0 | 0 | 0 | 0 | 95 | 247 | 157 | 14 | 13 | 14 | 4 | 11 | 15 | 15 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 223 | 216 | 0 | 0 | 0 | 0 | 0 | 0 | 0 | 0 | 0 | 0 | 0 | 0 | 15 | 2 | 15 | 11 | 10 | 1 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 61 | 90 | 0 | 0 | 0 | 0 | 0 | 0 | 0 | 0 | 0 | 0 | 0 | 0 | 0 | 0 | 0 | 0 | 15 | 2 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 51 | 75 | 0 | 0 | 0 | 0 | 0 | 0 | 0 | 0 | 0 | 0 | 0 | 0 | 0 | 0 | 0 | 0 | 0 | 0 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 101 | 31 | 0 | 0 | 0 | 0 | 0 | 0 | 0 | 13 | 236 | 64 | 77 | 0 | 0 | 0 | 0 | 0 | 0 | 0 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 95 | 56 | 0 | 0 | 0 | 248 | 143 | 190 | 69 | 122 | 240 | 135 | 251 | 0 | 0 | 0 | 0 | 0 | 0 | 0 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |

| | 195 | 196 | 197 | 198 | 199 | 200 | 201 | 202 | 203 | 204 | 205 | 206 | 207 |
|---|---|---|---|---|---|---|---|---|---|---|---|---|---|
| 1 | 0 | 0 | 0 | 0 | 0 | 0 | 0 | 0 | 0 | 0 | 0 | 0 | 0 |
| 2 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 |
| 5 | 0 | 0 | 0 | 0 | 0 | 0 | 0 | 0 | 0 | 0 | 0 | 0 | 0 |
| 6 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 |
| 9 | 0 | 0 | 0 | 0 | 0 | 0 | 0 | 0 | 0 | 0 | 0 | 0 | 0 |
| 10 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 |
| 13 | 0 | 0 | 0 | 0 | 0 | 0 | 0 | 0 | 0 | 0 | 0 | 0 | 0 |
| 14 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 |
| 17 | 0 | 0 | 0 | 0 | 0 | 0 | 0 | 0 | 0 | 0 | 0 | 0 | 0 |
| 18 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 |
| 21 | 0 | 0 | 0 | 0 | 0 | 0 | 0 | 0 | 0 | 0 | 0 | 0 | 0 |
| 22 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 |
| 25 | 0 | 0 | 0 | 0 | 0 | 0 | 0 | 0 | 0 | 0 | 0 | 0 | 0 |
| 26 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 |
| 29 | 14 | 0 | 0 | 0 | 0 | 0 | 0 | 0 | 0 | 0 | 0 | 0 | 0 |
| 30 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 |
| 33 | 14 | 2 | 10 | 4 | 4 | 0 | 0 | 0 | 0 | 0 | 0 | 0 | 0 |
| 34 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 |
| 37 | 10 | 2 | 1 | 10 | 0 | 2 | 5 | 13 | 249 | 0 | 0 | 0 | 0 |
| 38 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 |
| 41 | 0 | 0 | 3 | 9 | 12 | 12 | 14 | 11 | 12 | 11 | 5 | 251 | 23 |
| 42 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 |
| 45 | 0 | 0 | 0 | 0 | 0 | 0 | 3 | 2 | 12 | 9 | 7 | 3 | 11 |
| 46 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 |
| 49 | 0 | 0 | 0 | 0 | 0 | 0 | 0 | 0 | 0 | 0 | 9 | 10 | 3 |
| 50 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 |

SRS Signaling

When the Burst SRS Bytes are present, the VFIP packet shall be extended as defined below.

Turbo Stream

Introduction

The turbo stream is expected to be used in combination with SRS. The turbo stream is tolerant of severe signal distortion, enough to support the handheld and mobile broadcasting services. The robust performance is achieved by additional forward error corrections and an outer interleaver (bit-by-bit interleaving), which offers additional time-diversity.

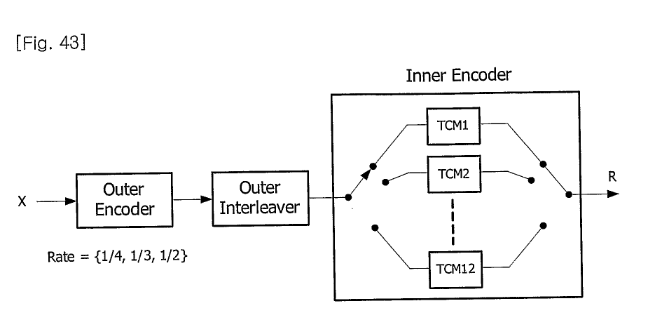

The simplified functional A-VSB turbo stream encoding block diagram is shown in FIG. 43. The turbo stream data is encoded in the outer encoder and bit-wise-interleaved in the outer interleaver. The coding rate in the outer encoder can be selectable among {¼, ⅓, ½} rates. Then, the interleaved data is fed to the inner encoder, which has a 12-way data splitter for the (12) TCM encoders input, and 12-way data de-splitter at outputs. The (de-)splitter operation is defined in ATSC Standard A/53 Part 2.

Since the outer encoder is concatenated to the inner encoder through the outer interleaver, an iteratively decodable serial turbo stream encoder is implemented. This scheme is unique and ATSC specific in the sense that the inner encoder is already a part of the 8-VSB system. By virtue of the A-VSB core element DF and by placing robust bytes in defined locations in TS packets (cross layer mapping techniques) the normal ATSC inner encoder is deterministically time division multiplexed (TDM) to carry normal or robust symbols. This cross layer approach enables an A-VSB receiver to perform a partial reception technique by identifying the robust symbols at the physical layer and demodulating just the robust symbols that the receiver needs and ignoring all normal symbols. All normal ATSC receivers continue to treat all symbols as normal symbols and thus ensure backward compatibility.

This cross layer TDM technique eliminates the need for a separate inner encoder to realize an ATSC turbo encoder. This design enables a significant bit savings by sharing (TDM) the existing ATSC inner encoder at the physical layer as part of the new A-VSB turbo encoder. Other designs that totally de-couple the new proposed turbo encoder from the 8-VSB physical layer will offer no opportunity for bit efficiency in encoding since two (2) new encoders must be introduced. The partial reception capability will also have benefits when used as part of a power saving scheme for battery powered receivers. Only two blocks (the outer encoder and the outer interleaver) are newly introduced in the A-VSB turbo stream encoder.

System Overview

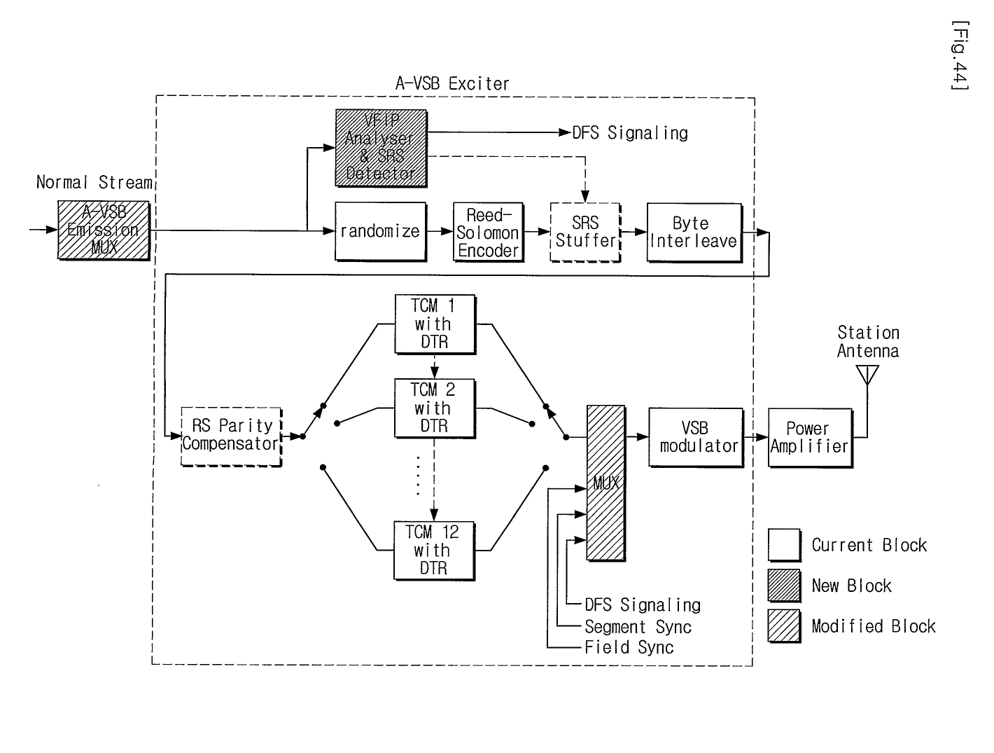

The A-VSB transmitter for the turbo stream includes the A-VSB multiplexer (Mux) and exciter as shown in FIG. 44. The turbo coding process is done in the A-VSB Mux and then the coded stream is delivered to the A-VSB exciter.

The A-VSB Mux receives a normal stream and turbo stream(s). In the A-VSB Mux, after being pre-processed, each turbo stream is outer-encoded, outer-interleaved and is encapsulated in the adaptation field of the normal stream.

There is no special processing needed in the A-VSB exciter for turbo stream operation as the processing is the same as that of a normal ATSC A/53 exciter. The A-VSB exciter is a synchronous slave of the emission multiplexer (DF) and the cross layer TDM of the robust symbols will occur in the inner ATSC encoder with no knowledge needed of the turbo stream in the exciter except for DFS signaling. Hence, no added complexity is spread into the network for the turbo stream, as all turbo processing is in one central location in the A-VSB multiplexer. In the A-VSB exciter, an ATSC A/53 randomizer drops sync bytes of TS packets from an A-VSB Mux and randomizes them. The SRS stuffer and parity compensator in FIG. 44 are active only when the SRS is used. The use of the SRS with the turbo stream is considered later. After being encoded in (207, 187) Reed-Solomon code, MPEG data streams are byte-interleaved. The byte interleaved data are then encoded by the TCM encoders.

An A-VSB multiplexer shall notify the corresponding exciter of some information (DFS signaling) via VSB frame initialization packet (VFIP) and/or SRS-byte placeholders when the SRS is used. Since the SRS-bytes placeholders serve no useful purpose between the A-VSB multiplexer and an exciter and will be discarded and replaced by pre-calculated SRS bytes in the exciter, the SRS-bytes placeholders can be used to create a high speed data channel to deliver A-VSB signaling and other data to the transmitter site. This information shall be conveyed to a receiver through the reserved space in the data field sync. The other information shall be delivered to a receiver though a signaling information channel (SIC), which is a sort of a turbo stream dedicated for signaling.

A-VSB Multiplexer for Turbo Stream

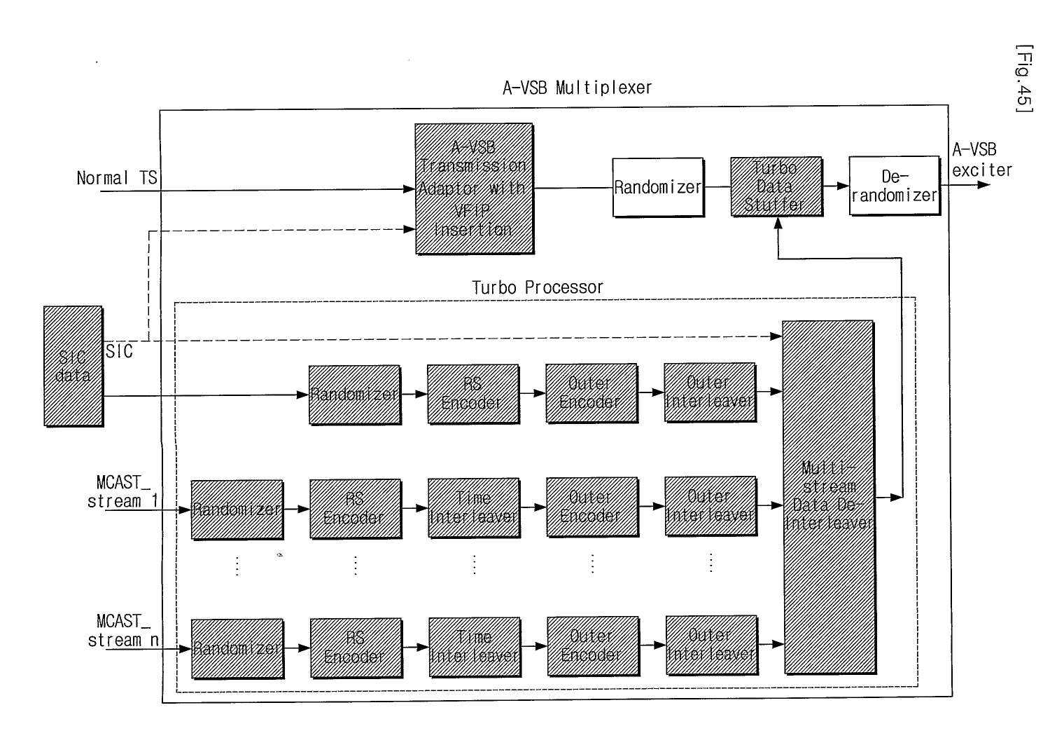

A-VSB Multiplexer for turbo streams is shown in FIG. 45. Referring to FIG. 45, the A-VSB multiplexer for turbo streams includes a transmission adaptor (TA), a turbo pre-processor, an outer encoder, an outer interleaver, a multi-stream data de-interleaver, and a turbo-packet stuffer. An A-VSB transmission adaptor recovers all elementary streams from the normal TS and re-packetizes all elementary streams with adaptation fields in every 4th packets, which serves as turbo stream packet placeholders.

In the turbo pre-processor, the MCAST packets are RS-encoded and time-interleaved. Then, the time-interleaved data are expanded by the outer-encoder with a selected code rate and outer-interleaved. The multi-stream data de-interleaver provides a sort of ATSC A/53 Data de-interleaving function for multi-stream data. The turbo data stuffer simply puts the de-interleaved multi-stream data into the AF of A/53 randomized TA output packets. After A/53 de-randomization, the output of the turbo data stuffer results in the output of the A-VSB multiplexer.

A-VSB Transmission Adaptor (TA)

A transmission adaptor (TA) recovers all elementary streams from the normal TS and re-packetizes them with adaptation fields to be used for placeholders of the SRS, the SIC, and the turbo-coded MCAST stream. The exact behavior of the TA depends on the chosen sliver template.

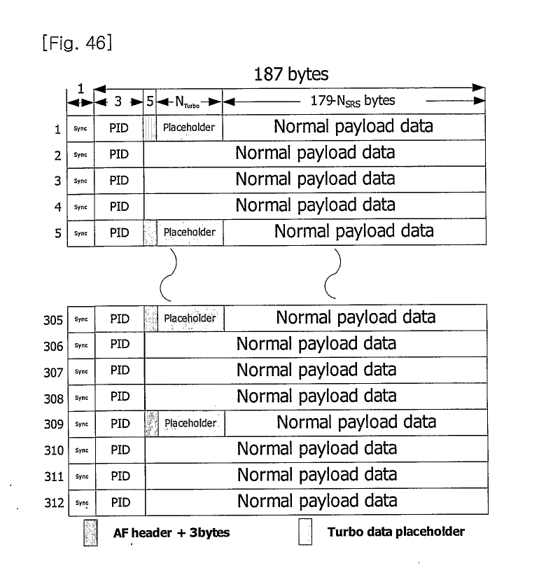

FIG. 46 shows a snapshot of the TA output with the adaptation field placed in every 4th packet. Since 1 package contains 312 packets, there are 78 packets that are forced to have the AF for turbo data placeholders. The amount of space depends on the number of turbo streams and the data rate of each turbo stream. This information is provided by SIC data in FIG. 45.

Sliver Template for Turbo Stream

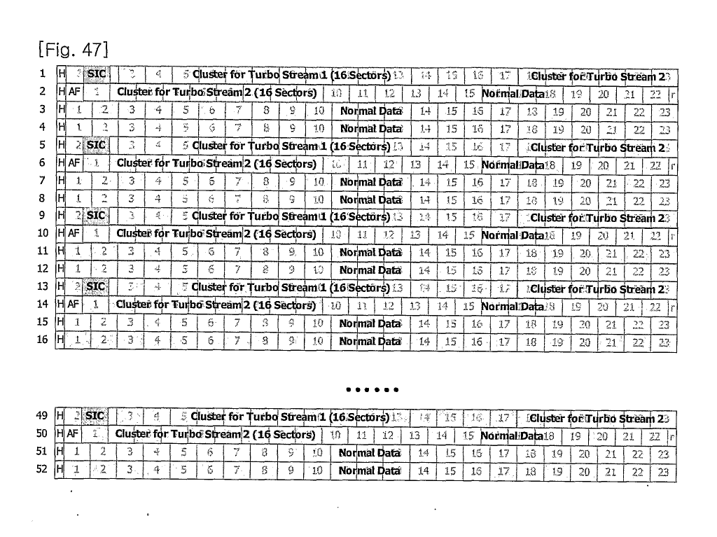

FIG. 47 shows an example of a sliver template for two (2) turbo streams, the clusters of which have 16 sectors. A cluster shall be defined as a multiple of 4 sectors (32 bytes). Each turbo stream occupies a cluster of a {1, 2, 3, 4} multiples of 4 sectors (32 bytes). The cluster size determines the normal TS overhead for the turbo stream. An outer encoder code rate {¼, ⅓, ½} determines the turbo stream data rate with a cluster size. When an MPEG data packet is entirely dedicated for A-VSB data (turbo stream and SRS), a null packet, A/90 data packet, or a packet with a newly defined PID is used to save 2 bytes of AF header and 3 bytes private field overhead.

Table 8 below summarizes the turbo stream modes which are defined from a VSB cluster size and a code rate. The cluster size for turbo streams (N_{Tstream}) is 4 sectors (32 bytes)*M and determines the normal TS payload loss. For example, when M=4 or equivalently N_{Tstream}=16 sectors (128 bytes), normal TS loss is:

$$\frac{128 \cdot ( 312 / 4 ) \cdot 8 ( bits )}{24.2 ( ms )} = 3.30 Mbps .$$

In Table 8 there are nine (9) turbo stream data rates defined by an outer encoder code rate and a cluster size. The combination of these two parameters is confined to three (3) code rates (½, ⅓, ¼) and four adaptation field lengths (N_{Tstream}): 4(32), 8(64), 12(96), and 16(128) sectors (bytes). This results in 12 effective turbo stream modes. Including the mode where the turbo stream is switched off, there are 13 different modes. The first byte of a turbo stream packet will be synchronized to the first byte in the first cluster in every package. The number of encapsulated turbo TS packets in a package (312 MPEG data packets) is the “# of MCAST packets in package” in Table 8 and denoted as N_{TP}.

Similar to the deterministic sliver for the burst SRS, several pieces of information (such as PCR etc.) have to be delivered through the adaptation field along with the turbo stream data. In the case of SRS, there are 4 fixed packet slots for constraint-free packets. On the contrary, the deterministic sliver for turbo stream allows for more degree of freedom for constraint-free packets because any packet carrying no turbo stream bytes can be any form of packets. However, a turbo stream sliver together with the burst SRS has the same constraints as an SRS sliver.

The parameters for turbo stream decoding shall be known to a receiver by the DFS and SIC signaling schemes. They are the code rate, the cluster position and size in a sliver for each turbo stream.

The optional turbo stream choices are tabulated in Table 9 below. They provide higher data rates than those in Table 8. Since they require more memory and higher processing speed to receivers, their implementation will be confirmed later.

TABLE 8
Normal TS Loss by Turbo TS Rate and Code Rate

| # of | | | | |
|---|---|---|---|---|
| MCAST | | | | |
| packets | Turbo | (Normal TS Loss in kbps, | | |
| in package | TS Rate | Occupied Sectors) | | |
| (N_{TP}) | (kbps) | ½ | ⅓ | ¼ |
| 3 | 186.45 | | | (825.12, 4) |
| 4 | 248.60 | | (825.12, 4) | |
| 6 | 372.89 | (825.12, 4) | | (1,650.25, 8 ) |
| 8 | 497.19 | | (1,650.25, 8 ) | |
| 9 | 559.34 | | | (2,475.37, 12) |
| 12 | 745.79 | (1,650.25, 8) | (2,475.37, 12) | (3,300.50, 16) |
| 16 | 994.38 | | (3,300.50, 16) | |
| 18 | 1,118.68 | (2,475.37, 12) | | |
| 24 | 1,491.57 | (3,300.50, 16) | | |

TABLE 9
Optional Turbo Stream Modes

| # of | | | | |
|---|---|---|---|---|
| MCAST | Turbo | | | |
| packets | TS | | | |
| in package | Rate | (Normal TS Loss in kbps, Occupied Sectors) | | |
| (N_{TP}) | (kbps) | ½ | ⅓ | ¼ |
| 24 | 1,491.57 | | | (6,600.99, 32) |
| 32 | 1,988.76 | | (6,600.99, 32) | |
| 33 | 2,050.91 | | | (9,076.36, 44) |
| 44 | 2,734.55 | | (9,076.36, 44) | |
| 48 | 2,983.14 | (6,600.99, 32) | | |
| 66 | 4,101.82 | (9,076.36, 44) | | |

MCAST Service Multiplexer

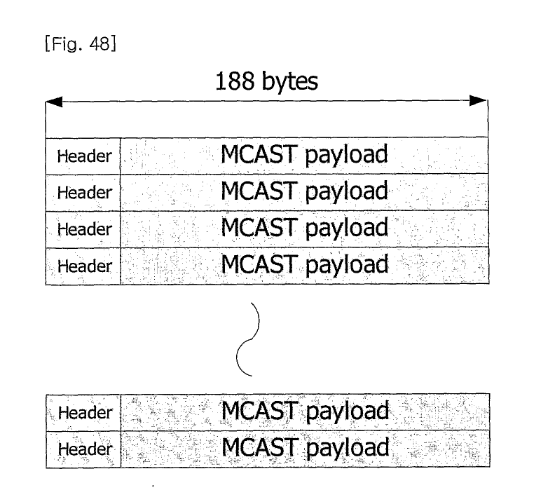

The MCAST service multiplexer block multiplexes the encapsulated A/V stream, IP stream, and/or objects. FIG. 48 shows a snapshot of its output stream that is the output of the transport layer and the input to the link layer. A MCAST packet has 188 bytes of length and its detail syntax is defined in ATSC-MCAST.

Randomizer

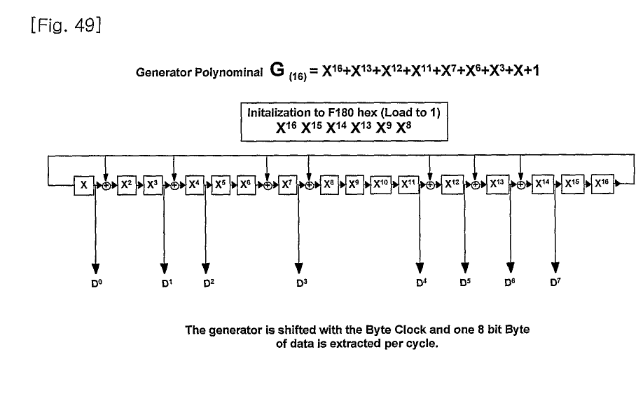

The randomizer is the same as that defined in A/53 Part 2, which is shown in FIG. 49. This randomizer shall be initialized just before the first byte of each turbo message block. The turbo message block is defined by the number of MCAST packets (N_{TP}) incorporated in a package. The number N_{TP} is tabulated in Table 8 above. For example, when a turbo stream has the code rate of ⅓ and the cluster size of 8 sectors, the turbo message block is 8 MCAST packets and 188 bytes×8=1504 bytes. Accordingly, whenever each 1504 bytes starts, the randomizer shall be initialized. This block of 1504 bytes is synchronized to packages. However, the turbo message block for the SIC is fixed to 188 bytes and this block is synchronized to parcels.

Reed-Solomon Encoder

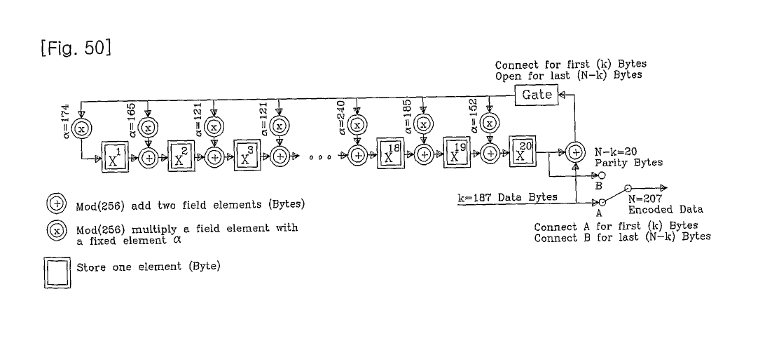

The MCAST stream and the SIC are encoded with the systematic RS code which is a t=10 (208,188) code. The generator polynomial is the same one as that defined in ATSC/A53 part 2. In creating bytes from the serial bit stream, the MSB shall be the first serial bit. The encoder structure is shown in FIG. 50.

Time Interleaver

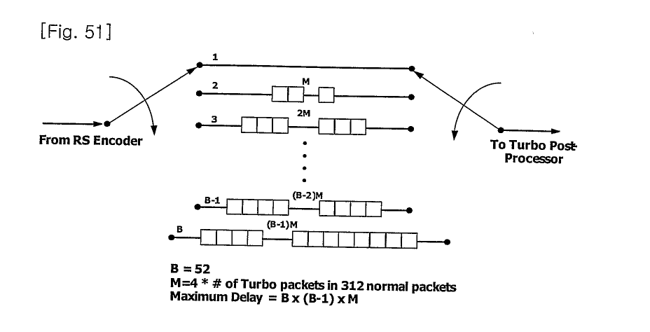

The time interleaver shown in FIG. 51 is a type of the convolutional byte interleaver. The number of branches (B) is fixed to 52 while the basic memory size (M) varies with the number of MCAST packets delivered in a package, so that the maximum interleaving depth is constant regardless of the number of MCAST packets contained in every package.

The maximum delay is B×(B−1)×M. Given the number of MCAST packets (N_{TP}) per package and the basic memory size (M) equal to N_{TP}*4, the maximum delay becomes B×(B−1)×M=51×208×NTP bytes. Since 208×N_{TP} bytes are transmitted in each field, the bytes of a MCAST packet are spread over 51 fields in all turbo stream transmission rates, which corresponds to 1.14 second of the interleaving depth.

The time interleaver shall be synchronized to the first byte of the data field. Table 10 shows the basic memory size for the number of MCAST packets contained 312 normal packets.

TABLE 10
Basic Memory Size in Time Interleaver (*optional)

| | # of MCAST | | | |
|---|---|---|---|---|
| Data | Packets | Basic | Maximum | Interleaving |
| rate | per package | Memory | delay | depth in |
| (Kbps) | (NT) | size (M) | in bytes | field |
| 186.5 | 3 | 12 | 31824 | 51 |
| 248.6 | 4 | 16 | 42432 | 51 |
| 372.9 | 6 | 24 | 63648 | 51 |
| 497.2 | 8 | 32 | 84864 | 51 |
| 559.4 | 9 | 36 | 95472 | 51 |
| 745.9 | 12 | 48 | 127296 | 51 |
| 994.5 | 16 | 64 | 169728 | 51 |
| 1118.0 | 18 | 72 | 190944 | 51 |
| 1491.0 | 24 | 96 | 254592 | 51 |
| 1988.8 | 32* | 128 | 339456 | 51 |
| 2050.9 | 33* | 132 | 350064 | 51 |
| 2734.6 | 44* | 176 | 466752 | 51 |
| 2983.1 | 48* | 192 | 509184 | 51 |
| 4101.8 | 66* | 264 | 700128 | 51 |

For the burst transmission, the delay induced by the time interleaver is preferred to be limited within a burst. Accordingly, the time interleaver can be optionally modified as follows. This modification shall be signaled via the SIC.

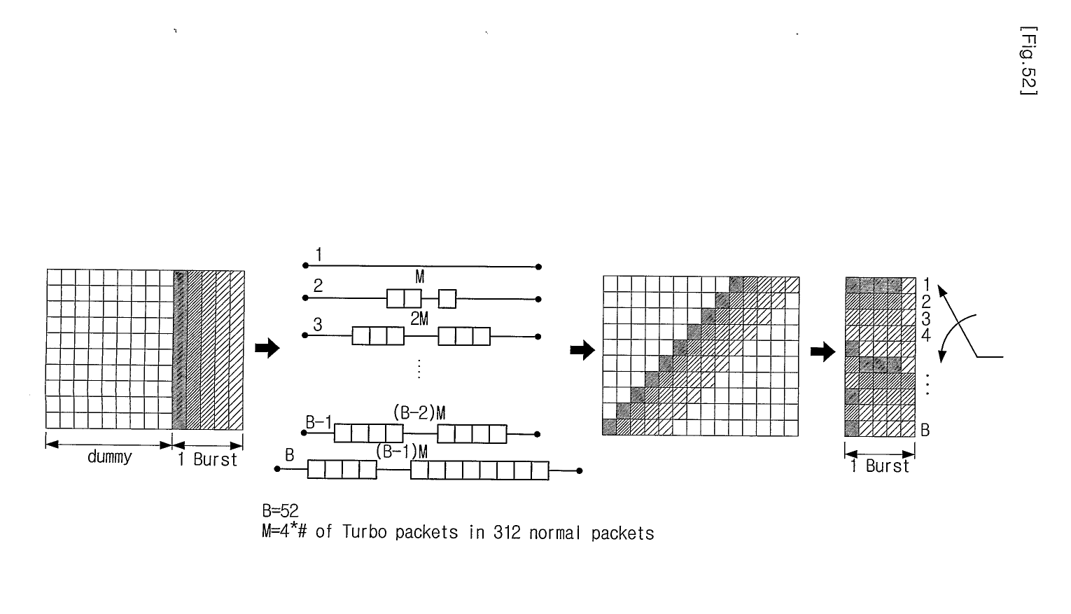

FIG. 52 shows a basic idea for the modification. In order to have the burst data get out of the time interleaver, dummy bytes are appended to the end of each burst data. Then, at the output of the time interleaver, dummy bytes and initial interleaver memory contents are discarded. Thus, interleaved burst data is obtained.

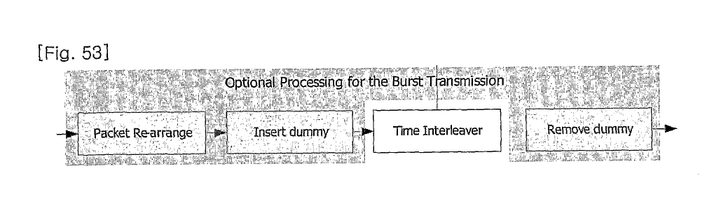

FIG. 53 depicts the optional processing steps in the burst transmission. First of all, packets are arranged for the burst transmission. This procedure is detailed in the power management section in the MCAST document. Then, the dummy bytes are appended. After time interleaving, the data are collected while discarding the dummy bytes.

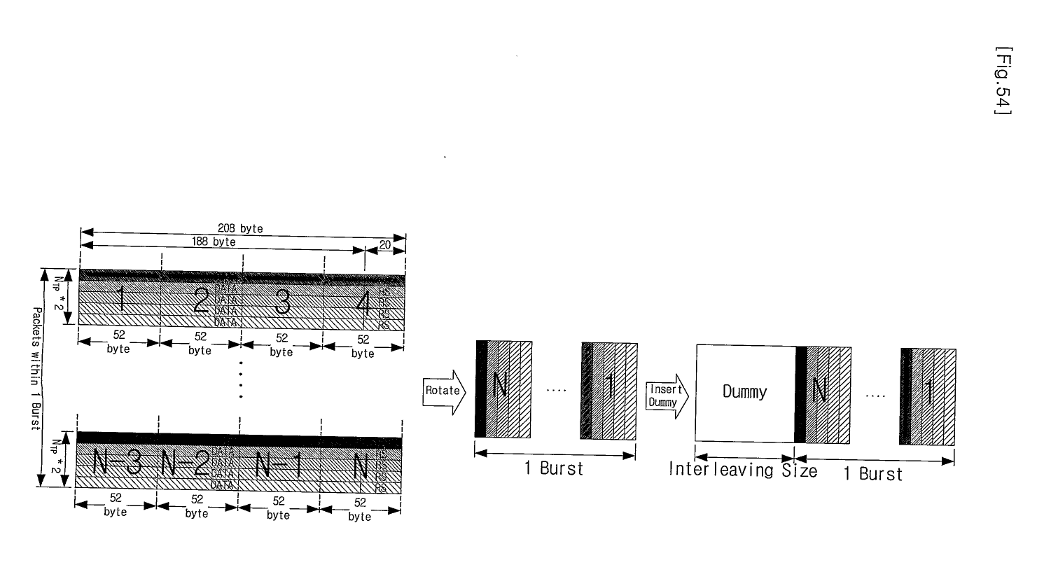

FIG. 54 shows how to process the packets for the time interleaver in the burst transmission in more detail. One burst constitutes N numbers of (52 bytes×N_{TP}×2) data where N_{TP} is the number of MCAST packets per package. Then, each (52 bytes×N_{TP}×2) data is rotated for the burst transmission. Finally, the dummy bytes are appended to have one burst data get out of the interleaver. Accordingly, the number of dummy bytes shall be (52 bytes×the interleaving size) bytes.

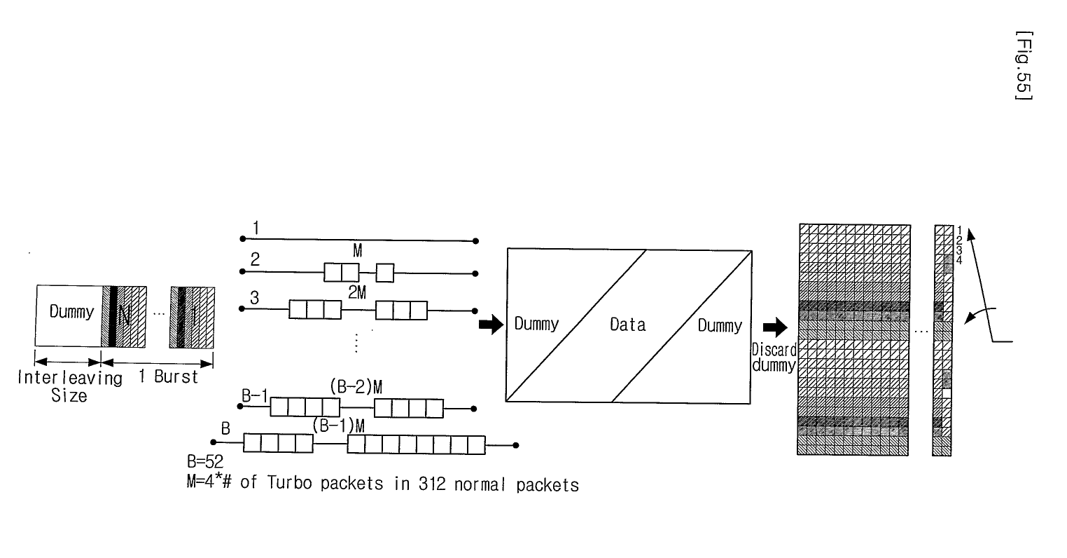

FIG. 55 explains how to process the interleaver output. From the nature of the convolutional interleaver, the data is arranged in the shape of a parallelogram at the output. In the sequel, one burst of data is collected while discarding the dummy bytes and the initial interleaver memory contents.

The net result of this additional processing is the interleaving within a burst delay, which is desirable in the burst transmission. Otherwise, the inter-burst interleaving results which causes an unacceptably long system latency.

Outer Encoder

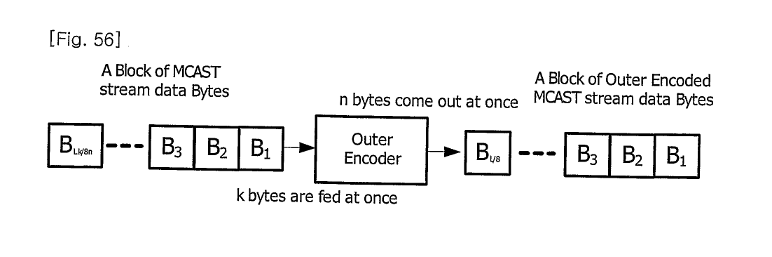

The outer encoder in the turbo processor is depicted in FIG. 56. Referring to FIG. 56, the outer encoder receives a block of MCAST stream data bytes (L/8 bytes=L bits) and produces a block of outer encoded MCAST stream data bytes. The outer encoder operates on a byte basis. Accordingly, k bytes enter the outer encoder and n bytes come out when the selected code rate is k/n.

The choice of the encoding block size (L) is shown in Table 11.

TABLE 11
Outer Interleaver Block Size by Cluster Size (*Option)

| | Cluster Size | Normal TS | Outer Interleaver |
|---|---|---|---|
| # of Sectors | In Bytes per slivers | Loss (Mbps) | Block (L bits) |
| 4 | 2496 | 0.8252 | 19968 |
| 8 | 4992 | 1.6504 | 39936 |
| 12 | 7488 | 2.4757 | 59904 |
| 16 | 9984 | 3.3009 | 79872 |
| 32* | 19968 | 6.6018 | 159744 |
| 44* | 27456 | 9.0764 | 219648 |

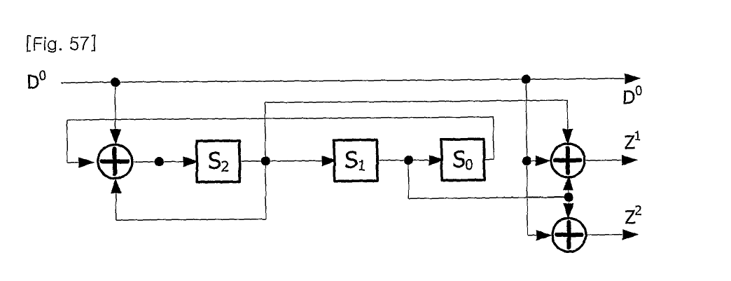

The outer encoder is shown in FIG. 57. Referring to FIG. 57, the outer encoder receives 1 bit)(D⁰ and produces 2 bits to 3 bits. At the beginning of a new block, the outer encoder state is set to 0. No trellis-terminating bits are appended at the end of a block. Since the block size is relatively long, it doesn't deteriorate the error-correction capability too much. Possible residual errors, if any, are corrected by the RS code applied in the pre-processor.

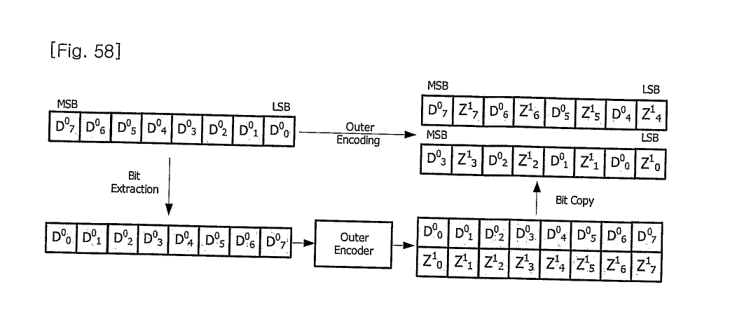

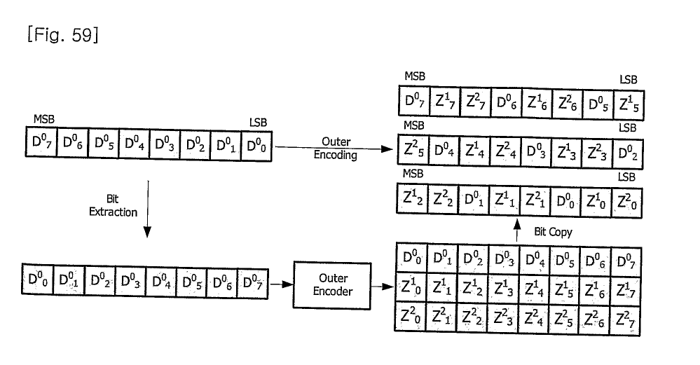

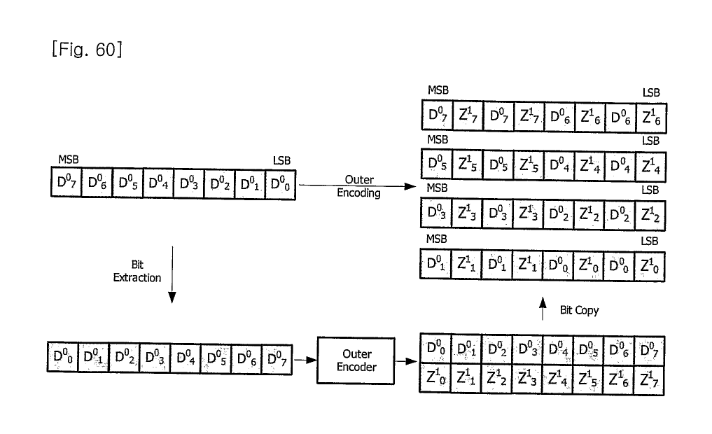

FIGS. 58-60 illustrate an encoding process. In the ½ rate mode, 1 byte is put through D⁰ to the outer encoder and the two bytes obtained from (D⁰ Z¹) are used to produce 2 bytes output. In the ⅓ rate mode, 1 byte is fed to the encoder through D⁰ and 3 bytes are obtained from D⁰, Z¹, Z². In the ¼ rate mode, 1 byte enters the encoder through D⁰ and 2 bytes are produced from D⁰, Z¹. These bits are duplicated to make 4 bytes. The top byte precedes the next top byte at the output of the encoder in FIGS. 58-60.

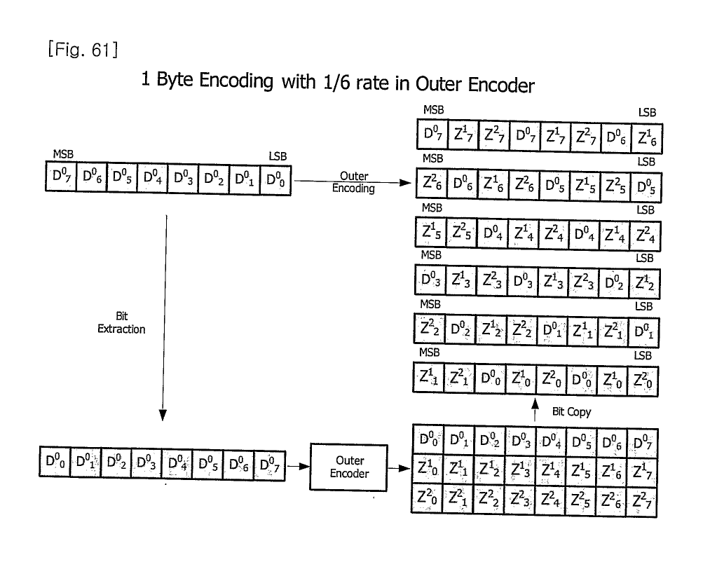

The SIC is encoded by ⅙ turbo code. FIG. 61 shows a process of encoding the SIC.

Outer Interleaver

The outer bit interleaver scrambles the outer encoder output bits. The bit interleaving rule is defined by a linear congruence expression as follows:

Π(i)=(P·i+D_{(i mod 4)})mod L

For a given interleaving length (L), this interleaving rule has 5 parameters (P, D0, D1, D2, D3) which are defined in Table 12.

TABLE 12
Interleaving Rule Parameters

| L | P | D0 | D1 | D2 | D3 |
|---|---|---|---|---|---|
| 79872 | 181 | 0 | 0 | 0 | 724 |
| 59904 | 173 | 0 | 0 | 0 | 692 |
| 39936 | 131 | 0 | 0 | 0 | 524 |
| 19968 | 95 | 0 | 0 | 380 | 760 |
| 4992(SIC) | 47 | 0 | 0 | 188 | 376 |

Each turbo stream mode specifies the interleaving length (L) as shown in Table 8. For example, when the interleaving length L=19968 is used, the outer interleaver takes turbo stream data bytes 13312 bits (L bits) to scramble. Table 12 dictates the parameter set (P, D0, D1, D2, D3)=(95,0,0,380,760). The interleaving rule {Π(0), Π(1), . . . , Π(L−1)} is generated by:

$$Π ( i ) = \{ \begin{matrix}( 95 \cdot i ) mod 19968 & i mod 4 == 0 , 1 \\ ( 95 \cdot i + 380 ) mod 19968 & i mod 4 == 2 \\ ( 95 \cdot i + mod 19968 & i mod 4 == 3\end{matrix}$$

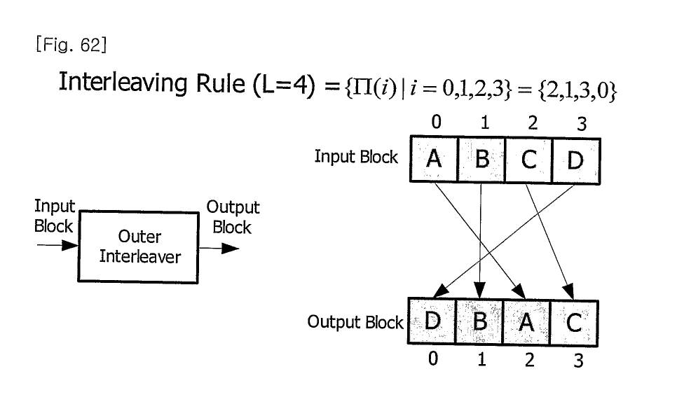

An interleaving rule is interpreted as “The i-th bit in the input block is placed in the Π(i)—the bit in the output block.” FIG. 62 shows an interleaving rule when the length is 4.

Multi-Stream Data Deinterleaver

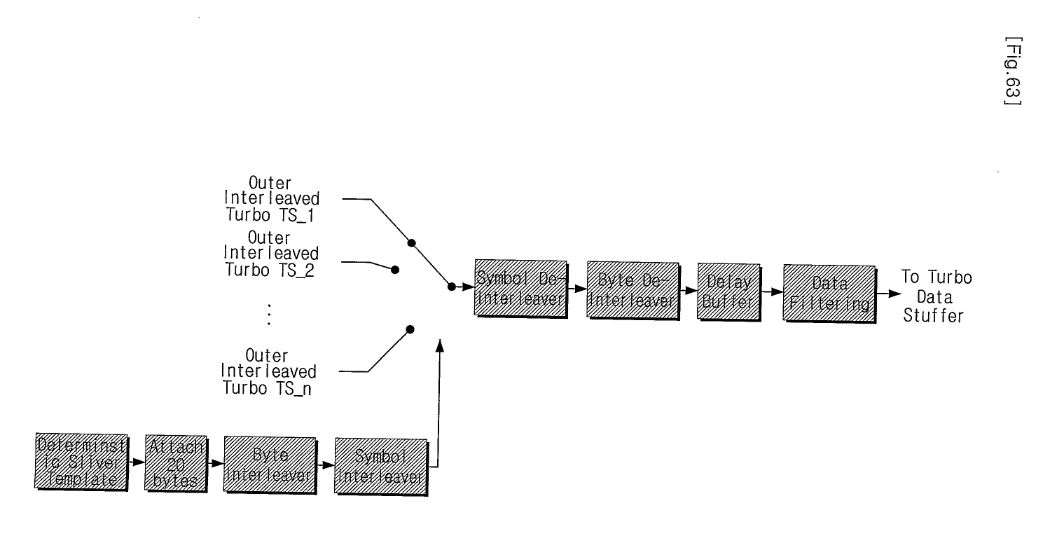

FIG. 63 illustrates a detailed block diagram of a multi-stream data de-interleaver. Following the selected deterministic sliver template, multiplexing information is generated through a 20 byte attacher, an A/53 byte interleaver, and an A/53 symbol interleaver. The A/53 symbol interleaver receives an input on a byte basis and produces an output on a symbol basis. Its block size is 828 bytes (828×4=3312) and its mapping is detailed in Table 13. Each symbol indicates which turbo TS symbol is fed to the symbol deinterleaver.

TABLE 13
Input-Output Mapping in Symbol Interleaver

| Output | Input | Bits in |
|---|---|---|
| Symbol | Byte | a byte |
| 0 | 0 | 7, 6 |
| 1 | 1 | 7, 6 |
| 2 | 2 | 7, 6 |
| 3 | 3 | 7, 6 |
| 4 | 4 | 7, 6 |
| 5 | 5 | 7, 6 |
| 6 | 6 | 7, 6 |
| 7 | 7 | 7, 6 |
| 8 | 8 | 7, 6 |
| 9 | 9 | 7, 6 |
| 10 | 10 | 7, 6 |
| 11 | 11 | 7, 6 |
| 12 | 0 | 5, 4 |
| 13 | 1 | 5, 4 |
| . . . | . . . | . . . |
| 19 | 7 | 5, 4 |
| 20 | 8 | 5, 4 |
| 21 | 9 | 5, 4 |
| 22 | 10 | 5, 4 |
| 23 | 11 | 5, 4 |
| 24 | 0 | 3, 2 |
| 25 | 1 | 3, 2 |
| . . . | . . . | . . . |
| 31 | 7 | 3, 2 |
| 32 | 8 | 3, 2 |
| 33 | 9 | 3, 2 |
| 34 | 10 | 3, 2 |
| 35 | 11 | 3, 2 |
| 36 | 0 | 1, 0 |
| 37 | 1 | 1, 0 |
| . . . | . . . | . . . |
| 47 | 11 | 1, 0 |
| 48 | 12 | 7, 6 |
| 49 | 13 | 7, 6 |
| . . . | . . . | . . . |
| 95 | 23 | 1, 0 |
| 96 | 24 | 7, 6 |
| 97 | 25 | 7, 6 |
| . . . | . . . | . . . |
| 767 | 191 | 1, 0 |
| 768 | 192 | 7, 6 |
| 769 | 193 | 7, 6 |
| . . . | . . . | . . . |
| 815 | 203 | 1, 0 |
| 816 | 204 | 7, 6 |
| 817 | 205 | 7, 6 |
| . . . | . . . | . . . |
| 827 | 215 | 7, 6 |
| 828 | 208 | 5, 4 |
| 829 | 209 | 5, 4 |
| 830 | 210 | 5, 4 |
| 831 | 211 | 5, 4 |
| 832 | 212 | 5, 4 |
| 833 | 213 | 5, 4 |
| 834 | 214 | 5, 4 |
| 835 | 215 | 5, 4 |
| 836 | 204 | 5, 4 |
| 837 | 205 | 5, 4 |
| 838 | 206 | 5, 4 |
| 839 | 207 | 5, 4 |
| 840 | 208 | 3, 2 |
| 841 | 209 | 3, 2 |
| . . . | . . . | . . . |
| 847 | 215 | 3, 2 |
| 848 | 204 | 3, 2 |
| 849 | 205 | 3, 2 |
| 850 | 206 | 3, 2 |
| 851 | 207 | 3, 2 |
| 852 | 208 | 1, 0 |
| 853 | 209 | 1, 0 |
| . . . | . . . | . . . |
| 859 | 215 | 1, 0 |
| 860 | 204 | 1, 0 |
| 861 | 205 | 1, 0 |
| 862 | 206 | 1, 0 |
| 863 | 207 | 1, 0 |
| 864 | 216 | 7, 6 |
| 865 | 217 | 7, 6 |
| . . . | . . . | . . . |
| 875 | 227 | 7, 6 |
| 876 | 216 | 5, 4 |
| 877 | 217 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 1643 | 419 | 7, 6 |
| 1644 | 408 | 5, 4 |
| 1645 | 409 | 5, 4 |
| . . . | . . . | . . . |
| 1655 | 419 | 5, 4 |
| 1656 | 412 | 3, 2 |
| 1657 | 413 | 3, 2 |
| 1658 | 414 | 3, 2 |
| 1659 | 415 | 3, 2 |
| 1660 | 416 | 3, 2 |
| 1661 | 417 | 3, 2 |
| 1662 | 418 | 3, 2 |
| 1663 | 419 | 3, 2 |
| 1664 | 408 | 3, 2 |
| 1665 | 409 | 3, 2 |
| 1666 | 410 | 3, 2 |
| 1667 | 411 | 3, 2 |
| 1668 | 412 | 1, 0 |
| 1669 | 413 | 1, 0 |
| . . . | . . . | . . . |
| 1675 | 419 | 1, 0 |
| 1676 | 408 | 1, 0 |
| 1677 | 409 | 1, 0 |
| 1678 | 410 | 1, 0 |
| 1679 | 411 | 1, 0 |
| 1680 | 420 | 7, 6 |
| 1681 | 421 | 7, 6 |
| . . . | . . . | . . . |
| 1687 | 427 | 7, 6 |
| 1688 | 428 | 7, 6 |
| 1689 | 429 | 7, 6 |
| 1690 | 430 | 7, 6 |
| 1691 | 431 | 7, 6 |
| 1692 | 420 | 5, 4 |
| 1693 | 421 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 2471 | 623 | 5, 4 |
| 2472 | 612 | 3, 2 |
| 2473 | 613 | 3, 2 |
| . . . | . . . | . . . |
| 2483 | 623 | 3, 2 |
| 2484 | 616 | 1, 0 |
| 2485 | 617 | 1, 0 |
| 2486 | 618 | 1, 0 |
| 2487 | 619 | 1, 0 |
| 2488 | 620 | 1, 0 |
| 2489 | 621 | 1, 0 |
| 2490 | 622 | 1, 0 |
| 2491 | 623 | 1, 0 |
| 2492 | 612 | 1, 0 |
| 2493 | 613 | 1, 0 |
| 2494 | 614 | 1, 0 |
| 2495 | 615 | 1, 0 |
| 2496 | 624 | 7, 6 |
| 2497 | 625 | 7, 6 |
| . . . | . . . | . . . |
| 2503 | 631 | 7, 6 |
| 2504 | 632 | 7, 6 |
| 2505 | 633 | 7, 6 |
| 2506 | 634 | 7, 6 |
| 2507 | 635 | 7, 6 |
| 2508 | 624 | 5, 4 |
| 2509 | 625 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 3299 | 827 | 3, 2 |
| 3300 | 816 | 1, 0 |
| 3301 | 817 | 1, 0 |
| . . . | . . . | . . . |
| 3311 | 827 | 1, 0 |

After multiplexing multi turbo stream symbols in accordance with the generated multiplexing information, they are A/53 symbol de-interleaved and A/53 byte de-interleaved. Since the ATSC A/53 byte interleaver has the delay of 51×4×52 (=204×52) and one sliver consists of 207×52 bytes, (207-204)×52=156 bytes of delay buffer is necessary to synchronize to the sliver unit. Finally, the delayed data corresponding to the reserved space in the AF of the selected sliver template are output to the next block, the turbo data stuffer. The selection of a sliver template is dictated by SIC data as shown with the dashed line in FIG. 45.

Turbo Data Stuffer

The operation of the turbo data stuffer is to get the output bytes of the multi stream data de-interleaver and put them sequentially in the AF made by the TA as is shown in FIG. 45.

Turbo Stream Combined with SRS

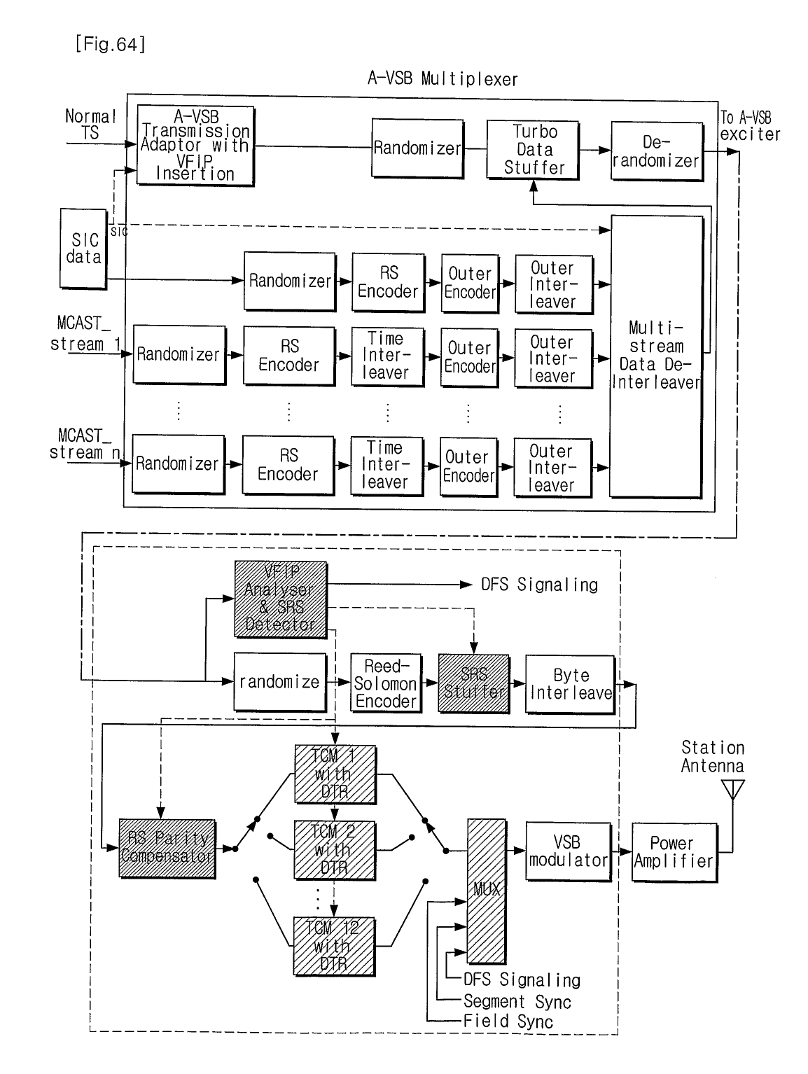

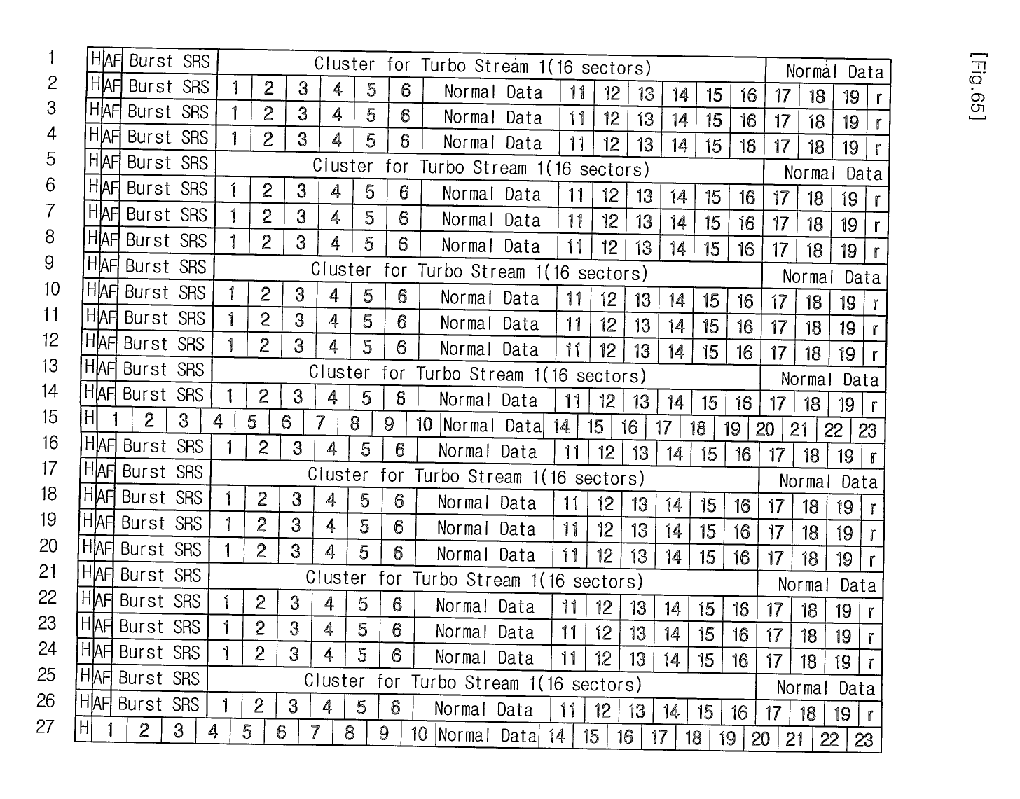

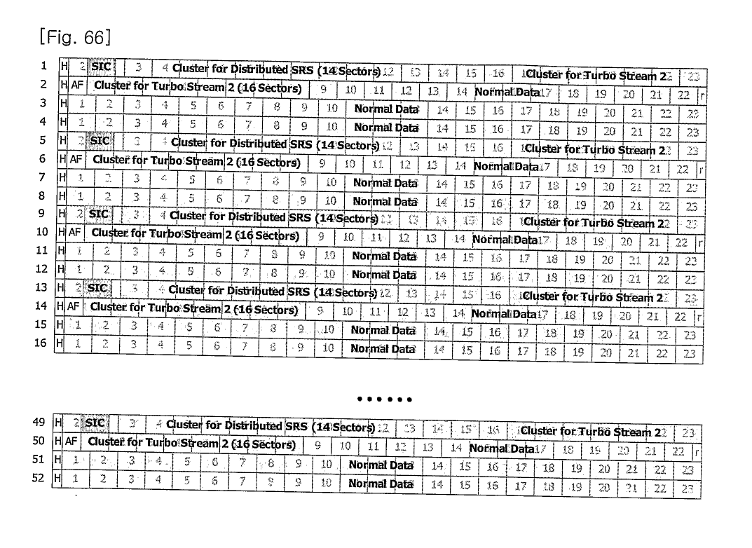

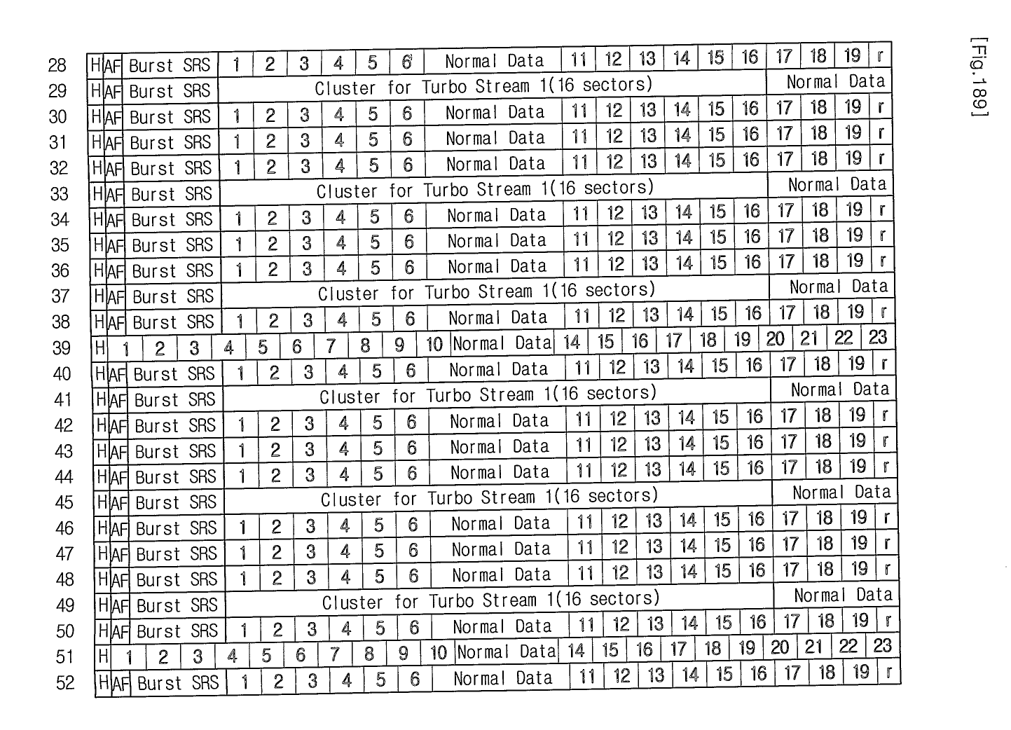

The SRS is easily incorporated into the turbo stream transmission system. FIG. 64 depicts the transmission system enabling the turbo stream with the SRS feature. The sliver templates are synthesized by a simple combination of the SRS and turbo stream sliver templates. The turbo stream cluster shall always follow the cluster for SRS-bytes. Two sliver templates are shown in FIGS. 65, 66, and 189. FIGS. 65 and 189 (hereinafter, FIG. 65) are one figure. One is a sliver template of the burst SRS with the turbo stream and the other is that using the distributed SRS.

Signaling Information

Signaling information that is needed in a receiver must be transmitted. There are two mechanisms for signaling information. One is through a Data Field Sync and the other is via the SIC.

Information that is transmitted through the Data Field Sync is the SRS, and turbo decoding parameters of primary service. The other signaling information will be transmitted through the SIC.

Since the SIC is a kind of turbo stream, the signaling information in the SIC passes through the exciter from an A-VSB Mux. On the other hand, the signaling information in the DFS has to be delivered to the exciter from an A-VSB Mux through VFIP packet because a DFS is created while the exciter makes a VSB frame. There are two ways to do this communication. One is through the VFIP and the other is through the SRS-placeholder which is filled with SRS-bytes in the exciter.

DFS Signaling Information Through the VFIP

When SRS-bytes are present, the VFIP shall be extended as defined in Table 14. This is shown with the SRS included. It is noted that if the SRS is used, a high speed data channel can carry all signaling to the exciter. If the SRS is not included, the srs_mode field is set to zero (private=0x00).

TABLE 14
DF with SRS and Turbo Stream Packet Syntax

| Syntax | # of Bits | mnemonic |
|---|---|---|
| VFIP_omp_packet( ) { | | |
| transport_packet_header | 32 | bslbf |
| OM_type | 8 | bslbf |
| reserved | 8 | uimsbf |
| srs_bytes | 26 * 8 | uimsbf |
| srs_mode | 8 | uimsbf |
| primary_turbo_stream_mode | 8 | uimsbf |
| private | 154 * 8 | uimsbf |

transport_packet_header—as defined and constrained by ATSC A/110A, Section 6.1.

OM_type—as defined in ATSC A/110, Section 6.1 and set to 0x30.

srs_bytes—as defined above with reference to the adaptation field contents (SRS bytes) for burst SRS.

srs_mode—signals the SRS mode to the exciter

turbo_stream_mode—signals the turbo stream modes

private—defined by other applications or application tools. If unused, shall be set to 0x00.

DFS Signaling Information

A/53 DFS Signaling (Informative)

The information about the current mode is transmitted on the reserved (104) symbols of each Data Field Sync. Specifically:

1. Allocate symbols for Mode of each enhancement: 82 symbols
A. 1st ˜82nd symbol

2. Enhanced data transmission methods: 10 symbols
A. 83rd ˜84th symbol (2 symbols): reserved
B. 85th ˜92nd symbol (8 symbols): Enhanced data transmission methods
C. On even data fields (negative PN63), the polarities of symbols 83 through 92 shall be inverted from those in the odd data field

3. Pre-code: 12 symbols

For more information, refer to the ATSC Digital Television Standard (A/53).

A-VSB DFS Signaling Extended from A/53 DFS Signaling

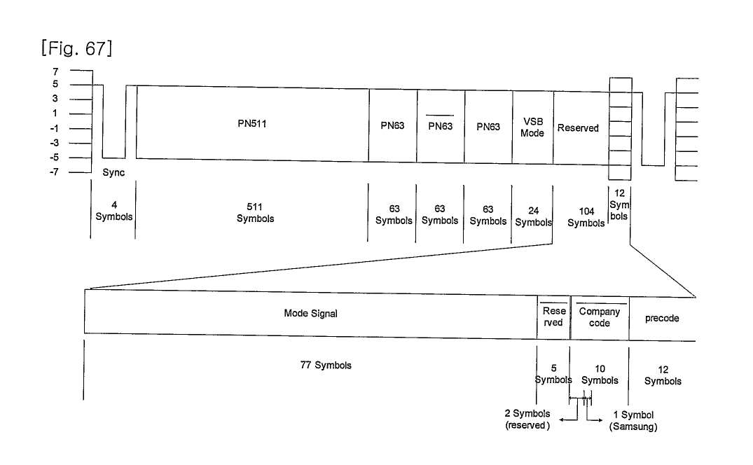

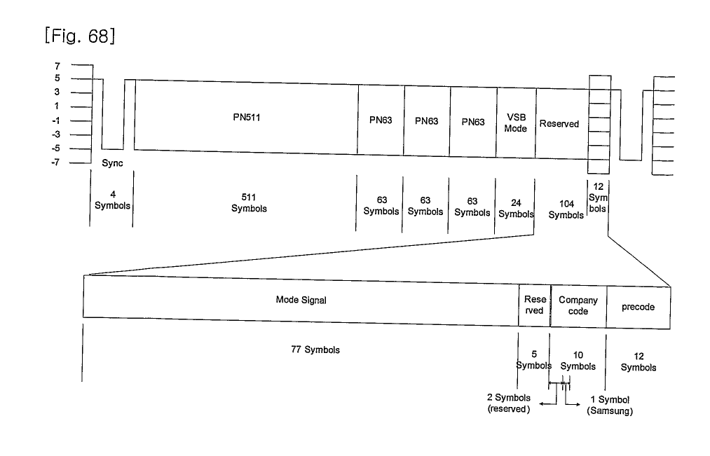

Signaling information is transferred through the reserved area of 2 DFSs. 77 Symbols in each DFS amount to 154 Symbols. Signaling information is protected from channel errors by a concatenated code (RS code+convolutional code). The DFS structure is depicted in FIGS. 67 and 68.

Allocation for A-VSB Mode

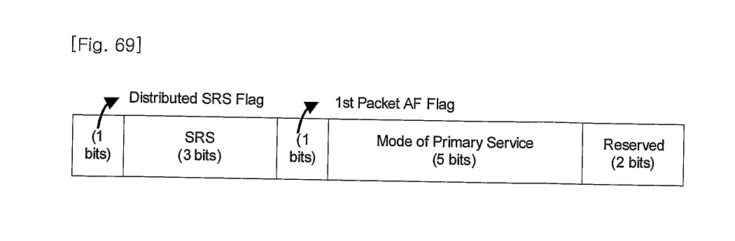

The mapping between a value and an A-VSB mode is as follows (FIG. 69).

Distributed SRS Flag

TABLE 15
Mapping of Distributed SRS flag

| Item | Value |
|---|---|
| Burst SRS | 0 |
| Distributed SRS | 1 |

SRS at Burst SRS

TABLE 16
Mapping of SRS @ Burst SRS

| SRS Bytes per Packet | Value |
|---|---|
| 0 | 000 |
| 10 | 001 |
| 15 | 010 |
| 20 | 011 |
| reserved | 100~111 |

SRS at Distributed SRS

TABLE 17
Mapping of SRS @ Distributed SRS

| SRS Bytes per Track | Value |
|---|---|
| 48 | 000 |
| 56 | 001 |
| 80 | 010 |
| 112 | 011 |
| reserved | 100~111 |

1st Packet AF Flag for Primary Turbo Stream

As described above, the turbo data placement will be different depending on the existence of the adaptation field (compare the A-VSB data in FIGS. 18 and 19). So it is necessary to signal the absence or presence of the adaptation field in order for a receiver to correctly locate the cluster for the primary turbo stream.

TABLE 18
Mapping of Full Packet flag

| Item | Value |
|---|---|
| Presence of AF in 1^{st} | 0 |
| packet in Track | |
| Absence of AF in 1^{st} | 1 |
| packet in Track | |

Mode of Primary Service

TABLE 19
Mapping of Turbo Stream Transmission Mode

| Cluster size in | Turbo | Turbo Data | # of MCAST | |
|---|---|---|---|---|
| Sectors (bytes) | Code | Rate | Packets | |
| In every track | Rate | (kbps) | Per package | Value |
| 0 | — | — | — | 00000 |
| 4 (32) | ½ | 372.89 | 6 | 00001 |
| 4 (32) | ⅓ | 248.59 | 4 | 00010 |
| 4 (32) | ¼ | 186.44 | 3 | 00011 |
| 8 (64) | ½ | 745.77 | 12 | 00100 |
| 8 (64) | ⅓ | 497.18 | 8 | 00101 |
| 8 (64) | ¼ | 372.88 | 6 | 00110 |
| 12 (96) | ½ | 1,118.65 | 18 | 00111 |
| 12 (96) | ⅓ | 745.77 | 12 | 01000 |
| 12 (96) | ¼ | 559.33 | 9 | 01001 |
| 16 (128) | ½ | 1,491.54 | 24 | 01010 |
| 16 (128) | ⅓ | 994.36 | 16 | 01011 |
| 16 (128) | ¼ | 745.77 | 12 | 01100 |
| 32 (256) | ½ | 2,983.08 | 48 | 01101 |
| 32 (256) | ⅓ | 1,988.72 | 32 | 01110 |
| 32 (256) | ¼ | 1,491.54 | 24 | 01111 |
| 44 (352) | ½ | 4,101.82 | 66 | 10000 |
| 44 (352) | ⅓ | 2,734.55 | 44 | 10001 |
| 44 (352) | ¼ | 2,050.91 | 33 | 10010 |

| | |
|---|---|
| Reserved | 10011~11111 |

Error Correction Coding for DFS Signaling Information

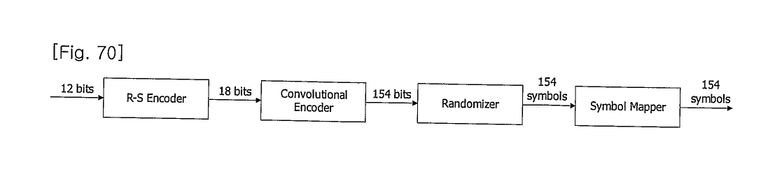

The DFS mode signaling information is encoded by a concatenation of a (6, 4) RS code and a 1/7 convolutional code. (FIG. 70)

R-S Encoder

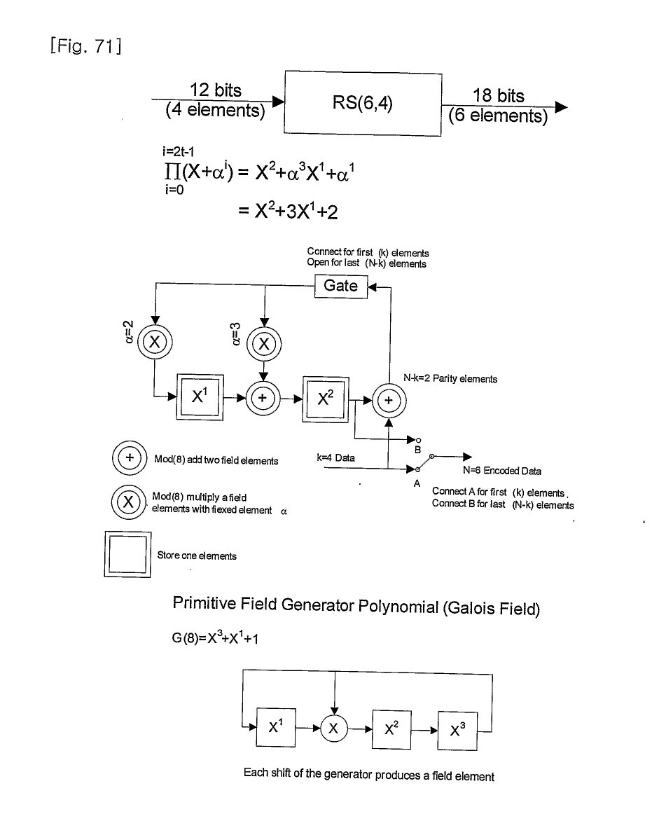

The (6, 4) RS parity bytes are attached to mode information. (FIG. 71)

1/7 rate Tail-biting Convolutional Coding

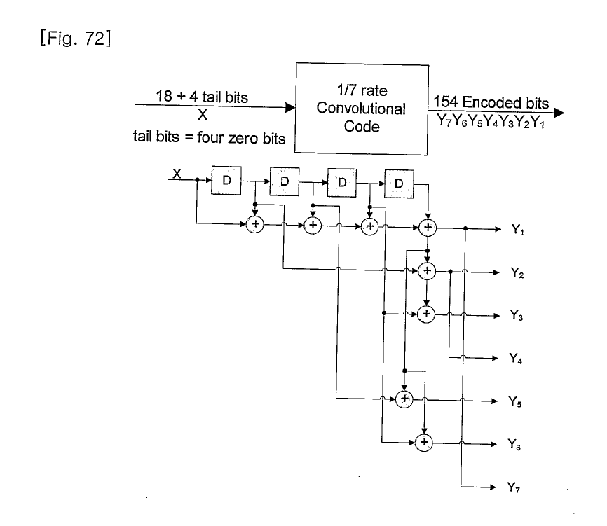

(6, 4) R-S encoded bits are encode again by a 1/7 rate trellis-terminating convolutional code. (FIG. 72)

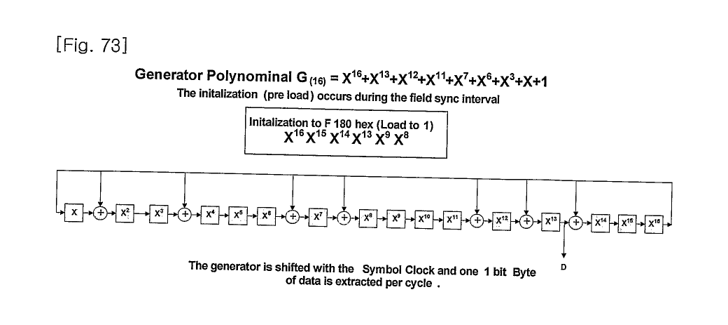

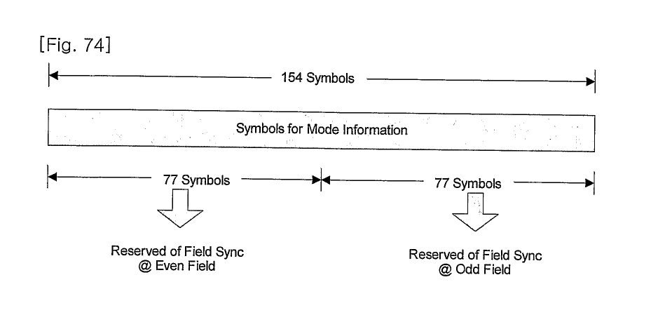

Randomizer (FIG. 73)

Symbol Mapping

The mapping between a Bit and Symbol is as provided in Table 20.

TABLE 20
Symbol Mapping

| Value of Bit | Symbol |
|---|---|
| 0 | −5 |
| 1 | +5 |

Insert mode signaling symbols at Data Field Sync's Reserved areas

SFN System

Overview (Informative)

When identical ATSC transport streams are distributed from a studio to multiple transmitters and when the channel coding and modulation processes in all modulators (transmitters) are synchronized, the same input bits will produce the same output RF symbols from all modulators. If the emission times are then controlled, these multiple coherent RF symbols will appear like natural environmental echoes to a receiver's equalizer and hence be mitigated and received.

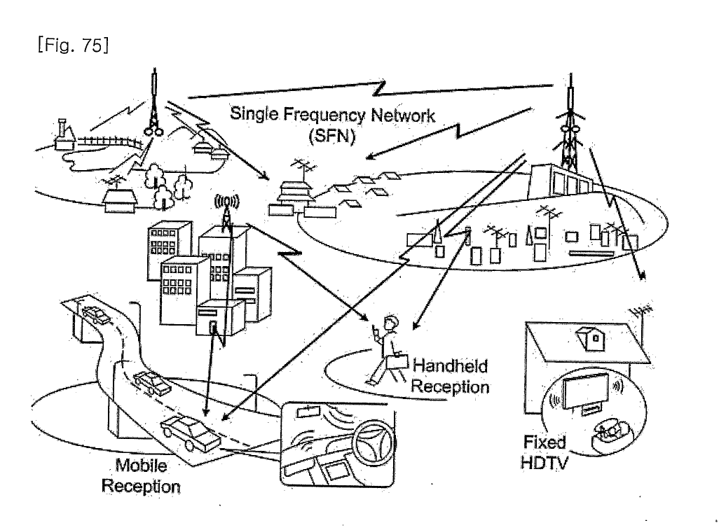

The A-VSB application tool, single frequency network (SFN), offers the option of using transmitter spatial diversity to obtain higher and more uniform signal strength throughout and in targeted portions of a service area. An SFN can be used to improve the quality of service to terrain shielded areas, including urban canyons, fixed or indoor reception environments, or to support new ATSC mobile and handheld services, as illustrated in FIG. 75.

The A-VSB application tool, SFN, requires several elements in each modulator to be synchronized. This will produce the emission of coherent symbols from all transmitters in the SFN and enable interoperability. The elements to be synchronized are:

### Frequency (Carrier, Symbol)

### VSB Data Frame

### Pre-Coders/Trellis Coders

### Emission Time

Frequency synchronization of all modulator's carrier frequencies and symbol clocks is achieved by locking these to a universally available frequency reference (10 MHz) from a GPS receiver.

Data frame synchronization requires that all modulators choose the same packet from the incoming transport stream to start or initialize a VSB Frame. A special operations and maintenance packet (OMP) known as a VSB frame initialization packet (VFIP) is inserted once every 20 VSB data frames (12,480 packets) as the last, or 624^{th}, packet in a frame. This cadence determined by a counter in either an emission multiplexer or VFIP inserter which is referenced to 1PPSF. All modulators slave their VSB data framing when VFIP appears in the transport stream.

Synchronization of all pre-coders and trellis coders in all modulators, known collectively as just trellis coders, is achieved by using the core element deterministic trellis reset (DTR) in a sequential fashion over the first 4 data segments in a frame. The cross layer mapping applied in VFIP has 12 byte positions reserved for the DTR operation to synchronize all trellis coders in all modulators in an SFN.

The emission time of the coherent symbols from all SFN transmitters is synchronized by the insertion of time stamps into the VFIP. These time stamps are referenced to the universally available temporal reference of the 1 pulse per second (1PPS) signal from a GPS receiver.

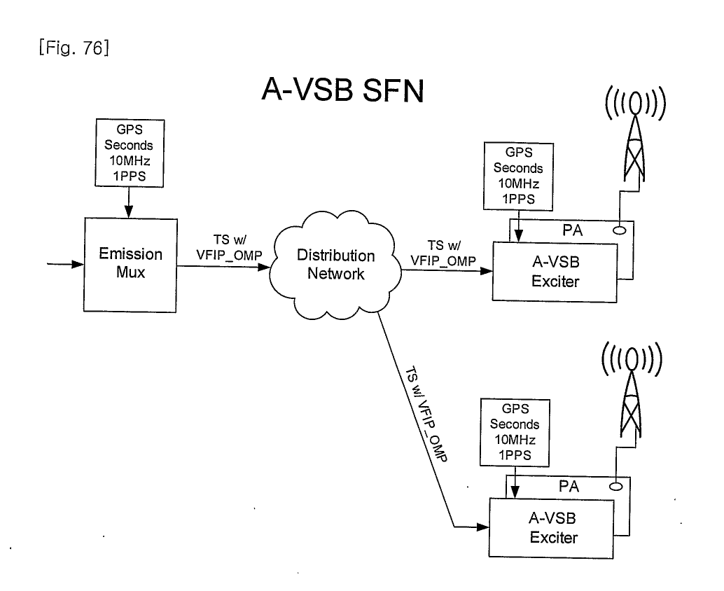

FIG. 76 shows an SFN with an emission multiplexer generating and sending a VFIP to each transmitter in the SFN over a distribution network. This VFIP contains the needed syntax to create all the functionality needed for an A-VSB SFN, as described above.

Encoding Process (Informative)

A brief overview is presented next of how the core element DF is used to synchronize all the VSB frames and how DTR is used to synchronize all the trellis coders in all modulators in an SFN. Then a discussion of how the emission timing is achieved to control the delay spread seen by a receiver will be illustrated using an SFN timing diagram.

DF (Frame Synchronization, DTR (Trellis Coders Synchronization)

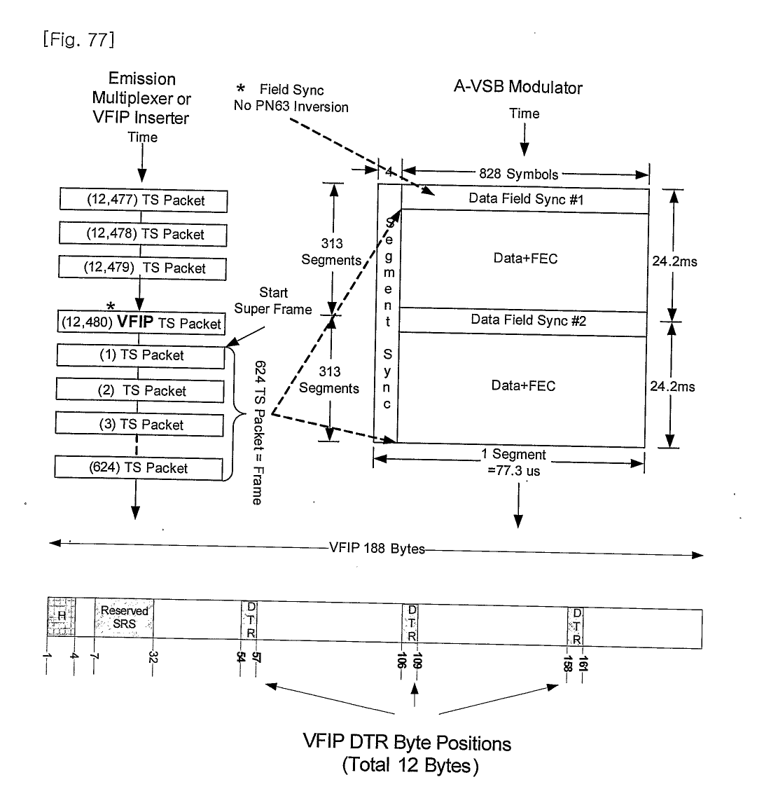

The VFIP is generated in the emission multiplexer or VFIP inserter and inserted as the last (624^{th}) packet of the last VSB frame of a super frame exactly once every 12,480 TS packets. The VFIP inserter is used to create the VFIP if a station wishes an SFN only. If turbo, SRS, and SFN are required the VFIP functionality would reside in the Emission Multiplexer. The insertion cadence is determined by a counter in the emission multiplexer locked to the ATSC system time. All modulators initialize or start a VSB frame by inserting a DFS with no middle PN 63 inversion after the last bit of VFIP. This action will synchronize all VSB frames in all modulators in an SFN. This is shown in FIG. 77.

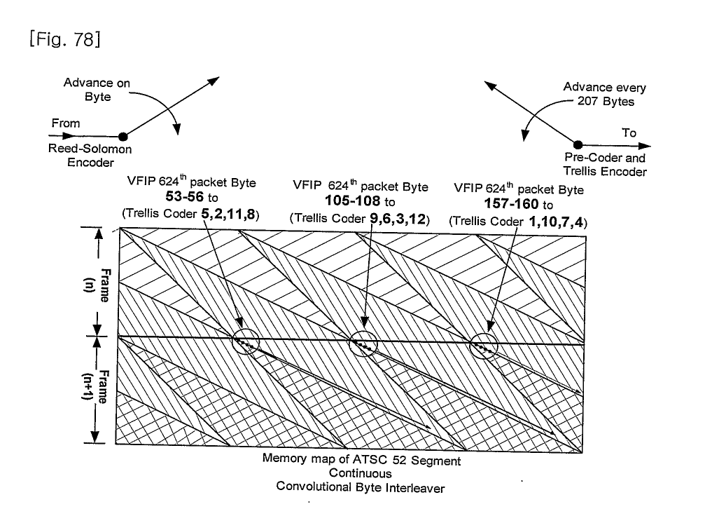

The synchronization of all trellis coders in all modulators uses the DTR byte mapping in a VFIP which contains twelve DTR bytes in pre-determined byte positions. The chosen DTR byte positions assure that later in time in each modulator a DTR byte is positioned in the designated one of 12 trellis coders the instant a DTR occurs. The DTR is designed to occur in a sequential fashion over the first 4 data segments of the next VSB frame following the insertion of a VFIP. FIG. 78 shows the position of the DTR bytes in the ATSC 52-segment byte interleaver. The last 52 packets in Frame (n), with VFIP as the last packet, are clocked as shown into the normal ATSC interleaver. An interleaver memory map is shown depicting the time of interest. Then the bytes are read out row-by-row and sent to the trellis coders. The middle horizontal line represents the frame boundary between Frames (n) and (n+1). Notice that half of the bytes of the last 52 input packets remain in Frame (n) and the other half reside in Frame (n+1) when removed from the ATSC 52-segment byte interleaver memory. It is further noted that the DTR byte position in the 52-segment interleaver appears to have been shifted one byte position because the segment sync has been stripped from the TS packet as part of the normal ATSC channel coding process.

The DTR bytes in the VFIP are shown circled in FIG. 78 and will reside in the first 4 data segments of (Frame n+1) when they are removed from the interleaver memory. These DTR bytes will each be sent to one of the designated 12 trellis coders. A deterministic trellis reset (DTR) occurs upon arrival of each of the DTR bytes at its respective targeted trellis coder. As a result of first achieving VSB framing using the DF and now by the simultaneous deterministic trellis reset (DTR) in all modulators within a network, coherent symbols will now be produced from all transmitters.

In summary, the appearance of the VFIP will cause VSB frame synchronization, and the DTR bytes in the VFIP are used to synchronize all trellis coders by performing the DTR in all modulators.

Emission Time Synchronization

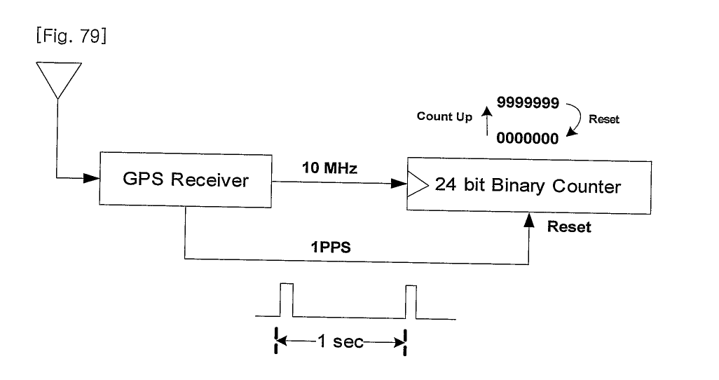

The emission times of the coherent symbols from all transmitters now need to be tightly controlled so that their arrival times at a receiver doesn't exceed the delay spread or echo handling range of the receiver's equalizer. Transmitters can be located miles apart and will receive a VFIP over a distribution network (microwave, fiber, satellite, etc). The distribution network has a different transit delay time on each path to a transmitter. This must be compensated to enable a common temporal reference to be used to control all emission timing in the SFN. The 1PPS signal from a GPS receiver is used to create a common temporal reference in all nodes of the SFN, that is the emission multiplexer and all the modulators. This is shown in FIG. 79.

Referring to FIG. 79, all nodes in the network have the equivalent of this circuit, a 24 bit binary counter driven by the GPS 10 MHz clock signal. The counter counts up from 0000000-9999999 in one-second intervals, then resets to 0000000 on the edge of the 1PPS pulse from the GPS receiver. Each clock tick and count advance is 100 nanoseconds. With the universal availability of GPS, this technique is easy to establish in all nodes in a network and forms the basis of all time stamps used to implement SFN emission timing.

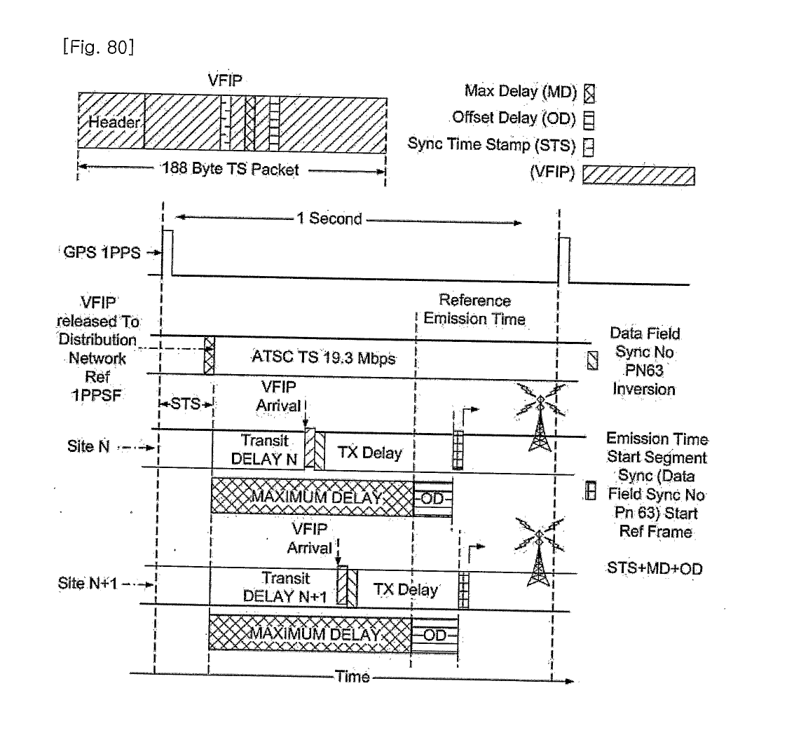

The major syntactic elements in VFIP to enable the basic emission timing in an SFN will be discussed, including sync_time_stamp (STS), maximum_delay (MD), and tx_time_offset (OD). FIG. 80 is an SFN timing diagram. All nodes have the 24-bit counter discussed above available as the temporal reference for all time stamps.

Referring to FIG. 80, the different transit delay times on all distribution paths must be compensated to enable tight SFN timing control. The MD timestamp contains a pre-calculated time stamp value established by the SFN network designer based on the transit time delays of all paths. The MD value is calculated to be greater than the longest transit delay on any path of the distribution network. The STS enables an input FIFO buffer delay to be established in each modulator that is equal to the MD value minus the actual transit delay time experienced on the distribution path to a modulator. This action will establish a reference emission time that is the same for all transmitters and is independent of the transit delays encountered in the distribution network, the transit delays having been mitigated. Then a calculated offset delay value OD may optionally be then applied to each exciter individually to optimize the SFN timing

Observing the SFN timing diagram in FIG. 80 more closely, we see the commonly available 1PPS on the first line of the timing diagram. Directly below is shown the release of the VFIP into the distribution network carrying an STS value equal to the value that was observed on the local 24 bit counter in the emission multiplexer the instant the VFIP was released into the distribution network. Site N is shown on the next line with the arrival of the VFIP; the instant that the VFIP arrives, the count on the local 24-bit counter is stored (arrival time). The actual transit time delay measured in 100 ns increments is the difference of the values of the (arrival time) minus the value of the received STS value (inserted by the emission multiplexer). The next line shows Site N+1, which experienced a different transit delay. The reference emission time is observed to be equal at both sites however, as a result of the tx_delay being calculated independently in each modulator based on the STS. The actual emission time for each site can then be optionally offset by the OD value, allowing for optimization of network timing under the control of the SFN designer.

It is noted that in an ideal model with all transmitters systems having identical time delays, the above description would produce a common reference emission time. However, in the real world, a delay value is calculated for each site to compensate each site's inherent time delay. All modulators have a means of accepting a 16-bit value of the calculated transmitter and antenna delay (TAD), a value represented in 100 ns increments. This value includes the total delay through the transmitter the RF filters and transmission line up to and including the antenna. This calculated value (TAD) is entered by the network designer and is subtracted from the MD value received in the VFIP to set an accurate, common timing demarcation point for the RF emission as the air interface of the antenna at each site. The TAD value shall equal the time from the entry of the last bit of the VFIP into the data randomizer in the exciter to the appearance at the antenna air interface of the leading edge of the segment sync of the data field sync having no PN 63 Inversion.

The cross layer mapping of the (12) DTR bytes in a VFIP will by design be used to reset the (12) trellis coders, thus producing a total of 12 RS byte-errors into the VFIP. A VFIP packet error occurs because the 12 byte-errors within a single packet exceeds the 10-byte RS correction capability of ATSC. This deterministic packet error will occur only on each VFIP packet every 12,480 TS packets. It should be noted that normal receivers will ignore the VFIP with an ATSC reserved PID 0x1FFA. Extensibility is envisioned to enable a single VFIP to control multiple tiers of SFN translators and also for providing signaling to SFN field test and measurement equipment. Therefore, additional error correction is included within the VFIP to allow specially designed receivers to successfully decode the syntax of a transmitted VFIP, effectively allowing reuse of the same VFIP over multiple tiers of an SFN translator network.

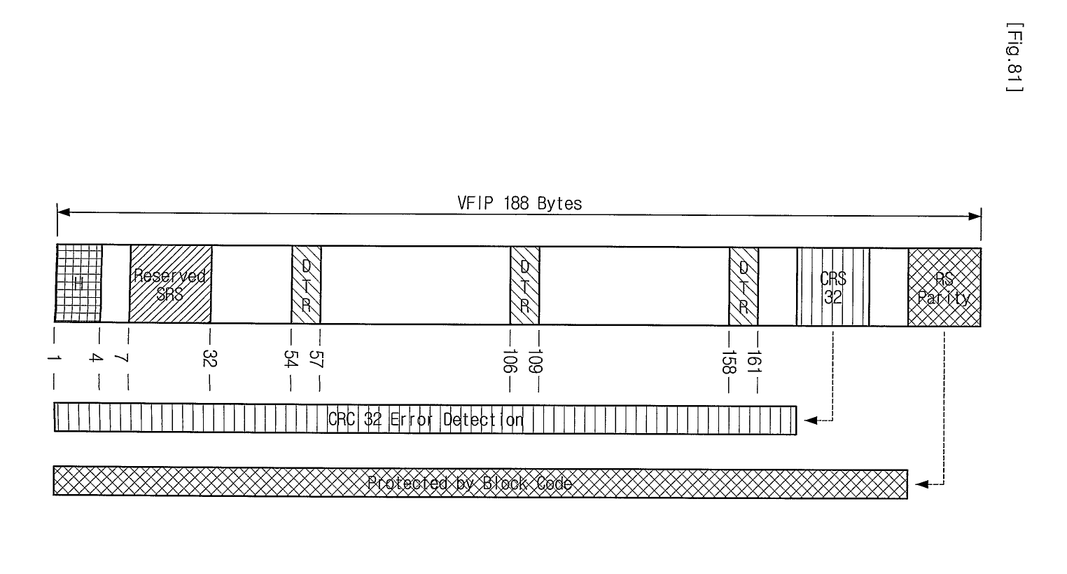

FIG. 81 shows that the VFIP has a CRC_{—}32 used to detect errors on the distribution network and an RS block code used to detect and correct byte errors of the transmitted VFIP by a special VFIP aware receiver. The RS encoding in the emission multiplexer first sets all DTR bytes to 0x00 before RS encoding and a special ATSC VFIP receiver sets all DTR bytes to 0x00 before RS decoding to enable correction of up to 10 RS byte errors.

Support for Translators in SFN

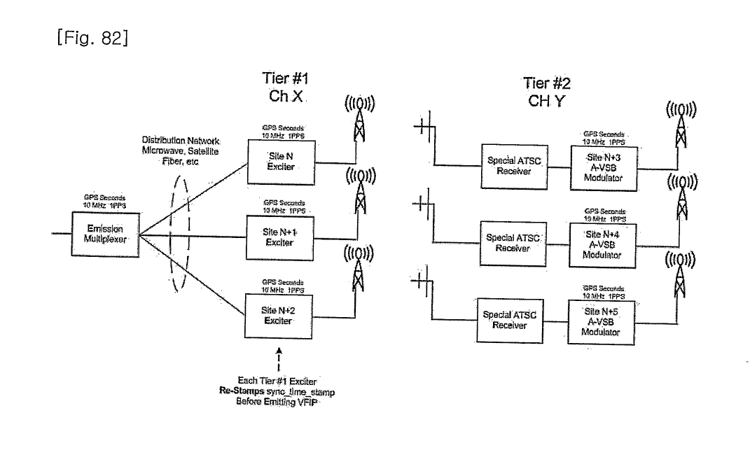

FIG. 82 shows a two-tier SFN translator network using VFIP. Referring to FIG. 82, tier #1 transmits on Ch X, receives the data stream over a distribution network, and achieves emission timing as described above for an SFN.

The RF broadcast signal from tier #1 is used as the distribution network to the transmitters in tier #2. To achieve this goal, the sync_time_stamp (STS) field in the VFIP is recalculated (and re-stamped) before being emitted by tier #1 modulators. The updated (tier #2) sync_time_stamp (STS) value is equal to the sum of the sync_time_stamp (STS) value and the maximum_delay (MD) value received from the tier #1 distribution network. The recalculated sync_time_stamp (STS) is used along with the tier #2 tier_maximum_delay value in the VFIP. The tier #2 emission timing is then achieved as described for an SFN. If another tier of translators is used, a similar re-stamping will occur at tier #2, etc. A single VFIP can support up to a total of 14 transmitters in up to four tiers. If more transmitters or tiers are desired, an additional VFIP can be used.

VFIP Syntax

A VFIP is required for the operation of an SFN. This OMP shall and have an OM_type in the range of 0x31-0x3F. The complete VFIP syntax is shown in Table 21.

TABLE 21
VFIP

| Syntax | # of Bits | mnemonic |
|---|---|---|
| vfip_packet( ) { | | |
| transport_packet_header | 32 | bslbf |
| om_type | 8 | bslbf |
| reserved | 8 | bslbf |
| for (i=0; i<26;i++) { | | |
| SRS_reserved | 8 | uimsbf |
| } | | |
| reserved | 8 | bslbf |
| srs_mode | 8 | uimsbf |
| turbo_stream_mode | 8 | uimsbf |
| sync_time_stamp | 24 | uimsbf |
| maximum_delay | 24 | uimsbf |
| network_id | 12 | uimsbf |
| T&M_flag | 1 | bslbf |
| number_of_translator_tiers | 3 | uimsbf |
| reserved | 8 | uimsbf |
| for (i=0; i<3; i++) { | | |
| if (i < number_of_translator_tiers) { | | |
| tier_maximum_delay | 24 | uimsbf |
| } | | |
| else { | | |
| stuffing | 24 | uimsbf |
| } | | |
| } | | |
| DTR_reserved | 32 | uimsbf |
| if (number_of_translator_tiers = 4) { | | |
| tier_maximum_delay | 24 | uimsbf |
| } | | |
| else { | | |
| stuffing | 24 | uimsbf |
| } | | |
| if (T&M_flag = ‘1’) { | | |
| field_T&M | 40 | bslbf |
| } | | |
| else { | | |
| stuffing | 40 | uimsbf |
| } | | |
| number_tx | 8 | uimsbf |
| for (i=0; i<6; i++) { | | |
| if (i < number_tx) { | | |
| tx_address | 12 | uimsbf |
| reserved | 4 | uimsbf |
| tx_time_offset | 16 | uimsbf |
| tx_power | 12 | uipfmsbf |
| tx_id_level | 3 | uimsbf |
| tx_data_inhibit | 1 | uimsbf |
| } | | |
| else { | | |
| stuffing | 48 | bslbf |
| } | | |
| } | | |
| for (i=0; i<3; i++) { | | |
| stuffing_byte | 8 | uimsbf |
| } | | |
| DTR_reserved | 32 | uimsbf |
| for (i=6; i<14; i++) { | | |
| if (i < number_tx) { | | |
| tx_address | 12 | uimsbf |
| reserved | 4 | uimsbf |
| tx_time_offset | 16 | uimsbf |
| tx_power | 12 | uipfmsbf |
| tx_id_level | 3 | uimsbf |
| tx_data_inhibit | 1 | uimsbf |
| } | | |
| else { | | |
| stuffing | 48 | bslbf |
| } | | |
| } | | |
| DTR_reserved | 32 | uimsbf |
| crc_32 | 32 | rpchof |
| for (i=0; i<3; i++) { | | |
| stuffing | 8 | uimsbf |
| } | | |
| vfip_ecc | 160 | uimsbf |
| } | | |

transport_packet_header—and constrained by ATSC A/110A, Section 6.1.

OM_type—defined in ATSC N110, Sec 6.1 and set to a value in a range of 0x31-0x3F inclusive, are assigned sequentially starting with 0x31 and continuing according to the number of transmitters in the SFN design. Each VFIP supports a maximum of 14 transmitters

srs_bytes—as defined above with reference to the adaptation field contents (SRS bytes) for burst SRS

srs_mode—signals SRS mode

turbo_stream_mode—signals turbo mode

sync_time_stamp—contains the time difference, expressed as a number of 100 ns steps, between the latest pulse of the 1PPS signal and the instant the VFIP is transmitted into the distribution network as indicated on a 24-bit counter in an emission multiplexer.

maximum_delay—a value larger than the longest delay path in the distribution network expressed as a number of 100 ns steps. The range of maximum_delay is 0x000000 to 0x98967F, which equals a maximum delay of 1 second.

network_id—a 12-bit unsigned integer field representing the network in which the transmitter is located. This also provides part of the 24 bit seed value (for the Kasami Sequence generator defined in A/110A) for a unique transmitter identification sequence to be assigned for each transmitter. All transmitters within a network shall use the same 12-bit network_id pattern.

TM_flag—signals data channel for automated A-VSB field test and measurement equipment where 0 indicates T&M channel inactive, and 1 indicates T&M channel active.

number_of_translator_tiers—indicates number of tiers of translators as defined in Table 22.

TABLE 22
Translator Tiers

| number_of_translator_tiers Value | Meaning |
|---|---|
| 000b | No translators |
| 001b | one tier of translators |
| 010b | two tiers of translators |
| 011b | three tiers of translators |
| 100b | four tiers of translators |
| 101b-111b | Prohibited |

tier_maximum_delay—shall be a value larger than the longest delay path in the translator distribution network expressed as a number of 100 ns steps. The range of tier_maximum_delay is 0x000000 to 0x98967F which equals a maximum delay of 1 second

reserved—all bits set to zero

DTR_bytes—shall be set 0x00000000.

field_TM—private data channel to control remote field T&M and monitoring equipment for the maintenance and monitoring of the SFN.

number_tx—number of transmitters in SFN being controlled by a VFIP. This is currently constrained to the values 0x00-0x0E, with 0x0F-0xFF Prohibited.

crc_{—}32—A 32 bit field that contains the CRC of all the bytes in the VFIP, excluding the vfip_ecc bytes. The algorithm as defined in ETSI TS 101 191, Annex A.

vfip_ecc—A 160-bit unsigned integer field that carries 20 bytes of Reed Solomon Parity bytes for error correcting coding used to protect the remaining payload bytes.

tx_address—A 12-bit unsigned integer field that carries the unique address of the transmitter to which the following fields are relevant. Also used as part of the 24-bit seed value (for the Kasami Sequence generator—see A/110A) for a unique sequence to be assigned to each transmitter. All transmitters in a network shall have a unique 12-bit address assigned.

tx_time_offset—A 16-bit signed integer field that indicates the time offset value, measured in 100 ns increments, allowing fine adjustment of the emission time of each individual transmitter to optimize network timing

tx_power—A 12-bit unsigned integer plus fraction that indicates the power level to which the transmitter to which it is addressed should be set. The most significant 8 bits indicate the power in integer dB relative to 0 dBm, and the least significant 4 bits indicate the power infractions of a dB. When set to zero, tx_power shall indicate that the transmitter to which the value is addressed is not currently operating in the network. The tx_power is left as an optional feature.

tx_id_level—A 3-bit unsigned integer field indicates to what injection level (including off) the RF watermark signal of each transmitter shall be set.

tx_data_inhibit—A 1-bit field that indicates when the tx_data( ) information should not be encoded into the RF watermark signal

RF Watermark (Informative)

The spread spectrum signal technology introduced first in A/110A for the transmitter identification (TxID) is also included. In addition to the applications of transmitter identification and enabling special test equipment for SFN timing and monitoring purposes, other uses of this technology may be possible.

ATSC System Time (Informative)

The emission multiplexer sends a VFIP every 12,480 TS packets to an A-VSB modulator to establish the deterministic frame (DF), which enables cross layer techniques to be employed to enhance 8-VSB. Instead of having each emission multiplexer at each station select independently a starting point for cadence of the VFIP, a global reference is developed to enable all station to have a deterministic VSB framing relationship. This synchronization may enable such things as future location based applications or ease the interoperability with 802.xx networks. If the global framing reference is combined with the deterministic mapping of turbo stream content, an effective handoff scheme for wide area mobile service between two cooperating stations can be enabled. The benefits of the ATSC system time (AST) is relevant to a single transmitter station or an SFN.

To achieve these goals, a global reference signal is needed to signal the opportunity to start a VSB super frame (SF) in all emission multiplexers and modulators. This is possible because of the fixed ATSC symbol rate and the fixed ATSC VSB frame structure and the global availability of GPS. GPS has several temporal references available that will be used:

1.) Defined Epoch

2.) GPS Seconds Count

3.) 1PPS

The epoch or start of GPS time is defined as Jan. 6, 1980 00:00:00 UTC. The ATSC epoch is defined to be the same as the GPS epoch, Jan. 6, 1980 00:00:00 UTC.

The ATSC epoch is defined as the instant the first symbol of the segment sync of the first DFS (No PN 63 Inv) of the first super frame was emitted at the air interface of the antenna of all ATSC DTV stations.

The GPS second count gives the number of seconds elapsed since the epoch. The one pulse per second signal (1PPS) is also provided by a GPS receiver and signals the start of a second by a rising edge of 1PPS.

We define an ATSC unit of time close to one second in duration which we can compare to GPS seconds. The A-VSB super frame (SF) is equal to 20 VSB frames and has a period of 0.967887927225471088 seconds. Given the common defined epoch and the global availability of the GPS second count and 1PPS we can calculate the offset between the next GPS second tick indicated by 1PPS and the start of a super frame at any point in time since the epoch. The super frame start signal is termed the one pulse per super frame (1PPSF). This relationship allows circuitry to be designed in the emission multiplexer and exciter to have the common 1PPSF reference for VSB framing. The ATSC system time is defined as the number of super frames (SF) since the epoch.

MCAST AL-FEC

Encoding Overview

The MCAST AL-FEC is a concatenated code of two linear block codes. The inner and outer codes are defined as generator matrices or equivalently graphs (the first attempt of a graphical representation seems to be “LDPC codes”, MIT press, Cambridge, Mass., 1963 by R. G. Gallager). For example, an inner or an outer code has a message word (u₁, u₂). Each of u₁ and u₂ represents a bit string with length L (L>1). Similarly, a codeword in the code is represented by (v₁, v₂, v₃, v₄, v₅, v₆), and vᵢ {i=1, . . . , 6} is a bit string with length L.

A message word (u₁, u₂) is encoded to a codeword (v₁, v₂, v₃, v₄, v₅, v₆) by v₁=u₁, v₂=u₁⊕u₂, v₃=u₁⊕u₂, v₄=u₂, v₅=u₁, v₆=u₂ when the generator matrix G is given by

$$G = {[ \begin{matrix}1 & 1 & 1 & 0 & 1 & 0 \\ 0 & 1 & 1 & 1 & 0 & 1\end{matrix} ] \begin{matrix}1 \\ 2\end{matrix} , }^{\begin{matrix}\begin{matrix}1 & 2 & 3 & 4 & 5 & 6\end{matrix} & v / u\end{matrix}}$$

where the operator ⊕ refers to the bitwise exclusive-OR.

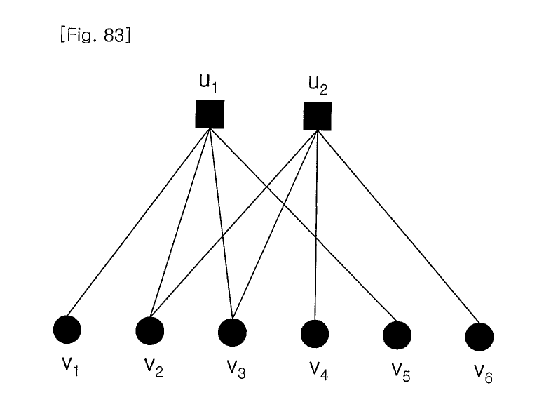

Since the length of codeword is three times that of the message word, the code rate is one-third. The generator matrix can be conveniently expressed by a graph. FIG. 83 depicts the graph representing the above G matrix. The graph description is equivalent to the generator matrix description. Each column corresponds to a codeword node (vᵢ, i=1, . . . , 6) in a graph while each row stands for a message node, u₁, u₂. The one in x-th row and y-th column in the G refers to the line between uₓ and v_{y} in the graph. The degree of a node (u or v) is the number of lines connected to the node and is denoted deg(u or v). For instance, deg(u₁) is 4 and deg(v₃) is 2. The generator matrix is an important element to be properly designed.

Generator Matrix Design

Where k is the number of message nodes and n is the number of code nodes, the code rate becomes k/n. Then, a message word is represented by (u₁, u₂, uₖ) and a codeword is represented by (v₁, v₂, . . . , vₙ). At first, a graph is designed. Then, the generator matrix is obtained by transforming the graph. The graph is obtained in two steps. The first step is to determine the degree of codeword nodes (deg(vᵢ)). The last step is to connect between message nodes and codeword nodes.

The First Step

Given the number of message nodes (k) and codeword nodes (n), the degree of codeword nodes (deg(vᵢ)) is determined as follows:
1. Determine d_{Max} from a design parameter Δ. Δ is an integral value from 1 to 4832. The d_{Max} is specified by a Δ value in Table 23 below. For example, when Δ is 8, d_{Max} is 61.

TABLE 23
Determination of D_{Max} from Δ (d_{Max} = function(Δ))

| | Δ | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| d_{Max} | 917 | 388 | 231 | 158 | 117 | 91 | 74 | 61 | 52 | 44 | 38 | 34 | 30 | 27 | 24 | 22 |
| | Δ | | | | | | | | | | | | | | | |
| | 17 | 18 | 19 | 20 | 21 | 22 | 23 | 24 | 25 | 26 | 27 | 28 | 29 | 30 | 31 | 32 |
| d_{Max} | 20 | 18 | 16 | 15 | 14 | 13 | 12 | 11 | 10 | 9 | 9 | 8 | 8 | 7 | 7 | 6 |
| | Δ | | | | | | | | | | | | | | | |
| | 33 | 34 | 35 | 36 | 37 | 38 | 39 | 40 | 41 | 42 | 43 | 44 | 45 | 46 | 47 | 48 |
| d_{Max} | 6 | 6 | 5 | 5 | 5 | 5 | 4 | 4 | 4 | 4 | 4 | 3 | 3 | 3 | 3 | 3 |
| | Δ | | | | | | | | | | | | | | | |
| | 1 | 2 | 3 | 4 | 5 | 6 | 7 | 8 | 9 | 10 | 11 | 12 | 13 | 14 | 15 | 16 |
| d_{Max} | 917 | 388 | 231 | 158 | 117 | 91 | 74 | 61 | 52 | 44 | 38 | 34 | 30 | 27 | 24 | 22 |
| | Δ | | | | | | | | | | | | | | | |
| | 17 | 18 | 19 | 20 | 21 | 22 | 23 | 24 | 25 | 26 | 27 | 28 | 29 | 30 | 31 | 32 |
| d_{Max} | 20 | 18 | 16 | 15 | 14 | 13 | 12 | 11 | 10 | 9 | 9 | 8 | 8 | 7 | 7 | 6 |

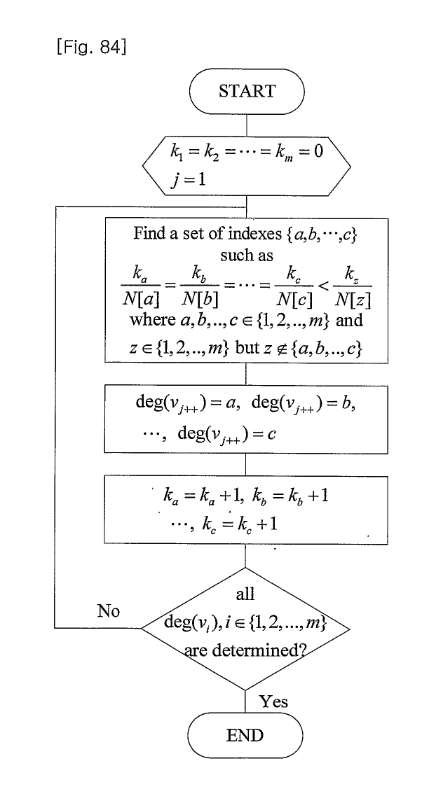

2. Determine an array of integral values, {N[i]|i=1, 2, . . . , d_{Max}} as follows:
   When an outer code is designed, N[l]=n and N[i]=0 (i=2, . . . , d_{Max})
   When an inner code is designed,

$$N [ 1 ] = ⌊ n \cdot \frac{2 \cdot Δ \cdot {d}_{Max} - 100}{{d}_{Max} ( 100 + 2 \cdot Δ )} ⌋$$

$$N [ i ] = ⌊ n \cdot \frac{100}{100 + 2 \cdot Δ} \cdot \frac{{d}_{Max} + 1}{{d}_{Max} - 1} \cdot \frac{1}{i \cdot ( i - 1 )} ⌋ , \\ i = 3 , … , {d}_{Max}$$

$$N [ 2 ] = n - N [ 1 ] - {\sum }_{i = 3}^{{d}_{Max}} N [ i ] ,$$

where └x┘ denote the largest positive integer which is less than or equal to x.
3. Determine the degrees of each codeword node (deg(v₁), deg(v₂), . . . deg(vₙ)) by the algorithm of the flow chart in FIG. 84. Referring to FIG. 84:
   First, initialize the integer variables (k₁, k₂, . . . , kₘ) with zeros (i.e., k₁=k₂= . . . =kₘ=0 where m is the largest integer such as N[m] is not zero). The other integer variable j is set to 1.
   Second, find an index a such as

$$a = {arg}_{i} {min}_{i = 1 , … , m} \frac{{k}_{i}}{N [ i ]} .$$

When there are a plurality of minimal values, a set of indexes {a, b, . . . , c} is found.
Then, the degree of vⱼ is a and j is increased by 1. The degree of vⱼ is b and j is increased by 1. This procedure is repeated until all indexes are used.
Increase only the variables (kₐ, k_{b}, . . . , k_{c}) specified in the index set {a, b, . . . , c} by 1.
Verify if all degrees (deg(vⱼ), j=1, . . . , n) are determined. If not, go to the second step.

The Last Step

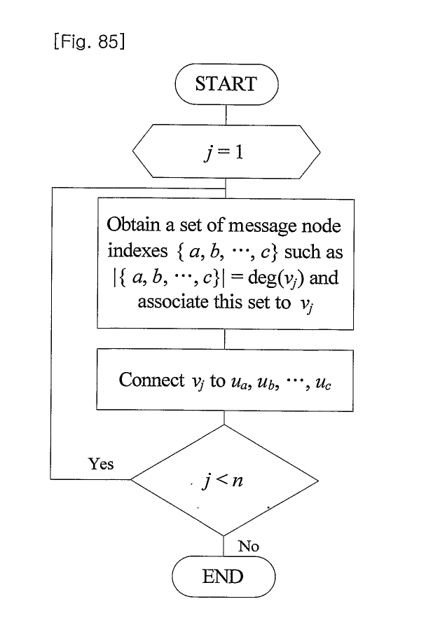

Given the number of message nodes (k), codeword nodes (n), and the degree of codeword nodes (deg(vᵢ)), the message nodes to be connected to a codeword node are identified by the algorithm described by the flow chart in FIG. 85. Referring to FIG. 85:
1. Initialize the index variable j of the codeword node vⱼ with one.
2. Obtain a set of message node indexes {a, b, . . . , c} to be associated with v₁. The number of elements (|{a, b, . . . , c}|) in this set shall be equal to the degree of vⱼ, deg(vⱼ).
3. Identify the message nodes to be connected to vⱼ with {uₐ, u_{b}, . . . u_{c}}.
4. Repeat the above procedures for all codeword nodes.

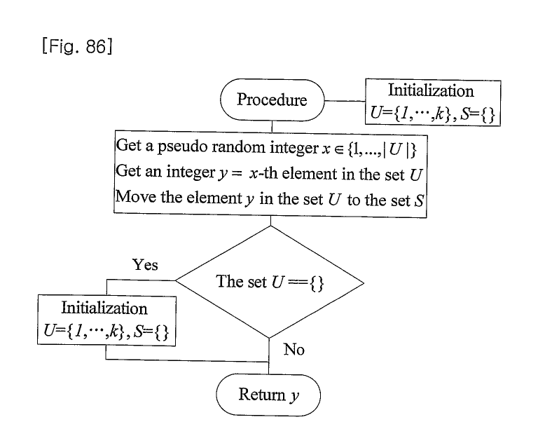

The procedure to obtain {a, b, . . . , c} in FIG. 85 is detailed in the flowchart illustrated in FIG. 86. Referring to FIG. 86:
1. The message node index set U and S are initialized with {1, . . . , k} and { } respectively. The set U and S are ordered sets and the order is defined as follows. Given the x-th element a and the y-th element b in the set U or S, if x<y, then a<b and vice versa. This initialization is done only once before any call of this procedure.
2. After getting a pseudo random value x in {1, . . . , |U|}, the message node index to return is obtained by the x-th element in the set U where |U| refers to the number of all elements in U. Then, this element moves from the set U to the set S. In this way, all of the previously selected message node index values are included in the set S while the other unselected values remain in the set U.
3. If the set U is empty, initialize the set S and U with {1, . . . , k} and { } respectively.

There is the still an unspecified procedure in FIG. 86, which is to get a message node index number x in {0, . . . , |U|}. This procedure is done by Mersenne Twister (MT), which is a pseudorandom number generating algorithm by Makoto Matsumoto and Takuji Nishimura in 1996/1997 and which is improved in 2002. There is the standard C code by the inventors which is freely available for any purpose, including commercial use.

Before any procedure call, the MT procedure is initialized by one unsigned 32-bit integer seed. This is done in the standard C code (mt19937ar.c) by calling init_genrand(seed). To get a message node index number x in {1, . . . , |U|}, generate an unsigned 32-bit integer. (this is done in the standard C code (mt19937ar.c) by calling genrand_int32( )), take the minimum integer e such as |U|<=2^{e}, take the most significant e bits and “discard and repeat the previous procedure again” if the number is greater than or equal to |U|. If the number is less than |U|, the message node index number x is the number+1 which is in {1, . . . , |U|}.

Designed Generator Matrix

Each column corresponds to a codeword node (vᵢ=1, . . . , n) in a graph while each row stands for a message node (uᵢ, i=1, . . . , k). When uₓ is connected to v_{y} in the graph, the element in the x-th row and the y-th column in the generator matrix shall be one. If not connected, the element shall be zero.

Pre-Designed AL-FEC Codes

In order to define a MCAST AL-FEC code, two matrices are defined. One is for the inner code and the other is for the outer code.
Given a (n, k) MCAST AL-FEC code, the inner code shall be a (n, k+δₖ) code and the outer code shall be a (k+δₖ, k) code. k+δₖ is the number of codeword nodes in the outer code and of message nodes in the inner codes.
To define deg(vⱼ) in the inner code, a design parameter Δ needs to be provided.
To define the connection between uᵢ and vⱼ in the inner and outer codes, a random seed for the Mersenne Twister procedure is to be provided. This seed shall be used for both inner and outer codes.

Thus, the 3 parameters (δₖ, Δ, seed) are enough to define a MCAST AL-FEC code. For the 3 different (n, k) MCAST AL-FEC codes, these parameters are listed in Table 24.

TABLE 24
Pre-defined AL-FEC Code Parameters

| (n, k) | (δₖ, Δ, seed) |
|---|---|
| (2880, 2304) | (10, 6, 14) |
| (1920, 1536) | (3, 8, 6) |
| (960, 768) | (1, 8, 8) |

The A-VSB Mobile Broadcasting (A-VSB MCAST) design consists of transport and signaling optimized for mobile and handheld services. The following disclosure provides the overall A-VSB MCAST architecture, and specifies the physical and link layers. Backwards compatibility is ensured by the careful design of the physical and link layers.

A-VSB MCAST Architecture

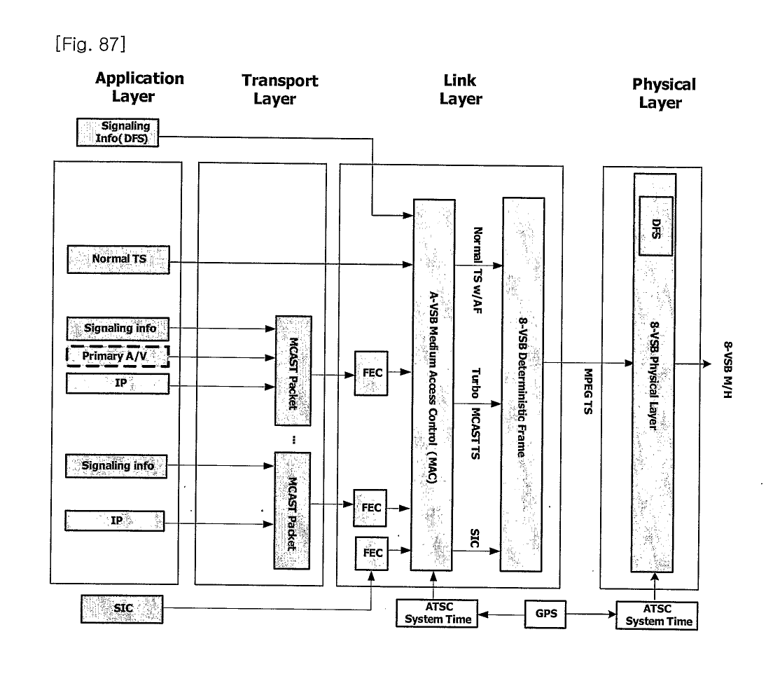

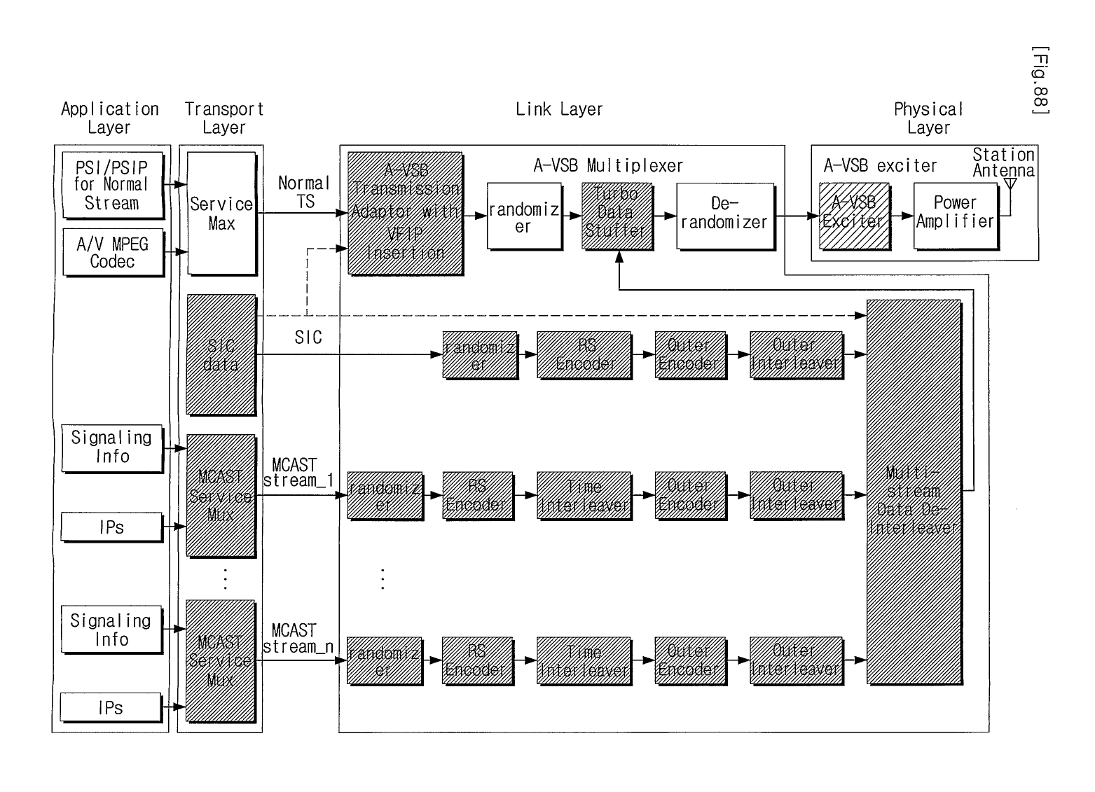

FIG. 87 illustrates the overall architecture of A-VSB MCAST, and FIG. 88 illustrates the overall architecture of A-VSB MCAST in more detail. Referring to FIGS. 87 and 88, A-VSB MCAST includes 4 layers: an application layer, a transport layer, a link layer, and a physical layer. IP Services are multiplexed into an MCAST stream per turbo channel. For fast initial service acquisition, A-VSB MCAST provides a primary service, which will be described in more detail below.

The link layer receives the turbo channels and applies a specific FEC (code rate, etc) to each turbo channel. The signaling information in the SIC will have the most robust FEC (⅙ rate turbo code) to ensure that the signaling information can be received at a signal-to-noise (SNR) level below the application data that the signaling information is signaling. The turbo channels with FEC applied thereto are then sent to the A-VSB MAC unit along with the normal TS packets. The exciter signaling information is transported in OMP or SRS placeholder bytes from the studio to the transmitter. The A-VSB Medium Access Control (MAC) unit is responsible for the sharing of the physical layer medium (8-VSB) between normal and robust data.

The A-VSB MAC unit uses adaptation fields (AF) in normal TS packets when needed. The A-VSB MAC Layer places constraints or rules on how the physical layer is to be operated in a deterministic manner and how the physical layer is partitioned between normal and robust data. The robust data is mapped into a deterministic frame structure, signaled and sent to the 8-VSB physical layer to achieve an overall gain in system efficiency and/or performance (enhancement) not intrinsically inherent from the 8-VSB system while still maintaining backward compatibility. The exciter at the physical layer also operates deterministically under the control of the MAC unit and inserts signaling in DFS.

Physical and Link Layers (A-VSB)

System Overview

The objective of A-VSB MCAST is to improve reception issues of 8-VSB services in mobile or handheld modes of operation. This system is backwards-compatible in that existing receiver designs are not adversely affected by the A-VSB signal. This disclosure defines the following core techniques: Deterministic Frame (DF) and Deterministic Trellis Reset (DTR)

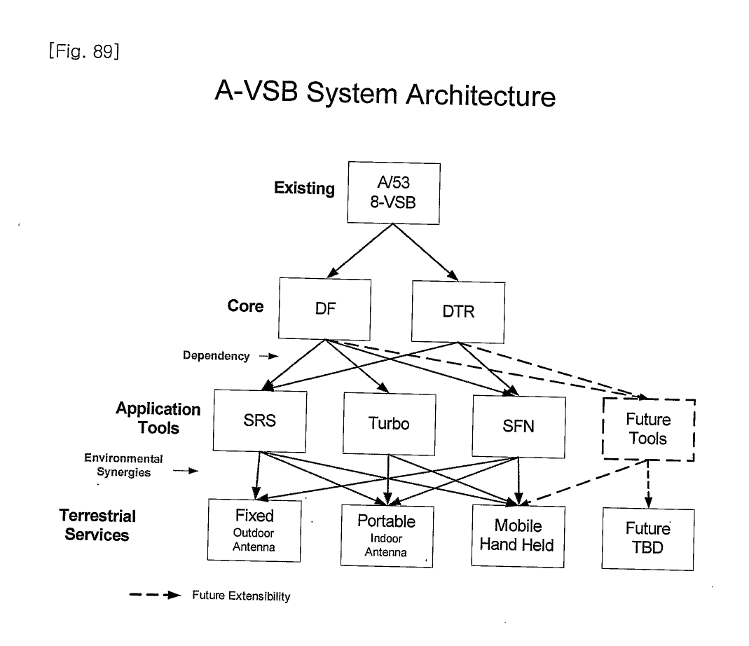

Furthermore, this document defines the following application tools: Supplementary Reference Sequence (SRS); Turbo Stream; and Single Frequency Network (SFN). These core techniques and application tools can be combined as shown in FIG. 89. FIG. 89 shows the core techniques (DF, DTR) as the basis for all of the application tools defined here and potentially in the future. The solid lines show this dependency. Certain tools are used to mitigate propagation channel environments expected for certain broadcast services. Again, the solid lines show this relationship. Tools can be combined together synergistically for certain terrestrial environments. The solid lines demonstrate this synergy. The dashed lines are for potential future tools not defined by this disclosure.

The Deterministic Frame (DF) and Deterministic Trellis Reset (DTR) are backwardly compatible system constraints that prepare the 8-VSB system to be operated in a deterministic or synchronous manner and enable a cross layer 8-VSB enhancement design. In the A-VSB system, the A-VSB multiplexer has knowledge of and signals the start of the 8-VSB frame to the A-VSB exciter. This a priori knowledge is an inherent feature of the A-VSB multiplexer which allows intelligent multiplexing (cross layer) to gain efficiency and/or increase performance of the 8-VSB system.

The absence of frequent equalizer training signals has encouraged receiver designs with an over dependence on “blind equalization” techniques to mitigate dynamic multipath. The SRS is a cross layer technique that offers a system solution with frequent equalizer training signals to overcome this using the latest algorithmic advances in receiver design principles. The SRS application tool is backwards compatible with existing receiver designs (specifically, the information is ignored in existing receiver designs), but improves reception in SRS-designed receivers.

The turbo stream provides an additional level of error protection capability. This brings robust reception in terms of lower SNR receiver threshold and improvements in multi-path environments. Like SRS, the turbo stream application tool is based on cross layer techniques and is backwards compatible with existing receiver designs (specifically, the information is ignored in existing receiver designs).

The application tool SFN leverages both core elements DF and DTR to enable an efficient cross layer SFN capability. An effective SFN design can enable a higher, more uniform signal strength along with spatial diversity to deliver a higher quality of service (QOS) in mobile and handheld environments.

The tools such as SRS, turbo stream, and SFN can be used independently. That is, there is no dependency among these application tools and any combination of them is possible. These tools also can be used together synergistically to improve the quality of service in many terrestrial environments.

Deterministic Frame (DF)

Introduction

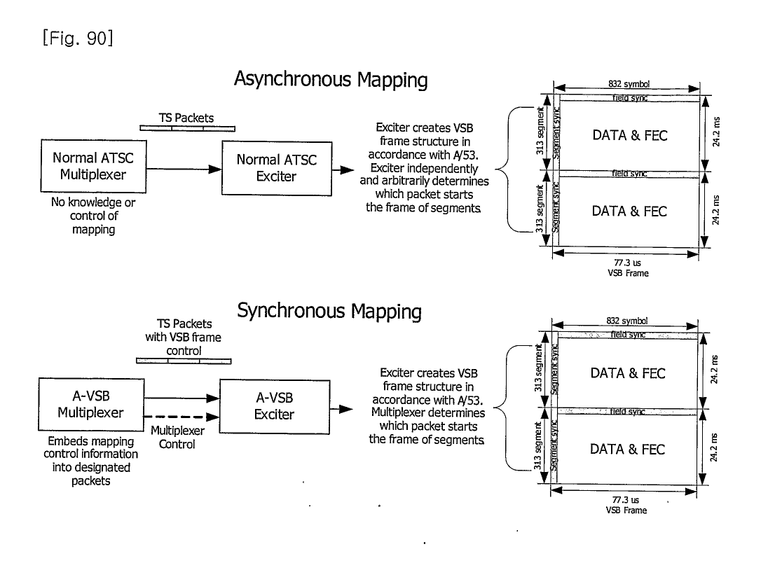

The first core technique of A-VSB is to make the mapping of ATSC transport stream packets a synchronous process (currently, this is an asynchronous process). The current ATSC multiplexer produces a fixed rate transport stream with no knowledge of the 8-VSB physical layer frame structure or mapping of packets. This is depicted in the top of FIG. 90.

When powered on, the 8-VSB ATSC exciter independently and arbitrarily determines which packet begins a frame of segments. Currently, no knowledge of this decision and hence the temporal position of any transport stream packet in the VSB frame is available to the current ATSC multiplexing system. Meanwhile, in the A-VSB system according to embodiments of the present invention, the A-VSB multiplexer makes a selection for the first packet to begin an ATSC physical layer frame. This framing decision is then signaled to the A-VSB exciter, which is a slave to the A-VSB multiplexer for this framing decision.

In summary, the knowledge of the starting packet coupled with the fixed ATSC VSB frame structure gives the A-VSB multiplexer insight into the position of every packet in the 8-VSB physical layer frame. This situation is shown in the bottom of FIG. 90. The knowledge of the DF structure allows pre-processing in an A-VSB multiplexer and synchronous post-processing in an A-VSB exciter (i.e., the a priori knowledge of where each and every byte in the TS will reside at a later point in time in the stages of ATSC exciter allows cross layer techniques to enhance the performance of the 8-VSB physical layer).

A-VSB Multiplexer to Exciter Control

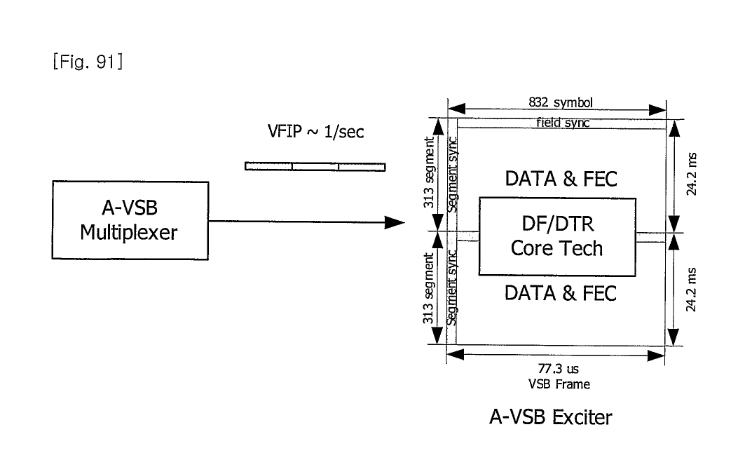

The A-VSB multiplexer inserts a VFIP (the A-VSB multiplexer VFIP cadence is aligned with the ATSC Epoch every 12,480 packets (this quantity of packets is equal to 20 VSB frames and is termed a super frame). The VFIP signals the A-VSB exciter to insert a DFS with no PN 63 inversion into the VSB Frame. This periodic appearance of VFIP establishes and maintains the A-VSB DF structure which is a core element of the A-VSB system architecture, as described above. This is shown in FIG. 91.

Additionally, the A-VSB multiplexer transport stream clock and the symbol clock in the A-VSB exciter must be locked to a common universally available frequency reference from a GPS receiver. Locking both the symbol and transport clocks to an external reference brings stability that assures the synchronous operation. It is noted that in the normal A/53 ATSC exciter, the symbol clock is locked to the incoming SMPTE 310M and has a tolerance of +/−30 Hz. Locking both to a common external reference will prevent rate adaptation or stuffing by the exciter in response to drift of the incoming SMPTE 310M+/−54 Hz tolerance. This helps maintain the DF once initialized. ASI is the transport stream interface, though it is understood that SMPTE 310M can still be used. Another benefit of locking both the symbol and transport clocks to a common external reference is the prevention of symbol clock jitter which can be problematic for a receiver.

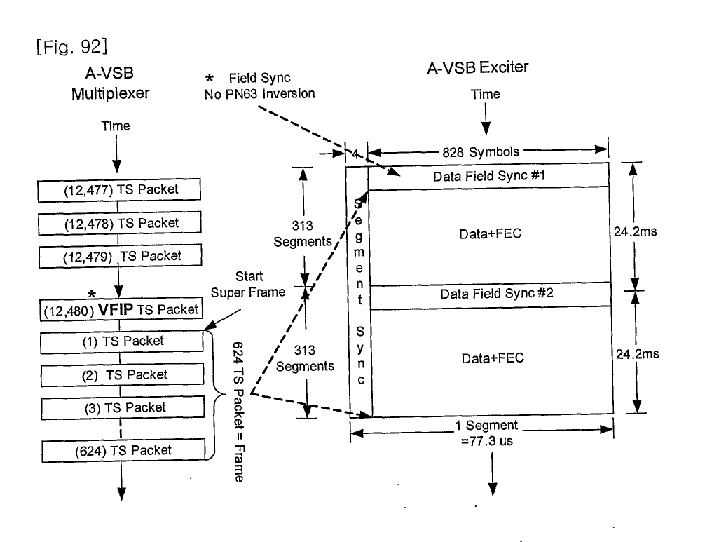

The A-VSB multiplexer is the master and signals which transport stream packet shall be used as the first VSB data segment in a VSB frame. Since the system is operating with synchronous clocks, it can be stated with 100 percent certainty which 624 transport stream packets make up a VSB frame in the A-VSB exciter. A counter (locked to 1PPSF as described below in the section on ATSC System Time) of (624×20=) 12,480 TS packets is maintained in the A-VSB multiplexer. The DF is achieved through the insertion of a VFIP as defined below. The VFIP shall be the last packet in group of 624 packets when the VFIP is inserted, as shown in FIG. 92.

VFIP Special Operations and Maintenance Packet

In addition to the common clock, a special transport stream packet is needed. This packet shall be an Operations and Maintenance Packet (OMP) as defined in ATSC A/110A, Section 6.1. The value of the OM_type shall be 0x30 (Note: a VFIP OM_type in the range of 0x31-0x3F shall be used for SFN operation). Moreover, this packet is on a reserved PID, 0x1FFA.

The A-VSB multiplexer inserts the VFIP into the transport stream once every 20 frames (12,480 TS packets), which will signal the exciter to start a VSB frame that also demarcates the beginning of next super frame. The VFIP is inserted as the last, 624^{th} packet in the frame, which causes the A-VSB modulator to insert a Data Field Sync with no PN63 inversion of the middle PN63 after the last bit of the VFIP.

Table 25 shows the syntax of the VFIP OMP. The complete packet syntax that includes the definition of the private field shall be as defined below in the SFN description.

TABLE 25
VFIP Packet Syntax

| Syntax | # of Bits | mnemonic |
|---|---|---|
| VFIP_omp_packet( ) { | | |
| transport_packet_header | 32 | bslbf |
| OM_type | 8 | bslbf |
| Reserved | 8 | uimsbf |
| Private | 182 * 8 | uimsbf |

In Table 25, transport_packet_header is as defined and constrained by ATSC A/110A, Section 6.1, OM_type is as defined in ATSC A/110A, Section 6.1 and set to 0x30, and private is to be defined by application tools.

Deterministic Trellis Reset (DTR)

Introduction

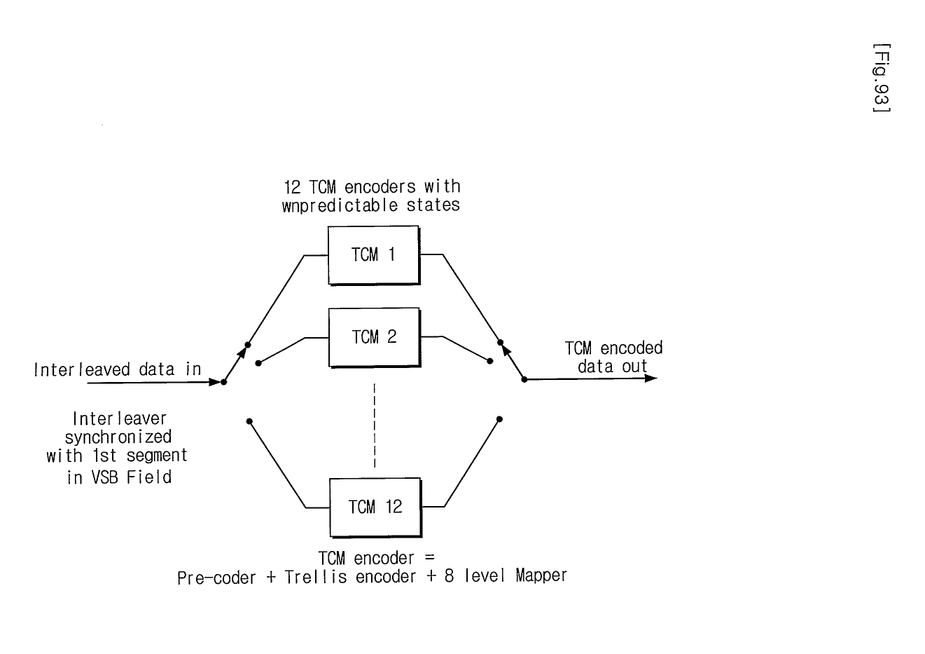

The second core element is the Deterministic Trellis Resetting (DTR), which resets the trellis coded modulation (TCM) encoder states (i.e., the pre-coder and trellis encoder xtates) in the A-VSB exciter. The reset is triggered at selected temporal locations in the VSB Frame. FIG. 93 shows that the states of the (12) TCM Encoders in 8VSB are random. No external knowledge of the states can be known due to the random nature in the A/53 design. The DTR offers a new mechanism to force all TCM encoders to zero state (i.e., a known deterministic state). The A-VSB multiplexer (cross layer design) allows insertion of placeholder packets in calculated positions in the TS, which later will be post processed in the A-VSB exciter.

Operation of State Reset

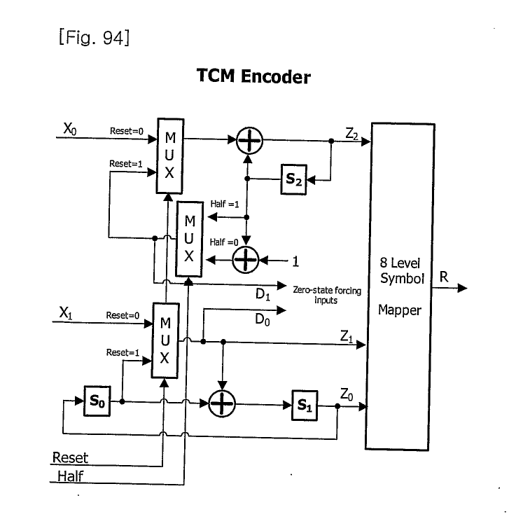

FIG. 94 shows 1 of 12 TCM encoders used in trellis coded 8-VSB (8T-VSB). There are two new multiplexer circuits added to existing logic gates in the shown circuit. When the reset is inactive (Reset=0) the circuit performs as a normal 8-VSB TCM encoder.

The truth table of an XOR gates provides that when both inputs are at like logic levels (either 1 or 0), the output of the XOR is always 0 (Zero). Note that there are three D-Latches (S0, S1, S2), which form the memory. The latches can be in one of two possible states (0 or 1). Therefore as shown in Table 26 below, the second column indicates eight (8) possible starting states of each TCM encoder. Table 26 shows the logical outcome when the reset signal is held active (Reset=1) for two consecutive symbol clock periods. Independent of the starting state of the TCM, the TCM is forced to a known zero state (S0=S1=S2=0). This is shown in the next to last column labeled Next State. Hence a DTR can be forced over two symbol clock periods. When the reset is not active, the circuit performs normally.

TABLE 26
Trellis Reset Truth Table (In (Reset Half) at t = 2, X don't care 0 or 1)

| (Reset | (S0 S1 | | (S0 S1 | (D0 | | (S0 S1 S2) | (Reset |
|---|---|---|---|---|---|---|---|
| Half) | S2) | (D0 D1) | S2) | D1) at | (Reset | Next State | Half) |
| at t = 0 | at t = 0 | at t = 0 | at t = 1 | t = 1 | Half) at t = 1 | t = 2 | at t = 2 |
| 1, 0 | 0, 0, 0 | 0, 1 | 0, 0, 1 | 0, 1 | 1, 1 | 0, 0, 0 | 0, X |
| 1, 0 | 0, 0, 1 | 0, 0 | 0, 0, 1 | 0, 1 | 1, 1 | 0, 0, 0 | 0, X |
| 1, 0 | 0, 1, 0 | 0, 1 | 1, 0, 1 | 1, 1 | 1, 1 | 0, 0, 0 | 0, X |
| 1, 0 | 0, 1, 1 | 0, 0 | 1, 0, 1 | 1, 1 | 1, 1 | 0, 0, 0 | 0, X |
| 1, 0 | 1, 0, 0 | 1, 1 | 0, 0, 1 | 0, 1 | 1, 1 | 0, 0, 0 | 0, X |
| 1, 0 | 1, 0, 1 | 1, 0 | 0, 0, 1 | 0, 1 | 1, 1 | 0, 0, 0 | 0, X |
| 1, 0 | 1, 1, 0 | 1, 1 | 1, 0, 1 | 1, 1 | 1, 1 | 0, 0, 0 | 0, X |
| 1, 0 | 1, 1, 1 | 1, 0 | 1, 0, 1 | 1, 1 | 1, 1 | 0, 0, 0 | 0, X |

Additionally, zero-state forcing inputs (D0, D1 in Table 26) are available. These are TCM encoder inputs which force the encoder state to be zero. During the 2 symbol clock periods, they are produced from the current TCM encoder state. At the instant to reset, the inputs of TCM encoder are discarded and the zero-state forcing inputs are fed to a TCM encoder over two symbol clock periods. Then the TCM encoder state becomes zero. Since these zero-state forcing inputs (D0, D1) are used to correct parity errors induced by DTR, they should be made available to any application tools. The actual point at which reset is performed is dependent on the application tool. See the SRS and SFN tools for examples.

Medium Access Control (MAC)

The A-VSB MAC unit is the protocol entity responsible for establishing the A-VSB core DF structure under the control of ATSC system time. This enables cross layer techniques to create tools such as the Distributed-SRS or enables the efficiency of the A-VSB turbo encoder scheme. The MAC unit sets the rules for sharing of the physical layer medium (8-VSB) between normal and robust data in the time domain. The MAC unit first defines an addressing scheme for locating robust data into the deterministic frame. The A-VSB track is first defined, which is then segmented into a grid of sectors. The sector is the smallest addressable robust unit of data. A group of sectors are assigned together to form a larger data container, which is called a cluster. The addressing scheme allows robust data to be mapped into the deterministic frame structure and this assignment (address) is signaled via the Signaling Information Channel (SIC). The SIC is ⅙ rate turbo coded for added robustness in low S/N and placed in a known position (address) in every VSB frame. The MAC unit also opens adaptation fields in the normal TS packets when needed.

A-VSB MCAST Data as MPEG Private Data

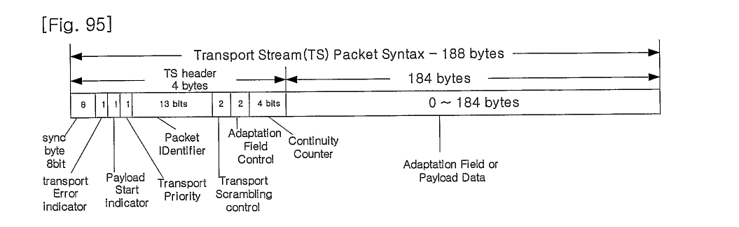

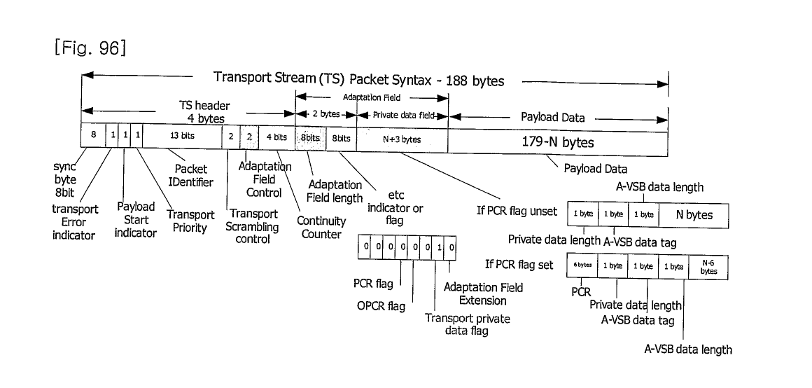

The normal MPEG-2 TS packet syntax is shown in FIG. 95. The adaptation field control in the TS header signals that an adaptation field is present. The normal transport packet syntax with an adaptation field is shown in FIG. 96. The “etc indicator” is a 1 byte field for various flags including PCR. See ISO/IEC 13818-1 for more details.

A-VSB MCAST data, such as the turbo stream and the SRS shall, be delivered through an MPEG private data field in the adaptation field. In order to identify the data type in the private data field, A-VSB MCAST data shall follow the tag-length-data syntax. If there are several data types from different applications, A-VSB MCAST data shall precede the other data types.

Data Mapping in Track

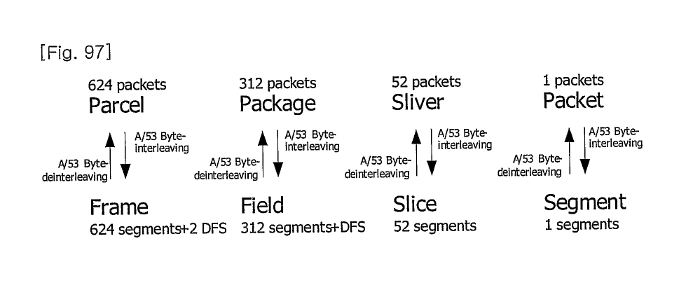

A VSB parcel, package, sliver, and track are defined as a group of 624, 312, 52, and 4 MPEG-2 data packets respectively. A VSB frame is composed of 2 data fields, each data field having a Data Field Sync and 312 data segments. A slice is defined as a group of 52 data segments. Accordingly, a VSB frame has 12 slices. This 52 data segment granularity fits well with the special characteristics of the 52 segment VSB-interleaver. These terms are summarized in FIG. 97.

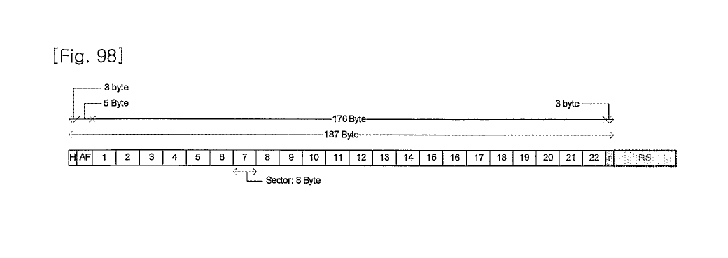

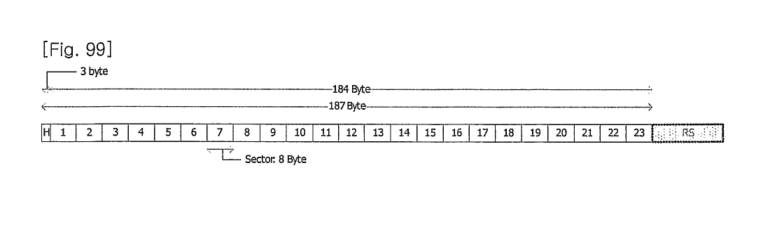

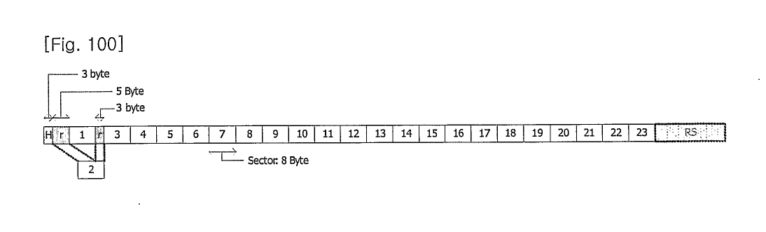

A VSB track is defined as 4 MPEG data packets. The reserved 8 byte space in the AF for the turbo stream is called a sector. A group of sectors is called a cluster. When data such as turbo TS packets and SRS-bytes are delivered in MPEG data packets, the private data field in the AF will be used. However, when a MPEG data packet is entirely dedicated for turbo data and/or SRS-bytes, a null packet, A/90 data packet, or a packet with a newly defined PID will be used to save 2 bytes of the AF header and 3 bytes of the private field overhead. In this case, the saved 5 bytes affect packet segmentation into a grid of sectors. For example, FIG. 98 shows the case of packet segmentation by sectors with the AF header (2 bytes) and the private data field overhead (3 bytes). Since (187−8=) 176 bytes is not divided by 8 bytes, there remain 3 bytes at the end of 22nd sectors. However, a packet without the adaptation field is segmented without any remaining bytes as is shown in FIGS. 99 and 100. A packet without the adaptation field shall be segmented in FIG. 100 when the 0^{th} packet in a track is concerned. Here, the second sector in a packet is divided into two fragments: one being 5 bytes and the other being 3 bytes. The division of the second sector provides the fixed location to the first sector which is used by SIC.

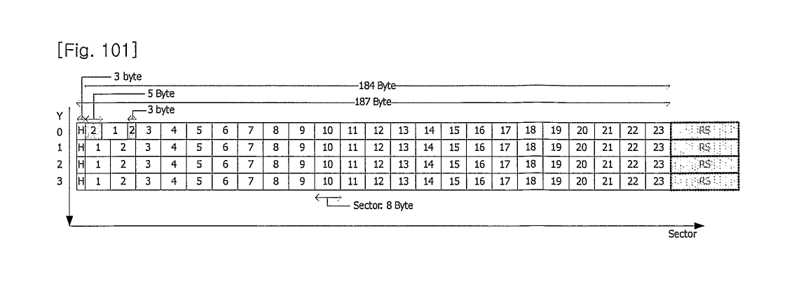

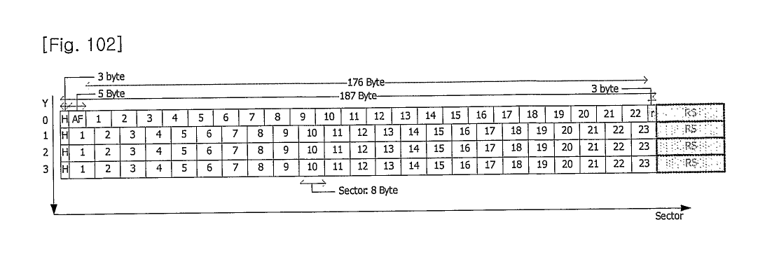

FIGS. 101 and 102 show the segmentation and partitioning of 4 packets by sectors. Since the data mapping into a cluster of sectors repeats every track in this disclosure, it suffices to define the data mapping within a track. Each data occupies a cluster of some sectors. The cluster size determines the normal TS overhead.

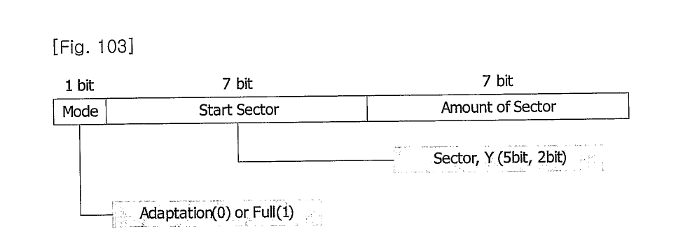

The data mapping is represented by 15 bits as shown in FIG. 103. Referring to FIG. 103, the mode refers to the existence of AF, the next 7 bits indicate the location of the first sector in a cluster, and the remaining 7 bits signify the cluster size as a number of sectors. The first sector in a cluster is located by a sector number in the Y-th packet in FIG. 101 or 102. When the mode is set to 1, the packet containing the first sector shall have no AF and the sector number can be up to 23.

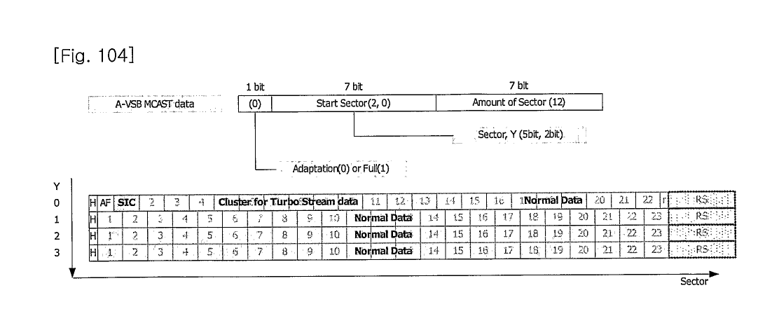

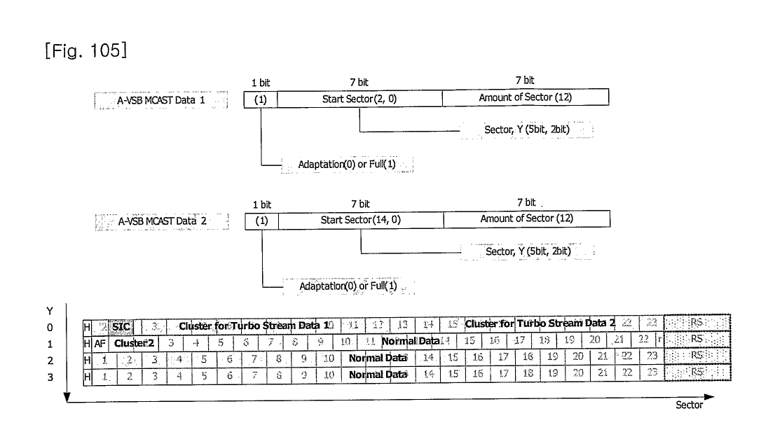

Data mapping example are shown in FIGS. 104 and 105. As shown in FIG. 105, when a packet is not enough to accommodate a specified number of sectors, the next packet provides the room for the rest of sectors. The 15 bits of mapping information for each turbo stream data is sent through the SIC. The SIC will always be placed at the 1st sector in the 0th packet.

Data Mapping with Burst SRS

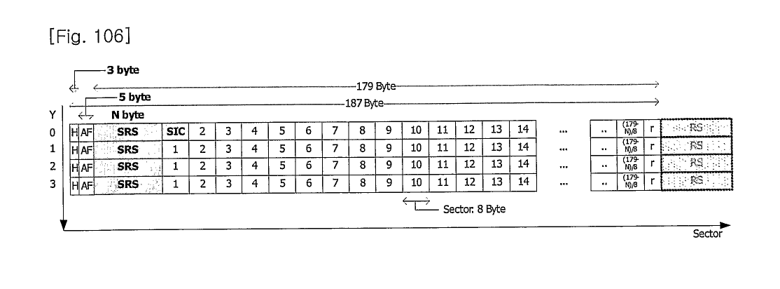

FIG. 106 shows how to segment a track by sectors when a burst SRS is turned on. The last sector number is limited due to the SRS placeholders and depends on the SRS placeholder size.

Data Mapping with Distributed SRS

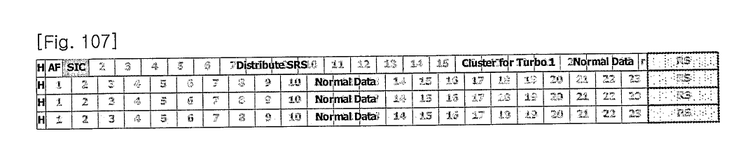

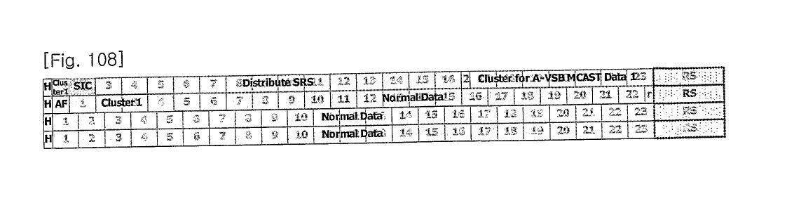

The distributed SRS-bytes shall always follow the SIC data. Thus, the distributed SRS of 14 sectors is depicted as shown in FIG. 107. However, when the first MPEG data packet is entirely used by A-VSB MCAST data such as SIC, SRS, and turbo stream data, the adaption field shall not be used. In this case, the second section is divided into two fragments: one being 5 bytes and the other being 3 bytes. The 5 byte fragment is bytes occupied by the adaptation field before. The other 3 byte fragment shall be placed at the end of the distributed SRS-bytes. The case of the distributed SRS of 14 sectors with a turbo stream of 12 sectors is depicted in FIG. 108. The division of the second sector in this way provides the fixed location of the cluster which is used by the distributed SRS.

Supplementary Reference Sequence (SRS)

Introduction

According to aspects of the present invention, the conventional ATSC 8-VSB system is improved to provide reliable reception for fixed, indoor, portable, mobile, and handheld environments in the dynamic multi-path interference by making known symbol sequences frequently available. The basic principle of the SRS is to periodically insert a special known sequence in a deterministic VSB frame in such a way that a receiver equalizer can utilize this known contiguous sequence to adapt itself to track a dynamically changing channel and, thus, mitigate dynamic multi-path and other adverse channel conditions.

System Overview

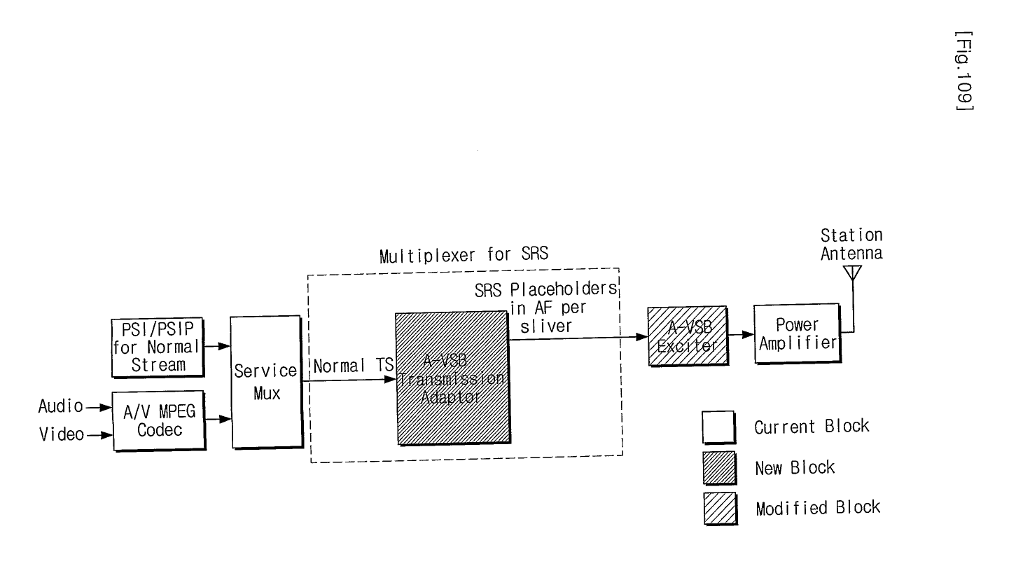

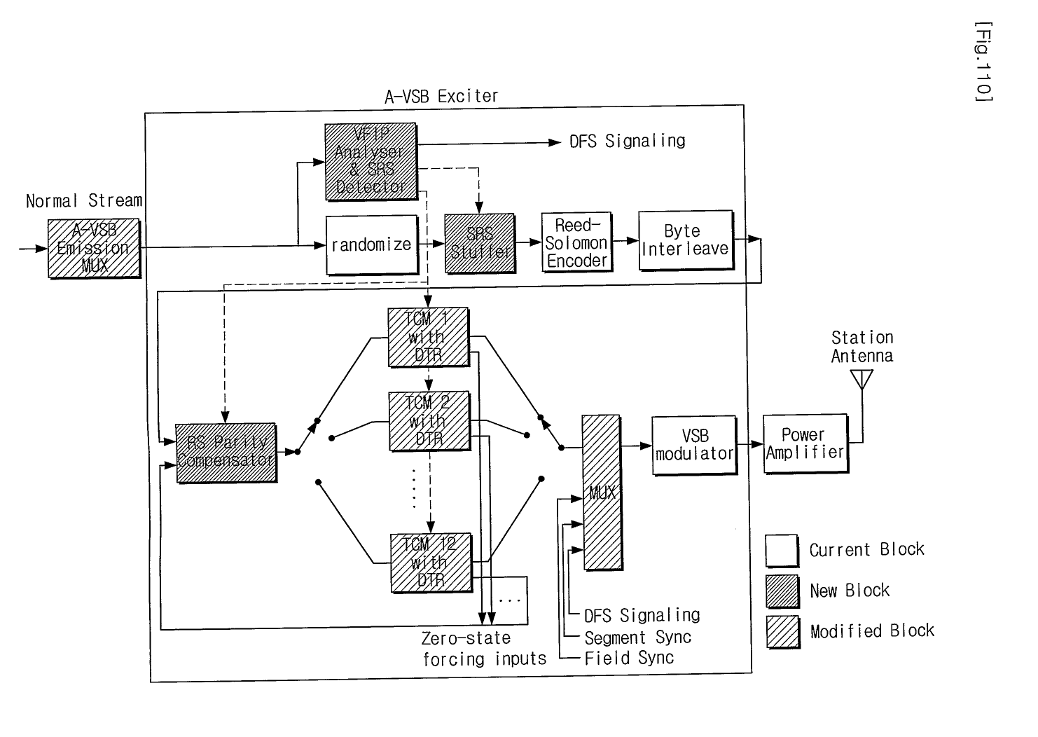

An SRS-enabled ATSC DTV Transmitter is shown in FIGS. 109 and 110. In detail, the blocks modified for SRS processing, the newly introduced block, and the current ATSC DTV blocks are shown in FIGS. 109 and 110. The ATSC A-VSB multiplexer takes into consideration a pre-defined deterministic frame template for SRS. The generated packets are prepared for the SRS post-processing in an A-VSB exciter.

A-VSB Multiplexer for SRS

An ATSC A-VSB multiplexer for SRS is shown in FIG. 109. As illustrated, there is a new conceptual process block, transmission adaptor (TA). The transmission adaptor processes a normal stream to properly set the adaptation fields which serve as SRS-byte placeholders. How to set the adaptation fields for SRS-byte placeholders is defined by the sliver templates.

A-VSB Exciter

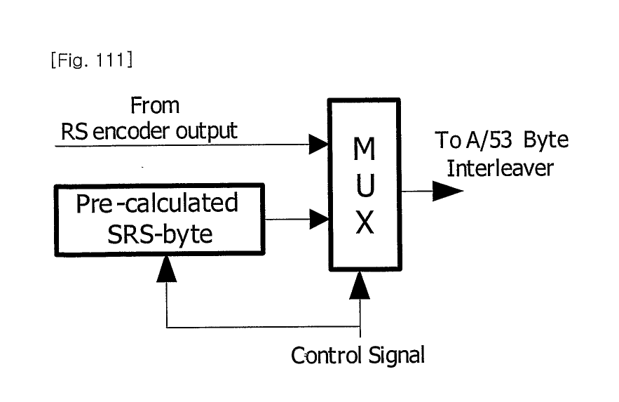

Referring to FIG. 110, the (Normal A/53) randomizer drops all sync bytes of incoming TS packets. The packets are then randomized, and the randomized packets are processed for forward error corrections with the (207, 187) Reed-Solomon code. Then, the SRS stuffer fills the SRS placeholders in the adaptation fields of packets with a pre-defined byte-sequence (i.e., the SRS-bytes). In FIG. 111, the pre-defined fixed SRS-bytes are stuffed into the adaptation field of incoming packets by the control signal at SRS stuffing time. The control signal switches the output of the SRS stuffer to the pre-calculated SRS-bytes properly configured for insertion before the interleaver.

It is noted that, since the placeholders bytes serve no useful purpose between the emission multiplexer and the exciter and will be discarded and replaced by pre-calculated SRS bytes in the exciter, the placeholders can be used to create a high speed data channel to deliver A-VSB signaling and other data to the transmitter site.

In the byte interleaver, output bytes of the SRS stuffer are interleaved. The segment (or the payload for a segment) is a unit of 207 bytes after byte interleaving. These segments are fed to the parity compensator.

The parity compensator gets zero-state forcing inputs from (12) TCM encoders. These inputs are necessary to properly compensate for the parity mismatches induced from the DTR in (12) TCM encoders.

The output of the parity compensator is encoded in (12) TCM encoders as shown in FIG. 110. The parity bytes are already compensated. At the prescribed DTR time, the TCM encoder states go to zeros in two successive symbol clocks. When TCM encoders go to a known deterministic zero state, a predetermined known byte-sequence (SRS-bytes) inserted by the SRS stuffer follows and is then immediately TCM encoded. The resulting 8-level symbols at the TCM encoder output will appear as known 8-level symbol patterns in known locations in the VSB frame. This 8-level symbol-sequence is called SRS-symbols and is available to the receiver as an additional equalizer training sequence. These generated symbols have the specific properties of a noise-like spectrum with a zero dc-value, which are an SRS-byte design criteria.

In the remaining blocks in FIG. 110, the MUX completes VSB frame generation by multiplexing the DFS signaling, frame sync, and segment sync signal. The remaining blocks are the same as the standard ATSC VSB Exciter.

Burst SRS

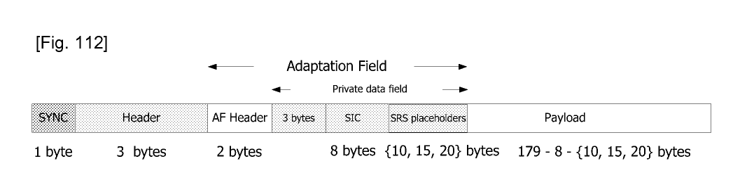

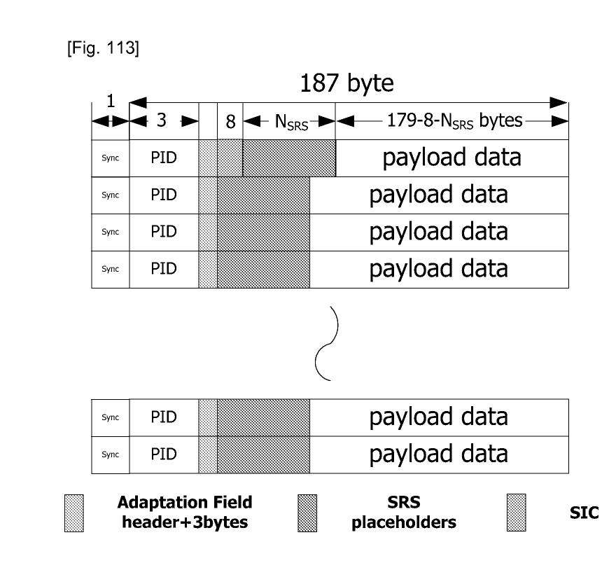

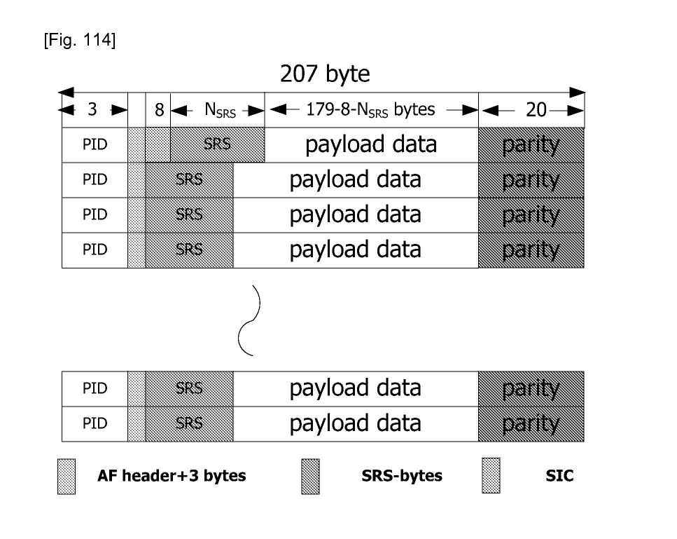

A burst SRS-placeholder-carrying packet is depicted in FIG. 112, and a transport stream with the SRS-placeholder-carrying packets is depicted in FIG. 113, which is the output of the A-VSB multiplexer. The SIC is placed in the adaptation field at every track. Furthermore, FIG. 114 depicts the packets carrying burst SRS-bytes in the adaptation field after the SRS stuffer. The SRS stuffer is careful not to overwrite a PCR or other standard adaptation field values when they are present in the adaptation field.

It is noted that the normal 8-VSB standard has two DFS per frame, each with training sequences (PN-511 and PN-63s). In addition to those training sequences, the burst SRS provides 184 symbols of SRS tracking sequences per segment in groups of 10, 15, or 20 segments. The number of such segments (with known 184 contiguous SRS symbols) available per frame will be 120, 180, and 240 for SRS-10, SRS-15, and SRS-20, respectively. These can help a new SRS receiver's equalizer track dynamic changing channel conditions when objects in the environment and/or the receiver itself are in motion.

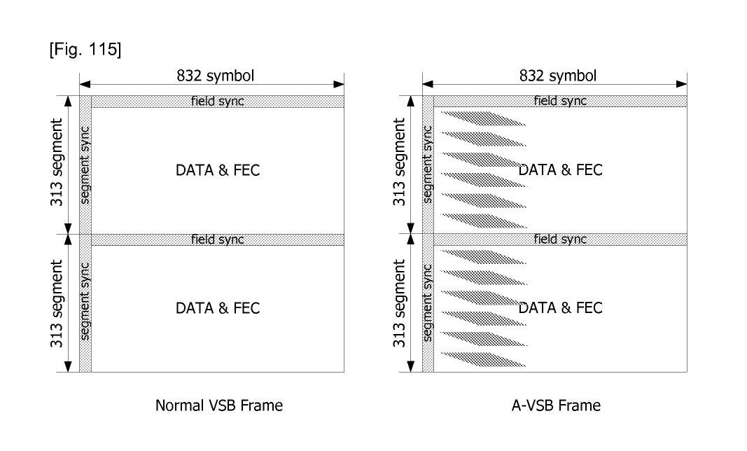

FIG. 115 shows the normal VSB frame on the left and an A-VSB frame on the right with the burst SRS turned on. Each A-VSB frame has 12 groups of SRS 8-level symbols. Each group is in 10, 15, or 20 sequential data-segments depending on N_{SRS} in FIG. 113. On MPEG-2 TS decoding, the SRS symbols appearing in the adaptation field will be ignored by a legacy receiver. Hence the backward compatibility is maintained.

FIG. 115 shows 12 (green) groups which have different compositions depending on the number of SRS bytes (N_{SRS}). The SRS-bytes that are stuffed and the resulting group of SRS symbols are pre-determined and fixed.

Sliver Template for Burst SRS

There are several pieces of information to be delivered through the adaptation field, along with the SRS bytes to be compatible with A/53. These can be the PCR, splice counter, PSIP, private data (other than A-VSB data), and so on. From the ATSC perspective, the program clock reference (PCR) and splice counter must also be carried when needed along with the SRS. This imposes a constraint during the TS packet generation since the PCR is located at the first 6 SRS-bytes.

Some packets such as PMT, PAT, and PSIP impose another constraint because they are assumed to have no adaptation fields. This conflict is solved using the DF. The DF enables these packets to be located in a known position of a sliver. Thus, an exciter designed for the burst SRS can know the temporal position of the PCR and splice counter, non-AF packets and accordingly fill the SRS-bytes, avoiding this other adaptation field information. See ATSC/TSG-3 Adhoc report (TSG3-024r5_UpdatedSummaryA-VSBImplications.doc) for more details on the adaptation field constraints.

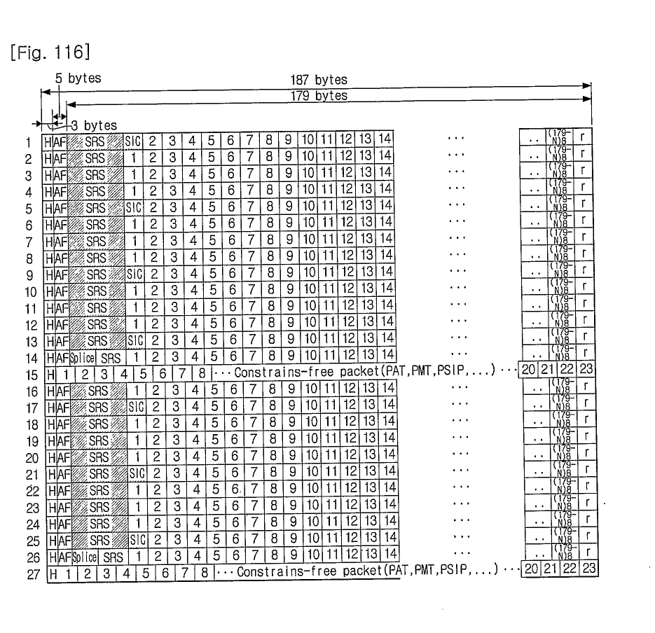

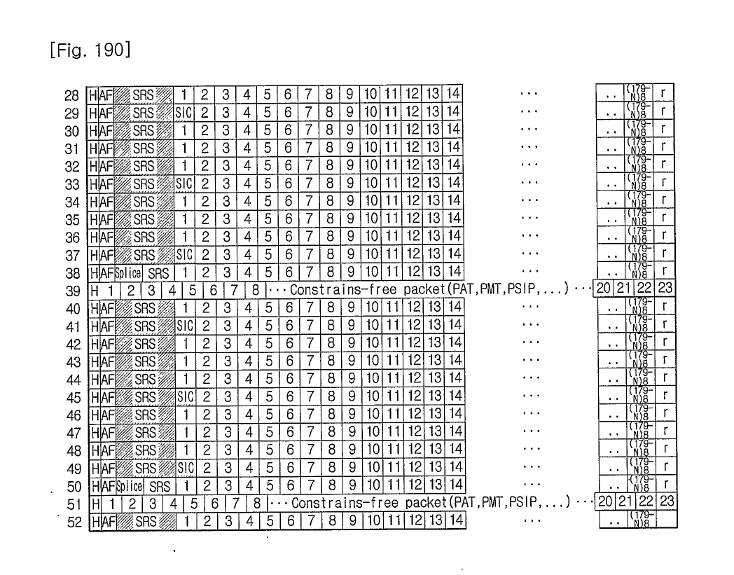

One sliver of SRS DF is shown in FIGS. 116 and 190. The burst SRS DF template stipulates that the 14th, 26th, 38th, 50th (15th, 27th, 39th, and 51st) MPEG data packets in every VSB sliver can be a splice counter-carrying (constraint-free) packet. This set-up makes the PCR (and splice counter) available at about 1 ms, which is well within the required frequency limit for PCR.

Obviously, a normal payload data rate with the burst SRS will be reduced depending on N_{SRS} bytes in FIG. 113. The N_{SRS} can be 0 through 20, SRS-0 bytes being normal ATSC 8-VSB. The proposed values of N_{SRS} bytes are 10, 15, or 20 bytes listed in Table 27 below. The table gives the three SRS byte length candidates. SRS-byte length choices are signaled through the VFIP to the exciter from the A-VSB multiplexer and also through DFS reserved bytes from the exciter to the receiver. Table 27 also shows the normal stream payload loss associated with each choice. Rough payload loss can be calculated as follows: Since 1 sliver takes 4.03 ms, the payload loss due to SRS-10 bytes is (10+5) bytes*48 packets/4.03 ms*8=1.43 Mbps (only 48 packets per slice are carrying N_{SRS} bytes). Similarly, a payload loss of SRS 15 and 20 bytes is 1.91 and 2.38 Mbps. The known SRS-symbols are used to update the equalizer in the receiver. The degree of improvement achieved for a given N_{SRS} byte will depend on a particular equalizer design.

TABLE 27
Recommended N_{SRS} bytes for Burst SRS

| SRS Mode | Choice 1 | Choice 2 | Choice 3 |
|---|---|---|---|
| SRS-bytes Length (N_{SRS)} | 10 bytes | 15 bytes | 20 bytes |
| Payload Loss | 1.43 Mbps | 1.91 Mbps | 2.38 Mbps |

Parity Compensator in Burst SRS

The parity compensator in FIG. 110 is a general description. The specific implementation can be varied as long as the desired objective is achieved. In this section, an efficient implementation of the parity compensator is explained.

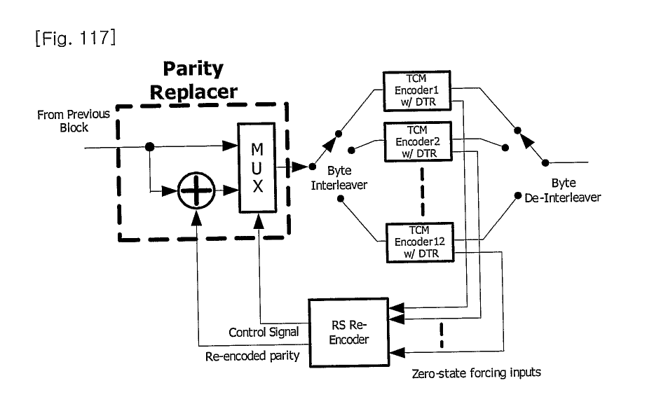

FIG. 117 shows the block diagram of the TCM encoder block with parity correction. The RS re-encoder receives zero-state forcing inputs from TCM encoders with DTR in FIG. 94. The message word for RS-re-encoding is synthesized by taking all zero-bit word except the bits replaced by zero-state forcing inputs. After synthesizing a message word in this way, the RS re-encoder calculates the parity bytes. As RS codes are linear codes, any codeword given by the XOR operation of two valid codewords is also a valid codeword. When the parity bytes to be replaced arrive, genuine parity bytes are obtained by the XOR operation of the incoming parity bytes and the parity bytes computed from the synthesized message word.

For example, assume that an original codeword by (7, 4) RS code is [M1 M2 M3 M4 P1 P2 P3] (M1 refers to a message byte and P1 refers to a parity byte). The deterministic trellis reset replaces the second message byte (M2) with M5 so that the genuine parity bytes are computed by the message word [M1 M5 M3 M4].

However the RS re-encoder receives only the zero-state forcing input(M5) and synthesizes the message word with [0 M5 0 0]. Suppose that the parity bytes computed from the synthesized message word [0 M5 0 0] by the RS re-encoder is [P4 P5 P6]. Then since the two RS codewords of [M1 M2 M3 M4 P1 P2 P3] and [0 M5 0 0 P4 P5 P6] are valid codewords, the parity bytes of the message word [M1 M2+M5 M3 M4] will be the bitwise XORed value of [P1 P2 P3] and [P4 P5 P6]. M2 is initially set to 0, so that the genuine parity bytes of the message word [M1 M5 M3 M4] are obtained by [P1+P4 P2+P5 P3+P6].

The A/53 byte interleaver and byte de-interleaver shown in FIG. 94 are described in ATSC document A/53 Part 2. The 12 trellis encoders have DTR functionality providing the zero-state forcing inputs.

Adaptation Field Contents (SRS Bytes) for Burst SRS

Table 28 below defines the pre-calculated SRS-byte values configured for insertion before the interleaver. TCM encoders are reset at the first SRS-byte and the adaptation fields shall contain the bytes of this table according to the algorithm here. The shaded values in Table 28, ranging from 0 to 15 (4 MSB bits are zeros, M2) are the first byte to be fed to TCM encoders (the beginning SRS-bytes). Since there are (12) TCM encoders, there are (12) bytes in shade in each column except the column 1˜3. At DTR, the 4 MSB bits of these bytes are discarded and replaced with the zero-state forcing inputs. Then the state of TCM encoders becomes zero and TCM encoders are ready to receive SRS-bytes to generate 8-level symbols (SRS-symbols) which serve as a training symbol sequence in a receiver. This training sequence (TCM encoder output) is 8-level symbols, +/−{1, 3, 5, 7}. The SRS-byte values are designed to give the SRS-symbols which have a white noise-like flat spectrum and almost zero DC value (the mathematical average of the SRS-symbols is almost zero).

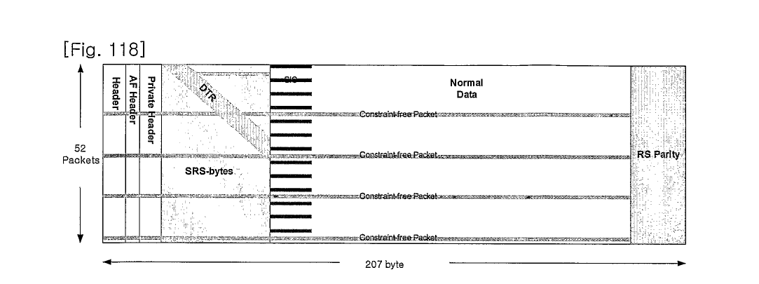

Depending on the selected NSRS bytes, only a specific portion of the SRS-byte values in Table 28 is used. For example, in the case of SRS-10 bytes, SRS byte values from the 1st to the 10th column in Table 28 are used. In the case of SRS-20 bytes, the byte values from the 1st to the 20th column are used. Since the same SRS-bytes are repeated at every 52 packets (a sliver), the table in Table 28 has values for only 52 packets. FIG. 118 clearly shows a sliver snapshot in the Burst SRS.

TABLE 28
Pre-calculated SRS Bytes to be stuffed into adaptation fields

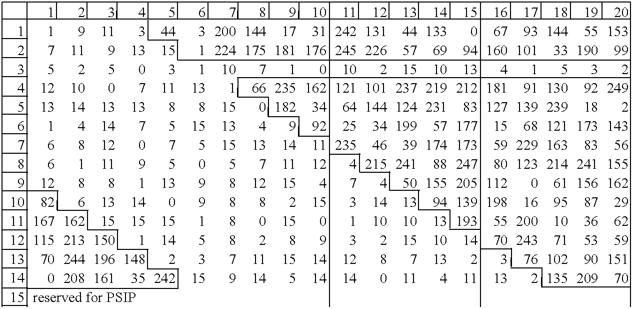

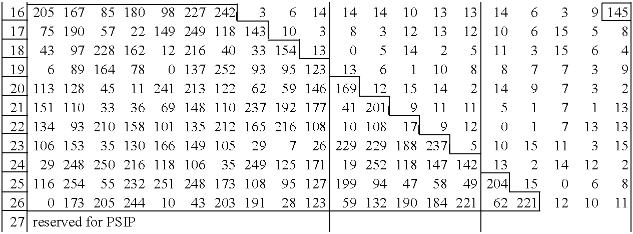

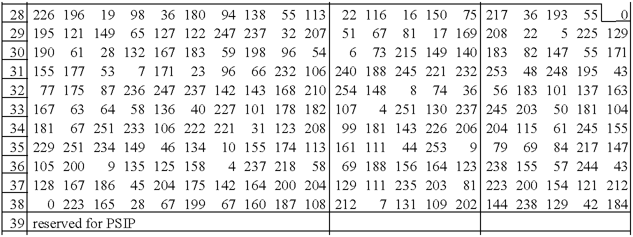

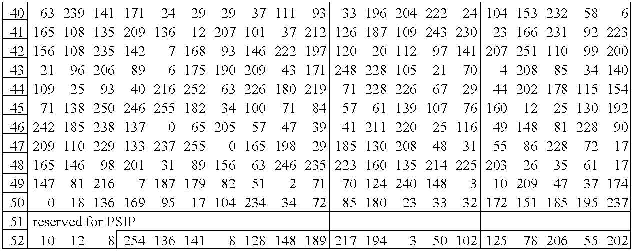

[symbol]

TCM input when DTRs happen
reserved slot for AF constraint-free packet
Splice Counter

Distributed SRS

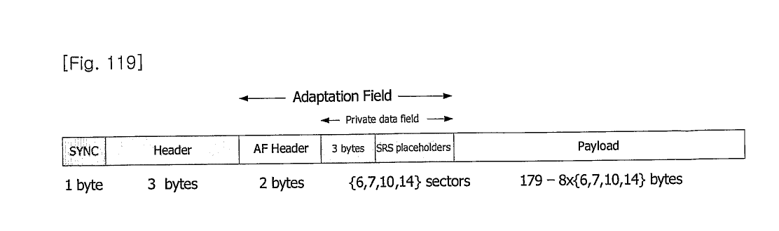

The basic idea of the distributed SRS is to uniformly spread the equalizer reference sequence through the VSB frame. A distributed SRS-placeholder-carrying packet is depicted in FIG. 119.

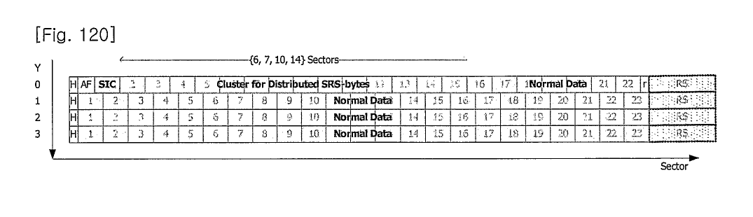

The distributed SRS-bytes are inserted into one packet per track and occupy a cluster of 6, 7, 10, or 14 sectors. When a cluster has {6, 7, 10, 14} sectors, FIG. 120 shows how the distributed SRS-bytes are specifically placed in a track. This is different from the case of the burst SRS. Note that these clusters are accommodated with the help of the adaptation field.

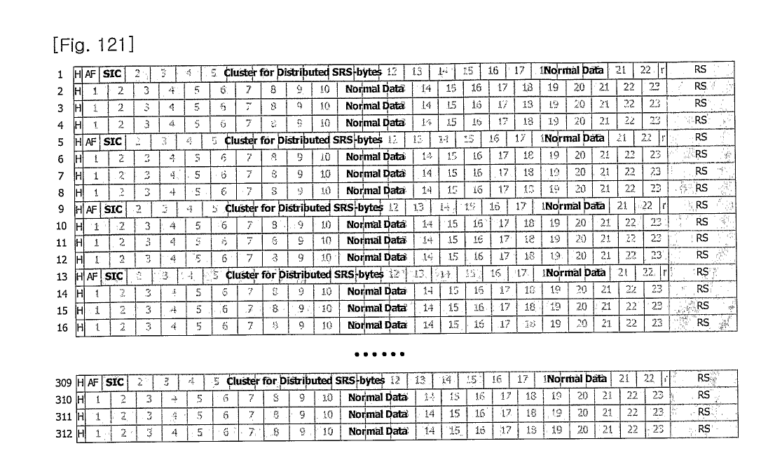

FIG. 121 depicts a package carrying distributed SRS-bytes in the adaptation field after the SRS stuffer. Since only one packet in a track carries the SRS-bytes, non-AF packets and other standard adaptation field values such as PCR come in the other packet slots than the first packet one in every track.

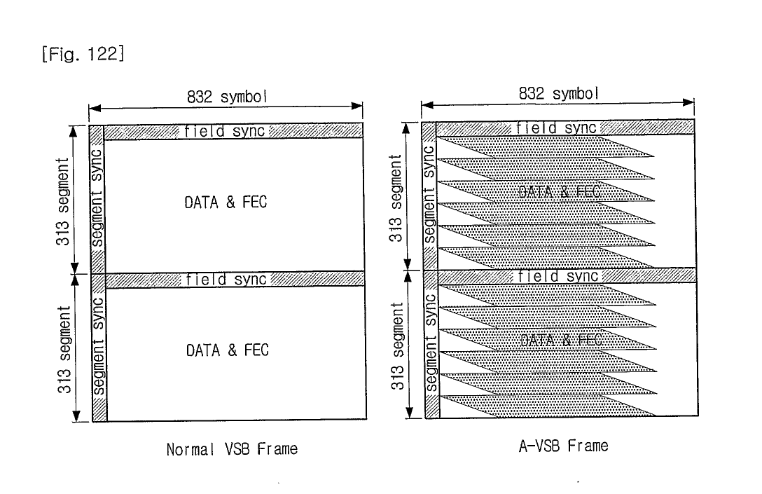

FIG. 122 shows the normal VSB frame on the left and an A-VSB frame on the right with distributed SRS. Each A-VSB frame has 12 groups of SRS 8-level symbols. Each group is in 52 consecutive data-segments, i.e. a slice. The 12 (green) groups stand for the distributed SRS-symbols for the use of the training sequence. Note that the distributed SRS provides a different number of tracking sequences in all segments. In other words, the number of such segments available per frame will be 312. These tracking sequences are less dense than a conventional SRS but more uniformly spread. They help a new distributed SRS receiver's equalizer track dynamic changing channel conditions when objects in the environment or the receiver itself are in motion.

Sliver Template for Distributed SRS

Non-AF packets such as PMT, PAT, and PSIP must be delivered. However, the distributed SRS is carried in adaptation fields. Accordingly, non-AF packets shall appear in the packet slots where there are no distributed SRS-bytes. Some standard adaptation field values such as PCR, splice count, and so on can be saved in this way.

Similar to the case of burst SRS, there are four different distributed SRS choices. These are summarized in Table 29 below with the normal payload overhead associated with each choice. Compared with values in Table 27 of burst SRS, payload losses in Choice 1 and Choice 3 in Table 29 are comparable with those in Choice 1 and the Choice 3 in burst SRS. (In the burst SRS, SRS-{10, 15, 20} has a payload loss of {1.43, 1.91, 2.39} Mbps.)

The sliver templates for Distributed SRS are obtained by repeating 13 times the track templates shown in FIG. 120 and FIG. 121. The explanation in Section [00141] can be applied to understand the sliver templates for the Distributed SRS.

TABLE 29
Recommended Cluster Size for Distributed SRS

| SRS Mode | Choice 1 | Choice 2 | Choice 3 | Choice 4 |
|---|---|---|---|---|
| Sector Count | 6 Sectors | 7 Sectors | 10 Sectors | 14 Sectors |
| Payload Loss | 1.37 Mbps | 1.58 Mbps | 2.20 Mbps | 3.03 Mbps |

Parity Compensation in Distributed SRS

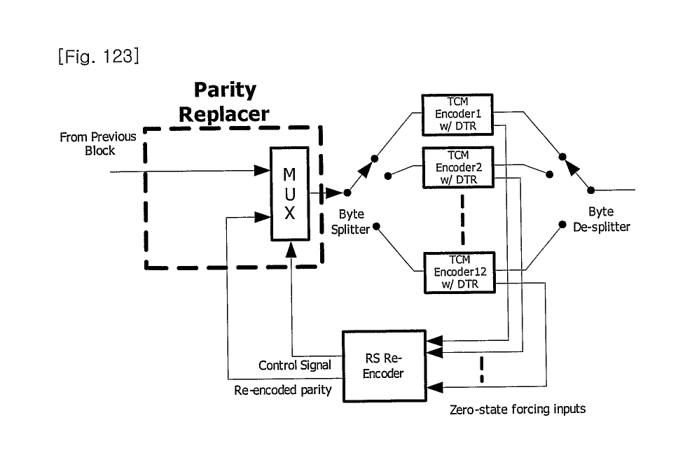

Referring to FIG. 123, the affected parity byte positions in the distributed SRS are sometimes taken in the last consecutive 20 bytes because all the corresponding parity-bytes do not appear after the bytes at DTR due to the (A/53 Normal) byte-interleaving. Even DTRs occur in the last consecutive 20 bytes. Consequently, some bytes in the distributed SRS cluster are reserved for parity compensation.

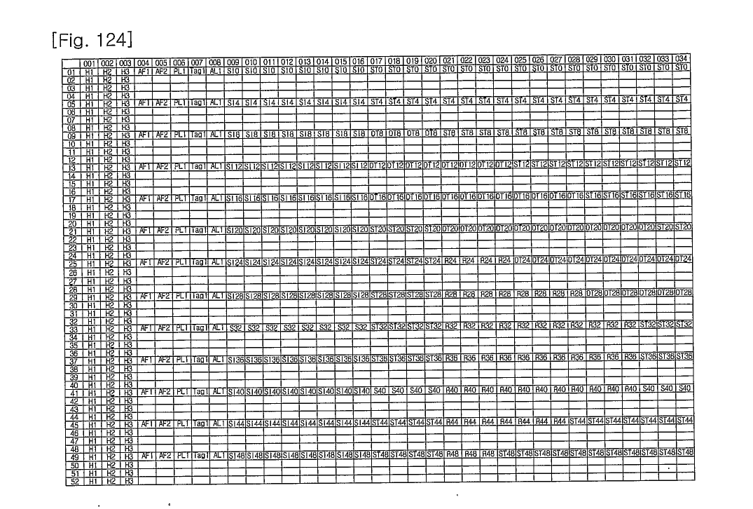

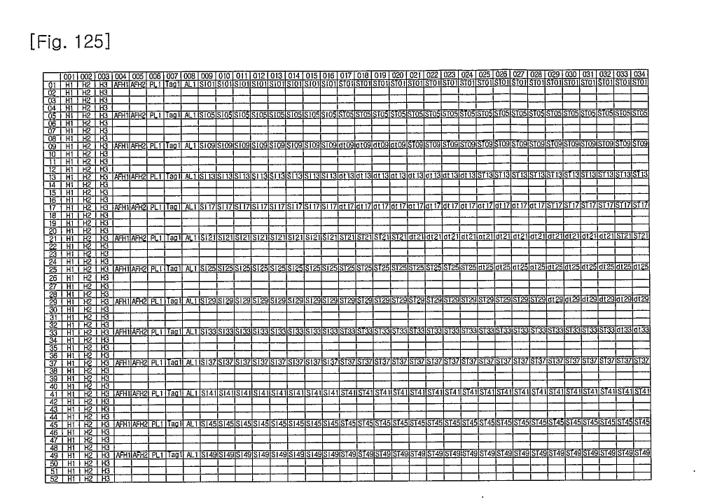

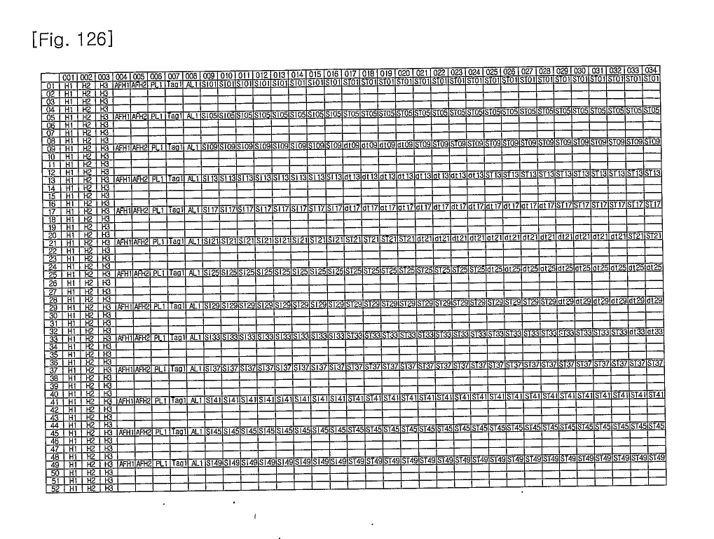

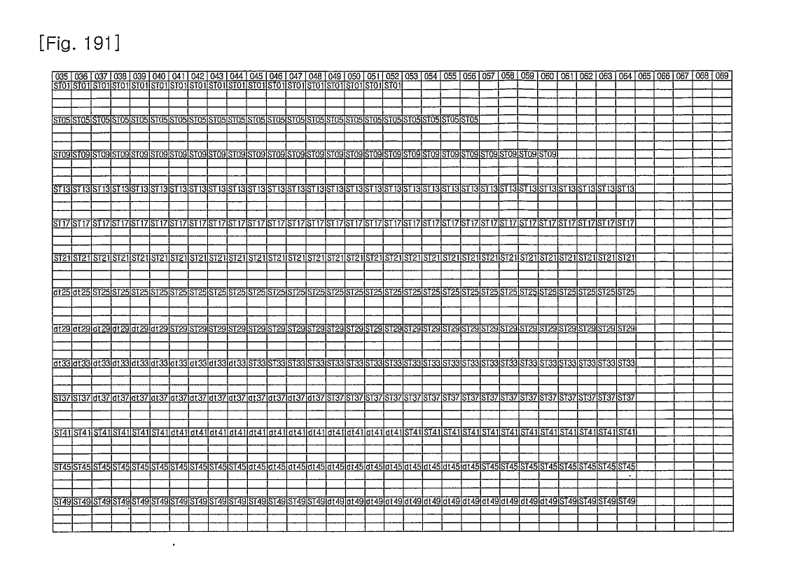

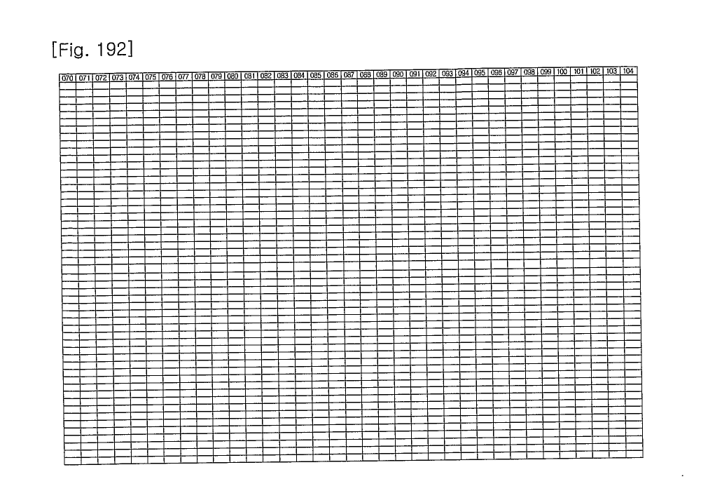

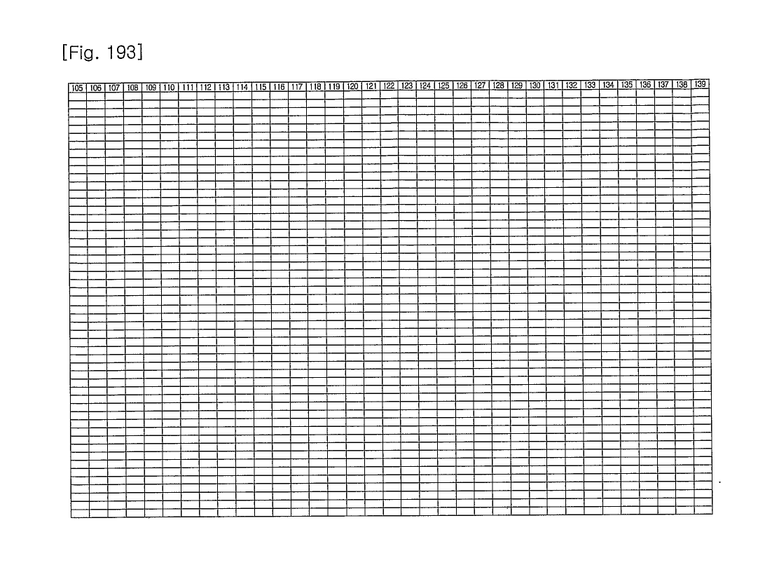

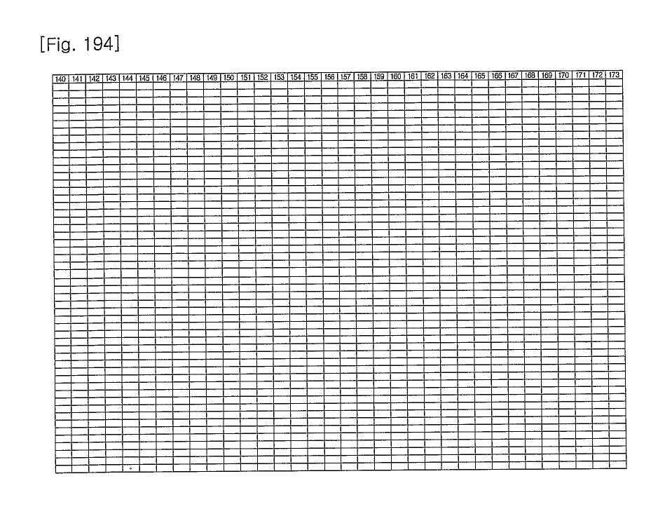

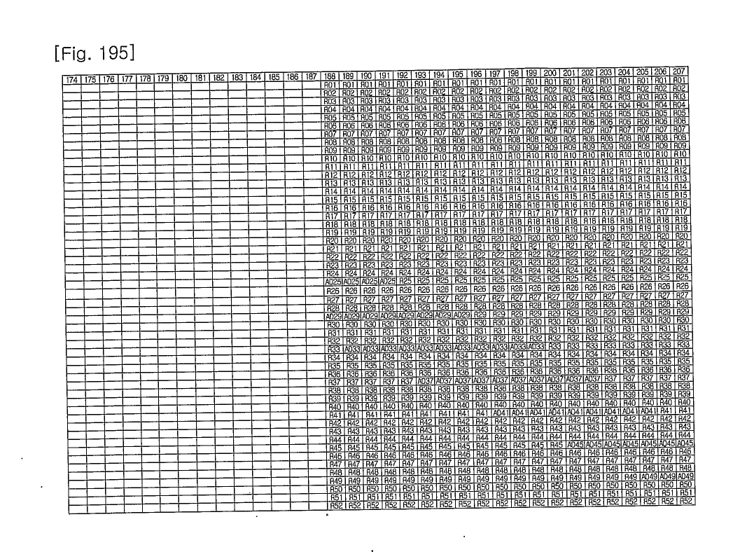

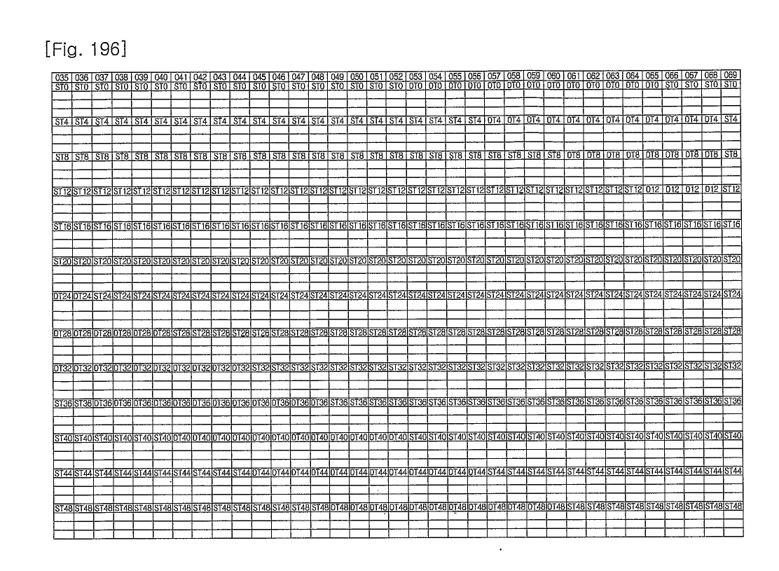

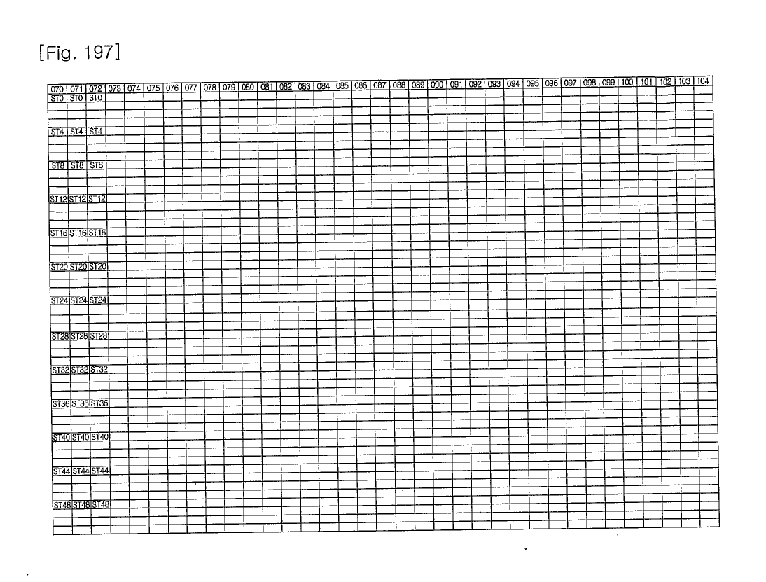

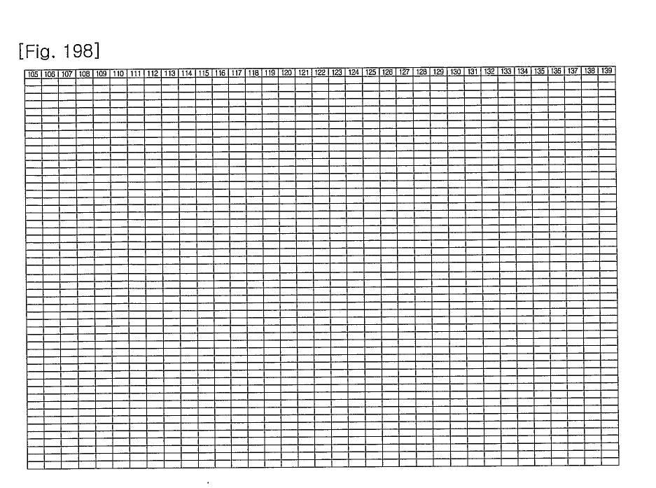

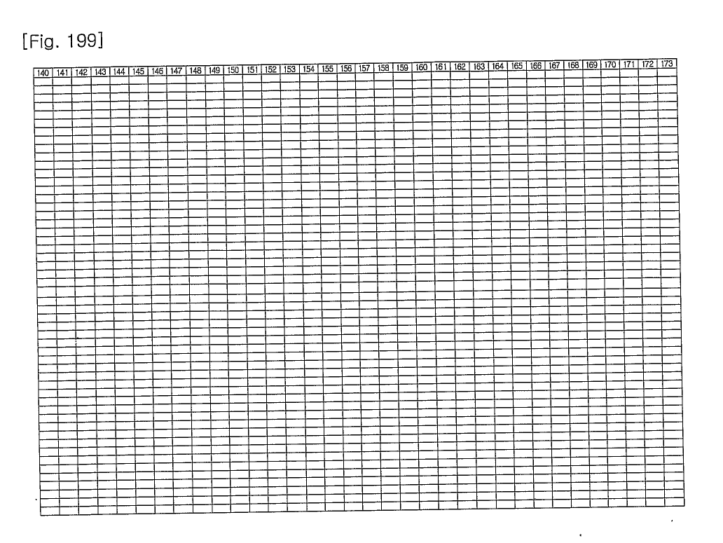

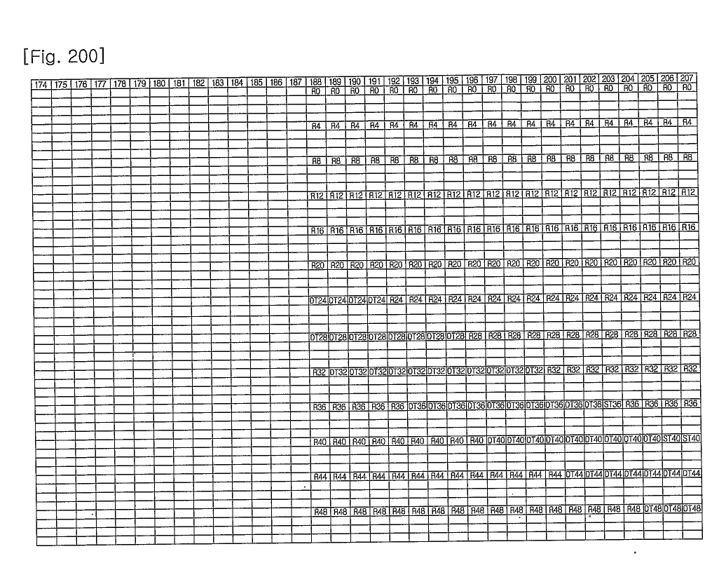

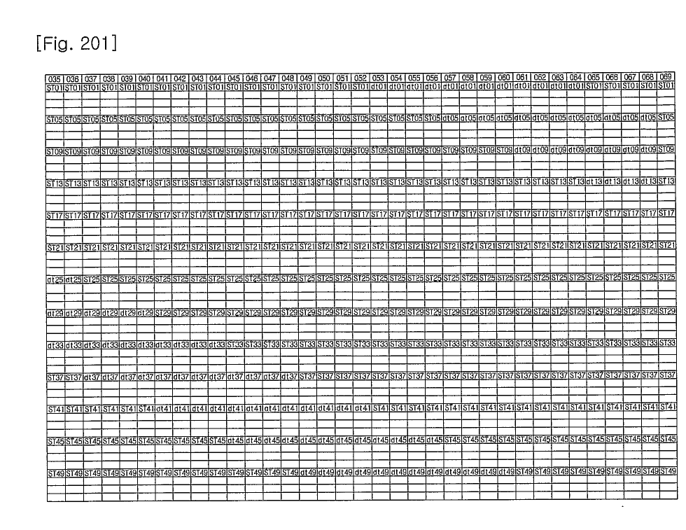

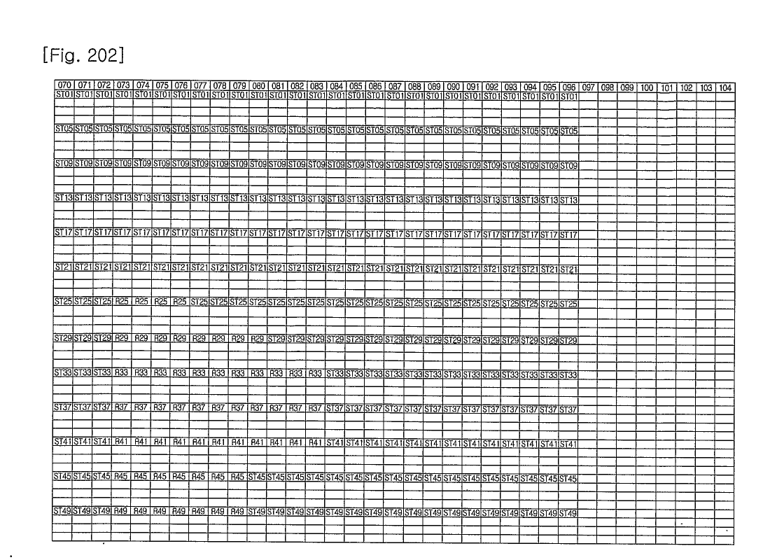

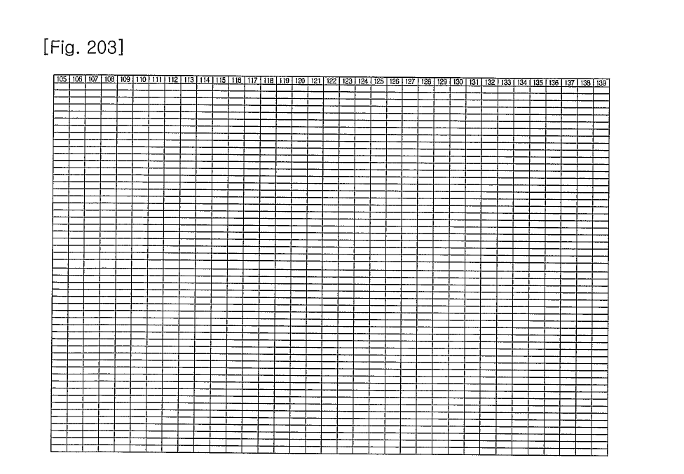

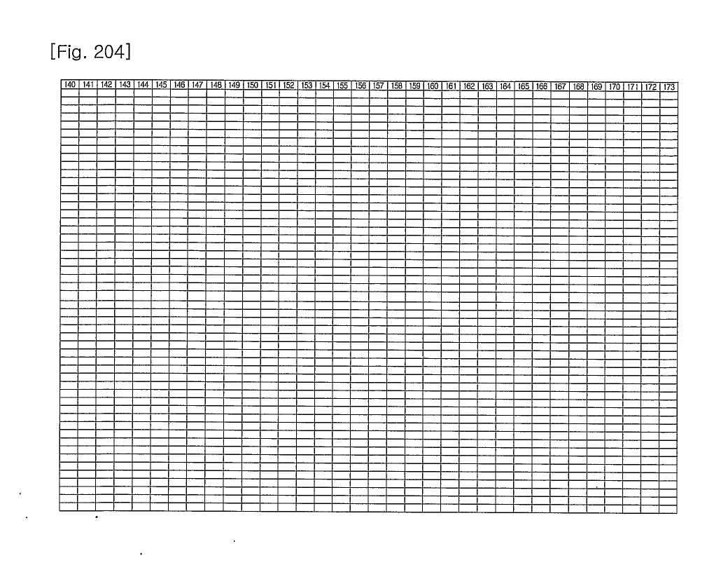

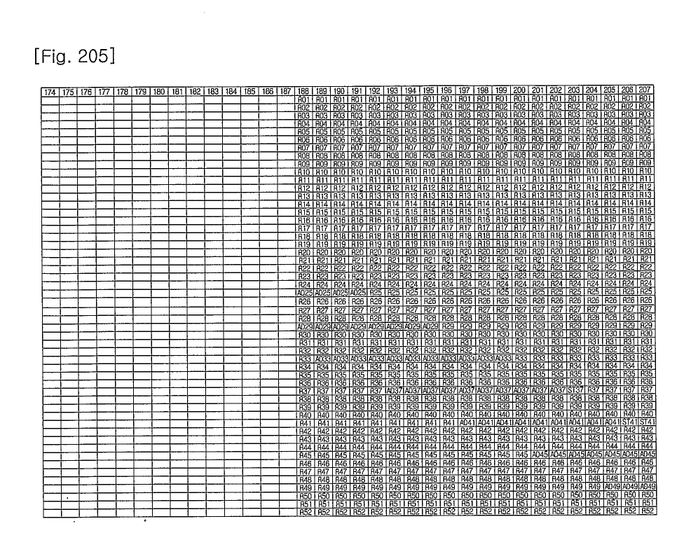

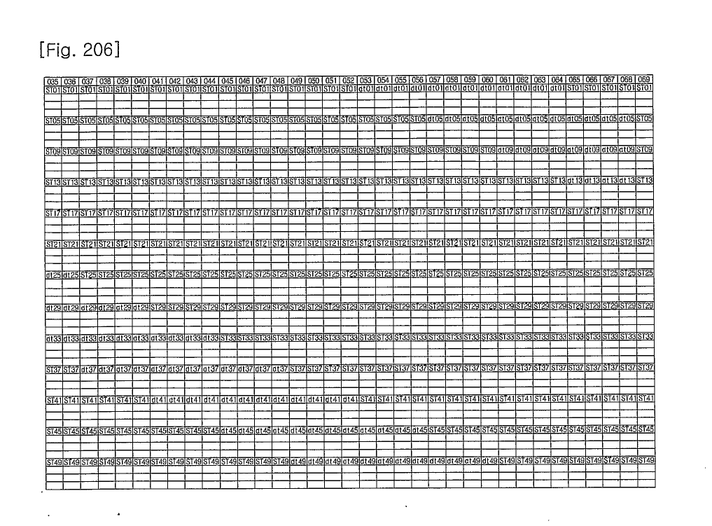

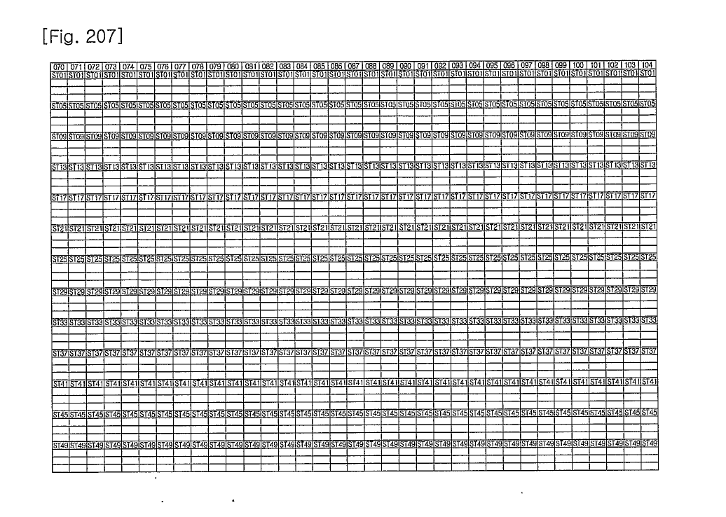

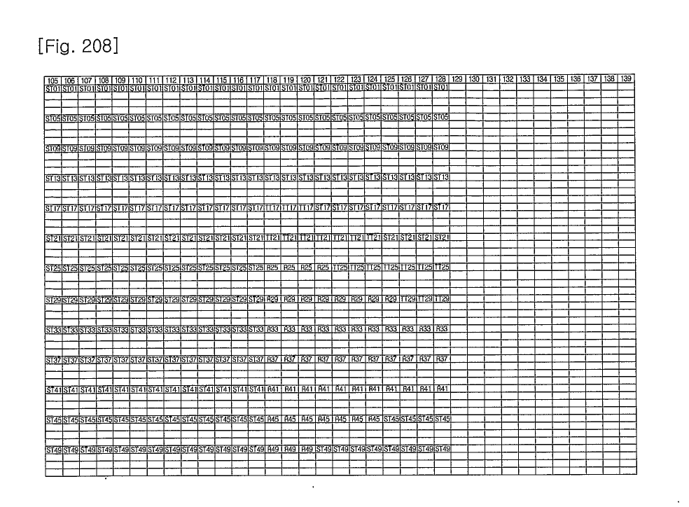

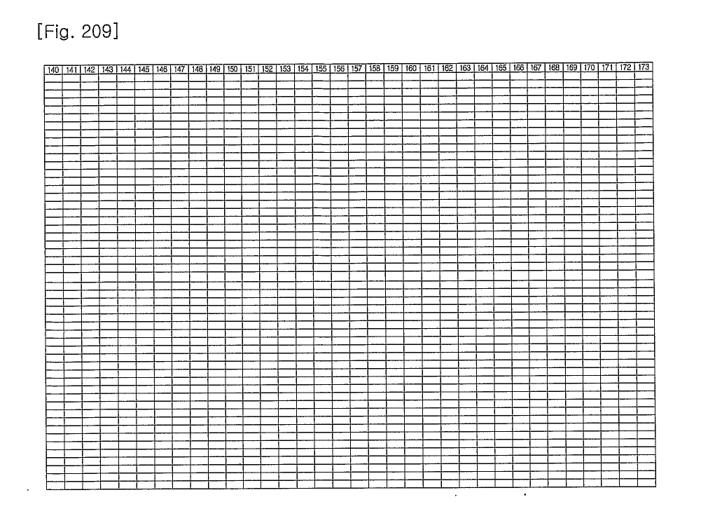

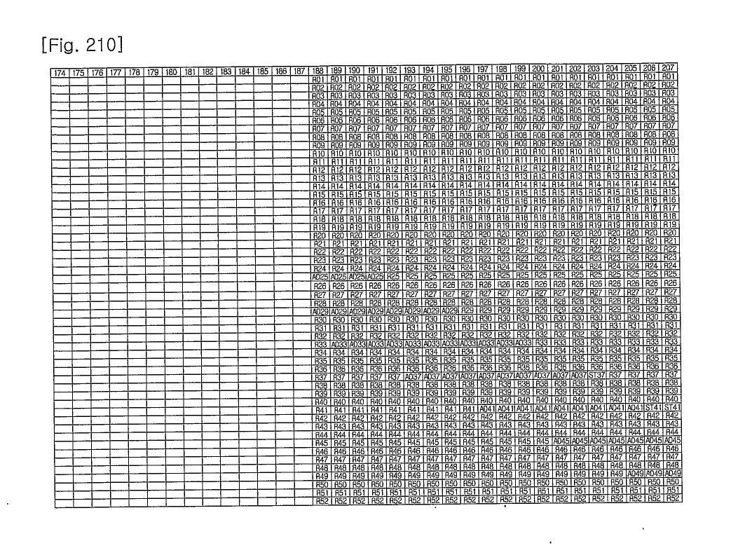

FIGS. 123-126 depict the DTR positions and their affected parity byte positions in the sliver templates of all cluster sizes, {6, 7, 10, 14} sectors. Due to the big horizontal size, they are cut in 6 parts and shown in 6 consecutive figures. In other words, FIGS. 123 and 191 to 195 are represented by one drawing (hereinafter referred to as FIG. 123), FIGS. 124 and 196 to 200 are represented by one drawing (hereinafter, referred to as FIG. 124), FIGS. 125 and 201 to 205 are represented by one drawing (hereinafter referred to as FIG. 125), and FIGS. 126 and 206 to 210 are represented by one drawing (hereinafter referred to as FIG. 126). Table 30 shows the legend of these figures. Table 30 shows the legend of these figures. The number after a symbol in figures means the packet slot number in a sliver. Note that there are the reserved bytes (marked in R) for RS parity compensation in the distributed SRS cluster due to DTR (marked in AD) and SRS-byte (marked in ST) in the last 20 bytes.

TABLE 30
Legend for FIGS. 123-126

| Symbol | Meaning |
|---|---|
| H1 | 1st byte in MPEG TS Packet Header |
| H2 | 2nd byte in MPEG TS Packet Header |
| H3 | 3rd byte in MPEG TS Packet Header |
| AFH1 | 1st byte in Adaptation Field Header |
| AFH2 | 2nd byte in Adaptation Field Header |
| PL1 | Private Data Field Length |
| Tag1 | Private Data (A-VSB MCAST data) Tag |
| AL1 | Private Data Length |
| dt | Byte at Deterministic Trellis Reset (DTR) |
| ST | Cluster for Distributed SRS bytes |
| SI | Cluster for Signaling Information Channel (SIC) |
| R | Reed Solomon Parity Bytes |
| AD | Byte at DTR in the last 20 consecutive bytes of |
| | packet |

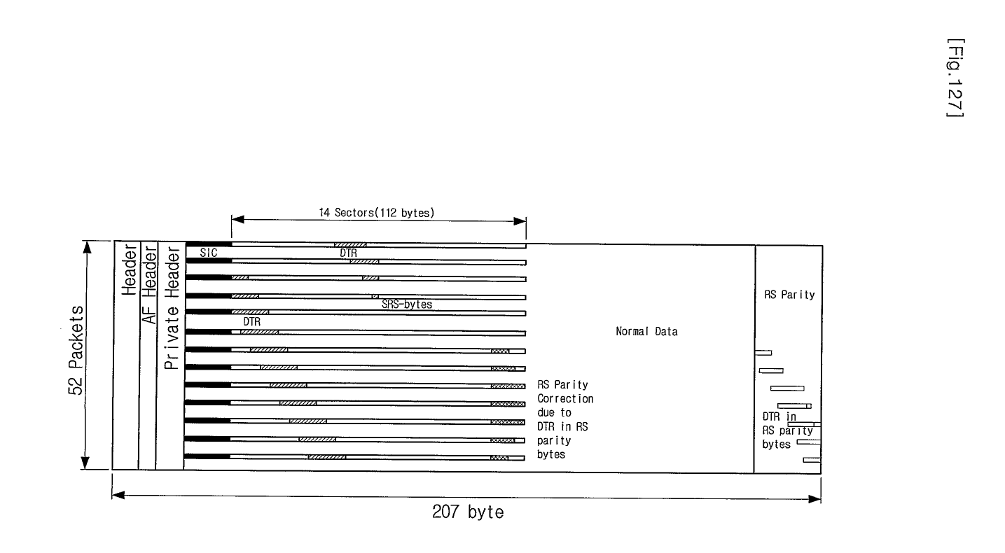

FIGS. 123-126 show the long tables for all choices in the distributed SRS. A sliver snapshot is shown in FIG. 127. All packets have 20 RS parity bytes. The RS parity bytes in some packets are located in the SRS-bytes cluster because some bytes in the last consecutive 20 bytes are reserved for the distributed SRS-bytes. So, in that case, the SRS-stuffer in FIG. 114 replaces the bytes in the last 20 bytes and the RS parity compensator calculates the bytes to be placed in the RS parity byte positions specified by ‘R’ in FIGS. 123-126. These RS parity byte positions are not always in the last 20 bytes as are shown in FIG. 127, but they are always 20 bytes per packet.

Adaptation Field Contents for Distributed SRS

Table 31 below defines the pre-calculated SRS-byte values configured for insertion for the distributed SRS. The bytes at DTR are the first byte to be fed to TCM encoders before the generation of SRS-symbols. The SRS-bytes are designed to give the SRS-symbols which have a white noise-like flat spectrum and almost zero DC value. Depending on the choice for various sliver templates, only a specific portion of the SRS-byte values in Table 31 is used. For example, in the case of the choice 1 (6 sectors), the SRS-bytes positions are identified from FIG. 123. These are marked in “ST#” (# means a numerical value). Then, the SRS stuffer shall overwrite the values in these positions with the values in Table 31 at the same position.

TABLE 31
Pre-calculated SRS Bytes for the Distributed SRS

| | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
|---|---|---|---|---|---|---|---|---|---|---|---|---|---|---|---|---|---|---|---|---|---|---|---|---|
| 1 | 0 | 0 | 0 | 2 | 7 | 5 | 12 | 3 | 0 | 0 | 0 | 0 | 0 | 0 | 0 | 0 | 176 | 243 | 117 | 151 | 119 | 5 | 137 | 134 |
| 2 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 5 | 0 | 0 | 0 | 177 | 11 | 11 | 10 | 2 | 0 | 0 | 0 | 0 | 0 | 0 | 0 | 0 | 50 | 152 | 132 | 79 | 142 | 40 | 23 | 235 |
| 6 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 9 | 0 | 0 | 0 | 56 | 36 | 49 | 186 | 198 | 0 | 0 | 0 | 0 | 0 | 0 | 0 | 0 | 4 | 13 | 0 | 7 | 101 | 138 | 129 | 180 |
| 10 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 13 | 0 | 0 | 0 | 245 | 106 | 251 | 147 | 46 | 0 | 0 | 0 | 0 | 0 | 0 | 0 | 0 | 13 | 15 | 5 | 5 | 2 | 12 | 8 | 3 |
| 14 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 17 | 0 | 0 | 0 | 87 | 1 | 115 | 76 | 118 | 0 | 0 | 0 | 0 | 0 | 0 | 0 | 0 | 1 | 11 | 13 | 14 | 1 | 2 | 12 | 6 |
| 18 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 21 | 0 | 0 | 0 | 104 | 61 | 217 | 18 | 92 | 0 | 0 | 0 | 0 | 0 | 0 | 0 | 0 | 38 | 6 | 254 | 43 | 7 | 8 | 12 | 14 |
| 22 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 25 | 0 | 0 | 0 | 145 | 137 | 79 | 118 | 41 | 0 | 0 | 0 | 0 | 0 | 0 | 0 | 0 | 52 | 161 | 106 | 133 | 46 | 45 | 158 | 252 |
| 26 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 29 | 0 | 0 | 0 | 3 | 227 | 43 | 108 | 208 | 0 | 0 | 0 | 0 | 0 | 0 | 0 | 0 | 157 | 247 | 123 | 237 | 42 | 142 | 192 | 51 |
| 30 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 33 | 0 | 0 | 0 | 126 | 32 | 183 | 214 | 143 | 0 | 0 | 0 | 0 | 0 | 0 | 0 | 0 | 64 | 215 | 20 | 105 | 216 | 83 | 121 | 195 |
| 34 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 37 | 0 | 0 | 0 | 183 | 119 | 10 | 29 | 131 | 0 | 0 | 0 | 0 | 0 | 0 | 0 | 0 | 37 | 255 | 47 | 66 | 41 | 119 | 145 | 42 |
| 38 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 41 | 0 | 0 | 0 | 56 | 65 | 129 | 143 | 202 | 0 | 0 | 0 | 0 | 0 | 0 | 0 | 0 | 54 | 9 | 45 | 61 | 205 | 76 | 144 | 149 |
| 42 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 45 | 0 | 0 | 0 | 15 | 47 | 5 | 92 | 48 | 0 | 0 | 0 | 0 | 0 | 0 | 0 | 0 | 208 | 254 | 171 | 56 | 252 | 198 | 96 | 50 |
| 46 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 49 | 0 | 0 | 0 | 15 | 7 | 58 | 2 | 11 | 0 | 0 | 0 | 0 | 0 | 0 | 0 | 0 | 41 | 15 | 229 | 40 | 149 | 10 | 249 | 101 |
| 50 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |

| | 25 | 26 | 27 | 28 | 29 | 30 | 31 | 32 | 33 | 34 | 35 | 36 | 37 | 38 | 39 | 40 | 41 | 42 | 43 | 44 |
|---|---|---|---|---|---|---|---|---|---|---|---|---|---|---|---|---|---|---|---|---|
| 1 | 36 | 145 | 152 | 244 | 194 | 196 | 123 | 208 | 184 | 115 | 127 | 236 | 210 | 108 | 228 | 191 | 16 | 194 | 143 | 158 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 80 | 12 | 100 | 137 | 146 | 65 | 175 | 215 | 10 | 6 | 206 | 150 | 147 | 180 | 132 | 192 | 202 | 61 | 17 | 6 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 85 | 160 | 236 | 54 | 165 | 203 | 246 | 124 | 230 | 74 | 81 | 225 | 203 | 69 | 100 | 245 | 77 | 137 | 92 | 157 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 60 | 100 | 222 | 190 | 26 | 184 | 183 | 23 | 128 | 203 | 55 | 171 | 104 | 171 | 172 | 187 | 53 | 159 | 32 | 233 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 15 | 2 | 10 | 6 | 213 | 229 | 164 | 25 | 47 | 243 | 128 | 175 | 228 | 35 | 139 | 173 | 87 | 191 | 93 | 149 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 12 | 9 | 6 | 2 | 3 | 2 | 14 | 4 | 199 | 31 | 91 | 104 | 143 | 127 | 95 | 204 | 95 | 107 | 69 | 180 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 7 | 5 | 13 | 13 | 10 | 15 | 9 | 14 | 10 | 14 | 11 | 11 | 224 | 33 | 65 | 115 | 252 | 25 | 192 | 43 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 217 | 94 | 23 | 30 | 12 | 9 | 2 | 8 | 2 | 15 | 5 | 3 | 10 | 11 | 3 | 2 | 0 | 58 | 95 | 9 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 121 | 102 | 52 | 197 | 95 | 101 | 87 | 15 | 5 | 15 | 14 | 13 | 5 | 14 | 7 | 11 | 0 | 1 | 4 | 2 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 148 | 227 | 207 | 38 | 39 | 34 | 165 | 91 | 163 | 5 | 187 | 236 | 9 | 2 | 3 | 12 | 10 | 12 | 10 | 12 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 71 | 182 | 30 | 109 | 77 | 81 | 15 | 65 | 50 | 251 | 146 | 35 | 20 | 39 | 247 | 20 | 10 | 9 | 13 | 13 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 250 | 237 | 155 | 250 | 26 | 6 | 66 | 118 | 219 | 165 | 38 | 9 | 128 | 27 | 244 | 193 | 176 | 47 | 197 | 181 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 178 | 88 | 120 | 38 | 22 | 12 | 235 | 200 | 144 | 2 | 147 | 223 | 7 | 204 | 8 | 31 | 16 | 160 | 16 | 89 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 45 | 46 | 47 | 48 | 49 | 50 | 51 | 52 | 53 | 54 | 55 | 56 | 57 | 58 | 59 | 60 | 61 | 62 | 63 | 64 |
| 1 | 149 | 232 | 212 | 236 | 210 | 174 | 133 | 39 | 7 | 4 | 9 | 4 | 11 | 14 | 13 | 11 | 15 | 9 | 1 | 1 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 55 | 62 | 184 | 188 | 170 | 147 | 143 | 212 | 160 | 210 | 155 | 137 | 8 | 0 | 5 | 13 | 13 | 5 | 12 | 9 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 199 | 207 | 100 | 8 | 85 | 121 | 98 | 97 | 50 | 34 | 167 | 142 | 125 | 114 | 42 | 33 | 15 | 10 | 2 | 0 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 178 | 177 | 78 | 207 | 174 | 253 | 87 | 59 | 134 | 19 | 33 | 106 | 200 | 203 | 212 | 225 | 66 | 35 | 166 | 79 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 195 | 76 | 67 | 249 | 182 | 136 | 105 | 246 | 124 | 38 | 20 | 70 | 101 | 107 | 55 | 30 | 253 | 174 | 238 | 227 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 241 | 44 | 147 | 42 | 29 | 64 | 169 | 252 | 45 | 200 | 47 | 255 | 62 | 183 | 98 | 37 | 48 | 72 | 60 | 244 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 254 | 178 | 236 | 104 | 227 | 36 | 76 | 9 | 171 | 151 | 1 | 252 | 45 | 238 | 126 | 107 | 91 | 93 | 172 | 123 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 194 | 215 | 40 | 247 | 113 | 249 | 184 | 173 | 126 | 179 | 211 | 182 | 148 | 190 | 21 | 132 | 142 | 25 | 238 | 228 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 203 | 211 | 242 | 48 | 255 | 4 | 31 | 149 | 24 | 90 | 72 | 121 | 87 | 210 | 13 | 237 | 220 | 73 | 51 | 205 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 13 | 5 | 8 | 2 | 39 | 207 | 219 | 120 | 41 | 101 | 89 | 62 | 145 | 158 | 232 | 3 | 244 | 37 | 145 | 111 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 11 | 2 | 0 | 3 | 13 | 13 | 14 | 7 | 103 | 210 | 229 | 13 | 116 | 97 | 163 | 74 | 159 | 131 | 136 | 23 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 7 | 13 | 9 | 0 | 3 | 12 | 0 | 5 | 7 | 1 | 10 | 12 | 223 | 45 | 159 | 33 | 213 | 181 | 176 | 137 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 101 | 57 | 63 | 193 | 12 | 11 | 13 | 13 | 4 | 8 | 1 | 7 | 7 | 6 | 12 | 15 | 75 | 182 | 173 | 199 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 65 | 66 | 67 | 68 | 69 | 70 | 71 | 72 | 73 | 74 | 75 | 76 | 77 | 78 | 79 | 80 | 81 | 82 | 83 | 84 |
| 1 | 124 | 92 | 248 | 72 | 103 | 143 | 10 | 59 | 184 | 67 | 38 | 107 | 179 | 37 | 58 | 92 | 142 | 216 | 17 | 147 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 15 | 3 | 14 | 13 | 210 | 9 | 89 | 215 | 75 | 236 | 118 | 57 | 125 | 218 | 52 | 35 | 121 | 216 | 250 | 214 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 5 | 14 | 15 | 2 | 90 | 119 | 5 | 30 | 192 | 245 | 38 | 17 | 198 | 186 | 92 | 226 | 105 | 189 | 249 | 209 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 5 | 13 | 3 | 13 | 60 | 163 | 187 | 93 | 96 | 50 | 44 | 25 | 38 | 215 | 113 | 147 | 148 | 193 | 100 | 163 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 72 | 154 | 174 | 3 | 123 | 27 | 140 | 235 | 91 | 148 | 67 | 128 | 98 | 245 | 119 | 220 | 219 | 252 | 184 | 56 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 172 | 211 | 130 | 47 | 205 | 201 | 252 | 176 | 77 | 110 | 172 | 186 | 204 | 186 | 105 | 190 | 8 | 165 | 53 | 119 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 158 | 119 | 216 | 148 | 254 | 120 | 149 | 203 | 137 | 137 | 139 | 16 | 120 | 162 | 153 | 215 | 30 | 170 | 103 | 188 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 19 | 73 | 90 | 234 | 194 | 78 | 23 | 17 | 139 | 136 | 135 | 85 | 103 | 226 | 108 | 49 | 59 | 225 | 252 | 232 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 230 | 134 | 58 | 239 | 10 | 80 | 48 | 129 | 23 | 245 | 110 | 220 | 208 | 254 | 55 | 155 | 212 | 15 | 133 | 34 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 151 | 29 | 49 | 66 | 181 | 254 | 233 | 119 | 84 | 45 | 149 | 33 | 228 | 185 | 197 | 148 | 218 | 27 | 222 | 25 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 219 | 124 | 103 | 126 | 223 | 194 | 196 | 201 | 45 | 7 | 31 | 184 | 45 | 30 | 25 | 174 | 168 | 240 | 112 | 85 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 10 | 74 | 129 | 31 | 112 | 41 | 141 | 63 | 31 | 27 | 101 | 100 | 4 | 65 | 42 | 118 | 128 | 103 | 206 | 178 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 131 | 225 | 185 | 56 | 197 | 149 | 74 | 248 | 230 | 211 | 64 | 58 | 190 | 151 | 101 | 124 | 102 | 253 | 133 | 20 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 85 | 86 | 87 | 88 | 89 | 90 | 91 | 92 | 93 | 94 | 95 | 96 | 97 | 98 | 99 | 100 | 101 | 102 | 103 | 104 |
| 1 | 204 | 251 | 74 | 41 | 236 | 155 | 208 | 41 | 141 | 160 | 88 | 202 | 146 | 197 | 59 | 59 | 50 | 151 | 4 | 96 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 216 | 188 | 203 | 18 | 207 | 133 | 144 | 24 | 104 | 130 | 208 | 253 | 36 | 197 | 3 | 179 | 18 | 159 | 173 | 242 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 104 | 107 | 247 | 203 | 235 | 233 | 61 | 60 | 220 | 168 | 153 | 144 | 115 | 71 | 29 | 54 | 21 | 80 | 7 | 131 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 198 | 183 | 146 | 143 | 242 | 250 | 67 | 63 | 19 | 35 | 1 | 125 | 38 | 160 | 174 | 88 | 103 | 122 | 149 | 44 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 13 | 244 | 85 | 189 | 78 | 158 | 15 | 177 | 5 | 155 | 72 | 197 | 41 | 138 | 152 | 253 | 227 | 205 | 57 | 191 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 102 | 162 | 34 | 204 | 130 | 78 | 127 | 248 | 113 | 247 | 2 | 41 | 223 | 178 | 226 | 101 | 135 | 125 | 112 | 100 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 182 | 122 | 168 | 157 | 36 | 44 | 80 | 199 | 205 | 54 | 255 | 232 | 153 | 166 | 150 | 62 | 67 | 225 | 26 | 253 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 153 | 131 | 150 | 126 | 83 | 30 | 36 | 242 | 133 | 251 | 128 | 61 | 150 | 135 | 33 | 120 | 191 | 186 | 8 | 233 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 100 | 183 | 182 | 2 | 191 | 169 | 232 | 119 | 35 | 149 | 124 | 26 | 236 | 81 | 96 | 28 | 130 | 150 | 133 | 246 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 128 | 35 | 18 | 136 | 34 | 225 | 197 | 201 | 158 | 194 | 233 | 198 | 169 | 230 | 228 | 232 | 103 | 169 | 84 | 204 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 79 | 130 | 177 | 6 | 175 | 38 | 222 | 166 | 228 | 73 | 11 | 50 | 113 | 99 | 105 | 69 | 7 | 105 | 196 | 170 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 45 | 188 | 6 | 31 | 71 | 229 | 235 | 38 | 30 | 62 | 30 | 117 | 199 | 203 | 169 | 163 | 63 | 189 | 179 | 5 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 117 | 237 | 224 | 21 | 76 | 210 | 148 | 207 | 213 | 200 | 156 | 72 | 59 | 117 | 8 | 186 | 142 | 232 | 129 | 5 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 105 | 106 | 107 | 108 | 109 | 110 | 111 | 112 | 113 | 114 | 115 | 116 | 117 | 118 | 119 | 120 | 121 | 122 | 123 | 124 |
| 1 | 133 | 196 | 108 | 56 | 151 | 120 | 218 | 157 | 87 | 58 | 203 | 96 | 17 | 160 | 24 | 38 | 125 | 255 | 55 | 62 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 1 | 94 | 22 | 91 | 144 | 126 | 124 | 29 | 246 | 6 | 245 | 236 | 185 | 62 | 134 | 38 | 166 | 16 | 22 | 244 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 138 | 82 | 130 | 42 | 61 | 50 | 194 | 102 | 42 | 22 | 202 | 128 | 118 | 125 | 234 | 251 | 253 | 142 | 247 | 94 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 127 | 122 | 53 | 72 | 46 | 109 | 17 | 188 | 164 | 42 | 126 | 168 | 214 | 226 | 193 | 234 | 90 | 58 | 203 | 37 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 196 | 146 | 136 | 157 | 120 | 163 | 147 | 54 | 166 | 195 | 73 | 83 | 36 | 129 | 222 | 206 | 76 | 22 | 29 | 236 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 141 | 81 | 5 | 126 | 253 | 8 | 88 | 110 | 232 | 131 | 169 | 226 | 227 | 50 | 145 | 8 | 235 | 167 | 30 | 253 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 116 | 250 | 122 | 108 | 213 | 210 | 19 | 130 | 201 | 140 | 25 | 138 | 30 | 35 | 196 | 71 | 75 | 57 | 147 | 176 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 4 | 103 | 35 | 87 | 200 | 199 | 217 | 81 | 46 | 28 | 137 | 149 | 175 | 60 | 115 | 244 | 176 | 153 | 125 | 144 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 240 | 93 | 142 | 163 | 121 | 78 | 250 | 214 | 219 | 94 | 51 | 172 | 235 | 160 | 114 | 90 | 4 | 224 | 103 | 159 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 5 | 95 | 249 | 154 | 124 | 0 | 236 | 252 | 75 | 15 | 66 | 229 | 72 | 35 | 196 | 75 | 234 | 17 | 217 | 133 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 62 | 146 | 251 | 232 | 67 | 236 | 24 | 159 | 236 | 127 | 84 | 10 | 135 | 221 | 91 | 99 | 79 | 193 | 112 | 116 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 127 | 111 | 194 | 234 | 198 | 190 | 227 | 44 | 154 | 30 | 46 | 76 | 85 | 79 | 152 | 3 | 170 | 4 | 73 | 24 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 233 | 225 | 255 | 102 | 68 | 52 | 241 | 15 | 159 | 105 | 13 | 109 | 135 | 126 | 253 | 191 | 251 | 134 | 17 | 187 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 125 | 126 | 127 | 128 | 129 | 130 | 131 | 132 | 133 | 134 | 135 | 136 | 137 | 138 | 139 | 140 | 141 | 142 | 143 | 144 |
| 1 | 190 | 82 | 17 | 61 | 116 | 227 | 79 | 97 | 150 | 205 | 95 | 115 | 60 | 173 | 183 | 52 | 122 | 94 | 146 | 41 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 207 | 67 | 176 | 34 | 100 | 83 | 4 | 46 | 54 | 52 | 145 | 238 | 249 | 49 | 185 | 230 | 150 | 49 | 161 | 217 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 39 | 33 | 12 | 217 | 195 | 151 | 195 | 253 | 181 | 138 | 41 | 122 | 86 | 35 | 86 | 178 | 14 | 107 | 59 | 208 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 79 | 247 | 140 | 25 | 233 | 180 | 203 | 127 | 67 | 230 | 137 | 222 | 188 | 30 | 186 | 183 | 153 | 191 | 74 | 212 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 159 | 69 | 128 | 231 | 229 | 33 | 202 | 197 | 10 | 167 | 221 | 172 | 94 | 96 | 136 | 103 | 130 | 195 | 9 | 244 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 45 | 62 | 23 | 118 | 30 | 61 | 235 | 56 | 148 | 148 | 180 | 134 | 206 | 92 | 152 | 182 | 70 | 6 | 74 | 145 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 29 | 171 | 144 | 244 | 109 | 73 | 160 | 165 | 43 | 182 | 142 | 216 | 100 | 24 | 174 | 34 | 180 | 230 | 115 | 113 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 119 | 211 | 132 | 16 | 67 | 42 | 86 | 228 | 112 | 203 | 146 | 89 | 196 | 3 | 255 | 114 | 128 | 171 | 214 | 168 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 249 | 95 | 97 | 7 | 175 | 119 | 250 | 232 | 246 | 122 | 122 | 4 | 66 | 119 | 251 | 227 | 55 | 138 | 1 | 41 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 247 | 8 | 206 | 170 | 111 | 161 | 129 | 55 | 67 | 180 | 106 | 158 | 109 | 150 | 112 | 71 | 17 | 39 | 24 | 19 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 242 | 122 | 207 | 253 | 32 | 44 | 100 | 234 | 218 | 115 | 162 | 124 | 152 | 124 | 112 | 107 | 211 | 129 | 177 | 127 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 16 | 25 | 249 | 54 | 61 | 194 | 159 | 37 | 120 | 19 | 217 | 12 | 43 | 113 | 211 | 80 | 4 | 84 | 45 | 187 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 140 | 113 | 104 | 120 | 187 | 120 | 199 | 90 | 246 | 215 | 225 | 124 | 159 | 0 | 102 | 110 | 70 | 144 | 151 | 46 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 145 | 146 | 147 | 148 | 149 | 150 | 151 | 152 | 153 | 154 | 155 | 156 | 157 | 158 | 159 | 160 | 161 | 162 | 163 | 164 |
| 1 | 237 | 226 | 134 | 124 | 30 | 170 | 57 | 250 | 39 | 223 | 90 | 48 | 123 | 2 | 70 | 0 | 225 | 55 | 159 | 229 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 148 | 241 | 89 | 90 | 184 | 120 | 144 | 161 | 1 | 43 | 185 | 137 | 101 | 139 | 78 | 109 | 163 | 216 | 29 | 7 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 223 | 38 | 106 | 168 | 183 | 222 | 226 | 227 | 191 | 247 | 81 | 126 | 96 | 92 | 161 | 83 | 117 | 74 | 52 | 53 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 121 | 34 | 188 | 130 | 79 | 126 | 232 | 53 | 225 | 0 | 216 | 191 | 136 | 224 | 51 | 50 | 118 | 61 | 22 | 218 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 241 | 117 | 96 | 150 | 243 | 246 | 222 | 87 | 78 | 19 | 159 | 67 | 58 | 180 | 113 | 213 | 208 | 121 | 75 | 123 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 118 | 78 | 102 | 111 | 216 | 29 | 52 | 66 | 24 | 213 | 184 | 160 | 98 | 48 | 167 | 72 | 252 | 172 | 95 | 237 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 210 | 199 | 233 | 175 | 87 | 130 | 124 | 211 | 146 | 107 | 236 | 193 | 207 | 96 | 94 | 82 | 248 | 159 | 188 | 83 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 41 | 89 | 119 | 5 | 31 | 201 | 183 | 118 | 130 | 220 | 179 | 109 | 87 | 66 | 200 | 176 | 136 | 238 | 64 | 131 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 204 | 197 | 54 | 144 | 194 | 107 | 27 | 52 | 130 | 49 | 205 | 252 | 241 | 169 | 11 | 180 | 57 | 81 | 102 | 85 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 115 | 41 | 130 | 24 | 223 | 235 | 116 | 151 | 58 | 94 | 216 | 83 | 179 | 116 | 212 | 143 | 59 | 128 | 207 | 158 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 101 | 93 | 65 | 44 | 113 | 142 | 164 | 108 | 79 | 186 | 147 | 161 | 6 | 100 | 99 | 127 | 204 | 206 | 27 | 249 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 115 | 112 | 28 | 39 | 81 | 132 | 53 | 249 | 202 | 238 | 50 | 97 | 236 | 241 | 163 | 77 | 85 | 129 | 8 | 160 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 26 | 117 | 120 | 148 | 98 | 82 | 255 | 82 | 251 | 2 | 60 | 51 | 237 | 245 | 201 | 233 | 251 | 183 | 144 | 121 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |
| | 165 | 166 | 167 | 168 | 169 | 170 | 171 | 172 | 173 | 174 | 175 | 176 | 177 | 178 | 179 | 180 | 181 | 182 | 183 | 184 |
| 1 | 94 | 209 | 107 | 224 | 96 | 45 | 24 | 39 | 41 | 0 | 8 | 247 | 226 | 248 | 132 | 230 | 149 | 78 | 205 | 2 |
| 2 | 0 | 0 | 0 | 0 | 0 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 | 0 | 0 | 0 | 0 | 0 | 0 | 0 | 0 |
| 5 | 42 | 194 | 227 | 173 | 63 | 3 | 105 | 153 | 27 | 78 | 198 | 126 | 223 | 95 | 132 | 153 | 58 | 208 | 43 | 197 |
| 6 | 0 | 0 | 0 | 0 | 0 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 | 0 | 0 | 0 | 0 | 0 | 0 | 0 | 0 |
| 9 | 71 | 167 | 101 | 83 | 130 | 148 | 159 | 157 | 106 | 181 | 115 | 142 | 246 | 183 | 247 | 85 | 20 | 66 | 212 | 30 |
| 10 | 0 | 0 | 0 | 0 | 0 | 0 | 0 | 0 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 | 0 | 0 | 0 | 0 | 0 | 0 | 0 | 0 |
| 13 | 244 | 14 | 99 | 156 | 43 | 33 | 226 | 172 | 122 | 251 | 19 | 129 | 132 | 128 | 90 | 146 | 59 | 15 | 70 | 47 |
| 14 | 0 | 0 | 0 | 0 | 0 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 | 0 | 0 | 0 | 0 | 0 |
| 17 | 239 | 149 | 21 | 38 | 199 | 90 | 189 | 95 | 3 | 69 | 227 | 229 | 241 | 165 | 194 | 201 | 102 | 32 | 196 | 79 |
| 18 | 0 | 0 | 0 | 0 | 0 | 0 | 0 | 0 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 | 0 | 0 | 0 | 0 | 0 |
| 21 | 12 | 6 | 158 | 36 | 173 | 58 | 148 | 90 | 85 | 48 | 161 | 175 | 192 | 99 | 124 | 144 | 101 | 49 | 59 | 191 |
| 22 | 0 | 0 | 0 | 0 | 0 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 | 0 | 0 | 0 | 0 | 0 |
| 25 | 255 | 33 | 253 | 196 | 140 | 198 | 192 | 239 | 157 | 183 | 47 | 69 | 0 | 0 | 0 | 0 | 1 | 69 | 157 | 188 |
| 26 | 0 | 0 | 0 | 0 | 0 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 | 0 | 0 | 0 | 0 | 0 |
| 29 | 154 | 109 | 88 | 220 | 240 | 62 | 133 | 183 | 189 | 86 | 205 | 181 | 0 | 0 | 0 | 0 | 0 | 0 | 0 | 0 |
| 30 | 0 | 0 | 0 | 0 | 0 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 | 0 | 0 | 0 | 0 | 0 |
| 33 | 59 | 248 | 205 | 152 | 197 | 219 | 22 | 15 | 218 | 247 | 223 | 216 | 0 | 0 | 0 | 0 | 0 | 0 | 0 | 0 |
| 34 | 0 | 0 | 0 | 0 | 0 | 0 | 0 | 0 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 | 0 | 0 | 0 | 0 | 0 |
| 37 | 59 | 19 | 42 | 17 | 95 | 46 | 29 | 241 | 225 | 178 | 61 | 90 | 0 | 0 | 0 | 0 | 0 | 0 | 0 | 0 |
| 38 | 0 | 0 | 0 | 0 | 0 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 | 0 | 0 | 0 | 0 | 0 | 0 | 0 | 0 |
| 41 | 152 | 12 | 64 | 252 | 247 | 24 | 4 | 247 | 248 | 182 | 51 | 75 | 0 | 0 | 0 | 0 | 0 | 0 | 0 | 0 |
| 42 | 0 | 0 | 0 | 0 | 0 | 0 | 0 | 0 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 | 0 | 0 | 0 | 0 | 0 |
| 45 | 128 | 167 | 18 | 167 | 42 | 191 | 210 | 129 | 117 | 98 | 101 | 31 | 0 | 0 | 0 | 0 | 0 | 0 | 0 | 13 |
| 46 | 0 | 0 | 0 | 0 | 0 | 0 | 0 | 0 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 | 0 | 0 | 0 | 0 | 0 | 0 | 0 | 0 |
| 49 | 252 | 121 | 239 | 22 | 48 | 225 | 181 | 15 | 209 | 80 | 95 | 56 | 0 | 0 | 0 | 248 | 143 | 190 | 69 | 122 |
| 50 | 0 | 0 | 0 | 0 | 0 | 0 | 0 | 0 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 0 | 0 | 0 | 0 | 0 | 0 | 0 | 0 |

| | 185 | 186 | 187 | 188 | 189 | 190 | 191 | 192 | 193 | 194 | 195 | 196 |
|---|---|---|---|---|---|---|---|---|---|---|---|---|
| 1 | 170 | 66 | 243 | 0 | 0 | 0 | 0 | 0 | 0 | 0 | 0 | 0 |
| 2 | 0 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 | 0 |
| 5 | 85 | 101 | 138 | 0 | 0 | 0 | 0 | 0 | 0 | 0 | 0 | 0 |
| 6 | 0 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 | 0 |
| 9 | 106 | 86 | 185 | 0 | 0 | 0 | 0 | 0 | 0 | 0 | 0 | 0 |
| 10 | 0 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 | 0 |
| 13 | 42 | 230 | 107 | 0 | 0 | 0 | 0 | 0 | 0 | 0 | 0 | 0 |
| 14 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 |
| 17 | 33 | 42 | 23 | 0 | 0 | 0 | 0 | 0 | 0 | 0 | 0 | 0 |
| 18 | 0 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 |
| 21 | 212 | 98 | 186 | 0 | 0 | 0 | 0 | 0 | 0 | 0 | 0 | 0 |
| 22 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 |
| 25 | 105 | 194 | 160 | 9 | 13 | 3 | 10 | 0 | 0 | 0 | 0 | 0 |
| 26 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 |
| 29 | 95 | 247 | 157 | 14 | 13 | 14 | 4 | 11 | 15 | 15 | 14 | 0 |
| 30 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 |
| 33 | 0 | 0 | 0 | 0 | 15 | 2 | 15 | 11 | 10 | 1 | 14 | 2 |
| 34 | 0 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 |
| 37 | 0 | 0 | 0 | 0 | 0 | 0 | 0 | 0 | 15 | 2 | 10 | 2 |
| 38 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 | 0 |
| 41 | 0 | 0 | 0 | 0 | 0 | 0 | 0 | 0 | 0 | 0 | 0 | 0 |
| 42 | 0 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 |
| 45 | 236 | 64 | 77 | 0 | 0 | 0 | 0 | 0 | 0 | 0 | 0 | 0 |
| 46 | 0 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 | 0 |
| 49 | 240 | 135 | 251 | 0 | 0 | 0 | 0 | 0 | 0 | 0 | 0 | 0 |
| 50 | 0 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 |

| | 197 | 198 | 199 | 200 | 201 | 202 | 203 | 204 | 205 | 206 | 207 |
|---|---|---|---|---|---|---|---|---|---|---|---|
| 1 | 0 | 0 | 0 | 0 | 0 | 0 | 0 | 0 | 0 | 0 | 0 |
| 2 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 |
| 4 | 0 | 0 | 0 | 0 | 0 | 0 | 0 | 0 | 0 | 0 | 0 |
| 5 | 0 | 0 | 0 | 0 | 0 | 0 | 0 | 0 | 0 | 0 | 0 |
| 6 | 0 | 0 | 0 | 0 | 0 | 0 | 0 | 0 | 0 | 0 | 0 |
| 7 | 0 | 0 | 0 | 0 | 0 | 0 | 0 | 0 | 0 | 0 | 0 |
| 8 | 0 | 0 | 0 | 0 | 0 | 0 | 0 | 0 | 0 | 0 | 0 |
| 9 | 0 | 0 | 0 | 0 | 0 | 0 | 0 | 0 | 0 | 0 | 0 |
| 10 | 0 | 0 | 0 | 0 | 0 | 0 | 0 | 0 | 0 | 0 | 0 |
| 11 | 0 | 0 | 0 | 0 | 0 | 0 | 0 | 0 | 0 | 0 | 0 |
| 12 | 0 | 0 | 0 | 0 | 0 | 0 | 0 | 0 | 0 | 0 | 0 |
| 13 | 0 | 0 | 0 | 0 | 0 | 0 | 0 | 0 | 0 | 0 | 0 |
| 14 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 |
| 17 | 0 | 0 | 0 | 0 | 0 | 0 | 0 | 0 | 0 | 0 | 0 |
| 18 | 0 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 |
| 21 | 0 | 0 | 0 | 0 | 0 | 0 | 0 | 0 | 0 | 0 | 0 |
| 22 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 |
| 25 | 0 | 0 | 0 | 0 | 0 | 0 | 0 | 0 | 0 | 0 | 0 |
| 26 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 |
| 29 | 0 | 0 | 0 | 0 | 0 | 0 | 0 | 0 | 0 | 0 | 0 |
| 30 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 |
| 33 | 10 | 4 | 4 | 0 | 0 | 0 | 0 | 0 | 0 | 0 | 0 |
| 34 | 0 | 0 | 0 | 0 | 0 | 0 | 0 | 0 | 0 | 0 | 0 |
| 35 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 |
| 37 | 1 | 10 | 0 | 2 | 5 | 13 | 249 | 0 | 0 | 0 | 0 |
| 38 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 |
| 40 | 0 | 0 | 0 | 0 | 0 | 0 | 0 | 0 | 0 | 0 | 0 |
| 41 | 3 | 9 | 12 | 12 | 14 | 11 | 12 | 11 | 5 | 251 | 23 |
| 42 | 0 | 0 | 0 | 0 | 0 | 0 | 0 | 0 | 0 | 0 | 0 |
| 43 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 |
| 45 | 0 | 0 | 0 | 0 | 3 | 2 | 12 | 9 | 7 | 3 | 11 |
| 46 | 0 | 0 | 0 | 0 | 0 | 0 | 0 | 0 | 0 | 0 | 0 |
| 47 | 0 | 0 | 0 | 0 | 0 | 0 | 0 | 0 | 0 | 0 | 0 |
| 48 | 0 | 0 | 0 | 0 | 0 | 0 | 0 | 0 | 0 | 0 | 0 |
| 49 | 0 | 0 | 0 | 0 | 0 | 0 | 0 | 0 | 9 | 10 | 3 |
| 50 | 0 | 0 | 0 | 0 | 0 | 0 | 0 | 0 | 0 | 0 | 0 |
| 51 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 |

SRS Signaling

When the Burst SRS Bytes are present, the VFIP packet shall be extended as defined below.

Turbo Stream

Introduction

The turbo stream is expected to be used in combination with SRS. The turbo stream is tolerant of severe signal distortion, enough to support the handheld and mobile broadcasting services. The robust performance is achieved by additional forward error corrections and an outer interleaver (bit-by-bit interleaving), which offers additional time-diversity.

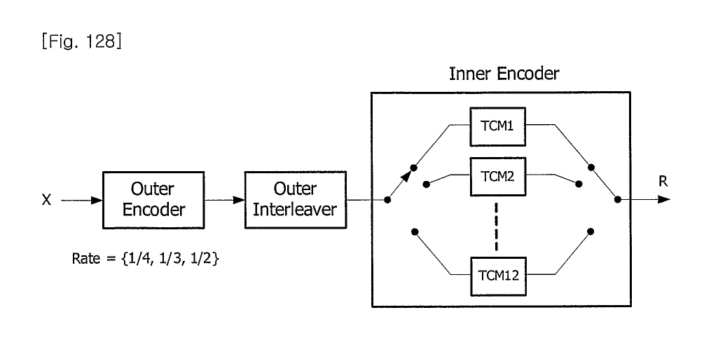

The simplified functional A-VSB turbo stream encoding block diagram is shown in FIG. 128. The turbo stream data is encoded in the outer encoder and bit-wise-interleaved in the outer interleaver. The coding rate in the outer encoder can be selectable among {¼, ⅓, ½} rates. Then, the interleaved data is fed to the inner encoder, which has an A/53 byte interleaver for the (12) TCM encoders input, and a A/53 byte de-interleaver at outputs. The byte (de-)interleaver operation is defined in ATSC Standard A/53 Part 2.

Since the outer encoder is concatenated to the inner encoder through the outer interleaver, an iteratively decodable serial turbo stream encoder is implemented. This scheme is unique and ATSC specific in the sense that the inner encoder is already a part of the 8-VSB system. By virtue of the A-VSB core element DF and by placing robust bytes in defined locations in TS packets (cross layer mapping techniques) the normal ATSC inner encoder is deterministically time division multiplexed (TDM) to carry normal or robust symbols. This cross layer approach enables an A-VSB receiver to perform a partial reception technique by identifying the robust symbols at the physical layer and demodulating just the robust symbols that the receiver needs and ignoring all normal symbols. All normal ATSC receivers continue to treat all symbols as normal symbols and thus ensure backward compatibility.

This cross layer TDM technique eliminates the need for a separate inner encoder to realize an ATSC turbo encoder. This design enables a significant bit savings by sharing (TDM) the existing ATSC inner encoder at the physical layer as part of the new A-VSB turbo encoder. Other designs that totally de-couple the new proposed turbo encoder from the 8-VSB physical layer will offer no opportunity for bit efficiency in encoding since two (2) new encoders must be introduced. The partial reception capability will also have benefits when used as part of a power saving scheme for battery powered receivers. Only two blocks (the outer encoder and the outer interleaver) are newly introduced in the A-VSB turbo stream encoder.

System Overview

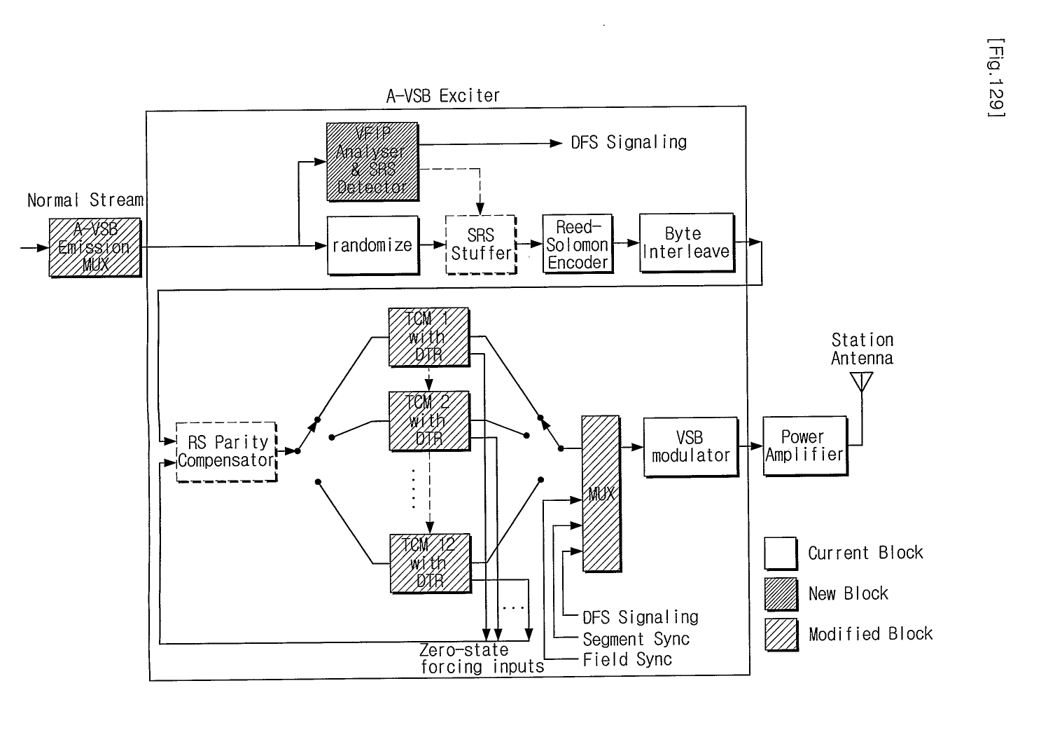

The A-VSB transmitter for the turbo stream includes the A-VSB multiplexer (Mux) and exciter as shown in FIG. 129. The turbo coding process is done in the A-VSB Mux and then the coded stream is delivered to the A-VSB exciter.

The A-VSB MUX receives a normal stream and turbo stream(s). In the A-VSB Mux, each Turbo stream is randomized, RS-encoded, time interleaved, outer-encoded, outer-interleaved and is encapsulated in the adaptation field of the normal stream.

There is no extra processing needed in the A-VSB exciter for the turbo stream. The A-VSB exciter is the same as that of a normal ATSC A/53 exciter except for DFS signaling and deterministic framing. The A-VSB exciter is a synchronous slave of the A-VSB multiplexer. Hence, no added complexity is spread into the network for the turbo stream, as all turbo processing is in one central location in the A-VSB multiplexer. In the A-VSB exciter, an ATSC A/53 randomizer drops sync bytes of TS packets from an A-VSB Mux and randomizes them. The SRS stuffer and parity compensator are active only when the SRS is used. The use of the SRS with the turbo stream is considered later. After being encoded in (207, 187) Reed-Solomon code, MPEG data streams are byte-interleaved. The byte interleaved data are then encoded by the TCM encoders.

An A-VSB multiplexer shall notify the corresponding exciter of some information (DFS signaling) via VSB Frame Initialization Packet (VSIP) and/or SRS-byte placeholders when the SRS is used. Since the SRS-bytes placeholders serve no useful purpose between the A-VSB multiplexer and an exciter and will be discarded and replaced by pre-calculated SRS bytes in the exciter, the SRS-bytes placeholders can be used to create a high speed data channel to deliver A-VSB signaling and other data to the transmitter site. This information shall be conveyed to a receiver through the reserved space in the data field sync. The other information shall be delivered to a receiver though a signaling information channel (SIC), which is a sort of turbo stream dedicated for signaling.

A-VSB Multiplexer for Turbo Stream

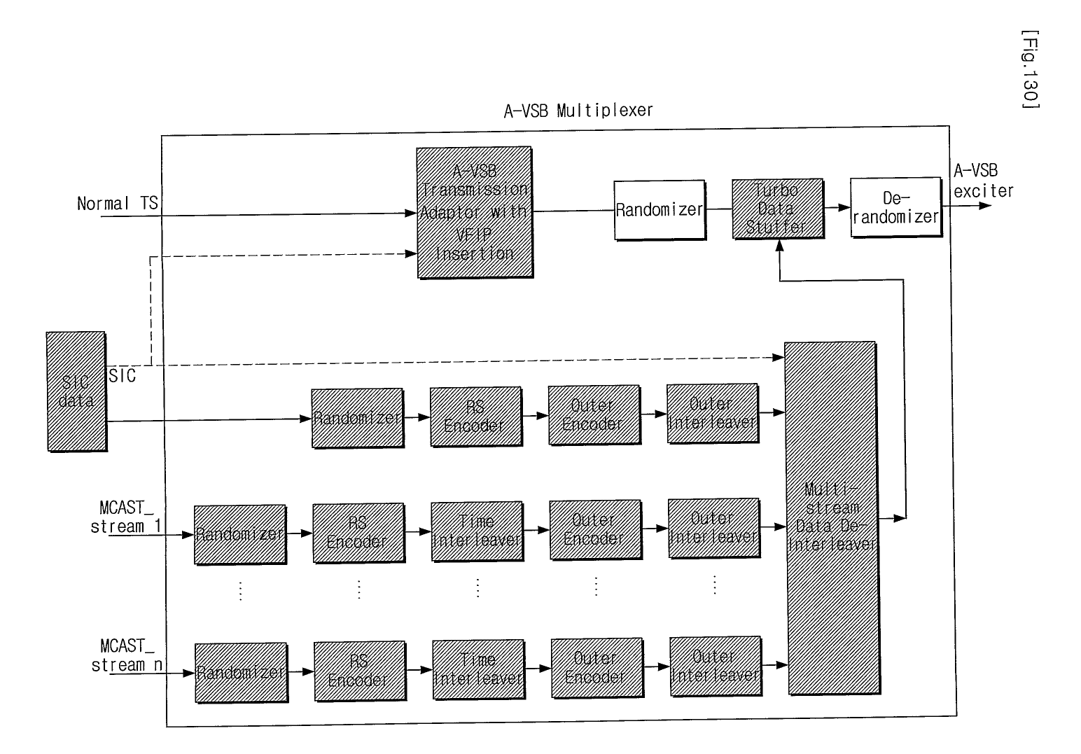

An A-VSB multiplexer for turbo stream is shown in FIG. 130. Referring to FIG. 130, the A-VSB multiplexer for turbo streams includes a transmission adaptor (TA), a randomizer, an RS encoder, a time interleaver, an outer encoder, an outer interleaver, a multi-stream data de-interleaver, and a turbo-packet stuffer. An A-VSB transmission adaptor recovers all elementary streams from the normal TS and re-packetizes all elementary streams with adaptation fields in every 4th packets, which serves as turbo stream packet placeholders.

At first, the MCAST packets are randomized, RS-encoded and time-interleaved. Then, the time-interleaved data are expanded by the outer-encoder with a selected code rate and outer-interleaved. The multi-stream data de-interleaver provides a sort of ATSC A/53 data de-interleaving function for multi-stream data. The turbo data stuffer simply puts the de-interleaved multi-stream data into the AF of A/53 randomized TA output packets. After A/53 de-randomization, the output of turbo data stuffer results in the output of the A-VSB multiplexer.

A-VSB Transmission Adaptor (TA)

A transmission adaptor (TA) recovers all elementary streams from the normal TS and re-packetizes them with adaptation fields to be used for placeholders of the SRS, the SIC, and the turbo-coded MCAST stream. The exact behavior of the TA depends on the chosen sliver template.

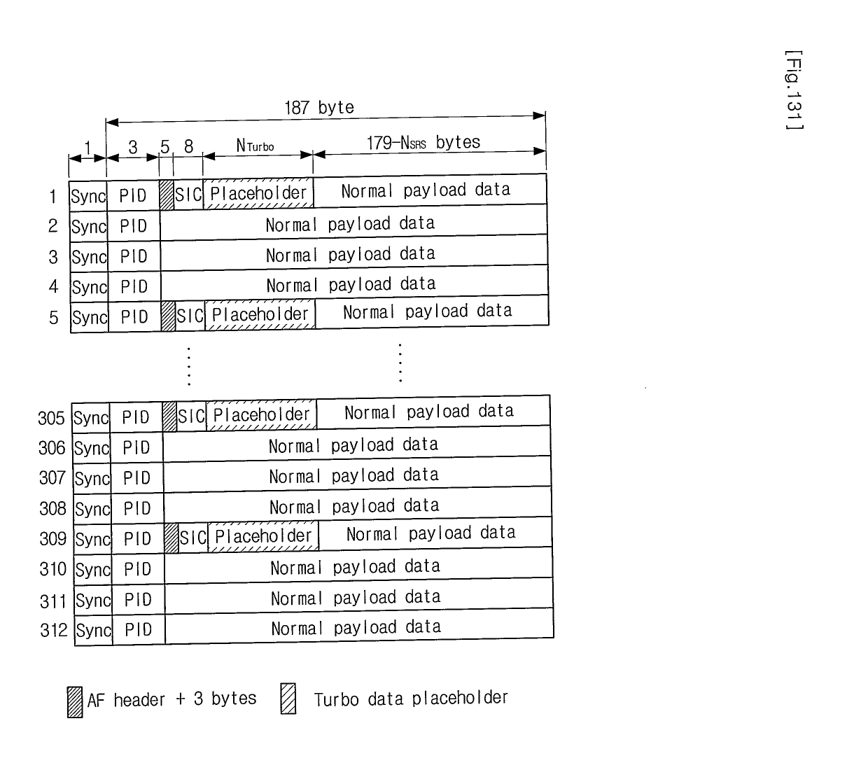

FIG. 131 shows a snapshot of the TA output with the adaptation field placed in every 4th packet. Since 1 package contains 312 packets, there are 78 packets that are forced to have the AF for turbo data placeholders. The amount of space depends on the number of turbo streams and the data rate of each turbo stream. This information is provided by SIC data.

Sliver Template for Turbo Stream

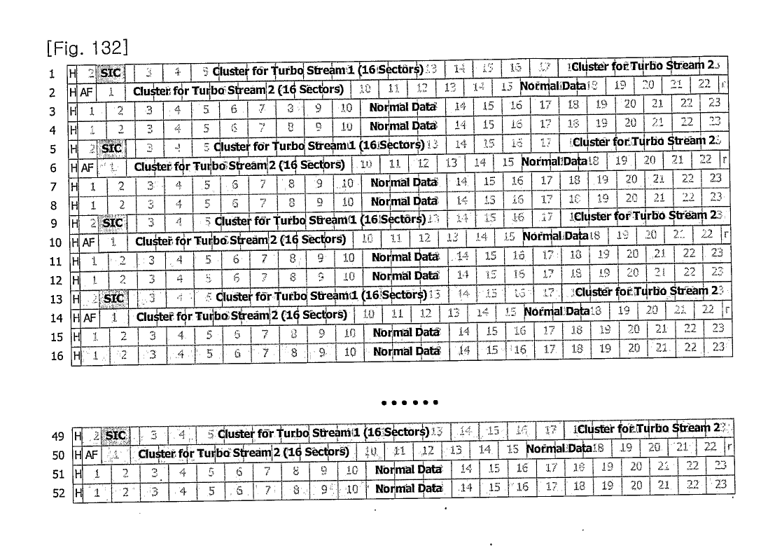

FIG. 132 shows an example of a sliver template for two (2) turbo streams, the clusters of which have 16 sectors. A cluster is defined as a multiple of 4 sectors (32 bytes). Each turbo stream occupies a cluster of a {1, 2, 3, 4} multiples of 4 sectors (32 bytes). The cluster size determines the normal TS overhead for the turbo stream. An outer encoder code rate {¼, ⅓, ½} determines the turbo stream data rate with a cluster size. When an MPEG data packet is entirely dedicated for A-VSB data (turbo stream and SRS), a null packet, A/90 data packet, or a packet with a newly defined PID is used to save 2 bytes of AF header and 3 bytes private field overhead.

Table 32 below summarizes the turbo stream modes which are defined from a VSB cluster size and a code rate. The cluster size for turbo streams (N_{Tstream}) is 4 sectors (32 bytes)*M and determines the normal TS payload loss. For example, when M=4 or equivalently N_{Tstream}=16 sectors(128 bytes), normal TS loss is:

$$\frac{128 \cdot ( 312 / 4 ) \cdot 8 ( bits )}{24 \cdot 2 ( ms )} 3.30 Mbps .$$

In Table 32 there are nine (9) turbo stream data rates defined by an outer encoder code rate and a cluster size. The combination of these two parameters is confined to three (3) code rates (½, ⅓, ¼) and four adaptation field lengths (N_{Tstream}): 4(32), 8(64), 12(96), and 16(128) sectors (bytes). This results in 12 effective turbo stream modes. Including the mode where the turbo stream is switched off, there are 13 different modes. The first byte of a turbo stream packet will be synchronized to the first byte in the first cluster in every package. The number of encapsulated turbo TS packets in a package (312 MPEG data packets) is the “# of MCAST packets in package” in Table 32 and denoted as N_{TP}.

Similar to the deterministic sliver for the burst SRS, several pieces of information (such as PCR etc.) have to be delivered through the adaptation field along with the turbo stream data. In the case of SRS, there are 4 fixed packet slots for constraint-free packets. On the contrary, the deterministic sliver for turbo stream allows for more degree of freedom for constraint-free packets because any packet carrying no turbo stream bytes can be any form of packets. However, a turbo stream sliver together with the burst SRS has the same constraints as an SRS sliver.

The parameters for turbo stream decoding shall be known to a receiver by the DFS and SIC signaling schemes. They are the code rate, the cluster position and size in a sliver for each turbo stream.

The optional turbo stream choices are tabulated in Table 33 below. They provide higher data rates than those in Table 32. Since they require more memory and higher processing speed to receivers, their implementation will be confirmed later.

TABLE 32
Normal TS Loss by Turbo TS Rate and Code Rate

| # of | | | | |
|---|---|---|---|---|
| MCAST | | | | |
| packets | Turbo TS | | | |
| in package | Rate | (Normal TS Loss in kbps, Occupied Sectors) | | |
| (N_{TP}) | (kbps) | ½ | ⅓ | 1/4 |
| 3 | 186.45 | | | (825.12, 4) |
| 4 | 248.60 | | (825.12, 4) | |
| 6 | 372.89 | (825.12, 4) | | (1,650.25, 8) |
| 8 | 497.19 | | (1,650.25, 8) | |
| 9 | 559.34 | | | (2,475.37, 12) |
| 12 | 745.79 | (1,650.25, 8) | (2,475.37, 12) | (3,300.50, 16) |
| 16 | 994.38 | | (3,300.50, 16) | |
| 18 | 1,118.68 | (2,475.37, 12) | | |
| 24 | 1,491.57 | (3,300.50, 16) | | |

TABLE 33
Optional Turbo Stream Modes

| # of | | | | |
|---|---|---|---|---|
| MCAST | Turbo | | | |
| packets | TS | | | |
| in package | Rate | (Normal TS Loss in kbps, Occupied Sectors) | | |
| (N_{TP}) | (kbps) | ½ | ⅓ | ¼ |
| 24 | 1,491.57 | | | (6,600.99, 32) |
| 32 | 1,988.76 | | (6,600.99, 32) | |
| 33 | 2,050.91 | | | (9,076.36, 44) |
| 44 | 2,734.55 | | (9,076.36, 44) | |
| 48 | 2,983.14 | (6,600.99, 32) | | |
| 66 | 4,101.82 | (9,076.36, 44) | | |

MCAST Service Multiplexer

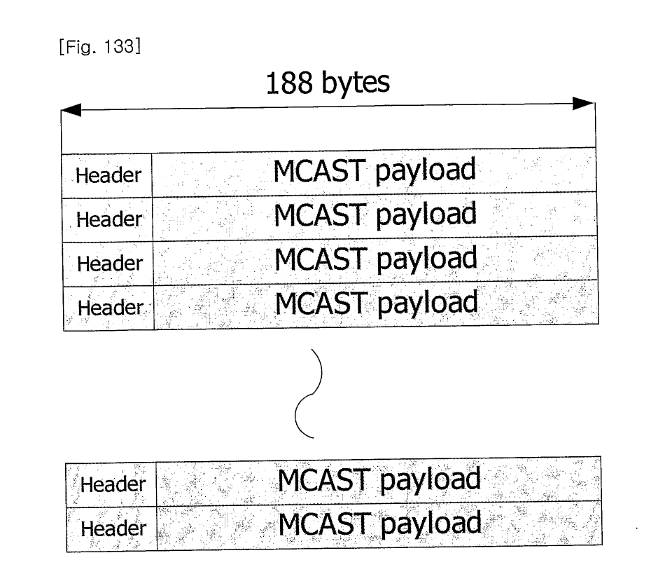

The MCAST service multiplexer block multiplexes the encapsulated A/V stream, IP stream, and/or objects. FIG. 133 shows a snapshot of its output stream that is the output of the transport layer and the input to the link layer. A MCAST packet has 188 bytes of length and its detail syntax is defined in MCAST document.

Randomizer

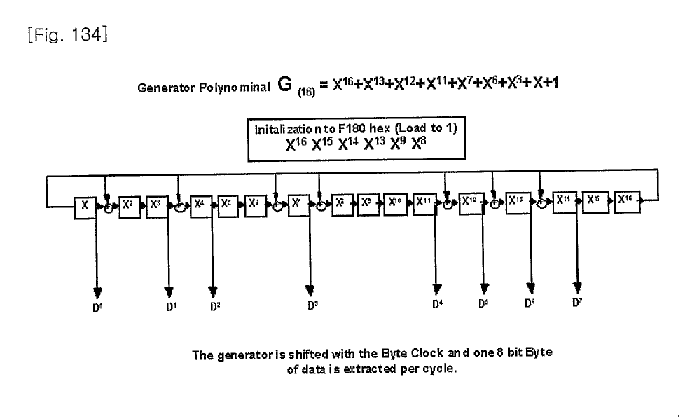

The randomizer is the same as that defined in A/53 Part 2, which is shown in FIG. 134. This randomizer shall be initialized just before the first byte of each turbo message block. The turbo message block is defined by the number of MCAST packets (N_{TP}) incorporated in a package. The number N_{TP} is tabulated in Table 32 above. For example, when a turbo stream has the code rate of ⅓ and the cluster size of 8 sectors, the turbo message block is 8 MCAST packets and 188 bytes×8=1504 bytes. Accordingly, whenever each 1504 bytes starts, the randomizer shall be initialized. This block of 1504 bytes is synchronized to packages. However, the turbo message block for the SIC is fixed to 188 bytes and this block is synchronized to parcels.

Reed-Solomon Encoder

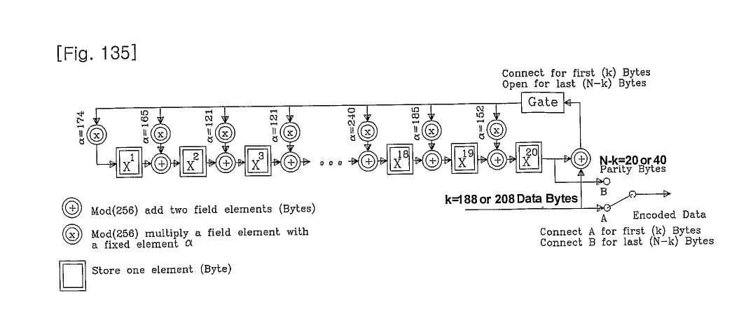

The MCAST stream is encoded with the systematic RS code which is a t=10 (208,188) code or a t=20 (208,168) code and the SIC is encoded with the systematic RS code which is a t=10 (208,188) code. For (208,188) RS code and (208,168) RS code, 20 RS parity bytes or 40 RS parity bytes are added for error correction, respectively. The generator polynomial is the same one as that defined in ATSC/A53 part 2. In creating bytes from the serial bit stream, the MSB shall be the first serial bit. The encoder structure is shown in FIG. 135.

Time Interleaver

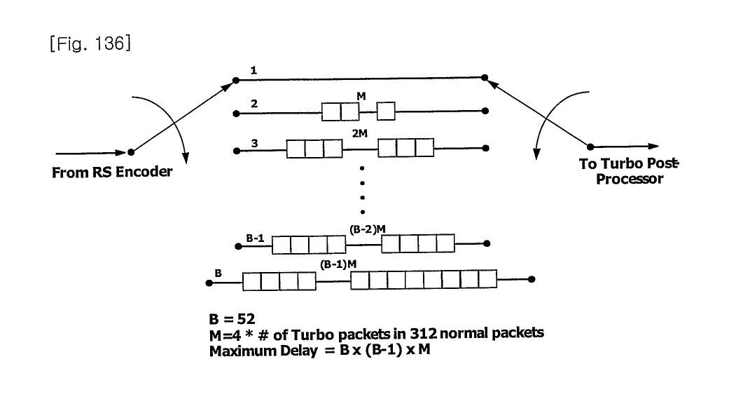

The time interleaver shown in FIG. 136 is a type of the convolutional byte interleaver. The number of branches (B) is fixed to 52 while the basic memory size (M) varies by the number of MCAST packets delivered in a package in order that the maximum interleaving depth is constant regardless of the number of MCAST packets contained in every package.

The maximum delay is B×(B−1)×M. Given the number of MCAST packets (NTP) per package and the basic memory size (M) equal to NTP*4, the maximum delay becomes B×(B−1)×M=51×208×NTP bytes. Since 208×NTP bytes are transmitted in each field, the bytes of a MCAST packet are distributed over 51 fields in all turbo stream transmission rates, which corresponds to 1.14 second of the interleaving depth.

The time Interleaver shall be synchronized to the first byte of the data field. Table 34 shows the basic memory size for the number of MCAST packets contained 312 normal packets.

TABLE 34
Basic Memory Size in Time Interleaver (*optional)

| | # of MCAST | Basic | Maximum | |
|---|---|---|---|---|
| Data rate | Packets | Memory | delay | Interleaving |
| (Kbps) | per package (NT) | size (M) | in bytes | depth in field |
| 186.5 | 3 | 12 | 31824 | 51 |
| 248.6 | 4 | 16 | 42432 | 51 |
| 372.9 | 6 | 24 | 63648 | 51 |
| 497.2 | 8 | 32 | 84864 | 51 |
| 559.4 | 9 | 36 | 95472 | 51 |
| 745.9 | 12 | 48 | 127296 | 51 |
| 994.5 | 16 | 64 | 169728 | 51 |
| 1118.0 | 18 | 72 | 190944 | 51 |
| 1491.0 | 24 | 96 | 254592 | 51 |
| 1988.8 | 32* | 128 | 339456 | 51 |
| 2050.9 | 33* | 132 | 350064 | 51 |
| 2734.6 | 44* | 176 | 466752 | 51 |
| 2983.1 | 48* | 192 | 509184 | 51 |
| 4101.8 | 66* | 264 | 700128 | 51 |

For the burst transmission, the delay induced by the time interleaver is preferred to be limited within a burst. Accordingly, the time interleaver can be optionally modified as follows. This modification shall be signaled via the SIC.

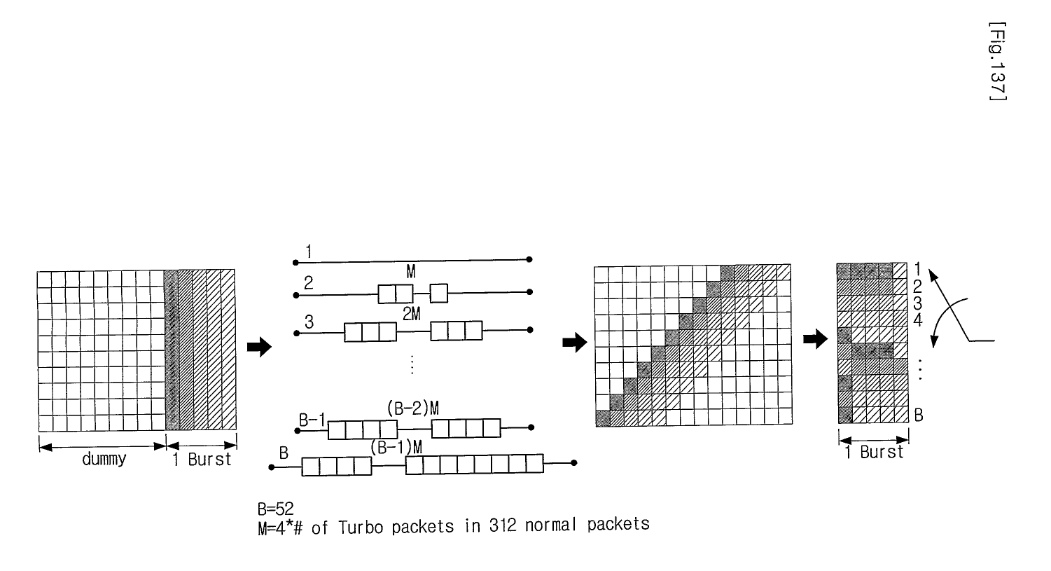

FIG. 137 shows basic idea for the modification. In order to have the burst data get out of the time interleaver, dummy bytes are appended to the end of each burst data. Then, at the output of the time interleaver, dummy bytes and initial interleaver memory contents are discarded. Thus, interleaved burst data is obtained.

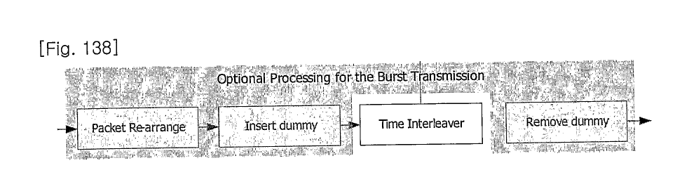

FIG. 138 depicts the optional processing steps in the burst transmission. First of all, packets are arranged for the burst transmission. This procedure is detailed in the power management section in the MCAST document. Then the dummy bytes are appended. After time interleaving, the data are collected while discarding the dummy bytes.

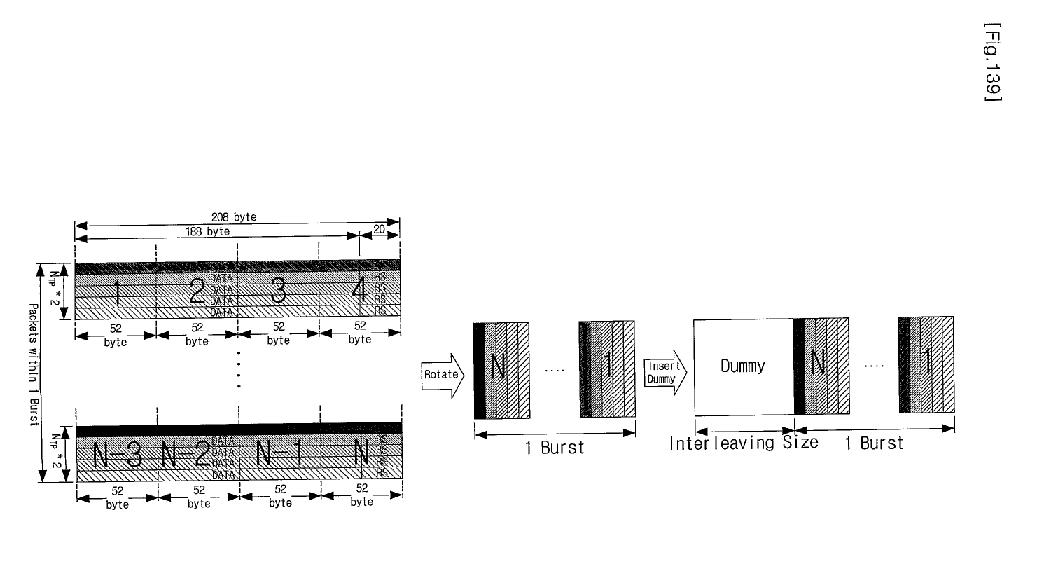

FIG. 139 shows how to process the packets for the time interleaver in more detail. One burst constitutes N numbers of (52 bytes×N_{TP}×2) data where N_{TP} is the number of MCAST packets per package. Then each (52 bytes×N_{TP}×2) data is rotated for the burst transmission. Finally, the dummy bytes are appended to have one burst data get out of the interleaver. Accordingly, the number of dummy bytes shall be (52 bytes×the interleaving size) bytes.

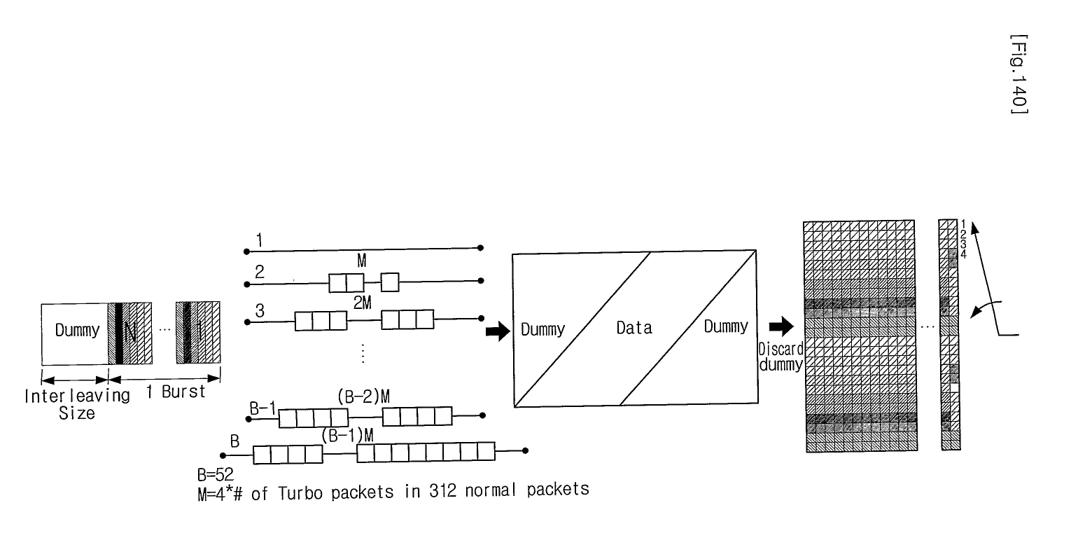

FIG. 140 explains how to process the interleaver output. From the nature of the convolutional interleaver, the data is arranged in the shape of a parallelogram at the output. In the sequel, one burst of data is collected while discarding the dummy bytes and the initial interleaver memory contents.

The net result of this additional processing is the interleaving within a burst delay, which is desirable in the burst transmission. Otherwise, the inter-burst interleaving results which causes an unacceptably long system latency.

Outer Encoder

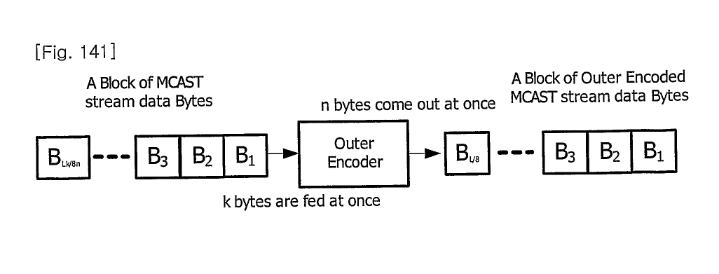

The outer encoder in the turbo processor is depicted in FIG. 141. Referring to FIG. 141, the outer encoder receives a block of MCAST stream data bytes (L/8 bytes=L bits) and produces a block of outer encoded MCAST stream data bytes. The outer encoder operates on a byte basis. Accordingly, k bytes enter the outer encoder and n bytes come out when the selected code rate is k/n.

The choice of the encoding block size (L) is shown in Table 35.

TABLE 35
Outer Interleaver Block Size by Cluster Size (*Option)

| | Cluster Size | Normal TS | Outer Interleaver |
|---|---|---|---|
| # of Sectors | In Bytes per slivers | Loss (Mbps) | Block (L bits) |
| 4 | 2496 | 0.8252 | 19968 |
| 8 | 4992 | 1.6504 | 39936 |
| 12 | 7488 | 2.4757 | 59904 |
| 16 | 9984 | 3.3009 | 79872 |
| 32* | 19968 | 6.6018 | 159744 |
| 44* | 27456 | 9.0764 | 219648 |

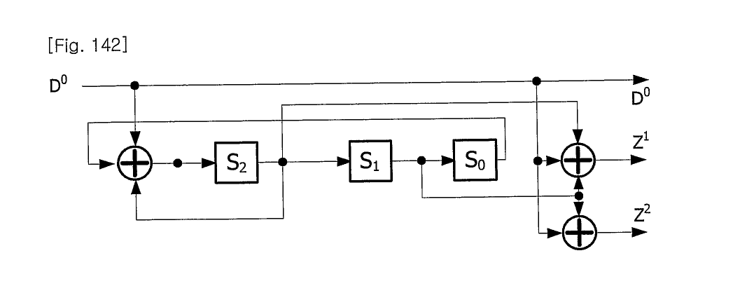

The outer encoder is shown in FIG. 142. Referring to FIG. 142, the outer encoder receives 1 bit (D⁰) and produces 2 bits to 3 bits. At the beginning of a new block, the outer encoder state is set to 0. No trellis-terminating bits are appended at the end of a block. Since the block size is relatively long, it doesn't deteriorate the error-correction capability too much. Possible residual errors, if any, are corrected by the RS code applied in the pre-processor.

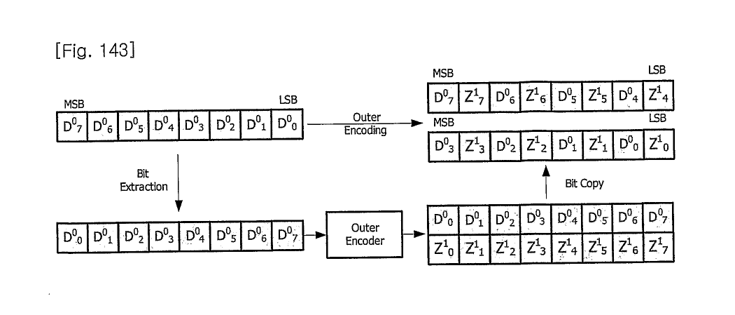

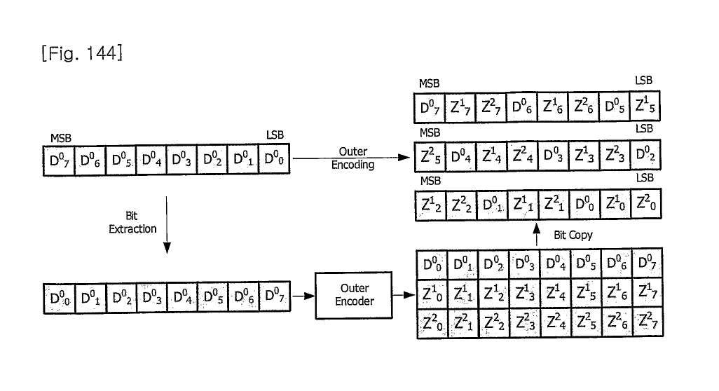

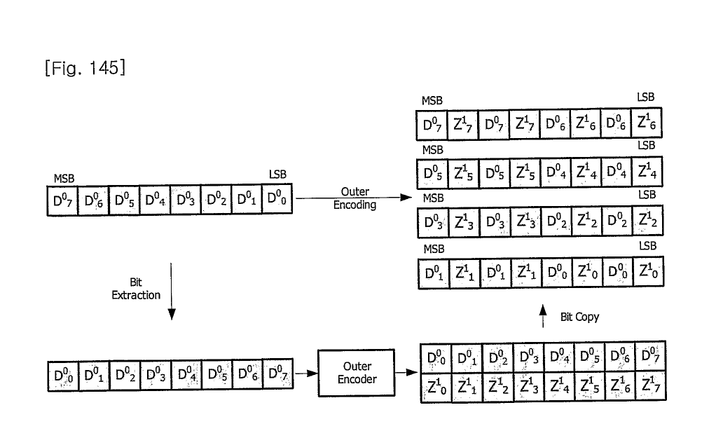

FIGS. 143-145 illustrate an encoding process. In the ½ rate mode, 1 byte is put through D⁰ to the outer encoder and the two bytes obtained from (D⁰ Z¹) are used to produce 2 bytes output. In the ⅓ rate mode, 1 byte is fed to the encoder through D⁰ and 3 bytes are obtained from D⁰, Z¹, Z². In the ¼ rate mode, 1 byte enters the encoder through D⁰ and 2 bytes are produced from D⁰, Z¹. These bits are duplicated to make 4 bytes. The top byte precedes the next top byte at the output of the encoder in FIGS. 143-145.

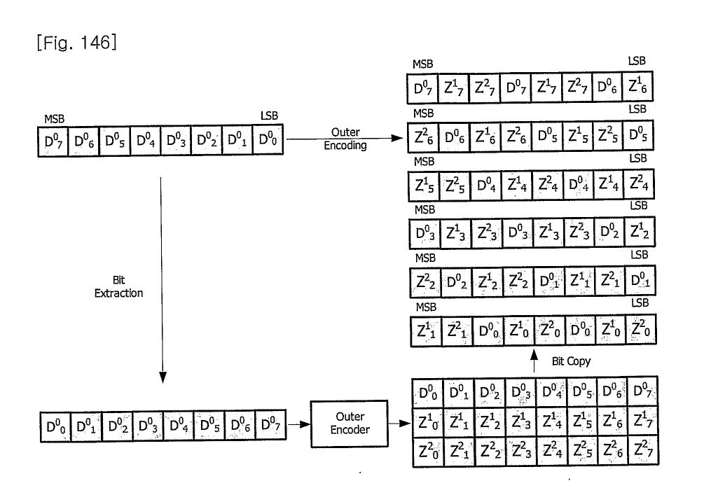

The SIC is encoded by ⅙ turbo code. FIG. 146 shows a process of encoding the SIC.

Outer Interleaver

The outer bit interleaver scrambles the outer encoder output bits. The bit interleaving rule is defined by a linear congruence expression as follows:

Π(i)=(P·i+D_{(i mod 4)mod} L

For a given interleaving length (L), this interleaving rule has 5 parameters (P, D₀, D₁, D₂, D₃) which are defined in Table 36.

TABLE 36
Interleaving Rule Parameters

| L | P | D₀ | D₁ | D₂ | D₃ |
|---|---|---|---|---|---|
| 79872 | 181 | 0 | 0 | 0 | 724 |
| 59904 | 173 | 0 | 0 | 0 | 692 |
| 39936 | 131 | 0 | 0 | 504 | 12 |
| 19968 | 95 | 0 | 380 | 20 | 372 |
| 4992(SIC) | 47 | 0 | 0 | 188 | 376 |

Each turbo stream mode specifies the interleaving length (L) as shown in Table 32. For example, when the interleaving length L=19968 is used, the outer interleaver takes turbo stream data bytes 13312 bits(L bits) to scramble. Table 29 dictates the parameter set (P, D0, D1, D2, D3)=(95,0, 0, 380, 760). The interleaving rule {Π(0), Π(1), Π(L−1)} is generated by:

$$Π ( i ) = \{ \begin{matrix}( 95 \cdot i ) mod 19968 & i mod 4 == 0 , 1 \\ ( 95 \cdot i + 380 ) mos 19968 & i mod 4 == 2 \\ ( 95 \cdot i + 760 ) mod 19968 & i mod 4 == 3\end{matrix}$$

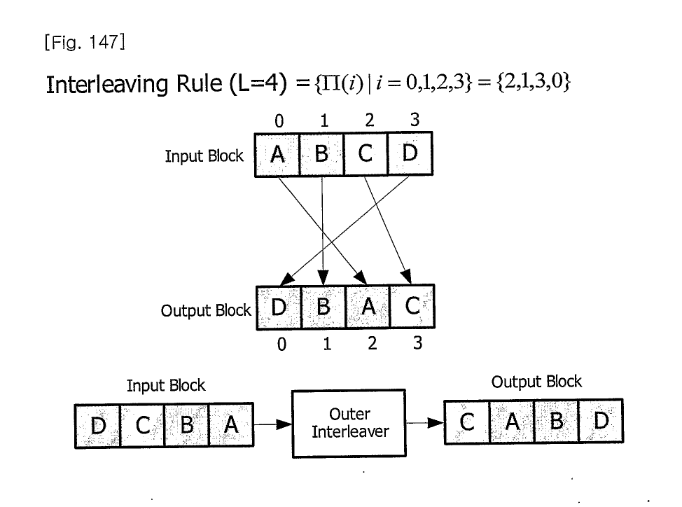

An interleaving rule is interpreted as “The i-th bit in the input block is placed in the Π(i)—the bit in the output block.” FIG. 147 shows an interleaving rule when the length is 4.

Multi-Stream Data Deinterleaver

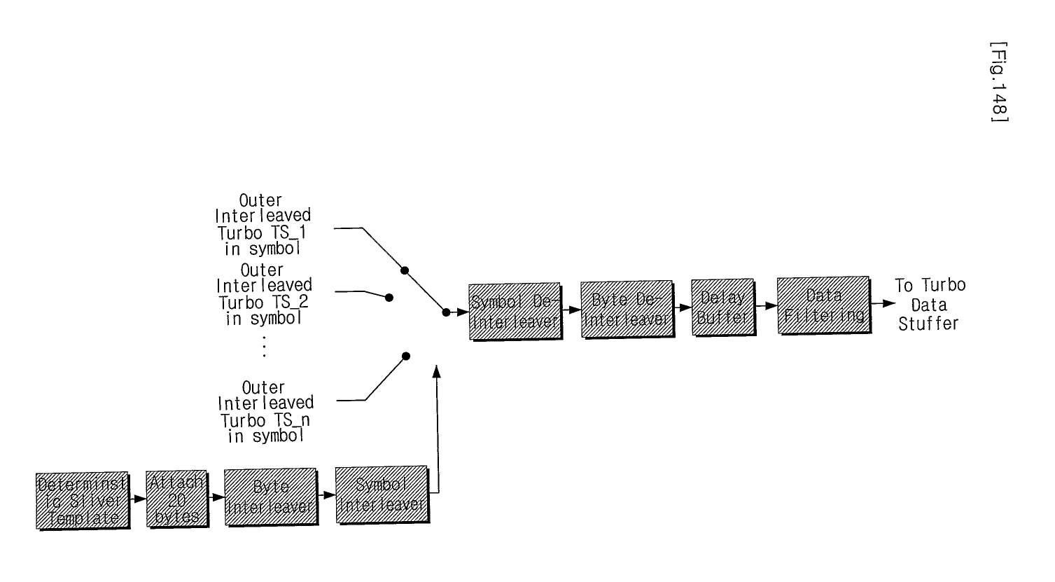

FIG. 148 illustrates a detailed block diagram of a multi-stream data de-interleaver. Following the selected deterministic sliver template, multiplexing information is generated through a 20 byte attacher, an A/53 byte interleaver, and an A/53 symbol interleaver. A symbol is a 2 bit unit. The A/53 symbol interleaver receives an input on a byte basis and produces an output on a symbol basis. Its block size is 828 bytes (828×4=3312) and it mapping is detailed in Table 37. For example, the 4th row in Table 37 indicates that the 3rd output symbol is the 7th and 6th bit of the 3rd input byte.

TABLE 37
Input-Output Mapping in Symbol Interleaver

| | | Bits in |
|---|---|---|
| Output | Input | input |
| Symbol | Byte | byte |
| 0 | 0 | 7, 6 |
| 1 | 1 | 7, 6 |
| 2 | 2 | 7, 6 |
| 3 | 3 | 7, 6 |
| 4 | 4 | 7, 6 |
| 5 | 5 | 7, 6 |
| 6 | 6 | 7, 6 |
| 7 | 7 | 7, 6 |
| 8 | 8 | 7, 6 |
| 9 | 9 | 7, 6 |
| 10 | 10 | 7, 6 |
| 11 | 11 | 7, 6 |
| 12 | 0 | 5, 4 |
| 13 | 1 | 5, 4 |
| . . . | . . . | . . . |
| 19 | 7 | 5, 4 |
| 20 | 8 | 5, 4 |
| 21 | 9 | 5, 4 |
| 22 | 10 | 5, 4 |
| 23 | 11 | 5, 4 |
| 24 | 0 | 3, 2 |
| 25 | 1 | 3, 2 |
| . . . | . . . | . . . |
| 31 | 7 | 3, 2 |
| 32 | 8 | 3, 2 |
| 33 | 9 | 3, 2 |
| 34 | 10 | 3, 2 |
| 35 | 11 | 3, 2 |
| 36 | 0 | 1, 0 |
| 37 | 1 | 1, 0 |
| . . . | . . . | . . . |
| 47 | 11 | 1, 0 |
| 48 | 12 | 7, 6 |
| 49 | 13 | 7, 6 |
| . . . | . . . | . . . |
| 95 | 23 | 1, 0 |
| 96 | 24 | 7, 6 |
| 97 | 25 | 7, 6 |
| . . . | . . . | . . . |
| 767 | 191 | 1, 0 |
| 768 | 192 | 7, 6 |
| 769 | 193 | 7, 6 |
| . . . | . . . | . . . |
| 815 | 203 | 1, 0 |
| 816 | 204 | 7, 6 |
| 817 | 205 | 7, 6 |
| . . . | . . . | . . . |
| 827 | 215 | 7, 6 |
| 828 | 208 | 5, 4 |
| 829 | 209 | 5, 4 |
| 830 | 210 | 5, 4 |
| 831 | 211 | 5, 4 |
| 832 | 212 | 5, 4 |
| 833 | 213 | 5, 4 |
| 834 | 214 | 5, 4 |
| 835 | 215 | 5, 4 |
| 836 | 204 | 5, 4 |
| 837 | 205 | 5, 4 |
| 838 | 206 | 5, 4 |
| 839 | 207 | 5, 4 |
| 840 | 208 | 3, 2 |
| 841 | 209 | 3, 2 |
| . . . | . . . | . . . |
| 847 | 215 | 3, 2 |
| 848 | 204 | 3, 2 |
| 849 | 205 | 3, 2 |
| 850 | 206 | 3, 2 |
| 851 | 207 | 3, 2 |
| 852 | 208 | 1, 0 |
| 853 | 209 | 1, 0 |
| . . . | . . . | . . . |
| 859 | 215 | 1, 0 |
| 860 | 204 | 1, 0 |
| 861 | 205 | 1, 0 |
| 862 | 206 | 1, 0 |
| 863 | 207 | 1, 0 |
| 864 | 216 | 7, 6 |
| 865 | 217 | 7, 6 |
| . . . | . . . | . . . |
| 875 | 227 | 7, 6 |
| 876 | 216 | 5, 4 |
| 877 | 217 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 1643 | 419 | 7, 6 |
| 1644 | 408 | 5, 4 |
| 1645 | 409 | 5, 4 |
| . . . | . . . | . . . |
| 1655 | 419 | 5, 4 |
| 1656 | 412 | 3, 2 |
| 1657 | 413 | 3, 2 |
| 1658 | 414 | 3, 2 |
| 1659 | 415 | 3, 2 |
| 1660 | 416 | 3, 2 |
| 1661 | 417 | 3, 2 |
| 1662 | 418 | 3, 2 |
| 1663 | 419 | 3, 2 |
| 1664 | 408 | 3, 2 |
| 1665 | 409 | 3, 2 |
| 1666 | 410 | 3, 2 |
| 1667 | 411 | 3, 2 |
| 1668 | 412 | 1, 0 |
| 1669 | 413 | 1, 0 |
| . . . | . . . | . . . |
| 1675 | 419 | 1, 0 |
| 1676 | 408 | 1, 0 |
| 1677 | 409 | 1, 0 |
| 1678 | 410 | 1, 0 |
| 1679 | 411 | 1, 0 |
| 1680 | 420 | 7, 6 |
| 1681 | 421 | 7, 6 |
| . . . | . . . | . . . |
| 1687 | 427 | 7, 6 |
| 1688 | 428 | 7, 6 |
| 1689 | 429 | 7, 6 |
| 1690 | 430 | 7, 6 |
| 1691 | 431 | 7, 6 |
| 1692 | 420 | 5, 4 |
| 1693 | 421 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 2471 | 623 | 5, 4 |
| 2472 | 612 | 3, 2 |
| 2473 | 613 | 3, 2 |
| . . . | . . . | . . . |
| 2483 | 623 | 3, 2 |
| 2484 | 616 | 1, 0 |
| 2485 | 617 | 1, 0 |
| 2486 | 618 | 1, 0 |
| 2487 | 619 | 1, 0 |
| 2488 | 620 | 1, 0 |
| 2489 | 621 | 1, 0 |
| 2490 | 622 | 1, 0 |
| 2491 | 623 | 1, 0 |
| 2492 | 612 | 1, 0 |
| 2493 | 613 | 1, 0 |
| 2494 | 614 | 1, 0 |
| 2495 | 615 | 1, 0 |
| 2496 | 624 | 7, 6 |
| 2497 | 625 | 7, 6 |
| . . . | . . . | . . . |
| 2503 | 631 | 7, 6 |
| 2504 | 632 | 7, 6 |
| 2505 | 633 | 7, 6 |
| 2506 | 634 | 7, 6 |
| 2507 | 635 | 7, 6 |
| 2508 | 624 | 5, 4 |
| 2509 | 625 | 5, 4 |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| . . . | . . . | . . . |
| 3299 | 827 | 3, 2 |
| 3300 | 816 | 1, 0 |
| 3301 | 817 | 1, 0 |
| . . . | . . . | . . . |
| 3311 | 827 | 1, 0 |

After multiplexing multi turbo stream symbols in accordance with the generated multiplexing information, they are A/53 symbol de-interleaved and A/53 byte de-interleaved. Since the ATSC A/53 byte interleaver has the delay of 51×4×52 (=204×52) and one sliver consists of 207×52 bytes, (207−204)×52=156 bytes of delay buffer is necessary to synchronize to the sliver unit. Finally, the delayed data corresponding to the reserved space in the AF of the selected sliver template are output to the next block, the turbo data stuffer. The selection of a sliver template is known to the multi-stream data de-interleaver through SIC data as shown with the dashed line in FIG. 130.

Turbo Data Stuffer

The operation of the turbo data stuffer is to get the output bytes of the multi stream data de-interleaver and put them sequentially in the AF made by TA as is shown in FIG. 130.

Turbo Stream Combined with SRS

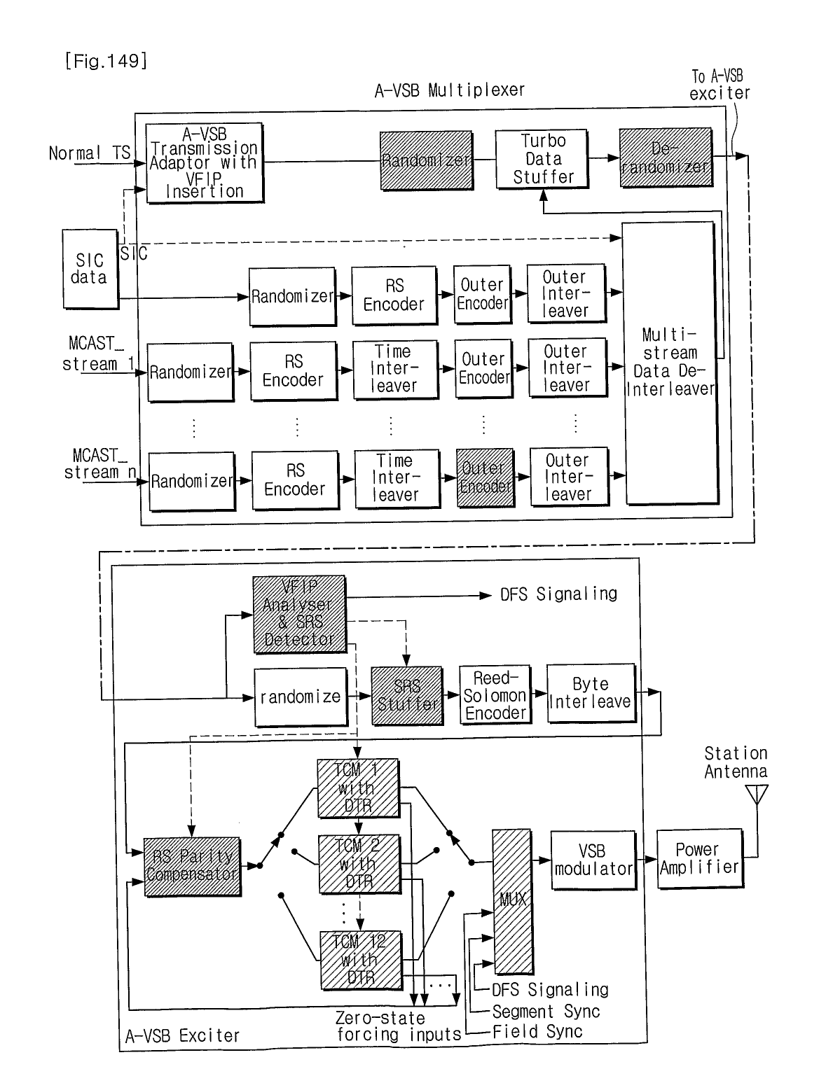

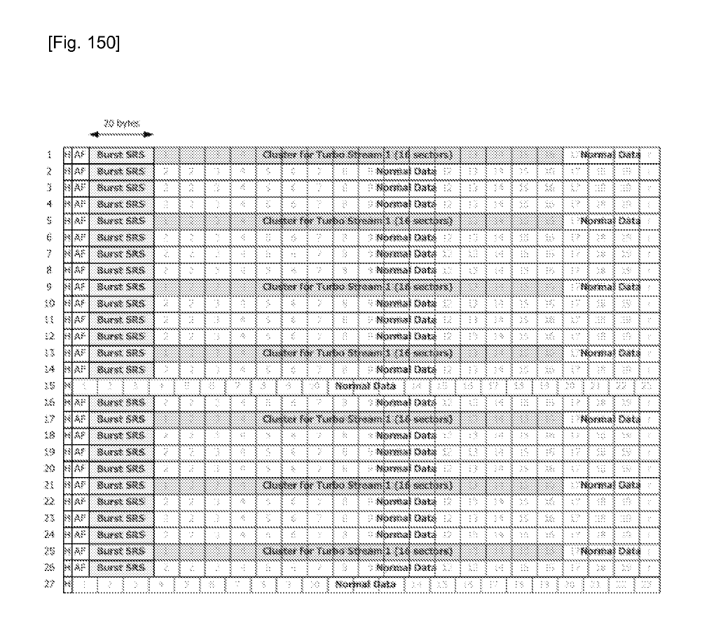

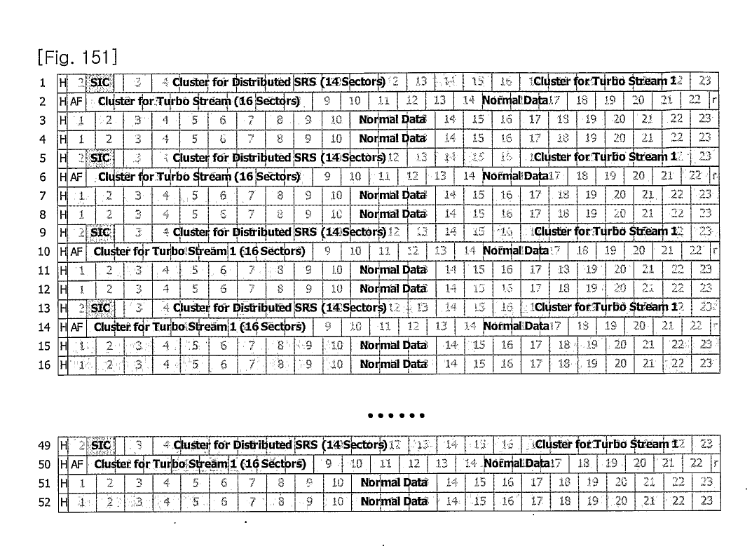

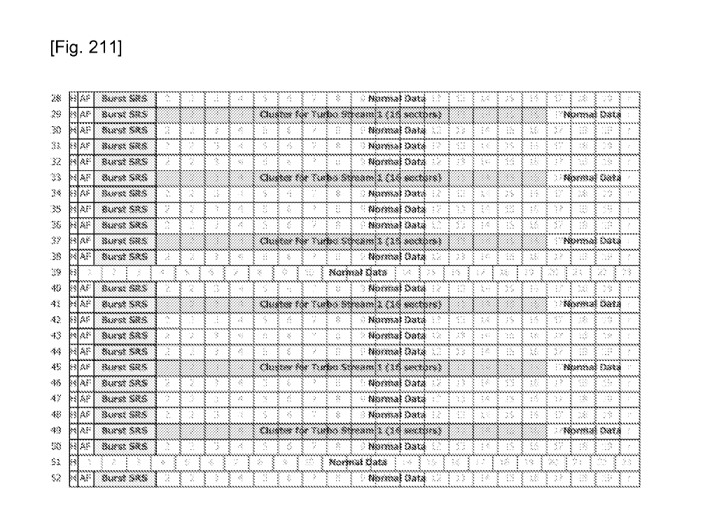

The SRS is easily incorporated into the turbo stream transmission system. FIG. 149 depicts the transmission system enabling the turbo stream with the SRS feature. The sliver templates are synthesized by a simple combination of the SRS and turbo stream sliver templates. The turbo stream cluster shall always follow the cluster for SRS-bytes. Two sliver templates are shown in FIGS. 150, 151, and 211. FIGS. 150 and 211 (hereinafter, FIG. 150) are one figure. One is a sliver template of the burst SRS with the turbo stream and the other is that using the distributed SRS.

Signaling Information

Signaling information that is needed in a receiver must be transmitted. There are two mechanisms for signaling information. One is through a Data Field Sync and the other is via the SIC.

Information that is transmitted through the Data Field Sync is the SRS, and turbo decoding parameters for the primary service. The other signaling information will be transmitted through the SIC.

Since the SIC is a kind of turbo stream, the signaling information in the SIC passes through the exciter from an A-VSB Mux. On the other hand, the signaling information in the DFS has to be delivered to the exciter from an A-VSB Mux through VFIP packet because a DFS is created while the exciter makes a VSB frame. There are two ways to do this communication. One is through the VFIP and the other is through the SRS-placeholder which is filled with SRS-bytes in the exciter.

DFS Signaling Information Through the VFIP

When SRS-bytes are present, the VFIP shall be extended as defined in Table 38. This is shown with the SRS included. It is noted that if the SRS is used, a high speed data channel can carry all signaling to the exciter. If the SRS is not included, the srs_mode field is set to zero (private=0x00).

TABLE 38
DF with SRS and Turbo Stream Packet Syntax

| Syntax | # of Bits | mnemonic |
|---|---|---|
| VFIP_omp_packet( ) { | | |
| transport_packet_header | 32 | bslbf |
| OM_type | 8 | bslbf |
| reserved | 8 | uimsbf |
| srs_bytes | 26 * 8 | uimsbf |
| srs_mode | 8 | uimsbf |
| primary_turbo_stream_mode | 8 | uimsbf |
| private | 154 * 8 | uimsbf |

transport_packet_header—as defined and constrained by ATSC A/110A, Section 6.1.

OM_type—as defined in ATSC A/110, Section 6.1 and set to 0X30.

srs_bytes—as defined above with reference to the adaptation field contents (SRS bytes) for burst SRS.

srs_mode—signals the SRS mode to the exciter and shall be as defined in Table 39, Table 40, and Table 41

turbo_stream_mode—signals the turbo stream modes defined in Table 42 and Table

private—defined by other applications or application tools. If unused, shall be set to 0x00.

DFS Signaling Information

A/53 DFS Signaling (Informative)

The information about the current mode is transmitted on the reserved (104) symbols of each Data Field Sync. Specifically:

1. Allocate symbols for Mode of each enhancement: 82 symbols
A. 1st˜82nd symbol

2. Enhanced data transmission methods: 10 symbols
A. 83rd˜84th symbol (2 symbols): reserved
B. 85th˜92nd symbol (8 symbols): Enhanced data transmission methods
C. On even data fields (negative PN63), the polarities of symbols 83 through 92 shall be inverted from those in the odd data field 3. Pre-code: 12 symbols
   For more information, refer to the ATSC Digital Television Standard (A/53).

A-VSB DFS Signaling Extended from A/53 DFS Signaling

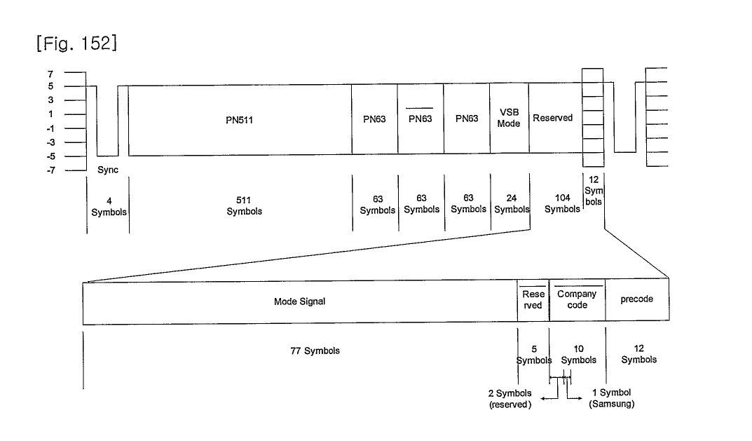

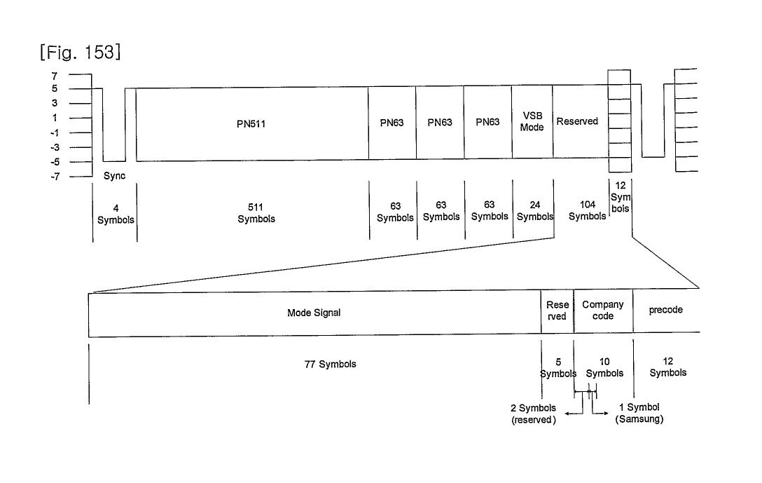

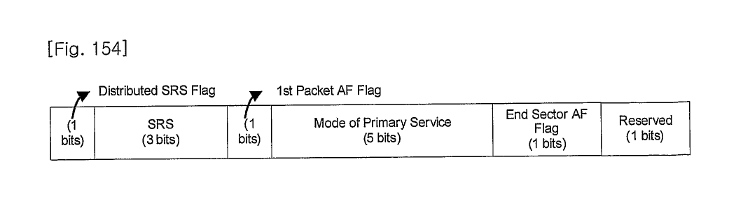

Signaling information is transferred through the reserved area of 2 DFS. 77 Symbols in each DFS amount to 154 Symbols. Signaling information is protected from channel errors by a concatenated code (RS code+convolutional code). The DFS structure is depicted in FIGS. 152 and 153.

Allocation for A-VSB Mode

The mapping between a value and an A-VSB mode is as follows.

Distributed SRS Flag

TABLE 39
Mapping of Distributed SRS flag

| Item | Value |
|---|---|
| Burst SRS | 0 |
| Distributed SRS | 1 |

SRS at Burst SRS

TABLE 40
Mapping of SRS @ Burst SRS

| SRS Bytes per Packet | Value |
|---|---|
| 0 | 000 |
| 10 | 001 |
| 15 | 010 |
| 20 | 011 |
| reserved | 100~111 |

SRS at Distributed SRS

TABLE 41
Mapping of SRS @ Distributed SRS

| SRS Bytes per Track | Value |
|---|---|
| 48 | 000 |
| 56 | 001 |
| 80 | 010 |
| 112 | 011 |
| reserved | 100~111 |

1st Packet AF flag for Primary Turbo Stream

As described above, the turbo data placement will be different depending on the existence of the adaptation field (compare the A-VSB data in FIGS. 104 and 105). So it is necessary to signal the absence or presence of the adaptation field in order for a receiver to correctly locate the cluster for the primary turbo stream.

TABLE 42
Mapping of Full Packet flag

| Item | Value |
|---|---|
| Presence of AF in 1^{st} | 0 |
| packet in Track | |
| Absence of AF in 1^{st} | 1 |
| packet in Track | |

Mode of Primary Service

TABLE 43
Mapping of Turbo Stream Transmission Mode

| Cluster size in | Turbo | Turbo Data | # of MCAST | |
|---|---|---|---|---|
| Sectors (bytes) | Code | Rate | Packets | |
| In every track | Rate | (kbps) | Per package | Value |
| 0 | — | — | — | 00000 |
| 4 (32) | ½ | 372.89 | 6 | 00001 |
| 4 (32) | ⅓ | 248.59 | 4 | 00010 |
| 4 (32) | ¼ | 186.44 | 3 | 00011 |
| 8 (64) | ½ | 745.77 | 12 | 00100 |
| 8 (64) | ⅓ | 497.18 | 8 | 00101 |
| 8 (64) | ¼ | 372.88 | 6 | 00110 |
| 12 (96) | ½ | 1,118.65 | 18 | 00111 |
| 12 (96) | ⅓ | 745.77 | 12 | 01000 |
| 12 (96) | ¼ | 559.33 | 9 | 01001 |
| 16 (128) | ½ | 1,491.54 | 24 | 01010 |
| 16 (128) | ⅓ | 994.36 | 16 | 01011 |
| 16 (128) | ¼ | 745.77 | 12 | 01100 |
| 32 (256) | ½ | 2,983.08 | 48 | 01101 |
| 32 (256) | ⅓ | 1,988.72 | 32 | 01110 |
| 32 (256) | ¼ | 1,491.54 | 24 | 01111 |
| 44 (352) | ½ | 4,101.82 | 66 | 10000 |
| 44 (352) | ⅓ | 2,734.55 | 44 | 10001 |
| 44 (352) | ¼ | 2,050.91 | 33 | 10010 |

| | |
|---|---|
| Reserved | 10011~11111 |

Error Correction Coding for DFS Signaling Information

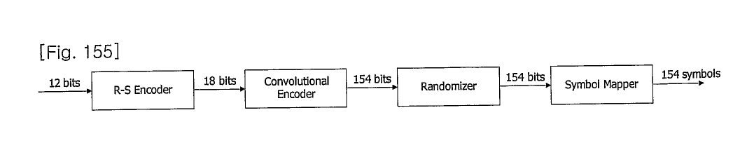

The DFS mode signaling information is encoded by a concatenation of a (6, 4) RS code and a 1/7 convolutional code. (FIG. 155)

R-S Encoder

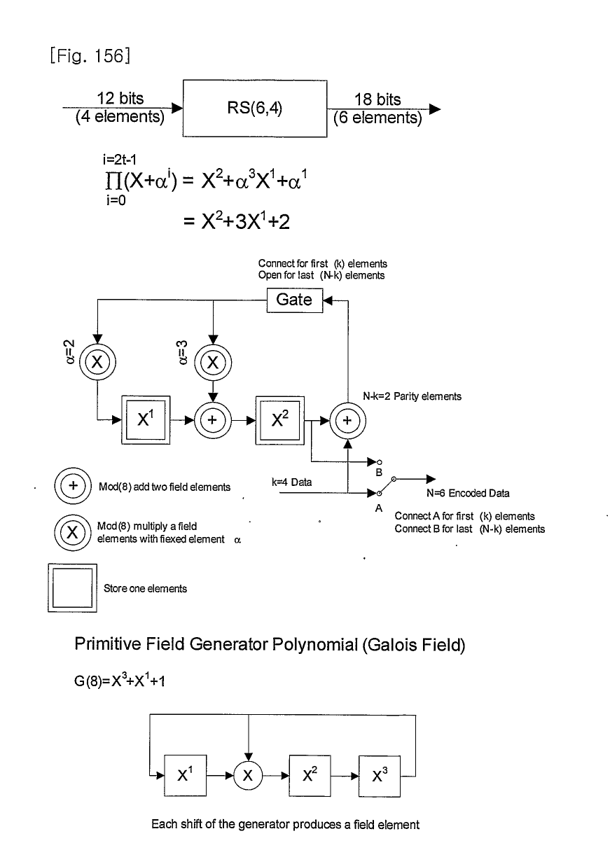

The (6, 4) RS parity bytes are attached to mode information. (FIG. 156)

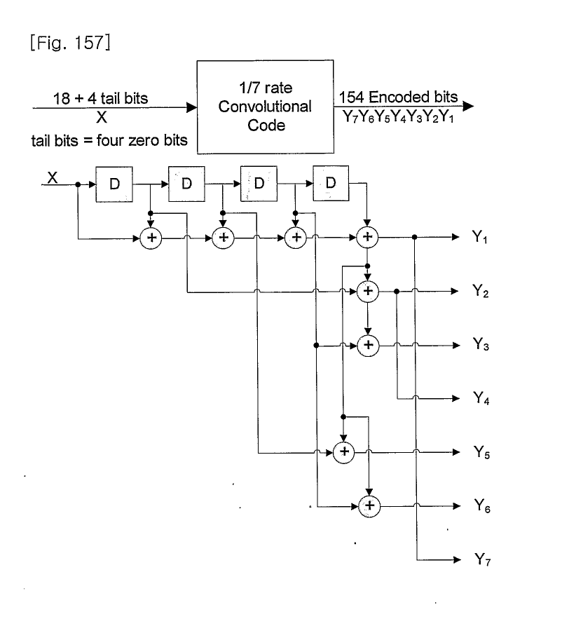

1/7 rate Tail-biting Convolutional Coding (6, 4) R-S encoded bits are encode again by a 1/7 rate trellis-terminating convolutional code. (FIG. 157)

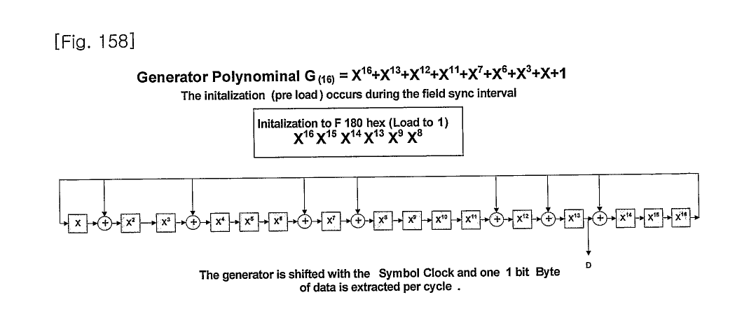

Randomizer. (FIG. 158)

Symbol Mapping

The mapping between a Bit and Symbol is as provided in Table 44.

TABLE 44
Symbol Mapping

| Value of Bit | Symbol |
|---|---|
| 0 | −5 |
| 1 | +5 |

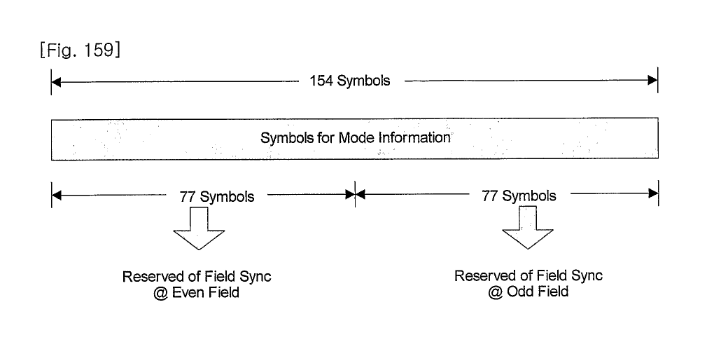

Insert mode signaling symbols at Data Field Sync's Reserved areas (FIG. 159)

SFN SYSTEM

Overview

When identical ATSC transport streams are distributed from a studio to multiple transmitters and when the channel coding and modulation processes in all modulators (transmitters) are synchronized, the same input bits will produce the same output RF symbols from all modulators. If the emission times are then controlled, these multiple coherent RF symbols will appear like natural environmental echoes to a receiver's equalizer and hence be mitigated and received.

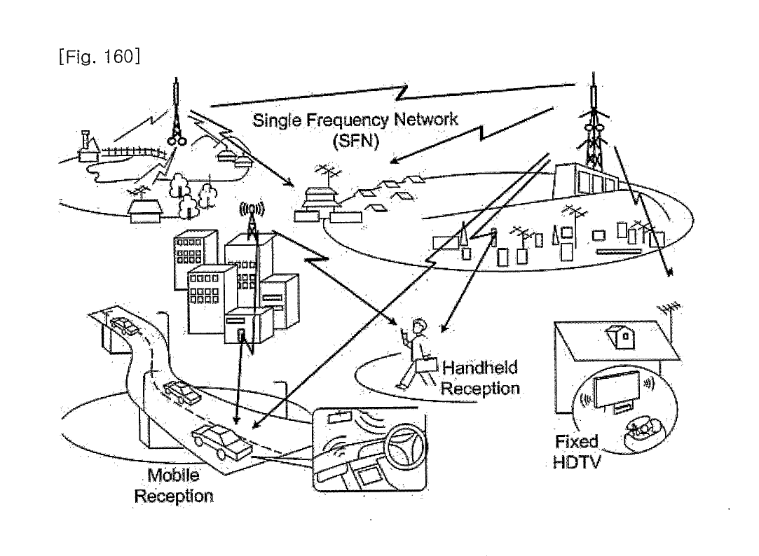

The A-VSB application tool, single frequency network (SFN), offers the option of using transmitter spatial diversity to obtain higher and more uniform signal strength throughout and in targeted portions of a service area. An SFN can be used to improve the quality of service to terrain shielded areas, including urban canyons, fixed or indoor reception environments, or to support new ATSC mobile and handheld services this is depicted in FIG. 160.

The A-VSB application tool, SFN, requires several elements in each modulator to be synchronized. This will produce the emission of coherent symbols from all transmitters in the SFN and enable interoperability. The elements to be synchronized are:

### Frequency (Carrier, Symbol)

### VSB Data Frame

### Pre-Coders/Trellis Coders

### Emission Time

Frequency synchronization of all modulator's carrier frequencies and symbol clocks is achieved by locking these to a universally available frequency reference (10 MHz) from a GPS receiver.

Data frame synchronization requires that all modulators choose the same packet from the incoming transport stream to start or initialize a VSB Frame. A special operations and maintenance packet (OMP) known as a VSB frame initialization packet (VFIP) is inserted once every 20 VSB data frames (12,480 packets) as the last, or 624^{th}, packet in a frame. This cadence determined by a counter in either an emission multiplexer or VFIP inserter which is referenced to 1PPSF. All modulators slave their VSB data framing when VFIP appears in the transport stream.

Synchronization of all pre-coders and trellis coders in all modulators, known collectively as just trellis coders, is achieved by using the core element deterministic trellis reset (DTR) in a sequential fashion over the first 4 data segments in a frame. The cross layer mapping applied in VFIP has 12 byte positions reserved for the DTR operation to synchronize all trellis coders in all modulators in an SFN.

The emission time of the coherent symbols from all SFN transmitters is synchronized by the insertion of time stamps into the VFIP. These time stamps are referenced to the universally available temporal reference of the 1 pulse per second (1PPS) signal from a GPS receiver.

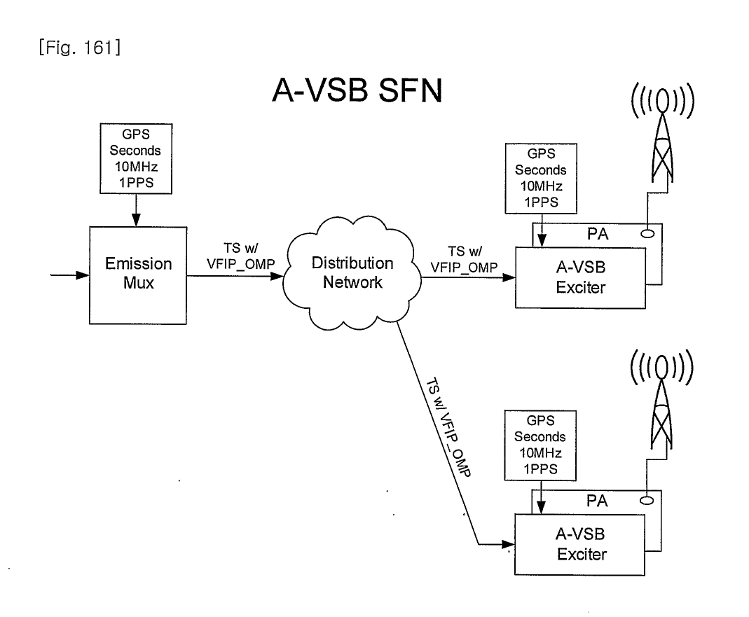

FIG. 161 shows an SFN with an emission multiplexer generating and sending a VFIP to each transmitter in the SFN over a distribution network. This VFIP contains the needed syntax to create all the functionality needed for an A-VSB SFN, as described above.

Encoding Process

A brief overview is presented next of how the core element DF is used to synchronize all the VSB frames and how DTR is used to synchronize all the trellis coders in all modulators in an SFN. Then a discussion of how the emission timing is achieved to control the delay spread seen by a receiver will be illustrated using an SFN timing diagram.

DF (Frame Synchronization, DTR (Trellis Coders Synchronization)

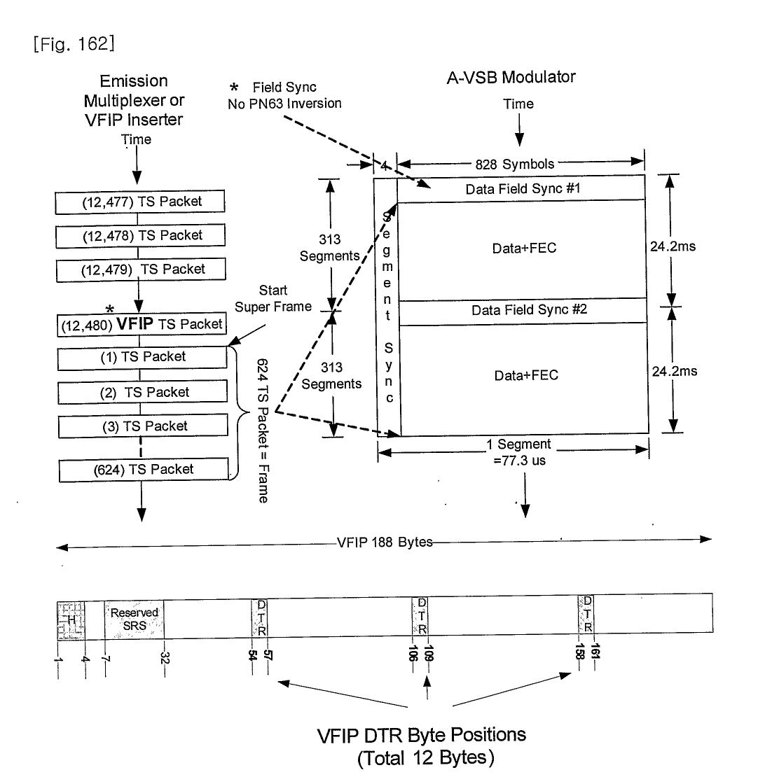

The VFIP is generated in the emission multiplexer or VFIP inserter and inserted as the last (624^{th}) packet of the last VSB frame of a super frame exactly once every 12,480 TS packets. The VFIP inserter is used to create the VFIP if a station wishes an SFN only. If turbo, SRS, and SFN are required the VFIP functionality would reside in the emission multiplexer. The insertion cadence is determined by a counter in the emission multiplexer locked to the ATSC system time. All modulators initialize or start a VSB frame by inserting a DFS with no middle PN 63 inversion after the last bit of VFIP. This action will synchronize all VSB frames in all modulators in a SFN. This is shown in FIG. 162.

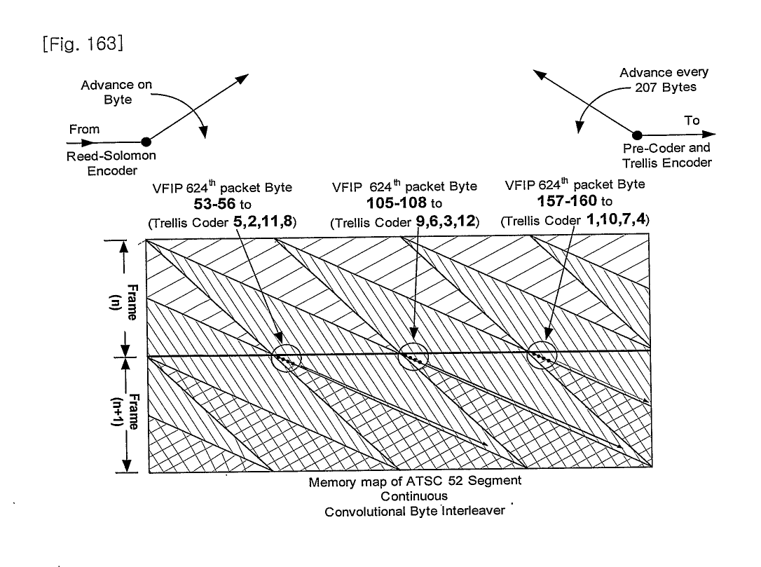

The synchronization of all trellis coders in all modulators uses the DTR byte mapping in a VFIP which contains twelve DTR bytes in pre-determined byte positions. The chosen DTR byte positions assure that later in time in each modulator a DTR byte is positioned in the designated one of 12 trellis coders the instant a DTR occurs. The DTR is designed to occur in a sequential fashion over the first 4 data segments of the next VSB frame following the insertion of a VFIP. FIG. 163 shows the position of the DTR bytes in the ATSC 52-segment byte interleaver. The last 52 packets in Frame (n), with VFIP as the last packet, are clocked as shown into the normal ATSC interleaver. An interleaver memory map is shown depicting the time of interest. Then the bytes are read out row-by-row and sent to the trellis coders. The middle horizontal line represents the frame boundary between Frames (n) and (n+1). Notice that half of the bytes of the last 52 input packets remain in Frame (n) and the other half reside in Frame (n+1) when removed from the ATSC 52-segment byte interleaver memory. It is further noted that the DTR byte position in the 52-segment interleaver appears to have been shifted one byte position because the segment sync has been stripped from the TS packet as part of the normal ATSC channel coding process.

The DTR bytes in the VFIP are shown circled in FIG. 163 and will reside in the first 4 data segments of (Frame n+1) when they are removed from the interleaver memory. These DTR bytes will each be sent to one of the designated 12 trellis coders. A deterministic trellis reset (DTR) occurs upon arrival of each of the DTR byte at its respective targeted trellis coder. As a result of first achieving VSB framing using the DF and now by the simultaneous deterministic trellis reset (DTR) in all modulators within a network, coherent symbols will now be produced from all transmitters.

In summary, the appearance of the VFIP will cause VSB frame synchronization, and the DTR bytes in the VFIP are used to synchronize all trellis coders by performing the DTR in all modulators.

Emission Time Synchronization

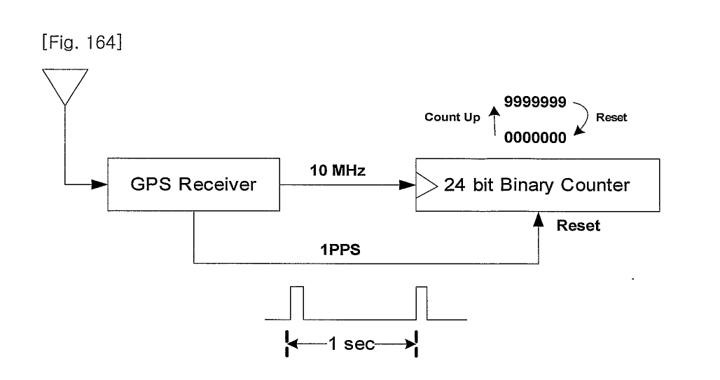

The emission times of the coherent symbols from all transmitters now need to be tightly controlled so that their arrival times at a receiver doesn't exceed the delay spread or echo handling range of the receiver's equalizer. Transmitters can be located miles apart and will receive a VFIP over a distribution network (microwave, fiber, satellite, etc). The distribution network has a different transit delay time on each path to a transmitter. This must be compensated to enable a common temporal reference to be used to control all emission timing in the SFN. The 1PPS signal from a GPS receiver is used to create a common temporal reference in all nodes of the SFN, that is the emission multiplexer and all the modulators. This is shown in FIG. 164.

Referring to FIG. 164, all nodes in the network have the equivalent of this circuit, a 24 bit binary counter driven by the GPS 10 MHz clock signal. The counter counts up from 0000000-9999999 in one-second intervals, then resets to 0000000 on the edge of the 1PPS pulse from the GPS receiver. Each clock tick and count advance is 100 nanoseconds. With the universal availability of GPS, this technique is easy to establish in all nodes in a network and forms the basis of all time stamps used to implement SFN emission timing.

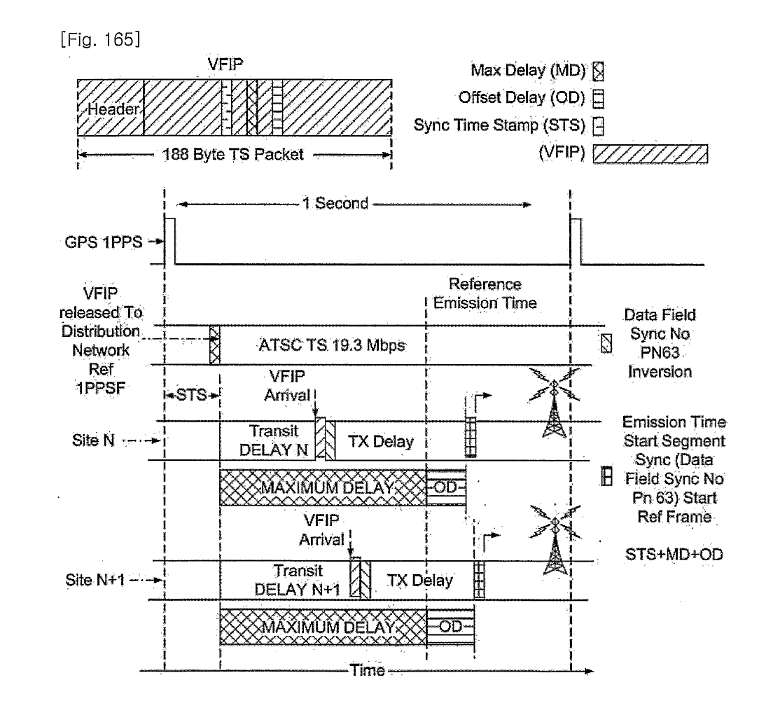

The major syntactic elements in VFIP to enable the basic emission timing in a SFN will be discussed, including sync_time_stamp (STS), maximum_delay (MD), and tx_time_offset (OD). FIG. 165 is an SFN timing diagram. All nodes have the 24-bit counter discussed above available as the temporal reference for all time stamps.

Referring to FIG. 165, the different transit delay times on all distribution paths must be compensated to enable tight SFN timing control. The MD timestamp contains a pre-calculated time stamp value established by the SFN network designer based on the transit time delays of all paths. The MD value is calculated to be greater than the longest transit delay on any path of the distribution network. The STS enables an input FIFO buffer delay to be established in each modulator that is equal to the MD value minus the actual transit delay time experienced on the distribution path to a modulator. This action will establish a reference emission time that is the same for all transmitters and is independent of the transit delays encountered in the distribution network, the transit delays having been mitigated. Then a calculated offset delay value OD may optionally be then applied to each exciter individually to optimize the SFN timing

Observing the SFN timing diagram in FIG. 165 more closely, we see the commonly available 1PPS on the first line of the timing diagram. Directly below is shown the release of the VFIP into the distribution network carrying an STS value equal to the value that was observed on the local 24 bit counter in the emission multiplexer the instant the VFIP was released into the distribution network. Site N is shown on the next line with the arrival of the VFIP; the instant that the VFIP arrives, the count on the local 24-bit counter is stored (arrival time). The actual transit time delay measured in 100 ns increments is the difference of the values of the (arrival time) minus the value of the received STS value (inserted by the emission multiplexer). The next line shows Site N+1, which experienced a different transit delay. The reference emission time is observed to be equal at both sites however, as a result of the tx_delay being calculated independently in each modulator based on the STS. The actual emission time for each site can then be optionally offset by the OD value, allowing for optimization of network timing under the control of the SFN designer.

It is noted that in an ideal model with all transmitters systems having identical time delays, the above description would produce a common reference emission time. However, in the real world, a delay value is calculated for each site to compensate each site's inherent time delay. All modulators have a means of accepting a 16-bit value of the calculated transmitter and antenna delay (TAD), a value represented in 100 ns increments. This value includes the total delay through the transmitter the RF filters and transmission line up to and including the antenna. This calculated value (TAD) is entered by the network designer and is subtracted from the MD value received in the VFIP to set an accurate, common timing demarcation point for the RF emission as the air interface of the antenna at each site. The TAD value shall equal the time from the entry of the last bit of the VFIP into the data randomizer in the exciter to the appearance at the antenna air interface of the leading edge of the segment sync of the data field sync having no PN 63 Inversion.

The cross layer mapping of the (12) DTR bytes in a VFIP will by design be used to reset the (12) trellis coders, thus producing a total of 12 RS byte-errors into the VFIP. A VFIP packet error occurs because the 12 byte-errors within a single packet exceeds the 10-byte RS correction capability of ATSC. This deterministic packet error will occur only on each VFIP packet every 12,480 TS packets. It should be noted that normal receivers will ignore the VFIP with an ATSC reserved PID 0x1FFA. Extensibility is envisioned to enable a single VFIP to control multiple tiers of SFN translators and also for providing signaling to SFN field test and measurement equipment. Therefore, additional error correction is included within the VFIP to allow specially designed receivers to successfully decode the syntax of a transmitted VFIP, effectively allowing reuse of the same VFIP over multiple tiers of an SFN translator network.

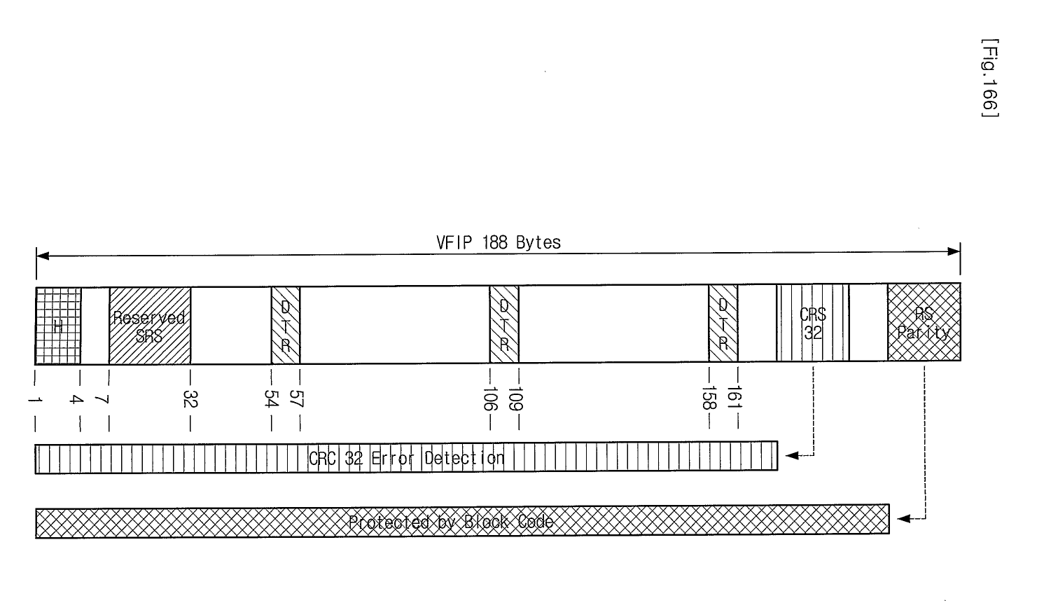

FIG. 166 shows that the VFIP has a CRC_{—}32 used to detect errors on the distribution network and an RS block code used to detect and correct byte errors of the transmitted VFIP by a special VFIP aware receiver. The RS encoding in the emission multiplexer first sets all DTR bytes to 0x00 before RS encoding and a special ATSC VFIP receiver sets all DTR bytes to 0x00 before RS decoding to enable correction of up to 10 RS byte errors.

Support for Translators in SFN

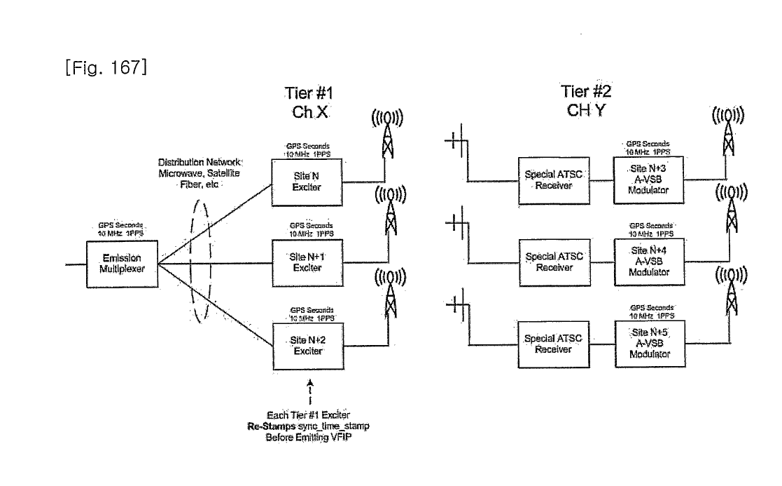

FIG. 167 shows a two-tier SFN translator network using VFIP. Referring to FIG. 167, tier #1 transmits on Ch X, receives the data stream over a distribution network, and achieves emission timing as described above for an SFN.

The RF broadcast signal from tier #1 is used as the distribution network to the transmitters in tier #2. To achieve this goal, the sync_time_stamp (STS) field in the VFIP is recalculated (and re-stamped) before being emitted by tier #1 modulators. The updated (tier #2) sync_time_stamp (STS) value is equal to the sum of the sync_time_stamp (STS) value and the maximum_delay (MD) value received from the tier #1 distribution network. The recalculated sync_time_stamp (STS) is used along with the tier #2 tier_maximum_delay value in the VFIP. The tier#2 emission timing is then achieved as described for an SFN. If another tier of translators is used, a similar re-stamping will occur at tier #2, etc. A single VFIP can support up to a total of 14 transmitters in up to four tiers. If more transmitters or tiers are desired an additional VFIP can be used.

VFIP Syntax

A VFIP is required for the operation of an SFN. This OMP shall and have an OM_type in the range of 0x31-0x3F. The complete VFIP syntax is shown in Table 45.

TABLE 45
VFIP Syntax

| Syntax | # of Bits | mnemonic |
|---|---|---|
| vfip_packet( ) { | | |
| transport_packet_header | 32 | bslbf |
| om_type | 8 | bslbf |
| reserved | 8 | bslbf |
| for (i=0; i<26;i++) { | | |
| SRS_reserved | 8 | uimsbf |
| } | | |
| reserved | 8 | bslbf |
| srs_mode | 8 | uimsbf |
| turbo_stream_mode | 8 | uimsbf |
| sync_time_stamp | 24 | uimsbf |
| maximum_delay | 24 | uimsbf |
| network_id | 12 | uimsbf |
| T&M_flag | 1 | bslbf |
| number_of_translator_tiers | 3 | uimsbf |
| reserved | 8 | uimsbf |
| for (i=0; i<3; i++) { | | |
| if (i < number_of_translator_tiers) { | | |
| tier_maximum_delay | 24 | uimsbf |
| } | | |
| else { | | |
| stuffing | 24 | uimsbf |
| } | | |
| } | | |
| DTR_reserved | 32 | uimsbf |
| if (number_of_translator_tiers = 4) { | | |
| tier_maximum_delay | 24 | uimsbf |
| } | | |
| else { | | |
| stuffing | 24 | uimsbf |
| } | | |
| if (T&M_flag = ‘1’) { | | |
| field_T&M | 40 | bslbf |
| } | | |
| else { | | |
| stuffing | 40 | uimsbf |
| } | | |
| number_tx | 8 | uimsbf |
| for (i=0; i<6; i++) { | | |
| if (i < number_tx) { | | |
| tx_address | 12 | uimsbf |
| reserved | 4 | uimsbf |
| tx_time_offset | 16 | uimsbf |
| tx_power | 12 | uipfmsbf |
| tx_id_level | 3 | uimsbf |
| tx_data_inhibit | 1 | uimsbf |
| } | | |
| else { | | |
| stuffing | 48 | bslbf |
| } | | |
| } | | |
| for (i=0; i<3; i++) { | | |
| stuffing_byte | 8 | uimsbf |
| } | | |
| DTR_reserved | 32 | uimsbf |
| for (i=6; i<14; i++) { | | |
| if (i < number_tx) { | | |
| tx_address | 12 | uimsbf |
| reserved | 4 | uimsbf |
| tx_time_offset | 16 | uimsbf |
| tx_power | 12 | uipfmsbf |
| tx_id_level | 3 | uimsbf |
| tx_data_inhibit | 1 | uimsbf |
| } | | |
| else { | | |
| stuffing | 48 | bslbf |
| } | | |
| } | | |
| DTR_reserved | 32 | uimsbf |
| crc_32 | 32 | rpchof |
| for (i=0; i<3; i++) { | | |
| stuffing | 8 | uimsbf |
| } | | |
| vfip_ecc | 160 | uimsbf |
| } | | |

transport_packet_header—and constrained by ATSC A/110A, Section 6.1.

OM_type—defined in ATSC A/110, Sec 6.1 and set to a value in a range of 0x31-0x3F inclusive, are assigned sequentially starting with 0x31 and continuing according to the number of transmitters in the SFN design. Each VFIP supports a maximum of 14 transmitters

srs_bytes—as defined above with reference to the adaptation field contents (SRS bytes) for burst SRS

srs_mode—signals SRS mode

turbo_stream_mode—signals turbo mode

sync_time_stamp—contains the time difference, expressed as a number of 100 ns steps, between the latest pulse of the 1PPS signal and the instant the VFIP is transmitted into the distribution network as indicated on a 24-bit counter in an emission multiplexer.

maximum_delay—a value larger than the longest delay path in the distribution network expressed as a number of 100 ns steps. The range of maximum_delay is 0x000000 to 0x98967F, which equals a maximum delay of 1 second.

network_id—a 12-bit unsigned integer field representing the network in which the transmitter is located. This also provides part of the 24 bit seed value (for the Kasami Sequence generator defined in A/110A) for a unique transmitter identification sequence to be assigned for each transmitter. All transmitters within a network shall use the same 12-bit network_id pattern.

TM_flag—signals data channel for automated A-VSB field test & measurement equipment where 0 indicates T&M channel inactive, and 1 indicates T&M channel active.

number_of_translator_tiers—indicates number of tiers of translators as defined in Table 46.

TABLE 46
Translator Tiers

| number_of_translator_tiers Value | Meaning |
|---|---|
| 000b | No translators |
| 001b | one tier of translators |
| 010b | two tiers of translators |
| 011b | three tiers of translators |
| 100b | four tiers of translators |
| 101b-111b | Prohibited |

tier_maximum_delay—shall be value larger than the longest delay path in the translator distribution network expressed as a number of 100 ns steps. The range of tier_maximum_delay is 0x000000 to 0x98967F which equals a maximum delay of 1 second

reserved—All bits set to zero

DTR_bytes—shall be set 0x00000000.

field_TM—private data channel to control remote field T&M and monitoring equipment for the maintenance and monitoring of SFN.

number_tx—number of transmitters in SFN being controlled by a VFIP. This is currently constrained to the values 0x00-0x0E, with 0x0F-0xFF Prohibited.

crc_{—}32—A 32 bit field that contains the CRC of all the bytes in the VFIP, excluding the vfip_ecc bytes. The algorithm as defined in ETSI TS 101 191, Annex A.

vfip_ecc—A 160-bit unsigned integer field that carries 20 bytes of Reed Solomon Parity bytes for error correcting coding used to protect the remaining payload bytes.

tx_address—A 12-bit unsigned integer field that carries the unique address of the transmitter to which the following fields are relevant. Also used as part of the 24-bit seed value (for the Kasami Sequence generator—see A/110A) for a unique sequence to be assigned to each transmitter. All transmitters in a network shall have a unique 12-bit address assigned.

tx_time_offset—A 16-bit signed integer field that indicates the time offset value, measured in 100 ns increments, allowing fine adjustment of the emission time of each individual transmitter to optimize network timing

tx_power—A 12-bit unsigned integer plus fraction that indicates the power level to which the transmitter to which it is addressed should be set. The most significant 8 bits indicate the power in integer dB relative to 0 dBm, and the least significant 4 bits indicate the power infractions of a dB. When set to zero, tx_power shall indicate that the transmitter to which the value is addressed is not currently operating in the network. The tx_power is left as an optional feature.

tx_id_level—A 3-bit unsigned integer field indicates to what injection level (including off) the RF watermark signal of each transmitter shall be set.

tx_data_inhibit—A 1-bit field that indicates when the tx_data( ) information should not be encoded into the RF watermark signal

RF Watermark

The spread spectrum signal technology introduced first in A/110A for the transmitter Identification (TxID) is also included. In addition to the applications of transmitter identification and enabling special test equipment for SFN timing and monitoring purposes other uses of this technology may be possible.

ATSC System Time

The emission multiplexer sends a VFIP every 12,480 TS packet to an A-VSB modulator to establish the deterministic frame (DF), which enables cross layer techniques to be employed to enhance 8-VSB. Instead of having each emission multiplexer at each station select independently a starting point for cadence of the VFIP, a global reference is developed to enable all station to have a deterministic VSB framing relationship. This synchronization may enable such things as future location based applications or ease the interoperability with 802.xx networks. If the global framing reference is combined with the deterministic mapping of turbo stream content, an effective handoff scheme for wide area mobile service between two cooperating stations can be enabled. The benefits of the ATSC system time (AST) is relevant to a single transmitter station or an SFN.

To achieve these goals, a global reference signal is needed to signal the opportunity to start a VSB super frame (SF) in all emission multiplexers and modulators. This is possible because of the fixed ATSC symbol rate and the fixed ATSC VSB frame structure and the global availability of GPS. GPS has several temporal references available that will be used:

### 1.) Defined Epoch

### 2.) GPS Seconds Count

### 3.) 1PPS

The epoch or start of GPS time is defined as Jan. 6, 1980 00:00:00 UTC. The ATSC epoch is defined to be the same as the GPS epoch, Jan. 6, 1980 00:00:00 UTC.

The ATSC epoch is defined as the instant the first symbol of the segment sync of the first DFS (No PN 63 Inv) of the first super frame was emitted at the air interface of the antenna of all ATSC DTV stations.

The GPS second count gives the number of seconds elapsed since the epoch. The one pulse per second signal (1PPS) is also provided by a GPS receiver and signals the start of a second by a rising edge of 1PPS.

We define an ATSC unit of time close to one second in duration which we can compare to GPS seconds. The A-VSB super frame (SF) is equal to 20 VSB frames and has a period of 0.967887927225471088 seconds. Given the common defined epoch and the global availability of the GPS second count and 1PPS we can calculate the offset between the next GPS second tick indicated by 1PPS and the start of a super frame at any point in time since the epoch. The super frame start signal is term the one pulse per super frame (1PPSF). This relationship allows circuitry to be designed in the emission multiplexer and exciter to have the common 1PPSF reference for VSB framing. The ATSC system time is defined as the number of super frames (SF) since the epoch.

Meanwhile, a digital broadcasting receiver according to an embodiment of the present invention may have a constitution that is implemented in reverse order to the constitution of the transmitting side as explained above. Aspects of the present invention can thereby receive and process a stream transmitted from the digital broadcasting transmitter as explained above.

The digital broadcasting receiver may, for example, include a tuner, a demodulator, an equalizer, and a decoding unit. In this case, the decoder may include a trellis decoder, an RS decoding unit, and a deinterleaver. In addition, a range of other units, such as a derandomizer and a demultiplexer, having various orders of arrangements, may also be added.

Although a few embodiments of the present invention have been shown and described, it would be appreciated by those skilled in the art that changes may be made in this embodiment without departing from the principles and spirit of the invention, the scope of which is defined in the claims and their equivalents.

1. A digital broadcasting transmitter, comprising:
a Reed-Solomon (RS) encoder to encode signaling information; and
a randomizer to randomize a stream including the signaling information encoded by the RS encoder.

2. The digital broadcasting transmitter of claim 1, further comprising:
a convolutional-encoder to convolutional-encode the signaling information encoded by the RS encoder; and
a symbol-mapper to symbol-map the stream randomized by the randomizer.

3. A method of processing a stream by a digital broadcasting transmitter, the method comprising:
encoding signaling information; and
randomizing a stream including the encoded signaling information.

4. The method of claim 3, further comprising:
convolutional-encoding the encoded signaling information; and
symbol-mapping the randomized stream.

5. A digital broadcasting receiver, comprising:
a receiver to receive a turbo stream processed to be robust against errors and signaling information;
a demodulator to demodulate the turbo stream; and
an equalizer to equalize the turbo stream,
wherein the demodulator and/or the equalizer demodulates and/or equalizes the turbo stream using the signaling information, and
wherein the signaling information is transmitted from a digital broadcasting transmitter which comprises an RS encoder to encode the signaling information and a randomizer to randomize the encoded signaling information.
